(19) United States
(12) Patent Application Publication
(10) Pub. No.: US 2022/0036319 A1
(43) Pub. Date: Feb. 3, 2022

(54) PROCESS FOR A CENTRAL OPERATING SYSTEM TO REPAIR AND MAINTAIN UNMANNED VEHICLES ONSITE OR AT A REPAIR DEPOT WITH IDENTIFICATION OF A VEHICLE NEEDING ONSITE OR REPAIR DEPOT REPAIR OR MAINTENANCE, WITH AUTHORIZING, SCHEDULING, ESTIMATING THE COST, TRANSPORTING VEHICLES TO AND FROM A REPAIR DEPOT, PERFORMING A FULL SYSTEM, 'DOWNING' A VEHICLE, REMOVING A 'GROUNDED' STATUS FROM A VEHICLE AND RETURNING A VEHICLE TO SERVICE AFTER REPAIR OR MAINTENANCE

(71) Applicant: Aeronyde Corporation, Melbourne, FL (US)

(72) Inventors: Donald Bittar, Palm Bay, FL (US); Alexander Bilous, Citrus Springs, FL (US); Daeheum Chung, Lake Mary, FL (US); Edgar Munoz, Orlando, FL (US)

(21) Appl. No.: 16/803,877

(22) Filed: Jul. 28, 2020

(51) Int. Cl. G06Q 10/00; G06Q 10/06; G06Q 10/08; G06Q 30/02

(52) U.S. Cl. CPC G06Q 10/20; G06Q 10/06311; G06Q 10/06313; G06Q 30/0283; G06Q 10/0833; G06Q 10/0875; G06Q 10/0832

(57) ABSTRACT

A process for a central operating system to repair and maintain unmanned Vehicles used for, but not limited to, inspection of commercial outdoor assets, agricultural crops, civil and public infrastructure, fire control, public safety and public emergency services. Perform the repair and maintenance of unmanned aerial Vehicles onsite or at a repair depot with identification of a Vehicle needing onsite or repair depot repair or maintenance, with authorizing, scheduling, estimating the cost, transporting Vehicles to and from a repair depot, performing a full system, ‘downing’ a Vehicle, removing a ‘grounded’ status from a Vehicle and returning a Vehicle to service after repair or maintenance.

### REFERENCES CITED, U.S. PATENT DOCUMENTS

This application claims priority from U.S. non-provisional application Ser. No. 16/519,906, filed Jul. 23, 2019, Ser. No. 16/578,874, filed Sep. 23, 2019, and Ser. No. 16/713,315 filed, Dec. 13, 2019 each of which is incorporated herein by reference in their entirety.

### BACKGROUND OF THE RELATED ART

One problem with repairing and maintaining remotely operated aerial Vehicles today is that no process exists to employ a centralized datastores, management, procedures, practices and facilities to repair and maintain a plurality of remotely operated aerial Vehicles compliant with FAA and other regulatory agencies. There does not exist today a remote, unmanned Vehicle operating center system to repair and maintain unmanned Vehicles onsite or at a repair depot with identification of a Vehicle needing onsite or repair depot repair or maintenance, with authorizing, scheduling, estimating the cost, transporting Vehicles to and from a repair depot, performing a full system, ‘downing’ a Vehicle, removing a ‘grounded’ status from a Vehicle and returning a Vehicle to service after repair or maintenance.

A process and system for a central operating system to repair and maintain unmanned Vehicles onsite or at a repair depot with identification of a Vehicle needing onsite or repair depot repair or maintenance, with authorizing, scheduling, estimating the cost, transporting Vehicles to and from a repair depot, performing a full system, ‘downing’ a Vehicle, removing a ‘grounded’ status from a Vehicle and returning a Vehicle to service after repair or maintenance, herein and commercially referred to as Aeronyde Repair, Operations, Maintenance and Administration (ROMA) or Aeronyde ROMA or ROMA, available from Aeronyde Corporation

Using a plurality of unrelated individuals to repair and maintain remotely operated aerial Vehicles (hereinafter called ‘Vehicle’) is costly, slow, inconsistent, not actionable, difficult to manage and control and often places the users and the Vehicles at risk with questionable repair and maintenance outcomes. Such an unmanageable process creates unnecessary risk to the public safety and welfare.

### BRIEF DESCRIPTION OF THE DRAWINGS

The present invention can be more easily understood and the advantages and uses thereof more readily apparent when the detailed description of the present invention is read in conjunction with the figures wherein:

FIG. 1 illustrates an exemplary method of identifying a Vehicle needing repair and the related processes of a Repair Technician to query a datastore for ‘down’ Vehicles;

and a Repair Technician to produce a Down Vehicle Report;

and a Repair Technician to review the standard repair time and cost estimates;

and a Repair Technician to determine the repair location for a Vehicle;

and a Repair Technician to determine the repair priority for the Vehicle;

and a Repair Technician to estimate the repair date for the Vehicle;

and a Repair Technician to notify Enterprise that a Vehicle needs repair;

and a Repair Technician to produce an Enterprise Vehicle Repair Report;

and a Repair Technician to send Enterprise an Authorization Vehicle Repair Report;

and a Repair Technician to produce an Enterprise Vehicle Repair Authorization Request Report;

and a Repair Technician to produce a Vehicle Repair Location Report;

and a Repair Technician to produce a Vehicle Repair Priority Report;

and a Repair Technician to produce a Vehicle Estimated Repair Completion Report.

FIG. 2 illustrates an exemplary method of having an Enterprise authorize repair of a Vehicle and the related processes of an Enterprise Agent to authorize a Vehicle repair;

and a Repair Technician to start a dispute process;

and an Enterprise Agent to sign and return an Enterprise Vehicle Authorization Request Report;

and a Repair Technician to start a loss mitigation process;

and a Repair Technician to determine the parts needed to repair a Vehicle;

and a Repair Technician to produce a Vehicle Repair Parts Report;

and a Repair Technician to estimate the cost of a Vehicle repair;

and a Repair Technician to produce a Vehicle Repair Cost Estimate Report;

and a Repair Technician to check the Enterprise accounts receivable credit balance;

and a Repair Technician to produce a Repair Dispute Report;

and a Repair Technician to produce an Enterprise Credit Balance Report.

FIG. 3 illustrates an exemplary method of having a Repair Technician scheduling the onsite repair of a Vehicle and the related processes of a Repair Technician to schedule a Vehicle repair;

and a Repair Technician to produce a Vehicle Repair Work Order Report;

and a Repair Technician to send a Work Order to Flight Management Operations;

and Flight Management Operations to acknowledge the receipt of a Work Order;

and a Repair Technician to order replacement parts for a Vehicle;

and a Repair Technician to produce a Vehicle Repair Parts Report;

and a Repair Technician to produce a Purchase Order for Repair Parts Report;

and the repair parts to be delivered to Repair Technician;

and a Repair Technician to acknowledge the receipt of the parts;

and a Repair Technician to produce a Parts Received Report.

FIG. 4 illustrates an exemplary method repairing a Vehicle while a Vehicle is onsite and the related processes of a Repair Technician to complete a Vehicle repair;

and a Repair Technician to update a Vehicle information with the new parts information, ID numbers and serial numbers;

and a Repair Technician to execute a Vehicle full system test and produce a Full System Test Report;

and a Repair Technician to notify the Flight Management Center a Vehicle has been repaired;

and a Repair Technician to produce a Vehicle Repair Completion Report;

and a Repair Technician to produce a Vehicle New Parts Report;

and a Repair Technician to produce a Full System Test Results Report.

FIG. 5 illustrates an exemplary method of scheduling a Vehicle to be repaired at a Repair Depot and the related processes of a Repair Technician to send a notice to the Visual Observer to prepare a Vehicle for shipment pickup;

and a Repair Technician to produce a Vehicle Pickup Notice Report;

and a Visual Observer to get the shipment pickup and packing requirements for Vehicle;

and a Visual Observer to request the shipment pickup and packing requirements for Vehicle from Repair Technician;

and a Repair Technician to produce a shipment Packing List and Crate Report;

and a Repair Technician to schedule a Vehicle pickup and transport with Shipper;

and a Repair Technician to produce a Crate and Vehicle Pickup and Shipping Report;

and a Repair Technician to give a Purchase Order to the Accounts Payable department.

FIG. 6 illustrates an exemplary method of shipping a Vehicle from a remote site to a Repair Depot for repair and the related processes of a Repair Technician to send a Vehicle and crate shipment tracking information to a Visual Observer;

and a Visual Observer to receive the crate and pack a Vehicle in the crate;

and a Visual Observer to send a notice to the Repair Technician that the Vehicle is packed

and ready for pickup;

and a Repair Technician to order Shipper to pick up a Vehicle;

and a Shipper to pick up a Vehicle and crate and deliver them to the Repair Depot;

and a Repair Technician to produce a Packing List and Crate Tracking Information Report;

and a Repair Technician to produce a Vehicle Pickup Request Report;

and a Repair Technician to produce a Vehicle Pickup Shipping Order Report;

and a Repair Technician to produce a shipment Pickup and Bill of Lading Report.

FIG. 7 illustrates an exemplary method of performing a Full System Test of a Vehicle needing to be repaired and the related processes of a Repair Technician to receive a Vehicle from Shipper;

and a Repair Technician to unpack a Vehicle;

and a Repair Technician to perform a full system test on a Vehicle;

and a Repair Technician to produce a Full System Test Report;

and a Repair Technician to perform a diagnostic analysis on a Vehicle;

and a Repair Technician to produce a Test Diagnostic Report;

and a Repair Technician to order replacement parts for a Vehicle from inventory;

and a Repair Technician to produce a Replacement Parts Order Report;

and a Repair Technician to produce a Vehicle Unpacking Condition Report.

FIG. 8 illustrates an exemplary of method of repairing a Vehicle at a Repair Depot and the related processes of and a Repair Technician to repair a Vehicle;

and a Repair Technician to update a Vehicle information with the new parts information, ID numbers and serial numbers;

and a Repair Technician to prepare a Vehicle Repair Report;

and a Repair Technician to send a Vehicle Repair Report to an Enterprise Agent;

and a Repair Technician to send a Vehicle Repair Report to Flight Management Operations;

and a Repair Technician to produce a Vehicle Repair Checklist Report;

and a Repair Technician to produce a Vehicle Parts Repaired Report;

and a Repair Technician to produce a Vehicle Repaired Report;

and a Repair Technician to produce an Enterprise Vehicle Repaired Report;

and a Repair Technician to produce a Flight Management Operations Vehicle Repaired Report.

FIG. 9 illustrates an exemplary method of removing the ‘Grounded’ status of a Vehicle needing repair and the related processes of a Repair Technician to remove a Vehicle ‘Grounded’ status;

and a Repair Technician to pack a Vehicle in a shipping crate;

and a Repair Technician to notify the Enterprise a Vehicle is being returned to the site;

and a Repair Technician to notify the Visual Observer a Vehicle is being returned to the site;

and a Visual Observer receiving a crate and unpacking a Vehicle;

and a Visual Observer to notify the Repair Technician a Vehicle arrived at the site;

and a Repair Technician performs full system test on Vehicle;

and a Repair Technician to produce a Remove Vehicle Grounded Report;

and a Repair Technician to produce a Packing List Report;

and a Repair Technician to produce a Visual Observer notice a Vehicle is Returned to Site Report;

and a Repair Technician to produce an Enterprise notice a Vehicle is Returned to Site Report;

and a Visual Observer to produce a Bill of Lading Report;

and a Visual Observer to produce a Vehicle On Site Report.

FIG. 10 illustrates an exemplary method of returning a Vehicle to service after it has been repaired and the related processes of a Visual Observer to confirm a full system test results;

and a Visual Observer to confirm a Vehicle is ready for service;

and a Repair Technician to notify the Enterprise a Vehicle is ready for service;

and a Visual Observer to review an onsite securing Vehicle checklist;

and a Visual Observer to secure a Vehicle on site;

and Flight Management Operations to return a Vehicle to service;

and a Visual Observer to produce a Visual Observer Test Confirmation Report;

and a Repair Technician to produce an Enterprise Ready for Service Report;

and a Visual Observer to produce a Secure Vehicle Onsite Checklist Report.

FIG. 11 illustrates an exemplary method of scheduling the maintenance of a Vehicle and ordering the parts needed to perform the maintenance and the related processes of a Repair Technician to determine a Vehicles is to be maintained onsite;

and a Repair Technician to determine the parts needed to maintain a Vehicle;

and a Repair Technician to create a parts list to maintain a Vehicle;

and a Repair Technician to request delivery of parts on the Parts List;

and a Repair Manager to check the parts needed for maintenance for availability in inventory;

and a Repair Manager to order parts from vendors for parts needed for maintenance which are not available in inventory;

and a Vendor to ship the parts to Repair Depot;

and a Repair Manager to receive the parts from vendors and update the inventory with that parts data;

and a Repair Technician to produce a Maintenance Job Report;

and a Repair Technician to produce a Vehicle Maintenance Parts List Report;

and a Repair Manager to produce a purchase order for parts from vendors for parts not available in inventory.

FIG. 12 illustrates an exemplary method of transporting the parts needed to maintain a Vehicle to a Repair Technician at the remote site of a Vehicle and the related processes of a Repair Manager to pack maintenance parts;

and a Repair Manager to send maintenance parts to Repair Technician;

and a Repair Manager to send a shipping notice and packing list to a Repair Technician;

and a Repair Technician to receive the parts needed to maintain a Vehicle;

and a Repair Technician to schedule a Vehicle for maintenance.

FIG. 13 illustrates an exemplary method of a Repair Technician to ‘down’ a Vehicle for maintenance and the related processes of a Repair Technician to travel to Vehicle to maintain the Vehicle;

and for a Repair Technician to request Flight Operation Management to ‘down’ a Vehicle for maintenance;

and for Flight Operations Management to notify the Enterprise that a Vehicle is ‘down’ for maintenance;

and for Flight Operations Management to ‘down’ a Vehicle for maintenance;

and for Flight Operations Management to issue to a Vehicle a command to ‘down’ Vehicle via radio frequency transmission (RF);

and for Flight Operations Management to notify a Repair Technician that a Vehicle is ‘down’ for maintenance;

and for a Repair Technician to examine a Vehicle and confirm a Vehicle is ‘down’.

FIG. 14 illustrates an exemplary method of having a Repair Technician perform the maintenance of a Vehicle while a Vehicle is at the remote site and the related processes of a Repair Technician to install parts in Vehicle for maintenance;

and a Repair Technician to update a Vehicle information with new parts information, ID numbers and serial numbers;

and a Repair Technician to complete a Vehicle Maintenance Job Report;

and a Repair Technician to notify Flight Operations Management a Vehicle maintenance is complete;

and a Repair Technician to request Flight Operation Management to send a full system test command to Vehicle;

and Flight Operations Management to send a full system test command to Vehicle;

and a Vehicle to perform a full system test;

and a Vehicle to transmit the Full System Test results to Flight Operations Management;

and a Repair Technician to repair a Vehicle if the full system test results are not OK;

and a Repair Technician to confirm the Full System Test is OK;

and a Repair Technician to produce a Full System Test Report;

and a Repair Technician to produce a Maintenance Job Report.

FIG. 15 illustrates an exemplary method of having a Repair Technician change a Vehicle status from ‘down’ to ‘ready’ after maintenance has been completed and the related processes of a Repair Technician to request Flight Operations Management to remove the ‘down’ status on a Vehicle;

and Flight Operations Management to change a Vehicle status from ‘down’ to ‘ready’;

and Flight Operations Management to notify an Enterprise that Vehicle maintenance is completed, and a Vehicle status has been changed from ‘down’ to ‘ready’;

and Flight Operations Management to approve a Maintenance Job Complete Report;

and Flight Operations Management to receive a Maintenance Job Complete Report.

FIG. 16 illustrates an exemplary method of having a Repair Technician schedule the maintenance of a Vehicle at a Repair Depot and the related processes of a Repair Technician to determine a Vehicles needs for maintenance to be performed at a Repair Depot;

and a Repair Technician to pack a Vehicle in shipping crate to be sent to Repair Depot;

and a Repair Technician to request authorization from Flight Operations Management to ship a Vehicle to a Repair Depot;

and a Repair Technician top ship a Vehicle to a Repair Depot for maintenance;

and a Vehicle to arrive at a Repair Depot;

and a Repair Technician to examine a Vehicle for damage;

and a Repair Technician to file a damage claim with a Shipper;

and a Repair Technician to notify Asset Accounting of damage to a Vehicle and a damage claim for Vehicle;

and a Repair Technician to produce a Shipping Authorization Report;

and a Repair Technician to produce a Packing List Report;

and a Repair Technician to produce a Bill of Lading Report;

and a Repair Technician to produce a Full System Test Report.

FIG. 17 illustrates an exemplary method of having a Repair Technician return a Vehicle to a remote site after a Vehicle maintenance has been completed at a Repair Depot and the related processes of a Repair Technician to pack a Vehicle for return to site;

and a Repair Technician to request authorization from Flight Operations Management to

ship a Vehicle to be returned to a site;

and a Flight Operations Management authorizes Vehicle to be shipped to site;

and a Repair Technician to ship a Vehicle to a site;

and a Vehicle to arrive at a site;

and Flight Operations Management to produce a Shipping Authorization Report;

and a Repair Technician to produce a Packing List Report;

and a Repair Technician to produce a Bill of Lading Report.

FIGS. 18.1-18.98 illustrate exemplary communication methods used in the present invention and include:

FIG. 18.1 illustrates an onboard Snap for communicating between an accessory device and the Vehicle CPU using the Universal Device Coupler and the Vehicle to CPU interface. Also included in Vehicle Operating System. Includes Start of Message communication method. Includes End of Message communication method.

FIG. 18.2 illustrates a Communications Method between any device or entity in a network and any other device or entity in a network using a single or multiple packets comprising a message. Also included in Vehicle Operating System. Includes Start of Message communication method. Includes End of Message communication method.

FIG. 18.3 illustrates a Snap for communicating between the Vehicle and the electrical charger for connecting and disconnecting the charger and the Vehicle. Also included in Vehicle Operating System. Includes Start of Message communication method. Includes End of Message communication method.

FIG. 18.4 illustrates a start of Message Communication Method Also included in Vehicle Operating System. Includes Start of Message communication method. Includes End of Message communication method.

FIG. 18.5 illustrates a Snap for remoting connecting and disconnecting the electrical connection between the Vehicle and the recharging station. Also included in Vehicle Operating System. Includes Start of Message communication method. Includes End of Message communication method.

FIG. 18.6 illustrates a Snap for transmitting sensor data. Also included in Vehicle Operating System. Includes Start of Message communication method. Includes End of Message communication method.

FIG. 18.7 illustrates an end of Message Communication Method. Also included in Vehicle Operating System. Includes Start of Message communication method. Includes End of Message communication method.

FIG. 18.8 illustrates a Snap for communicating the Vehicle data from the autonomous aircraft and the data storage facility. Also included in Vehicle Operating System. Includes Start of Message communication method. Includes End of Message communication method.

FIG. 18.9 illustrates a Snap for the Vehicle to transmit a ‘ready to send images ’ status Message and an ‘end of images sent’ status Message. Also included in Vehicle Operating System. Includes Start of Message communication method. Includes End of Message communication method.

FIG. 18.10 illustrates a Snap for transmitting identification information about an autonomous Vehicle from one Vehicle or component of the Vehicle to another Vehicle or component of the Vehicle. For the exchange of component status information on a Vehicle. Also, used to transmit information about a Vehicle to a charging station. Regional Identifier or “RID”, Sectional Identifier or “SID”, Device Identifier or “DID” are also included in Vehicle Operating System. Includes Start of Message communication method. Includes End of Message communication method.

FIG. 18.11 illustrates a Snap for an autonomous Vehicle to communicate with the correct recharging station. The protocol is used by and included in the Vehicle operating system. Also included in Vehicle Operating System. Includes Start of Message communication method. Includes End of Message communication method.

FIG. 18.12 illustrates a Snap for the Vehicle to communicate its identification to the Management Center. Also included in Vehicle Operating System. Includes Start of Message communication method. Includes End of Message communication method.

FIG. 18.13 illustrates a Snap for marrying an autonomous or unmanned Vehicle with an autonomous single aircraft acting as part of an integral part of a fleet or swarm of Vehicles. Also included in Vehicle Operating System. Includes Start of Message communication method. Includes End of Message communication method.

FIG. 18.14 illustrates a Snap for the Management Center to communicate an authorization for the Vehicle to operate in the geographic area. Also included in Vehicle Operating System. Includes Start of Message communication method. Includes End of Message communication method.

FIG. 18.15 illustrates a Snap for transmitting a copy of any message from an enterprise, Vehicle or Vehicle component to any other entity with a network Device ID. Also included in Vehicle Operating System. Includes Start of Message communication method. Includes End of Message communication method.

FIG. 18.16 illustrates a Snap for marrying an autonomous or unmanned Vehicle with an autonomous single independent aircraft. Also included in Vehicle Operating System. Includes Start of Message communication method. Includes End of Message communication method.

FIG. 18.17 illustrates a Snap for communicating to the autonomous aircraft to resend the images. Also included in Vehicle Operating System. Includes Start of Message communication method. Includes End of Message communication method.

FIG. 18.18 illustrates a communication Snap from Management Center to an operator approving a flight plan. Also included in Vehicle Operating System. Includes Start of Message communication method. Includes End of Message communication method.

FIG. 18.19 illustrates a Snap for transmitting the creating the layered, 4-dimensional, virtual recreation of an environment from a 180 degree, variable altitude perspective. Also included in Vehicle Operating System. Includes Start of Message communication method. Includes End of Message communication method.

FIG. 18.20 illustrates a Snap for communicating to the autonomous aircraft the requirement to perform a full system component test. Also included in Vehicle Operating System. Includes Start of Message communication method. Includes End of Message communication method.

FIG. 18.21 illustrates a communication Snap from the Management Center to the aircraft for requesting the type and frequency of the data which the aircraft will collect and transmit. Also included in Vehicle Operating System. Includes Start of Message communication method. Includes End of Message communication method.

FIG. 18.22 illustrates a Snap for communicating the results of a full system component test from a Vehicle to the repair depot. Also included in Vehicle Operating System. Includes Start of Message communication method. Includes End of Message communication method.

FIG. 18.23 illustrates a Snap from the Management Center to the aircraft communicating the Landing Zone or “LIZ” area defining the authorized geographic area. Also included in Vehicle Operating System. Includes Start of Message communication method. Includes End of Message communication method.

FIG. 18.24 illustrates a Snap between a Vehicle and a Charger with an electrical and communications connector. Also included in Vehicle Operating System. Includes Start of Message communication method. Includes End of Message communication method.

FIG. 18.25 illustrates a communication Snap from the Management Center to the aircraft specifying the Low Altitude Authorization and Notification Capability or “LAANC” authorization number, as amended by the FAA, which the Vehicle will apply to the flight and mission data. Also included in Vehicle Operating System. Includes Start of Message communication method. Includes End of Message communication method.

FIG. 18.26 illustrates a communication Snap from an operator for submitting a flight plan to the Management Center. Also included in Vehicle Operating System. Includes Start of Message communication method. Includes End of Message communication method.

FIG. 18.27 illustrates a Snap from the Management Center communicating to the aircraft the specifying the amount of flight time the aircraft has been in an authorized geographic area. Also included in Vehicle Operating System. Includes Start of Message communication method. Includes End of Message communication method.

FIG. 18.28 illustrates a communication Snap from the aircraft to the Management Center for each type of data the aircraft will send to the Management Center. Also included in Vehicle Operating System. Includes Start of Message communication method. Includes End of Message communication method.

FIG. 18.29 illustrates a Snap from the Management Center communicating to the autonomous aerial Vehicle aircraft it must terminate operations and exit the geographic area. Also included in Vehicle Operating System. Includes Start of Message communication method. Includes End of Message communication method.

FIG. 18.30 illustrates a Snap from one Management Center communicating to an adjacent Management Center identifying and authorizing the autonomous aircraft to fly into the adjacent geographic area. Also included in Vehicle Operating System. Includes Start of Message communication method. Includes End of Message communication method.

FIG. 18.31 illustrates a communication Snap from Management Center to an operator defining the limits of the flight plan. Also included in Vehicle Operating System. Includes Start of Message communication method. Includes End of Message communication method.

FIG. 18.32 illustrates a Snap from the Management Center communicating to the autonomous aircraft it is not authorized to operate (locked out) in geographic area. Also included in Vehicle Operating System. Includes Start of Message communication method. Includes End of Message communication method.

FIG. 18.33 illustrates a Snap for communicating to the autonomous aircraft to resend the images. Also included in Vehicle Operating System. Includes Start of Message communication method. Includes End of Message communication method.

FIG. 18.34 illustrates a Snap for the repair depot to communicate to the autonomous aircraft that the aircraft has been grounded. Also included in Vehicle Operating System. Includes Start of Message communication method. Includes End of Message communication method.

FIG. 18.35 illustrates a Snap for the repair depot to communicate to the autonomous aircraft that the aircraft grounded status has been removed. Also included in Vehicle Operating System. Includes Start of Message communication method. Includes End of Message communication method.

FIG. 18.36 illustrates a Snap for the repair depot to communicate to the autonomous aircraft that the aircraft has been placed in active service. Also included in Vehicle Operating System. Includes Start of Message communication method. Includes End of Message communication method.

FIG. 18.37 illustrates a Snap for communicating to the autonomous aircraft confirmation the images were received and the number of images which were received. Also included in Vehicle Operating System. Includes Start of Message communication method. Includes End of Message communication method.

FIG. 18.38 illustrates a Snap for communicating to the autonomous aircraft the identification of the repair depot to which the aircraft has been assigned. Also included in Vehicle Operating System. Includes Start of Message communication method. Includes End of Message communication method.

FIG. 18.39 illustrates a Snap for connecting elements of a network to each other based on the identification of an Enterprise. Also included in Vehicle Operating System. Includes Start of Message communication method. Includes End of Message communication method.

FIG. 18.40 illustrates a Snap for connecting elements of a network to each other based on the identification of a Fleet and an Enterprise. Also included in Vehicle Operating System. Includes Start of Message communication method. Includes End of Message communication method.

FIG. 18.41 illustrates a Snap for connecting elements of a Fleet to a licensed FAA Part 107 Pilot, as amended by the FAA, based on the identification of a Pilot or on the identification of a Fleet. Also included in Vehicle Operating System. Includes Start of Message communication method. Includes End of Message communication method.

FIG. 18.42 illustrates a Snap for connecting a Vehicle and its components to a licensed FAA Part 107 Pilot based on the identification of a Pilot or on the identification of a Vehicle. Also included in Vehicle Operating System. Includes Start of Message communication method. Includes End of Message communication method.

FIG. 18.43 illustrates a Snap for connecting elements of a Fleet to a Certified FAA Visual Observer based on the identification of a Certified Visual Observer or on the identification of a Fleet. Also included in Vehicle Operating System. Includes Start of Message communication method. Includes End of Message communication method.

FIG. 18.44 illustrates a Snap for connecting a Vehicle and its components to a Certified FAA Visual Observer based on the identification of a Visual Observer or on the identification of the Vehicle. Also included in Vehicle Operating System. Includes Start of Message communication method. Includes End of Message communication method.

FIG. 18.45 illustrates a Snap for connecting a Fleet and its components to a Mission Set based on the identification of a Mission Set or on the identification of a Fleet. Also included in Vehicle Operating System. Includes Start of Message communication method. Includes End of Message communication method.

FIG. 18.46 illustrates a Snap for connecting a Mission Set identification number to any component in a network. Also included in Vehicle Operating System. Includes Start of Message communication method. Includes End of Message communication method.

FIG. 18.47 illustrates a Snap for connecting a Fleet and its components to a Project Set based on the identification of a Project Set or on the identification of a Fleet. Also included in Vehicle Operating System. Includes Start of Message communication method. Includes End of Message communication method.

FIG. 18.48 illustrates a Snap for connecting a Charger and its components to a Fleet and its components based on the identification of a Charger or on the identification of a Fleet. Also included in Vehicle Operating System. Includes Start of Message communication method. Includes End of Message communication method.

FIG. 18.49 illustrates a Snap for connecting elements of a network to each other based on the identification of a Charger. Also included in Vehicle Operating System. Includes Start of Message communication method. Includes End of Message communication method.

FIG. 18.50 illustrates a Snap for connecting elements of a network to each other based on the identification of a Certified Visual Observer. Also included in Vehicle Operating System. Includes Start of Message communication method. Includes End of Message communication method.

FIG. 18.51 illustrates a Snap for connecting elements of a network to each other based on the identification of a Licensed FAA 107 Pilot, as amended by the FAA. Also included in Vehicle Operating System. Includes Start of Message communication method. Includes End of Message communication method.

FIG. 18.52 illustrates a Snap for connecting a Licensed FAA Part 107 Pilot to a Mission Set and its components based on the identification of a Licensed FAA Part 107 Pilot, as amended by the FAA, or on the identification of a Mission Set. Also included in Vehicle Operating System. Includes Start of Message communication method. Includes End of Message communication method.

FIG. 18.53 illustrates a Snap for connecting a Certified FAA Visual Observer to a Mission Set and its components based on the identification of a Certified FAA Visual Observer or on the identification of a Mission Set. Also included in Vehicle Operating System. Includes Start of Message communication method. Includes End of Message communication method.

FIG. 18.54 illustrates a Snap connecting the Pilot with the Vehicle assigning the Vehicle the next priority Mission Set. Also included in Vehicle Operating System. Includes Start of Message communication method. Includes End of Message communication method.

FIG. 18.55 illustrates a Snap for connection the Pilot to the Fight Log data store allowing the Pilot to enter a descriptive comment for each event experience by the Vehicle, sensors chargers, transporters, Pilots and Visual Observers assigned to a Mission Set flight. Also included in Vehicle Operating System. Includes Start of Message communication method. Includes End of Message communication method.

FIG. 18.56 illustrates a Snap for connecting a Fleet and its components, ready to execute a Mission, to a Mission Set and its components based on the identification of a Certified FAA Visual Observer or on the identification of a Mission Set. Also included in Vehicle Operating System. Includes Start of Message communication method. Includes End of Message communication method.

FIG. 18.57 illustrates a Snap for connecting a Mission Set and its components to an FAA Approved Waiver based on the identification of a Mission Set or on the identification of an FAA Approved Waiver. Also included in Vehicle Operating System. Includes Start of Message communication method. Includes End of Message communication method.

FIG. 18.58 illustrates a Snap for connecting elements of a network to each other based on the identification of an FAA Waiver. Also included in Vehicle Operating System. Includes Start of Message communication method. Includes End of Message communication method.

FIG. 18.59 illustrates a Snap for connecting a Vehicle and its components, ready to execute a Mission, to a Mission Set and its components based on the identification of a Vehicle or on the identification of a Mission Set. Also included in Vehicle Operating System. Includes Start of Message communication method. Includes End of Message communication method.

FIG. 18.60 illustrates a Snap for connecting a Licensed FAA Part 107 Pilot, as amended by the FAA, ready to execute a Mission, to a Mission Set and its components based on the identification of a Licensed FAA Part 107 Pilot or on the identification of a Mission Set. Also included in Vehicle Operating System. Includes Start of Message communication method. Includes End of Message communication method.

FIG. 18.61 illustrates a Snap for connecting a Certified FAA Visual Observer, ready to execute a Mission, to a Mission Set and its components based on the identification of a certified FAA visual Observer or on the identification of a Mission Set. Also included in Vehicle Operating System. Includes Start of Message communication method. Includes End of Message communication method.

FIG. 18.62 illustrates a Snap for connecting elements of a network to each other based on the identification of an FAA Waiver or Exemption, as amended. Also included in Vehicle Operating System. Includes Start of Message communication method. Includes End of Message communication method.

FIG. 18.63 illustrates a Snap for connecting elements of a network to each other based on the identification of an Enterprise Also included in Vehicle Operating System. Includes Start of Message communication method. Includes End of Message communication method.

FIG. 18.64 illustrates a Snap for connecting elements of a network to each other based on the identification of a Fleet. Also included in Vehicle Operating System. Includes Start of Message communication method. Includes End of Message communication method.

FIG. 18.65 illustrates a Snap for connecting elements of a network to each other based on the identification of a Repair Depot. Also included in Vehicle Operating System. Includes Start of Message communication method. Includes End of Message communication method.

FIG. 18.66 illustrates a Snap for connecting elements of a network to each other based on the identification of a Geographic Area. Also included in Vehicle Operating System. Includes Start of Message communication method. Includes End of Message communication method.

FIG. 18.67 illustrates a Snap for connecting the Fleet Management Center to a Vehicle and its components, ready to execute a Mission Set in a Geographic Area based on the identification of a Vehicle or on the identification of a Geographic Area. Also included in Vehicle Operating System. Includes Start of Message communication method. Includes End of Message communication method.

FIG. 18.68 illustrates a Snap identifying the radio frequency for transmitting and receiving to be used for connecting the Fleet Management Center to a Vehicle and its components, ready to execute a Mission Set in a Geographic Area based on the identification of a Vehicle or on the identification of a Geographic Area. Also included in Vehicle Operating System. Includes Start of Message communication method. Includes End of Message communication method.

FIG. 18.69 illustrates a Snap identifying the antenna radio frequency used for transmitting and receiving and used for connecting the Fleet Management Center to a Vehicle and its components, ready to execute a Mission Set in a Geographic Area based on the identification of a Vehicle or on the identification of a Geographic Area. Also included in Vehicle Operating System. Includes Start of Message communication method. Includes End of Message communication method.

FIG. 18.70 illustrates a Snap used by the Fleet Management Center to send a radio frequency ping to radio transceiver in a Geographic Area. Also included in Vehicle Operating System. Includes Start of Message communication method. Includes End of Message communication method.

FIG. 18.71 illustrates a snap used by the Fleet Management Center to request a Charger, associated with a Fleet which is associated with a Mission Set, to perform a full system component test. Also included in Vehicle Operating System. Includes Start of Message communication method. Includes End of Message communication method.

FIG. 18.72 illustrates a snap used by the Fleet Management Center to request a Charger, associated with a Fleet which is associated with a Mission Set, to communicate the results of full system component test. Also included in Vehicle Operating System. Includes Start of Message communication method. Includes End of Message communication method.

FIG. 18.73 illustrates a Snap used by the Pilot assigned to a Vehicle instructing the Vehicle to power down all of its functions. Also included in Vehicle Operating System. Includes Start of Message communication method. Includes End of Message communication method.

FIG. 18.74 illustrates a Snap used to identify a flight checklist for a Vehicle. Also included in Vehicle Operating System. Includes Start of Message communication method. Includes End of Message communication method.

FIG. 18.75 illustrates a Snap used to identify the checklist for a flight plan. Also included in Vehicle Operating System. Includes Start of Message communication method. Includes End of Message communication method.

FIG. 18.76 illustrates a Snap used to connect data about a flight plan with the flight plan. Also included in Vehicle Operating System. Includes Start of Message communication method. Includes End of Message communication method.

FIG. 18.77 illustrates a Snap used to connect data about a FAA Waiver with a specific FAA Waiver. Also included in Vehicle Operating System. Includes Start of Message communication method. Includes End of Message communication method.

FIG. 18.78 illustrates a Snap used to connect data about a WayPoint connected to a Mission Set to a specific WayPoint. Also included in Vehicle Operating System. Includes Start of Message communication method. Includes End of Message communication method.

FIG. 18.79 illustrates a Snap used to communicate the Visual Observer for a Vehicle is ready for Vehicle to Launch. Also included in Vehicle Operating System. Includes Start of Message communication method. Includes End of Message communication method.

FIG. 18.80 illustrates a Snap used to communicate the authorized altitude for a Vehicle in flying in a Mission Set. Also included in Vehicle Operating System. Includes Start of Message communication method. Includes End of Message communication method.

FIG. 18.81 illustrates a Snap identifying the next WayPoint to which a Vehicle should travel. Also included in Vehicle Operating System. Includes Start of Message communication method. Includes End of Message communication method.

FIG. 18.82 illustrates a Snap containing data used to reconfigure a flight plan for a Vehicle. Also included in Vehicle Operating System. Includes Start of Message communication method. Includes End of Message communication method.

FIG. 18.83 illustrates a Snap used to describe the operational status of a Vehicle, charger, pilot, VO or other entity. Also included in Vehicle Operating System. Includes Start of Message communication method. Includes End of Message communication method.

FIG. 18.84 illustrates a Snap used to record the date and time of an event. Also included in Vehicle Operating System. Includes Start of Message communication method. Includes End of Message communication method.

FIG. 18.85 illustrates a Snap containing a command to a Vehicle for the Vehicle to descend and land. Also included in Vehicle Operating System. Includes Start of Message communication method. Includes End of Message communication method.

FIG. 18.86 illustrates a Snap containing the identification number of a Project Set associated with a Mission Set. Also included in Vehicle Operating System. Includes Start of Message communication method. Includes End of Message communication method.

FIG. 18.87 illustrates a Snap containing the current longitude, latitude and distance above or below mean sea level of a Vehicle. Also included in Vehicle Operating System. Includes Start of Message communication method. Includes End of Message communication method.

FIG. 18.88 illustrates a Snap containing the current longitude, latitude and distance above or below mean sea level of an emergency landing zone assigned to a Vehicle. Also included in Vehicle Operating System. Includes Start of Message communication method. Includes End of Message communication method.

FIG. 18.89 illustrates a Snap containing the current longitude, latitude and distance above or below mean sea level of an obstacle in the path of a Vehicle. Also included in Vehicle Operating System. Includes Start of Message communication method. Includes End of Message communication method.

FIG. 18.90 illustrates a Snap containing a command to a Vehicle, Charger or transporter of such to cease movement. Also included in Vehicle Operating System. Includes Start of Message communication method. Includes End of Message communication method.

FIG. 18.91 illustrates a Snap containing the description of an issue impacting a Mission Set, project set, waypoint set, Vehicle, charger or other entity during the execution of a Mission Set. Also included in Vehicle Operating System. Includes Start of Message communication method. Includes End of Message communication method.

FIG. 18.92 illustrates a Snap containing the current longitude, latitude and distance above or below mean sea level of a Charger. Also included in Vehicle Operating System. Includes Start of Message communication method. Includes End of Message communication method.

FIG. 18.93 illustrates a Snap containing a command to a Vehicle for the Vehicle to refuel or recharge. Also included in Vehicle Operating System. Includes Start of Message communication method. Includes End of Message communication method.

FIG. 18.94 illustrates a Snap used to describe the current operational status for the fuel or power level in a Vehicle. Also included in Vehicle Operating System. Includes Start of Message communication method. Includes End of Message communication method.

FIG. 18.95 illustrates a Snap containing a command to a Vehicle for the Vehicle to ascend. Also included in Vehicle Operating System. Includes Start of Message communication method. Includes End of Message communication method.

FIG. 18.96 illustrates a Snap containing a command to a Vehicle for the Vehicle to return to the Vehicle's origin location. Also included in Vehicle Operating System. Includes Start of Message communication method. Includes End of Message communication method.

FIG. 18.97 illustrates a Snap containing encrypted data. Also included in Vehicle Operating System. Includes Start of Message communication method. Includes End of Message communication method.

FIG. 18.98 illustrates a Snap containing decrypted data. Also included in Vehicle Operating System. Includes Start of Message communication method. Includes End of Message communication method.

FIGS. 19.1-19.104 illustrate an exemplary data architecture for the present invention and include the following data tables:

FIG. 19.1 illustrates the Table of Contents for the Database Architecture.

FIG. 19.2 illustrates a Battery Profile Table consisting of a plurality of data fields containing alphabetic, numeric and symbolic characters to define a plurality of Battery Profiles.

FIG. 19.3 illustrates a Cargo Profile Table consisting of a plurality of data fields containing alphabetic, numeric and symbolic characters to define a plurality of Cargo Profiles.

FIG. 19.4 illustrates a Certification Profile Table consisting of a plurality of data fields containing alphabetic, numeric and symbolic characters to define a plurality of Certification Profiles.

FIG. 19.5 illustrates a Charger Table consisting of a plurality of data fields containing alphabetic, numeric and symbolic characters to define a plurality of Chargers.

FIG. 19.6 illustrates a Charger Type Table consisting of a plurality of data fields containing alphabetic, numeric and symbolic characters to define a plurality of Charger Types.

FIG. 19.7 illustrates a Data Priority Profile Table consisting of a plurality of data fields containing alphabetic, numeric and symbolic characters to define a plurality of Data Priority Profiles.

FIG. 19.8 illustrates an Enterprise Table consisting of a plurality of data fields containing alphabetic, numeric and symbolic characters to define a plurality of Enterprises.

FIG. 19.9 illustrates an Event Table consisting of a plurality of data fields containing alphabetic, numeric and symbolic characters to define a plurality of Events.

FIG. 19.10 illustrates an Event Profile Table consisting of a plurality of data fields containing alphabetic, numeric and symbolic characters to define a plurality of Event Profiles.

FIG. 19.11 illustrates a FAA License Table consisting of a plurality of data fields containing alphabetic, numeric and symbolic characters to define a plurality of FAA Licenses.

FIG. 19.12 illustrates a Flight Plan Table consisting of a plurality of data fields containing alphabetic, numeric and symbolic characters to define a plurality of Flight Plans.

FIG. 19.13 illustrates a Geographic Area Table consisting of a plurality of data fields containing alphabetic, numeric and symbolic characters to define a plurality of Geographic Areas.

FIG. 19.14 illustrates a Job Table consisting of a plurality of data fields containing alphabetic, numeric and symbolic characters to define a plurality of Jobs.

FIG. 19.15 illustrates a Mission Set Table consisting of a plurality of data fields containing alphabetic, numeric and symbolic characters to define a plurality of Mission Sets.

FIG. 19.16 illustrates a Mission Set Profile Table consisting of a plurality of data fields containing alphabetic, numeric and symbolic characters to define a plurality of Mission Set Profiles.

FIG. 19.17 illustrates a Mission Status Table consisting of a plurality of data fields containing alphabetic, numeric and symbolic characters to define a plurality of Mission Status.

FIG. 19.18 illustrates a Mission Journal Table consisting of a plurality of data fields containing alphabetic, numeric and symbolic characters to define a plurality of Mission Journals.

FIG. 19.19 illustrates an Operator Table consisting of a plurality of data fields containing alphabetic, numeric and symbolic characters to define a plurality of Operators.

FIG. 19.20 illustrates an Operator Profile Table consisting of a plurality of data fields containing alphabetic, numeric and symbolic characters to define a plurality of Operator Profiles.

FIG. 19.21 illustrates a Project Set Table consisting of a plurality of data fields containing alphabetic, numeric and symbolic characters to define a plurality of Project Sets.

FIG. 19.22 illustrates a Project Set Data Priority Table consisting of a plurality of data fields containing alphabetic, numeric and symbolic characters to define a plurality of Project Set Data Priorities.

FIG. 19.23 illustrates a Radio Frequency Table consisting of a plurality of data fields containing alphabetic, numeric and symbolic characters to define a plurality of Radio Frequencies.

FIG. 19.24 illustrates a Sensor Table consisting of a plurality of data fields containing alphabetic, numeric and symbolic characters to define a plurality of Sensors.

FIG. 19.25 illustrates a Sensor Profile Table consisting of a plurality of data fields containing alphabetic, numeric and symbolic characters to define a plurality of Sensor Profiles.

FIG. 19.26 illustrates a Status Table consisting of a plurality of data fields containing alphabetic, numeric and symbolic characters to define a plurality of Status.

FIG. 19.27 illustrates a Status Profile Table consisting of a plurality of data fields containing alphabetic, numeric and symbolic characters to define a plurality of Status Profiles.

FIG. 19.28 illustrates a Sub-Enterprise Table consisting of a plurality of data fields containing alphabetic, numeric and symbolic characters to define a plurality of Sub-Enterprises.

FIG. 19.29 illustrates a Vehicle Table consisting of a plurality of data fields containing alphabetic, numeric and symbolic characters to define a plurality of Vehicles.

FIG. 19.30 illustrates a Vehicle Profile Table consisting of a plurality of data fields containing alphabetic, numeric and symbolic characters to define a plurality of Vehicle Profiles.

FIG. 19.31 illustrates a Waypoint Table consisting of a plurality of data fields containing alphabetic, numeric and symbolic characters to define a plurality of Waypoints.

FIG. 19.32 illustrates a What3Words Table consisting of a plurality of data fields containing alphabetic, numeric and symbolic characters to define a plurality of What3Words.

FIG. 19.33 illustrates a Pre-Flight Charger Checklist Table consisting of a plurality of data fields containing alphabetic, numeric and symbolic characters to define a plurality of Pre-Flight Charger Checklists.

FIG. 19.34 illustrates a Fleet Table consisting of a plurality of data fields containing alphabetic, numeric and symbolic characters to define a plurality of Fleets.

FIG. 19.35 illustrates a Pilot Table consisting of a plurality of data fields containing alphabetic, numeric and symbolic characters to define a plurality of Pilots.

FIG. 19.36 illustrates a Visual Observer Table consisting of a plurality of data fields containing alphabetic, numeric and symbolic characters to define a plurality of Visual Observers.

FIG. 19.37 illustrates a Repair Depot Location Table consisting of a plurality of data fields containing alphabetic, numeric and symbolic characters to define a plurality of Repair Depot Locations.

FIG. 19.38 illustrates a Mission Set Checklist Table consisting of a plurality of data fields containing alphabetic, numeric and symbolic characters to define a plurality of Mission Set Checklists.

FIG. 19.39 illustrates a FAA Waiver Table consisting of a plurality of data fields containing alphabetic, numeric and symbolic characters to define a plurality of FAA Waivers.

FIG. 19.40 illustrates a LAANC Table consisting of a plurality of data fields containing alphabetic, numeric and symbolic characters to define a plurality of LAANCs.

FIG. 19.41 illustrates an Encryption Table consisting of a plurality of data fields containing alphabetic, numeric and symbolic characters to define a plurality of Encryptions.

FIG. 19.42 illustrates a Flight Log Table consisting of a plurality of data fields containing alphabetic, numeric and symbolic characters to define a plurality of Flight Logs.

FIG. 19.43 illustrates a Pre-Flight Checklist Table consisting of a plurality of data fields containing alphabetic, numeric and symbolic characters to define a plurality of Pre-Flight Checklists.

FIG. 19.44 illustrates a Pre-Flight Vehicle Checklist Table consisting of a plurality of data fields containing alphabetic, numeric and symbolic characters to define a plurality of Pre-Flight Vehicle Checklists.

FIG. 19.45 illustrates a Pre-Flight Sensor Checklist Table consisting of a plurality of data fields containing alphabetic, numeric and symbolic characters to define a plurality of Pre-Flight Sensor Checklists.

FIG. 19.46 illustrates a Pre-Flight Flight Plan Checklist Table consisting of a plurality of data fields containing alphabetic, numeric and symbolic characters to define a plurality of Pre-Flight Flight Plan Checklists.

FIG. 19.47 illustrates an Emergency Landing Zone Location Table consisting of a plurality of data fields containing alphabetic, numeric and symbolic characters to define a plurality of Emergency Landing Zone Locations.

FIG. 19.48 illustrates a Recent Obstacle Table consisting of a plurality of data fields containing alphabetic, numeric and symbolic characters to define a plurality of Recent Obstacles.

FIG. 19.49 illustrates a Flight Issue Profile Table consisting of a plurality of data fields containing alphabetic, numeric and symbolic characters to define a plurality of Flight Issue Profiles.

FIG. 19.50 illustrates a Data Profile Table consisting of a plurality of data fields containing alphabetic, numeric and symbolic characters to define a plurality of Data Profiles.

FIG. 19.51 illustrates a Full System Test Table consisting of a plurality of data fields containing alphabetic, numeric and symbolic characters to define a plurality of Full System Tests.

FIG. 19.52 illustrates a Shipping Company Table consisting of a plurality of data fields containing alphabetic, numeric and symbolic characters to define a plurality of Shipping Companies.

FIG. 19.53 illustrates a Bill of Lading Report Table consisting of a plurality of data fields containing alphabetic, numeric and symbolic characters to define a plurality of Bill of Lading Reports.

FIG. 19.54 illustrates a Purchase Order Table consisting of a plurality of data fields containing alphabetic, numeric and symbolic characters to define a plurality of Purchase Orders.

FIG. 19.55 illustrates a Maintenance & Repair Table consisting of a plurality of data fields containing alphabetic, numeric and symbolic characters to define a plurality of Maintenance & Repairs.

FIG. 19.56 illustrates a Work Order Table consisting of a plurality of data fields containing alphabetic, numeric and symbolic characters to define a plurality of Work Orders.

FIG. 19.57 illustrates a Crate Pickup & Shipping Order Report Table consisting of a plurality of data fields containing alphabetic, numeric and symbolic characters to define a plurality of Crate Pickup & Shipping Order Reports.

FIG. 19.58 illustrates a Damage Claim Report Table consisting of a plurality of data fields containing alphabetic, numeric and symbolic characters to define a plurality of Damage Claim Reports.

FIG. 19.59 illustrates a Down Vehicle Report Table consisting of a plurality of data fields containing alphabetic, numeric and symbolic characters to define a plurality of Down Vehicle Reports.

FIG. 19.60 illustrates an Enterprise Authorization Vehicle Repair Request Report Table consisting of a plurality of data fields containing alphabetic, numeric and symbolic characters to define a plurality of Enterprise Authorization Vehicle Repair Request Reports.

FIG. 19.61 illustrates an Enterprise Credit Balance Report Table consisting of a plurality of data fields containing alphabetic, numeric and symbolic characters to define a plurality of Enterprise Credit Balance Reports.

FIG. 19.62 illustrates an Enterprise Vehicle Ready for Service Report Table consisting of a plurality of data fields containing alphabetic, numeric and symbolic characters to define a plurality of Enterprise Vehicle Ready for Service Reports.

FIG. 19.63 illustrates an Enterprise Vehicle Repair Notice Report Table consisting of a plurality of data fields containing alphabetic, numeric and symbolic characters to define a plurality of Enterprise Vehicle Repair Notice Reports.

FIG. 19.64 illustrates an Enterprise Vehicle Repaired Report Table consisting of a plurality of data fields containing alphabetic, numeric and symbolic characters to define a plurality of Enterprise Vehicle Repaired Reports.

FIG. 19.65 illustrates an Enterprise Vehicle Return to Site Report Table consisting of a plurality of data fields containing alphabetic, numeric and symbolic characters to define a plurality of Enterprise Vehicle Return to Site Reports.

FIG. 19.66 illustrates a Flight Ops Vehicle Repaired Report Table consisting of a plurality of data fields containing alphabetic, numeric and symbolic characters to define a plurality of Flight Ops Vehicle Repaired Reports.

FIG. 19.67 illustrates a Full System Test Report Table consisting of a plurality of data fields containing alphabetic, numeric and symbolic characters to define a plurality of Full System Test Reports.

FIG. 19.68 illustrates a Maintenance Job Completion Report Table consisting of a plurality of data fields containing alphabetic, numeric and symbolic characters to define a plurality of Maintenance Job Completion Reports.

FIG. 19.69 illustrates a Maintenance Job Report Table consisting of a plurality of data fields containing alphabetic, numeric and symbolic characters to define a plurality of Maintenance Job Reports.

FIG. 19.70 illustrates an Onsite Full System Test Report Results Report Table consisting of a plurality of data fields containing alphabetic, numeric and symbolic characters to define a plurality of Onsite Full System Test Report Results Reports.

FIG. 19.71 illustrates an Onsite Parts Receipt Form Report Table consisting of a plurality of data fields containing alphabetic, numeric and symbolic characters to define a plurality of Onsite Parts Receipt Form Reports.

FIG. 19.72 illustrates an Onsite Vehicle New Parts Update Report Table consisting of a plurality of data fields containing alphabetic, numeric and symbolic characters to define a plurality of Onsite Vehicle New Parts Update Reports.

FIG. 19.73 illustrates an Onsite Vehicle Repair Completion Report Table consisting of a plurality of data fields containing alphabetic, numeric and symbolic characters to define a plurality of Onsite Vehicle Repair Completion Reports.

FIG. 19.74 illustrates a Onsite Vehicle Repair Parts Report Table consisting of a plurality of data fields containing alphabetic, numeric and symbolic characters to define a plurality of Onsite Vehicle Repair Parts Reports.

FIG. 19.75 illustrates a Vehicle Repair Work Order Report Table consisting of a plurality of data fields containing alphabetic, numeric and symbolic characters to define a plurality of Vehicle Repair Work Order Reports.

FIG. 19.76 illustrates a Packing List and Crate Report Table consisting of a plurality of data fields containing alphabetic, numeric and symbolic characters to define a plurality of Packing List and Crate Reports.

FIG. 19.77 illustrates a Packing List Report Table consisting of a plurality of data fields containing alphabetic, numeric and symbolic characters to define a plurality of Packing List Reports.

FIG. 19.78 illustrates a Packing Slip & Tracking Information Report Table consisting of a plurality of data fields containing alphabetic, numeric and symbolic characters to define a plurality of Packing Slip & Tracking Information Reports.

FIG. 19.79 illustrates a Pickup and Bill of Lading Report Table consisting of a plurality of data fields containing alphabetic, numeric and symbolic characters to define a plurality of Pickup and Bill of Lading Reports.

FIG. 19.80 illustrates a Purchase Order for Repair Parts Report Table consisting of a plurality of data fields containing alphabetic, numeric and symbolic characters to define a plurality of Purchase Order for Repair Parts Reports.

FIG. 19.81 illustrates a Remove Vehicle Grounded Report Table consisting of a plurality of data fields containing alphabetic, numeric and symbolic characters to define a plurality of Remove Vehicle Grounded Reports.

FIG. 19.82 illustrates a Repair Dispute Report Table consisting of a plurality of data fields containing alphabetic, numeric and symbolic characters to define a plurality of Repair Dispute Reports.

FIG. 19.83 illustrates a Replacement Parts Order Report Table consisting of a plurality of data fields containing alphabetic, numeric and symbolic characters to define a plurality of Replacement Parts Order Reports.

FIG. 19.84 illustrates a Secure Vehicle Onsite Checklist Report Table consisting of a plurality of data fields containing alphabetic, numeric and symbolic characters to define a plurality of Secure Vehicle Onsite Checklist Reports.

FIG. 19.85 illustrates a Shipping Authorization Report Table consisting of a plurality of data fields containing alphabetic, numeric and symbolic characters to define a plurality of Shipping Authorization Reports.

FIG. 19.86 illustrates a Signed Enterprise Vehicle Repair Authorization Request Report Table consisting of a plurality of data fields containing alphabetic, numeric and symbolic characters to define a plurality of Signed Enterprise Vehicle Repair Authorization Request Reports.

FIG. 19.87 illustrates a Test Diagnosis Report Table consisting of a plurality of data fields containing alphabetic, numeric and symbolic characters to define a plurality of Test Diagnosis Reports.

FIG. 19.88 illustrates a Vehicle Repair Location Report Table consisting of a plurality of data fields containing alphabetic, numeric and symbolic characters to define a plurality of Vehicle Repair Location Reports.

FIG. 19.89 illustrates a Vehicle Estimated Repair Complete Date Report Table consisting of a plurality of data fields containing alphabetic, numeric and symbolic characters to define a plurality of Vehicle Estimated Repair Complete Date Reports.

FIG. 19.90 illustrates a Vehicle Onsite Report Table consisting of a plurality of data fields containing alphabetic, numeric and symbolic characters to define a plurality of Vehicle Onsite Reports.

FIG. 19.91 illustrates a Vehicle Packing List Report Table consisting of a plurality of data fields containing alphabetic, numeric and symbolic characters to define a plurality of Vehicle Packing List Reports.

FIG. 19.92 illustrates a Vehicle Parts Repaired Report Table consisting of a plurality of data fields containing alphabetic, numeric and symbolic characters to define a plurality of Vehicle Parts Repaired Reports.

FIG. 19.93 illustrates a Vehicle Pickup Notice Report Table consisting of a plurality of data fields containing alphabetic, numeric and symbolic characters to define a plurality of Vehicle Pickup Notice Reports.

FIG. 19.94 illustrates a Vehicle Pickup Request Report Table consisting of a plurality of data fields containing alphabetic, numeric and symbolic characters to define a plurality of Vehicle Pickup Request Reports.

FIG. 19.95 illustrates a Vehicle Pickup Shipping Order Report Table consisting of a plurality of data fields containing alphabetic, numeric and symbolic characters to define a plurality of Vehicle Pickup Shipping Order Reports.

FIG. 19.96 illustrates a Vehicle Repair Checklist Report Table consisting of a plurality of data fields containing alphabetic, numeric and symbolic characters to define a plurality of Vehicle Repair Checklist Reports.

FIG. 19.97 illustrates a Vehicle Repair Cost Estimate Report Table consisting of a plurality of data fields containing alphabetic, numeric and symbolic characters to define a plurality of Vehicle Repair Cost Estimate Reports.

FIG. 19.98 illustrates a Vehicle Repair Parts Report Table consisting of a plurality of data fields containing alphabetic, numeric and symbolic characters to define a plurality of Vehicle Repair Parts Reports.

FIG. 19.99 illustrates a Vehicle Repair Priority Report Table consisting of a plurality of data fields containing alphabetic, numeric and symbolic characters to define a plurality of Vehicle Repair Priority Reports.

FIG. 19.100 illustrates a Vehicle Repaired Report Table consisting of a plurality of data fields containing alphabetic, numeric and symbolic characters to define a plurality of Vehicle Repaired Reports.

FIG. 19.101 illustrates a Vehicle Unpacking Condition Report Table consisting of a plurality of data fields containing alphabetic, numeric and symbolic characters to define a plurality of Vehicle Unpacking Condition Reports.

FIG. 19.102 illustrates a Visual Observer Test Confirmation Report Table consisting of a plurality of data fields containing alphabetic, numeric and symbolic characters to define a plurality of Visual Observer Test Confirmation Reports.

FIG. 19.103 illustrates a Visual Observer Vehicle Return to Site Report Table consisting of a plurality of data fields containing alphabetic, numeric and symbolic characters to define a plurality of Visual Observer Vehicle Return to Site Reports.

FIG. 19.104 illustrates a Vehicle Maintenance Parts List Report Table consisting of a plurality of data fields containing alphabetic, numeric and symbolic characters to define a plurality of Vehicle Maintenance Parts List Reports.

FIGS. 20.2-20.50 illustrate an exemplary information displays and presentations for the present invention and include the following data tables:

FIG. 20.2 illustrates the data elements used to create an information description about a Bill of Lading which is presented using a plurality of display mediums including, but limited to, digital graphic image, digital file, paper and visual display device.

FIG. 20.3 illustrates the data elements used to create an information description about a Crate Pickup & Shipping Order which is presented using a plurality of display mediums including, but limited to, digital graphic image, digital file, paper and visual display device.

FIG. 20.4 illustrates the data elements used to create an information description about a Damage Claim which is presented using a plurality of display mediums including, but limited to, digital graphic image, digital file, paper and visual display device.

FIG. 20.5 illustrates the data elements used to create an information description about a Down Vehicle which is presented using a plurality of display mediums including, but limited to, digital graphic image, digital file, paper and visual display device.

FIG. 20.6 illustrates the data elements used to create an information description about a Enterprise Authorization Vehicle Repair Request which is presented using a plurality of display mediums including, but limited to, digital graphic image, digital file, paper and visual display device.

FIG. 20.7 illustrates the data elements used to create an information description about a Enterprise Credit Balance which is presented using a plurality of display mediums including, but limited to, digital graphic image, digital file, paper and visual display device.

FIG. 20.8 illustrates the data elements used to create an information description about an Enterprise Vehicle Ready for Service which is presented using a plurality of display mediums including, but limited to, digital graphic image, digital file, paper and visual display device.

FIG. 20.9 illustrates the data elements used to create an information description about an Enterprise Vehicle Repair Notice which is presented using a plurality of display mediums including, but limited to, digital graphic image, digital file, paper and visual display device.

FIG. 20.10 illustrates the data elements used to create an information description about an Enterprise Vehicle Repaired which is presented using a plurality of display mediums including, but limited to, digital graphic image, digital file, paper and visual display device.

FIG. 20.11 illustrates the data elements used to create an information description about an Enterprise Vehicle Return to Site which is presented using a plurality of display mediums including, but limited to, digital graphic image, digital file, paper and visual display device.

FIG. 20.12 illustrates the data elements used to create an information description about a Flight Ops Vehicle Repaired which is presented using a plurality of display mediums including, but limited to, digital graphic image, digital file, paper and visual display device.

FIG. 20.13 illustrates the data elements used to create an information description about a Full System Test which is presented using a plurality of display mediums including, but limited to, digital graphic image, digital file, paper and visual display device.

FIG. 20.14 illustrates the data elements used to create an information description about a Maintenance Job Completion which is presented using a plurality of display mediums including, but limited to, digital graphic image, digital file, paper and visual display device.

FIG. 20.15 illustrates the data elements used to create an information description about a Maintenance Job which is presented using a plurality of display mediums including, but limited to, digital graphic image, digital file, paper and visual display device.

FIG. 20.16 illustrates the data elements used to create an information description about a Onsite Full System Test Report Results which is presented using a plurality of display mediums including, but limited to, digital graphic image, digital file, paper and visual display device.

FIG. 20.17 illustrates the data elements used to create an information description about an Onsite Parts Receipt Form which is presented using a plurality of display mediums including, but limited to, digital graphic image, digital file, paper and visual display device.

FIG. 20.18 illustrates the data elements used to create an information description about an Onsite Vehicle New Parts Update which is presented using a plurality of display mediums including, but limited to, digital graphic image, digital file, paper and visual display device.

FIG. 20.19 illustrates the data elements used to create an information description about an Onsite Vehicle Repair Completion which is presented using a plurality of display mediums including, but limited to, digital graphic image, digital file, paper and visual display device.

FIG. 20.20 illustrates the data elements used to create an information description about a Packing List and Crate which is presented using a plurality of display mediums including, but limited to, digital graphic image, digital file, paper and visual display device.

FIG. 20.21 illustrates the data elements used to create an information description about a Packing List which is presented using a plurality of display mediums including, but limited to, digital graphic image, digital file, paper and visual display device.

FIG. 20.22 illustrates the data elements used to create an information description about a Packing Slip & Tracking Information which is presented using a plurality of display mediums including, but limited to, digital graphic image, digital file, paper and visual display device.

FIG. 20.23 illustrates the data elements used to create an information description about a Pickup and Bill of Lading which is presented using a plurality of display mediums including, but limited to, digital graphic image, digital file, paper and visual display device.

FIG. 20.24 illustrates the data elements used to create an information description about a Purchase Order for Repair Parts which is presented using a plurality of display mediums including, but limited to, digital graphic image, digital file, paper and visual display device.

FIG. 20.25 illustrates the data elements used to create an information description about a Remove Vehicle Grounded which is presented using a plurality of display mediums including, but limited to, digital graphic image, digital file, paper and visual display device.

FIG. 20.26 illustrates the data elements used to create an information description about a Repair Dispute which is presented using a plurality of display mediums including, but limited to, digital graphic image, digital file, paper and visual display device.

FIG. 20.27 illustrates the data elements used to create an information description about a Replacement Parts Order which is presented using a plurality of display mediums including, but limited to, digital graphic image, digital file, paper and visual display device.

FIG. 20.28 illustrates the data elements used to create an information description about a Secure Vehicle Onsite Checklist which is presented using a plurality of display mediums including, but limited to, digital graphic image, digital file, paper and visual display device.

FIG. 20.29 illustrates the data elements used to create an information description about a Shipping Authorization which is presented using a plurality of display mediums including, but limited to, digital graphic image, digital file, paper and visual display device.

FIG. 20.30 illustrates the data elements used to create an information description about a Signed Enterprise Vehicle Repair Authorization Request which is presented using a plurality of display mediums including, but limited to, digital graphic image, digital file, paper and visual display device.

FIG. 20.31 illustrates the data elements used to create an information description about a Test Diagnosis which is presented using a plurality of display mediums including, but limited to, digital graphic image, digital file, paper and visual display device.

FIG. 20.32 illustrates the data elements used to create an information description about a Vehicle Estimated Repair Complete Date which is presented using a plurality of display mediums including, but limited to, digital graphic image, digital file, paper and visual display device.

FIG. 20.33 illustrates the data elements used to create an information description about a Vehicle Maintenance Parts List which is presented using a plurality of display mediums including, but limited to, digital graphic image, digital file, paper and visual display device.

FIG. 20.34 illustrates the data elements used to create an information description about a Vehicle Onsite which is presented using a plurality of display mediums including, but limited to, digital graphic image, digital file, paper and visual display device.

FIG. 20.35 illustrates the data elements used to create an information description about a Vehicle Packing List which is presented using a plurality of display mediums including, but limited to, digital graphic image, digital file, paper and visual display device.

FIG. 20.36 illustrates the data elements used to create an information description about a Vehicle Parts Repaired which is presented using a plurality of display mediums including, but limited to, digital graphic image, digital file, paper and visual display device.

FIG. 20.37 illustrates the data elements used to create an information description about a Vehicle Pickup Notice which is presented using a plurality of display mediums including, but limited to, digital graphic image, digital file, paper and visual display device.

FIG. 20.38 illustrates the data elements used to create an information description about a Vehicle Pickup Request which is presented using a plurality of display mediums including, but limited to, digital graphic image, digital file, paper and visual display device.

FIG. 20.39 illustrates the data elements used to create an information description about a Vehicle Pickup Shipping Order which is presented using a plurality of display mediums including, but limited to, digital graphic image, digital file, paper and visual display device.

FIG. 20.40 illustrates the data elements used to create an information description about a Vehicle Repair Checklist which is presented using a plurality of display mediums including, but limited to, digital graphic image, digital file, paper and visual display device.

FIG. 20.41 illustrates the data elements used to create an information description about a Vehicle Repair Cost Estimate which is presented using a plurality of display mediums including, but limited to, digital graphic image, digital file, paper and visual display device.

FIG. 20.42 illustrates the data elements used to create an information description about a Vehicle Repair Location which is presented using a plurality of display mediums including, but limited to, digital graphic image, digital file, paper and visual display device.

FIG. 20.43 illustrates the data elements used to create an information description about a Vehicle Repair Parts which is presented using a plurality of display mediums including, but limited to, digital graphic image, digital file, paper and visual display device.

FIG. 20.45 illustrates the data elements used to create an information description about a Vehicle Repair Priority which is presented using a plurality of display mediums including, but limited to, digital graphic image, digital file, paper and visual display device.

FIG. 20.46 illustrates the data elements used to create an information description about a Vehicle Repair Work Order which is presented using a plurality of display mediums including, but limited to, digital graphic image, digital file, paper and visual display device.

FIG. 20.47 illustrates the data elements used to create an information description about a Vehicle Repaired which is presented using a plurality of display mediums including, but limited to, digital graphic image, digital file, paper and visual display device.

FIG. 20.48 illustrates the data elements used to create an information description about a Vehicle Unpacking Condition which is presented using a plurality of display mediums including, but limited to, digital graphic image, digital file, paper and visual display device.

FIG. 20.49 illustrates the data elements used to create an information description about a Visual Observer Test Confirmation which is presented using a plurality of display mediums including, but limited to, digital graphic image, digital file, paper and visual display device.

FIG. 20.50 illustrates the data elements used to create an information description about a Visual Observer Vehicle Return to Site which is presented using a plurality of display mediums including, but limited to, digital graphic image, digital file, paper and visual display device.

FIG. 21 illustrates the symbols used in the figures.

In accordance with common practice, the various described features are not drawn to scale, but are drawn to emphasize specific features relevant to the invention. Like reference characters denote like elements throughout the figures and text.

### DETAILED DESCRIPTION OF THE PRESENT INVENTION

The definition of each of the following terms is included to facilitate understanding of the present invention.

The terms “autonomous aerial Vehicle”, “autonomous Vehicle”, “drone”, “UAS”, “unmanned aerial Vehicle”, and “unmanned Vehicle” are all used interchangeably in the present invention.

A “Charger” or “Charging Station” is an aerial, surface, maritime, or sub-marine system, which provides electricity, fossil fuel, or another energy-generating material to an unmanned Vehicle. It can be fixed or mobile, automated, semi-automated or manually operated. The Charger includes a telecommunications connection to the Management Center, and the plurality of unmanned Vehicles in a Fleet or to Vehicles not assigned to a Fleet. It is capable of remotely contacting and then connecting to an unmanned Vehicle and replenishing the Vehicle with the energy-generating material as required by the Vehicle.

A “Command” is an electronic, analog or digital instruction for a device, entity or process to perform an action.

A “Communication Method” is a process by which data elements are standardized, organized, and formatted in a specific order and sequence.

“Company Personnel” includes employees, individuals, independent contractors, agents, and student interns of Aeronyde Corporation and its subsidiaries, affiliates, research partnership members and partners. Also included are Artificial Intelligence and Machine Learning systems.

A “Device Identifier” or “DID”, is a subset of a “SID”, and an alphanumeric identifier of a device.

A “Dispute” is any action, suit, or formal proceeding between and among the Parties arising in connection with any disagreement, controversy, or claim arising out of or relating to an agreement or any related document.

A “Down Command” or “Down” is a process wherein the Vehicle is on the ground and stationary, the electrical power to the flight movement components is shut off. The Vehicle is inactive and not part of a fleet.

An “Enterprise” is a reference to a customer financially and/or operationally responsible for a Vehicle, Charger, Fleet and Mission Sets.

An “FAA Waiver” is an official authorization document issued by the Federal Aviation Administration (FAA), which approves specific operations of unmanned aerial Vehicle or plurality of unmanned aerial Vehicles outside the restrictions and limitations of a regulation defined in the FAA 14 CFR Part 107 and under 49 U.S.C. § 44809(a), as amended.

A “Filter” is a device which excludes predefined radio frequencies from input to a radio receiver.

A “Fleet” is plurality of unmanned Vehicles operating independently from and in concert with each other.

A “Fleet Management Center” is a subset of the Management Center. The Fleet Management Center is located within the Management Center, which is at a location remote from the unmanned Vehicles, associated with FAA 14 CFR (Code of Federal Regulations) Part 107 licensed Pilots, as amended, responsible for creating, operating, and monitoring Fleets of unmanned Vehicles.

A “Flight Management Center” is a subset of the Management Center. “Flight Management Center” and “Vehicle Flight Management” are used interchangeably in the present invention. It is located within the Management Center, which is at a location remote from the unmanned Vehicles, associated with FAA 14 CFR Part 107 licensed Pilots, as amended, responsible for operating and monitoring unmanned Vehicles.

A “Full System Test”, “Full Systems Test” or “Full Sys Test” is a test of a complete and fully integrated unmanned Vehicle, Charger, Sensor, Shipping Container, or a combination thereof. A Full System Test includes a series of different sub-tests, the sole purpose of which is to exercise individual components of the unmanned Vehicle, Charger or Sensor. The hardware, software and firmware are tested individually and together. The Full System Test evaluates the test results and compares those results against a set of desired or required results.

A “Geographic Area” or “Geo Area” is a demarcated area of the Earth is defined by a longitude and latitude for each significant boundary point of the area. The surface of the earth is divided into an established grid, bounded by longitude and latitude lines. Each cell of the grid defines a specific geographic area.

A “Ground Command” or “Ground” is a process wherein the Vehicle is forced to remain stationary and, on the ground, permission to move or take off is revoked. The Vehicle is active and is part of a fleet.

“LAANC” is the FAA Low Altitude Authorization and Notification Capability. It directly supports Unmanned Aerial Systems integration into the controlled airspace. LAANC automates the application and approval process for airspace authorizations. Through automated applications developed by an FAA approved Unmanned Aerial System Service Suppliers (USS) pilots apply for an airspace authorization to operate an unmanned Vehicle, in accordance with Public Law 112-95, § 333 and its implementing regulations at 14 CFR Part 107 and under 49 U.S.C. § 44809(a), as amended.

A “Land Command” or “Land” is a command to the Vehicle to move from its present location and elevation to another location on the ground and to cease flying.

A “Landing Zone” or “LZ” or “LIZ” is the longitude and latitude identifying the physical fixed location or mobile platform from which a Vehicle departs, takes off or on which a Vehicle arrives, lands.

“Launch” is the process of a Vehicle leaving a stationary place on the ground and moving to its Next position in a mission set.

“Loss Mitigation” is the process for minimizing the degree and the amount of possible risk and loss to a party.

A “Management Center” is a location remote from the unmanned Vehicles, associated with licensed FAA 14 CFR Part 107 Pilots responsible for operating and monitoring unmanned Vehicles, unmanned Vehicle fleets and chargers. “Management Center” and “Management and Control Center” are all used interchangeably in the present invention.

A “Manager” or “MGR” is a person responsible for controlling or administering all or part of the company or similar organization.

A “Mission Set” includes a collection of operating rules, operating instructions, locations, device and Fleet lists, used to perform a task or series of tasks at a specific time and location. It is a collection of one or more Project Sets.

A “Modem” is a device for modulation and demodulation of radio frequency signals. It converts digital data to be transmitted into an analog signal and converts a received analog radio signal into digital data.

A “Multiplexor” or “MUX” is a device allowing one or more analog or digital input signals to be selected, combined and transmitted at a higher speed on a single shared medium or within a single shared device. Thus, when multiplexed, several signals may share a single device or transmission medium, such as a radio frequency transmitter.

A “Next” as associated with the terms Mission Set, Project Set, Flight Plan, WayPoint, LZ, Vehicle as part of a Fleet, Fleet, Charger and other things, is a first, or second, or third and continuing sequential instances until the last instance of a Mission Set, Project Set, Flight Plan, WayPoint, LZ, Vehicle as part of a Fleet, Fleet, Charger and other things.

An “Origin Location” (“Origin”), is the latitude, longitude, and altitude of the fixed geographic location or mobile platform from which the Vehicles launched.

A “Pilot” or “Licensed Pilot” or “FAA Part 107 Pilot” is a member of Company Personnel, who directs, operates and controls a Vehicle or plurality of Vehicles. The Pilot is licensed by the Federal Aviation Administration (FAA) under 14 CFR Part 107 and under 49 U.S.C. § 44809(a) of the FAA, as amended, to remotely operate and control an unmanned Vehicle or plurality of unmanned Vehicles.

A “Ping” is a process to test if a specific receiving entity is reachable by a specific transmitting entity. It is a diagnostic that checks if the transmitting entity is connected to a receiving entity. A Ping sends a data packet from a transmitting entity to a receiving entity. If it is received by the receiving entity, the receiving entity returns a data packet to the transmitting entity acknowledging receipt of the data packet.

A “P.O.” or “PO” or “Purchase Order” is a commercial document and first official offer issued by a buyer to a seller indicating types, quantities, and agreed prices for products or services. It is used to control the purchasing of products and services from external suppliers.

A “Project Set” is a subset of a Mission Set. The Project Set includes a collection of operating rules, operating instructions, locations, events, and lists of Pilots, Vehicles, Sensors, Chargers and Fleets that are used to perform specific event tasks at a specific time and location associated with the Project Set. It also includes but is not limited to a Flight Plan, Start time, End time. It also includes a plurality of project Waypoints and L/Zs.

“Ready” is a command process wherein the Vehicle is on the ground and stationary. The electrical power to the flight movement components is on and the Vehicle can be placed into service to complete a mission.

A “Repair Technician” or “RT” is a member of Company Personnel authorized to repair Vehicles, Vehicle Components, Sensors, Chargers and other things.

A “Report” is a a spoken, written and/or graphically presented account of a particular matter, especially in the form of an official document, after thorough investigation or consideration by an appointed person or body.

A “Return to Home Altitude” is a predefined or real-time determined altitude, to which the Vehicle ascends or descends and continues at that altitude until it reaches its origin location.

A “Shipping Container” is a container built with a plurality of materials and used to protect and enclose Vehicles, Vehicle Components, Sensors, Chargers and other things for and during shipping.

A “Regional Identifier” or “RID” is an alphanumeric identifier of a region.

A “Sectional Identifier” or “SID”, is a subset of a “RID”, and an alphanumeric identifier of section of a Region.

A “Snap” is a connection between two or more entities in a network. It virtually affixes two or more entities to each other within the network.

A “System” is an interconnected, integrated, coordinated, functioning operation of Vehicles, or Fleets, or Chargers, or equipment, or hardware, or software, or humans, or procedures, or objects.

“Uvionics” is a commercial name of an onboard, Vehicle operating and control system, that allows licensed Pilots to remotely operate multiple Vehicles, concurrently and efficiently. Such a Vehicle Control System is commercially referred to as a Uvionics System, available from the Aeronyde Corporation of Melbourne, Fla

A “Vehicle” is an unmanned remotely operated and monitored aerial, surface, sub-surface, maritime, or sub-marine device or system used for transporting people, goods, sensors or other objects.

A “Visual Observer” or “VO” is a member of Company Personnel, required under the FAA 14 CFR Part 107 of the FAA Rules and Regulations, as amended, to coordinate the remote operation of an unmanned Vehicle with a Pilot. The Visual Observer is situated at the site of the unmanned aircraft and scans the airspace where the unmanned aircraft is operating for any potential collision hazards and maintains awareness of the position of the unmanned aircraft through direct visual observation.

A “Waypoint” is a subset of a Project Set. The WayPoint includes but is not limited to a digital or analog collection of operating rules, operating instructions, device lists, and a specific location's longitude, latitude and altitude, used for an event at a specific location, altitude, and time.

“What3Words” is a geocode system for the communication of locations' longitudes and latitudes with a resolution of three meters. What3words encodes geographic coordinates into three dictionary words address; the encoding is permanently fixed. The What3Words system relies on a fixed algorithm rather than a large database of every location on earth. It works on devices with limited storage and no Internet connection.

These and other features and advantages of this invention are described in, or are apparent from, the following detailed description of various exemplary embodiment.

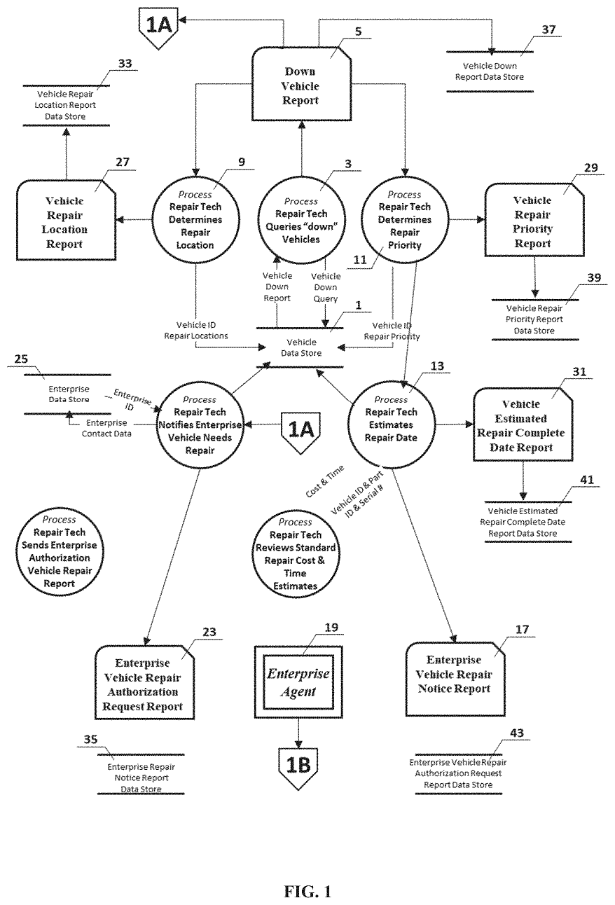

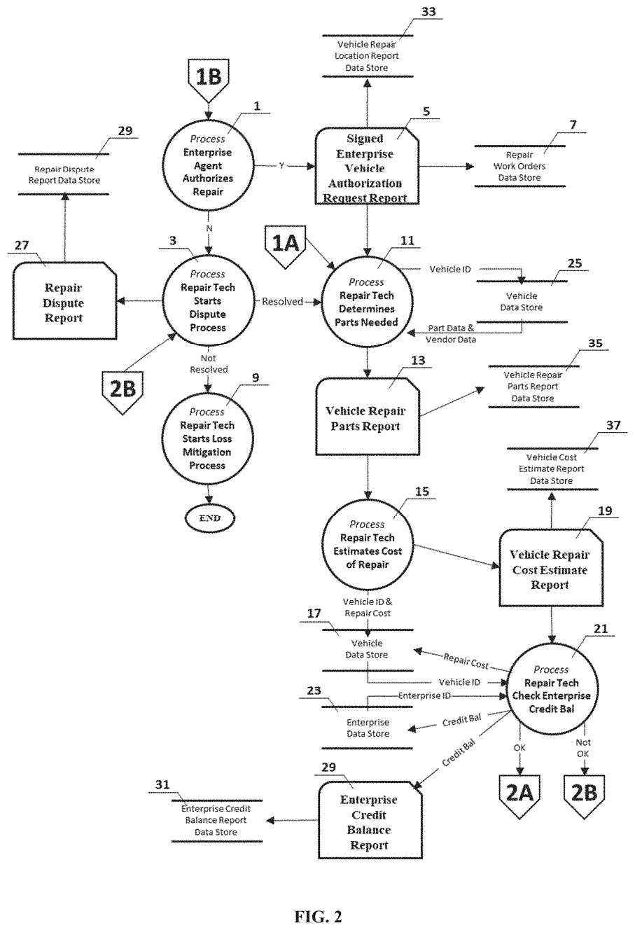

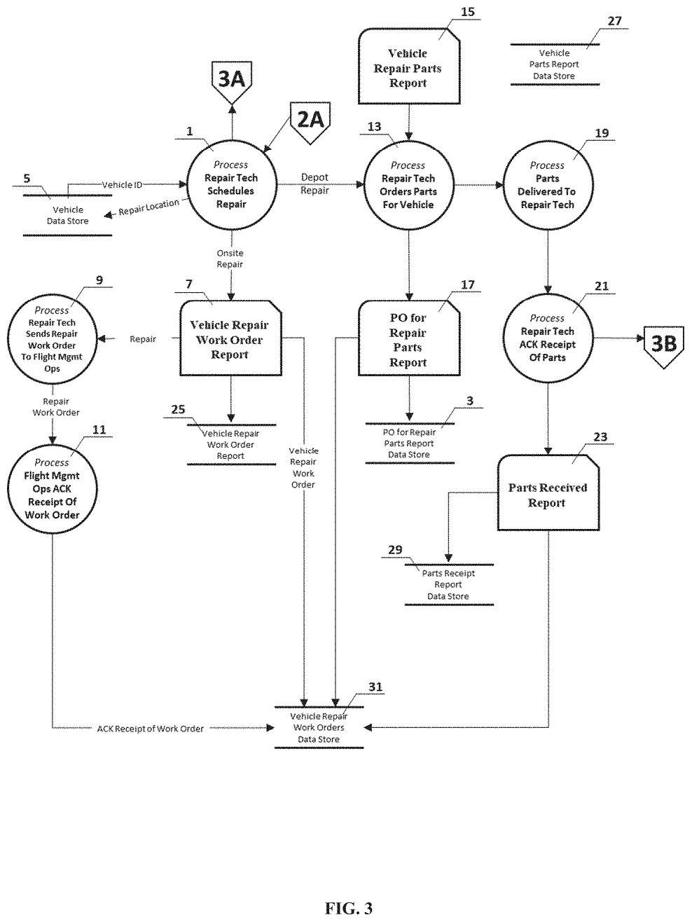

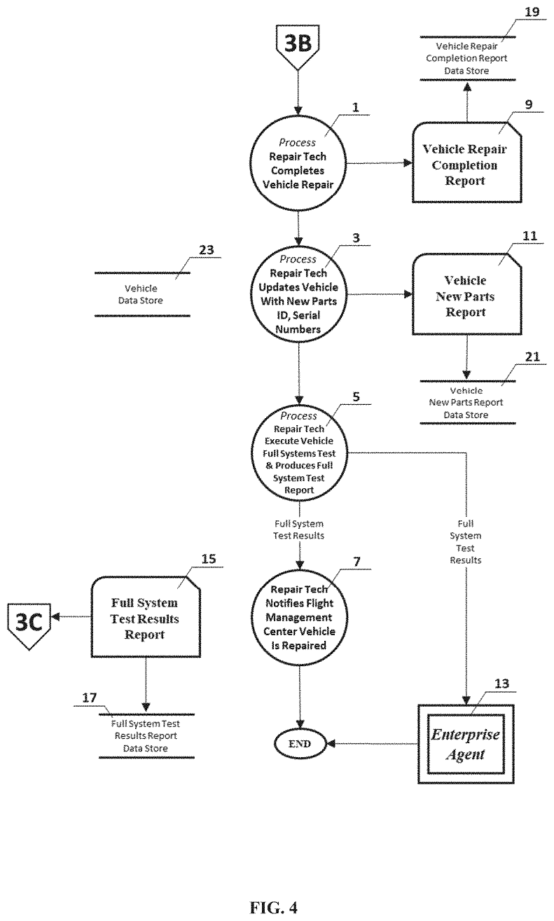

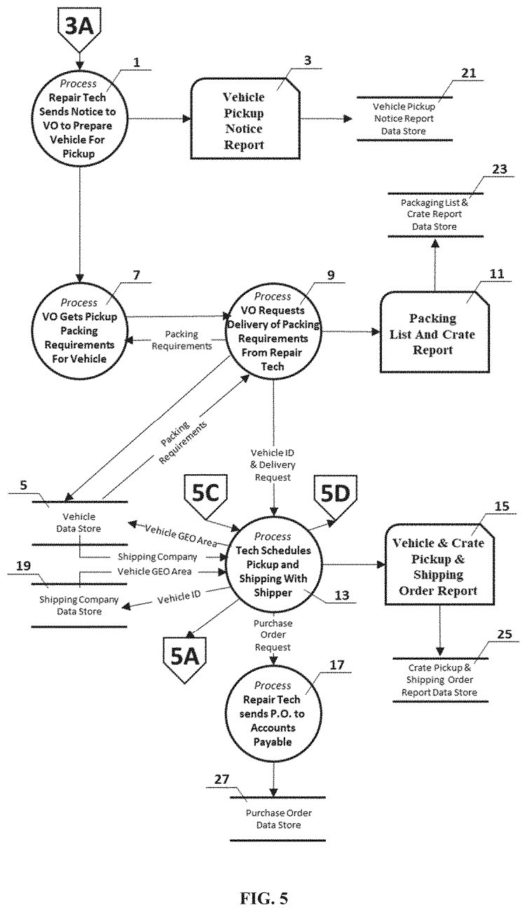

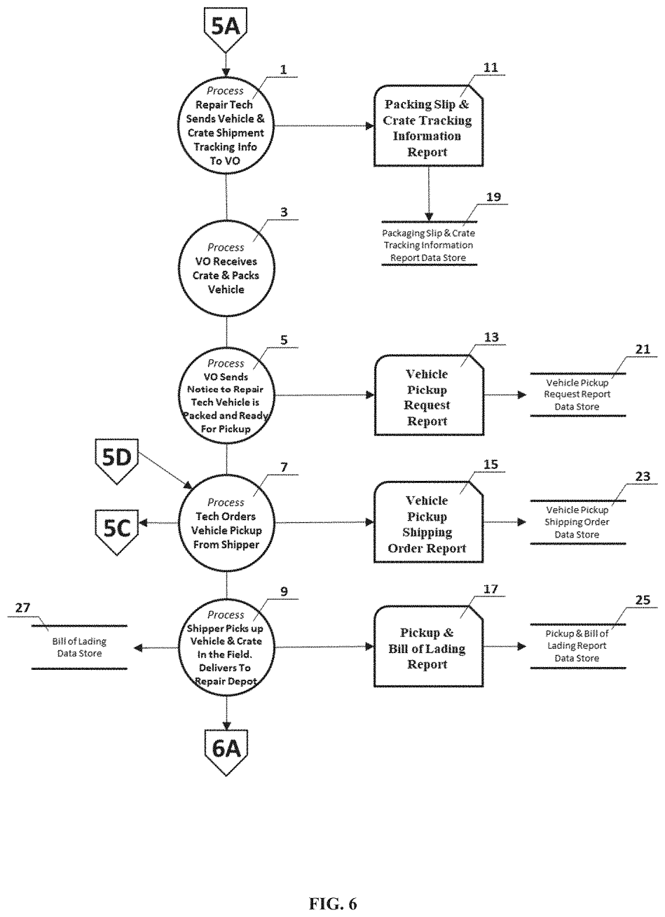

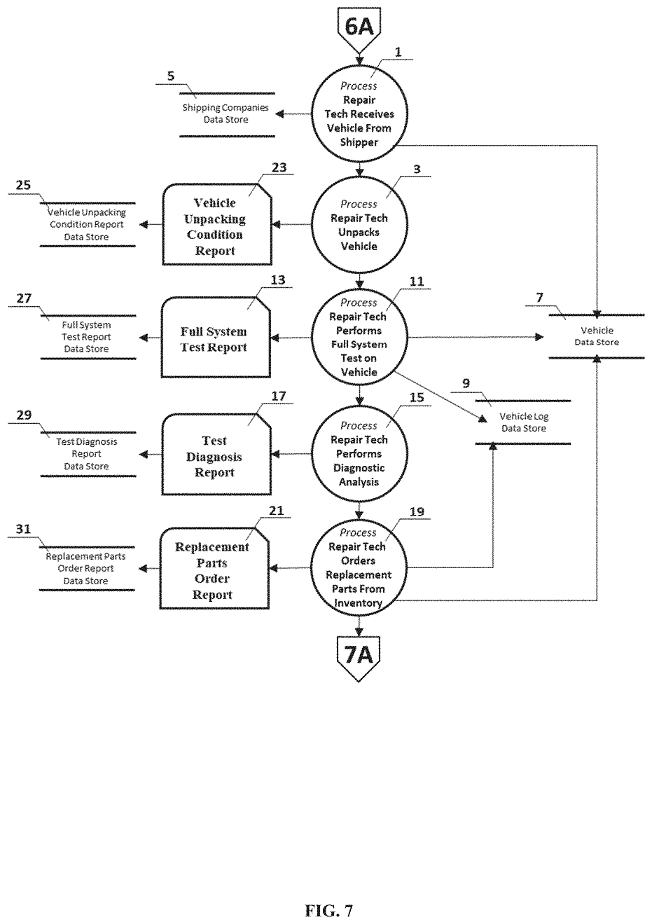

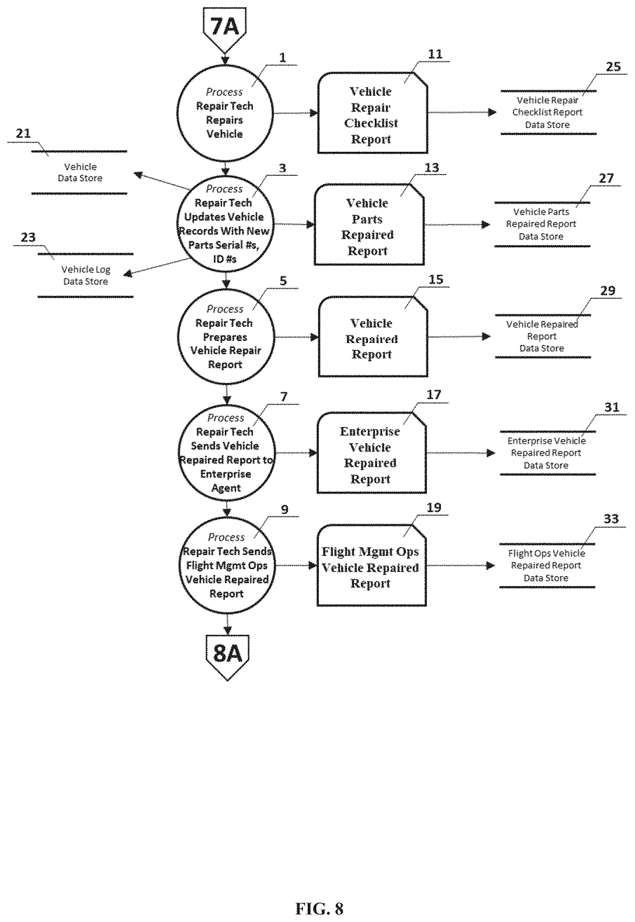

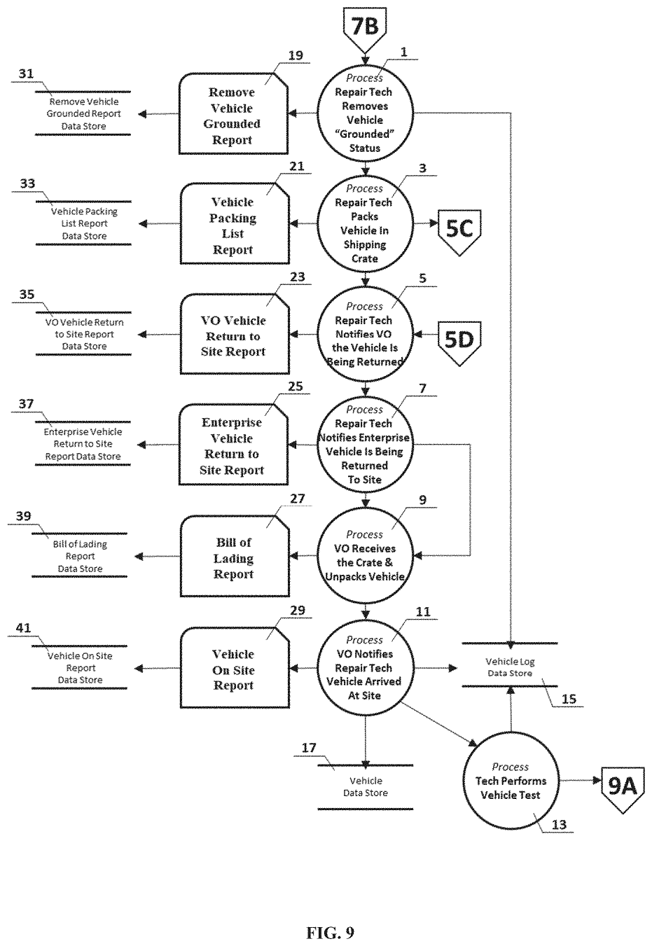

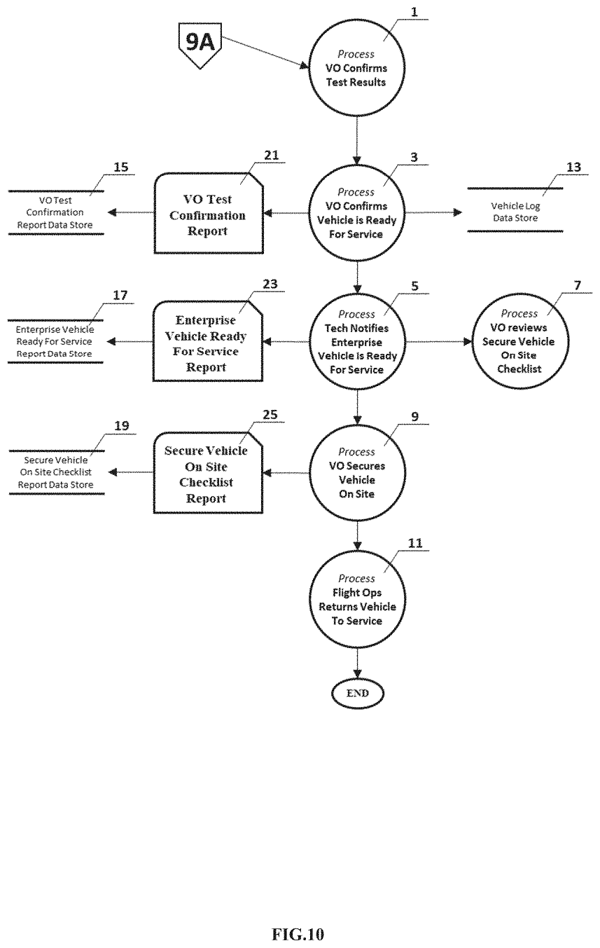

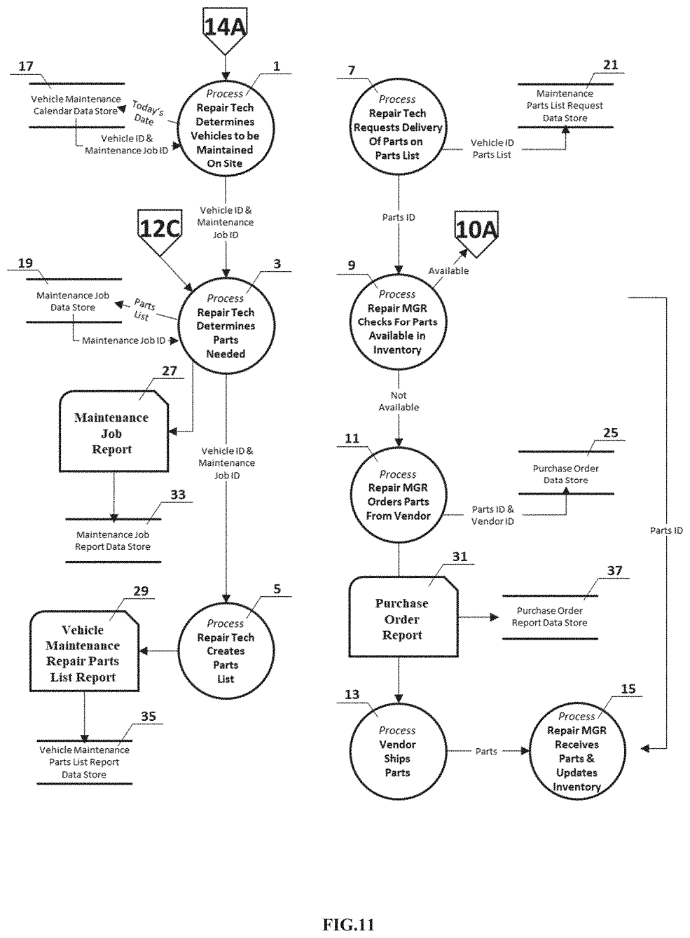

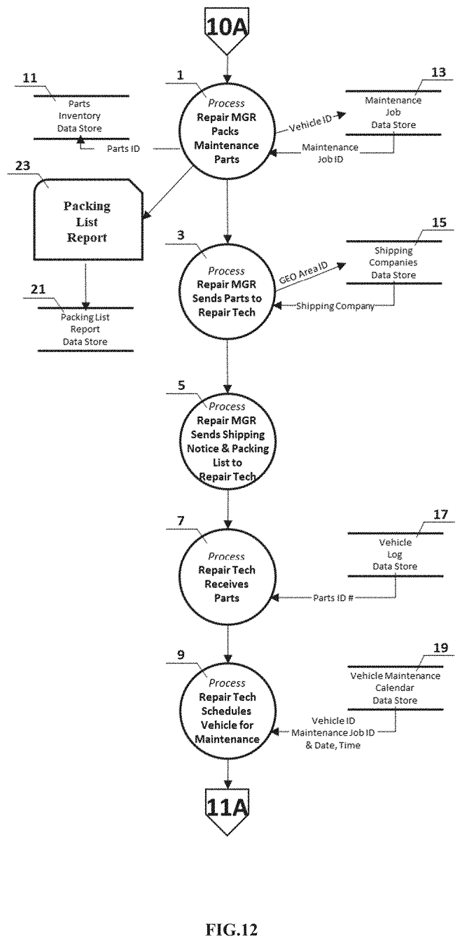

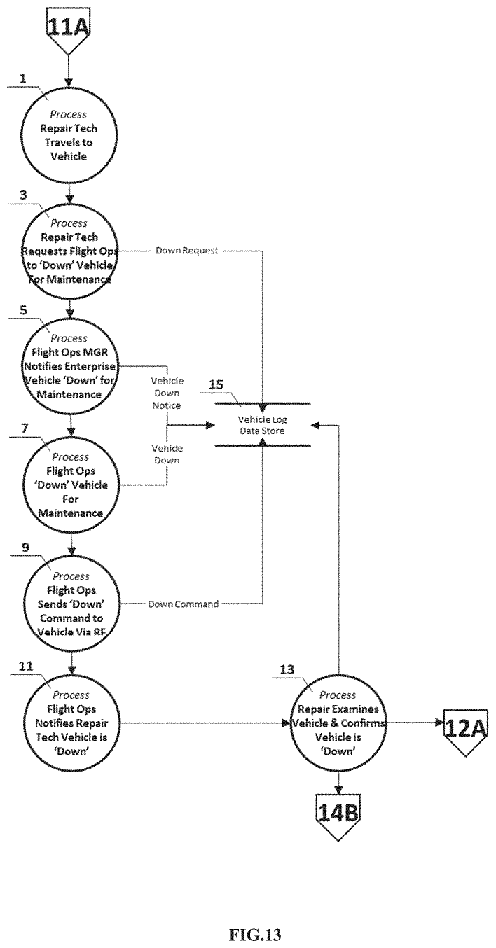

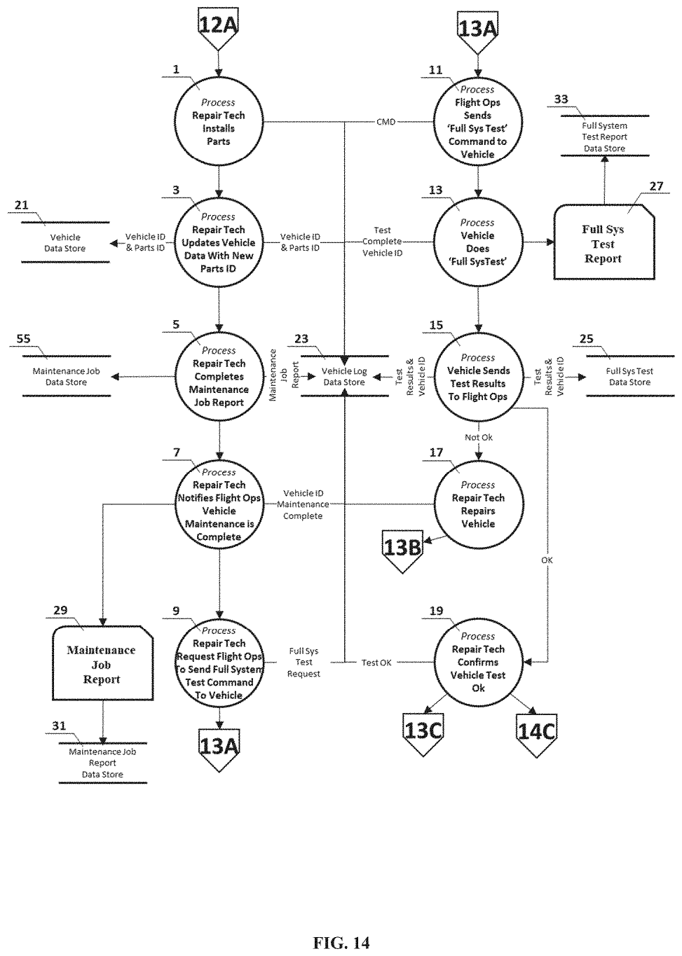

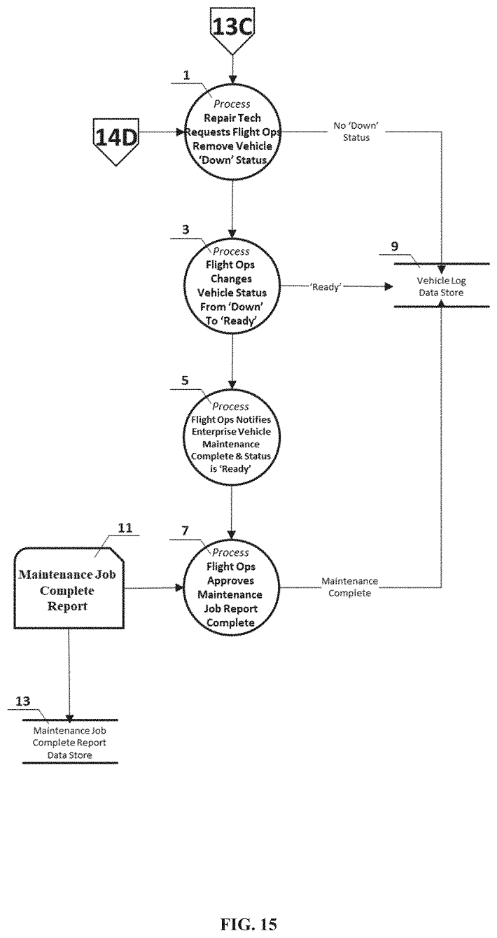

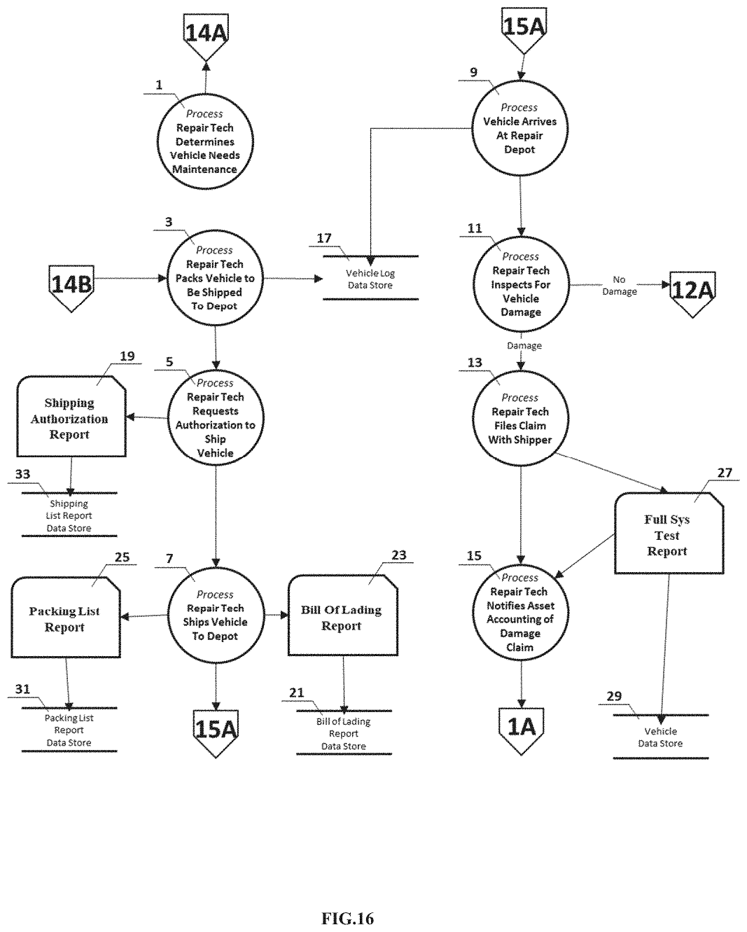

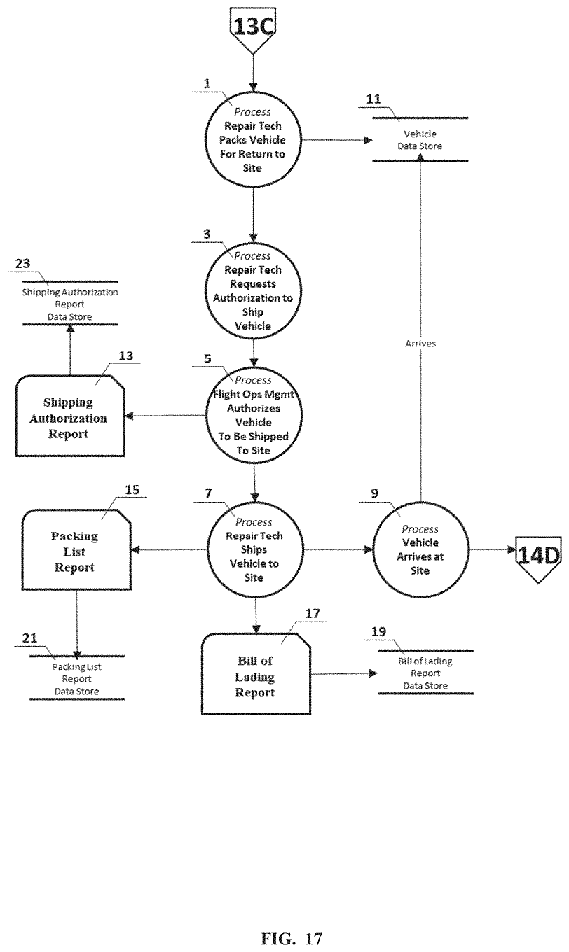

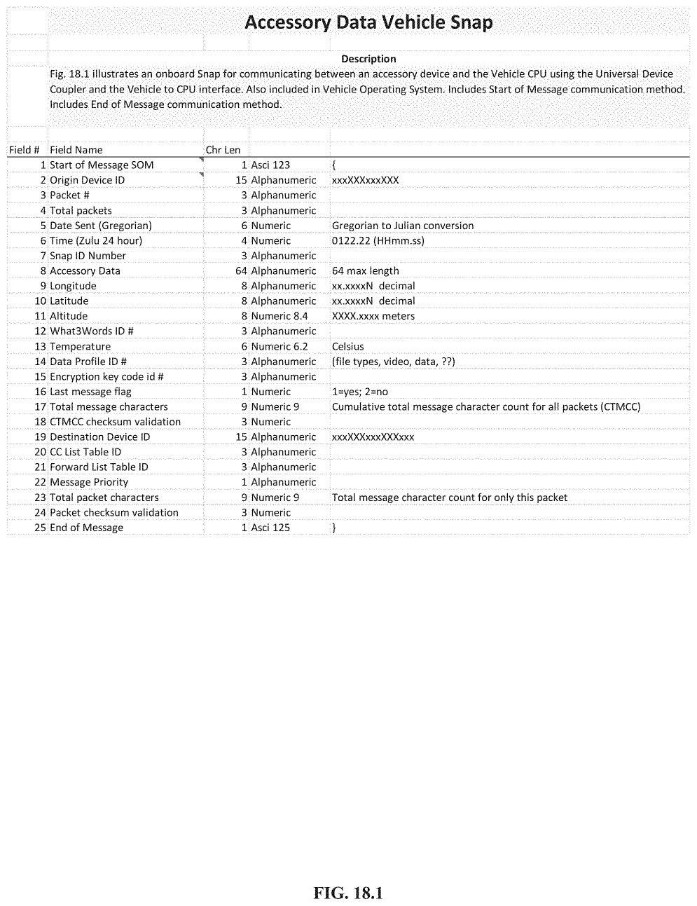

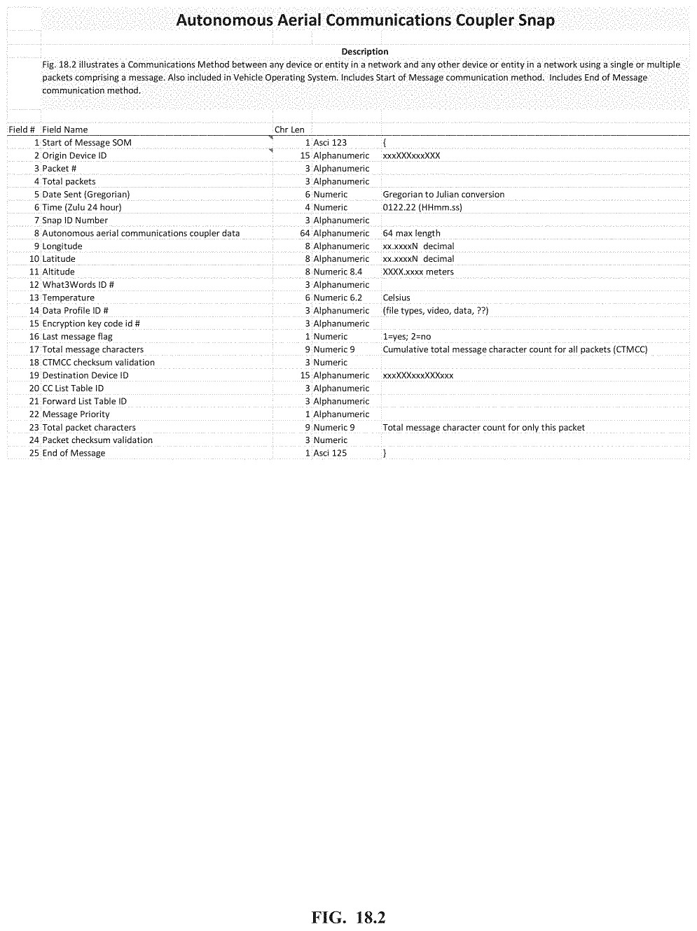

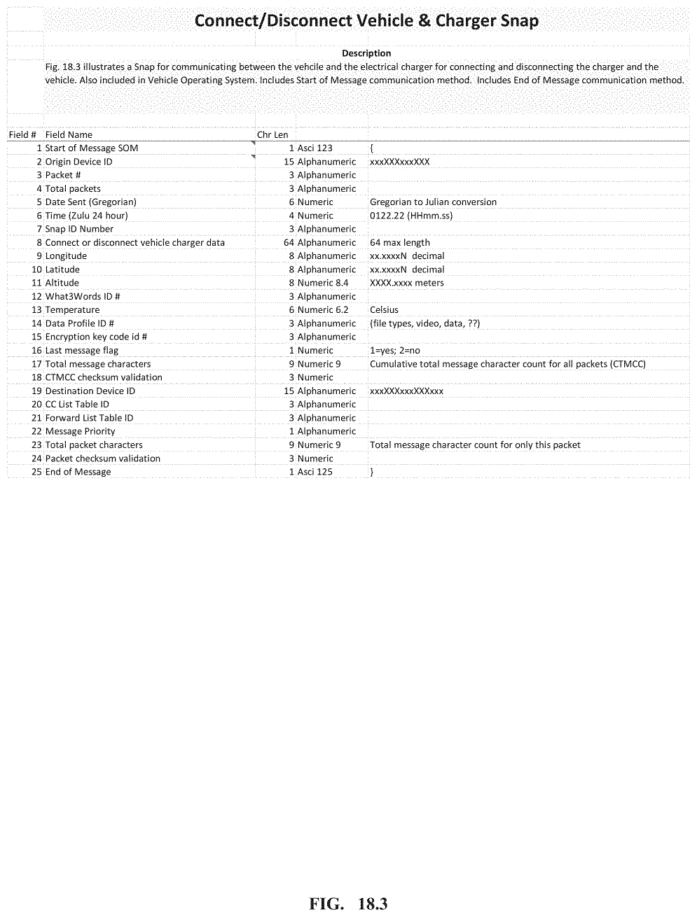

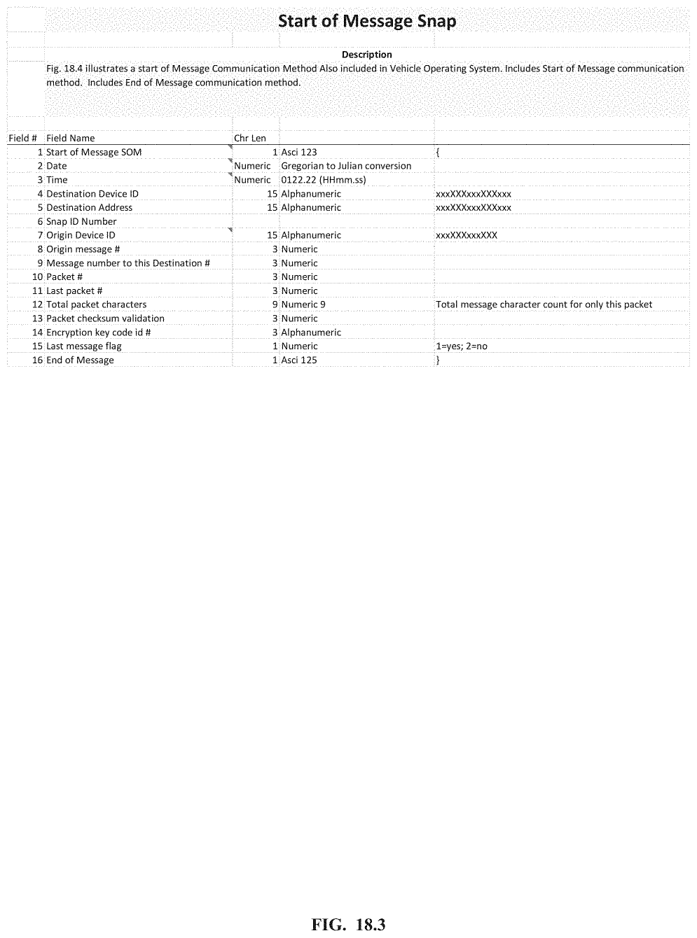

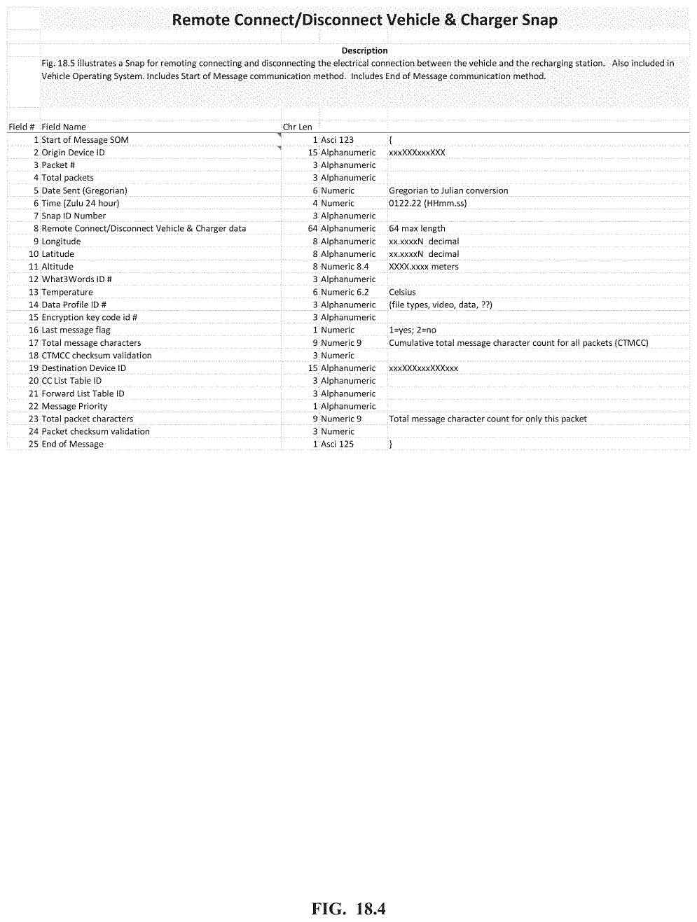

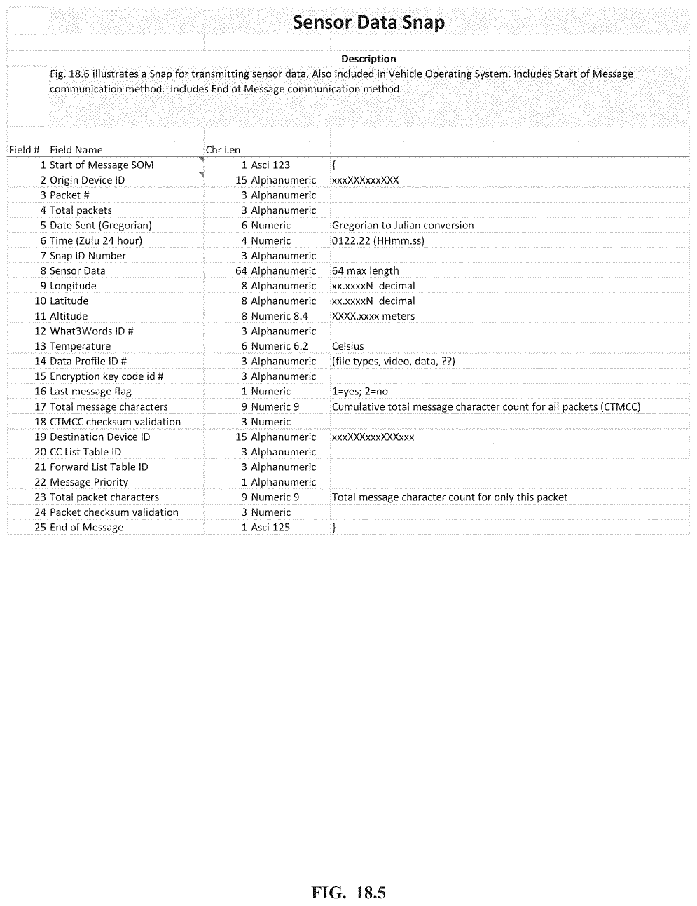

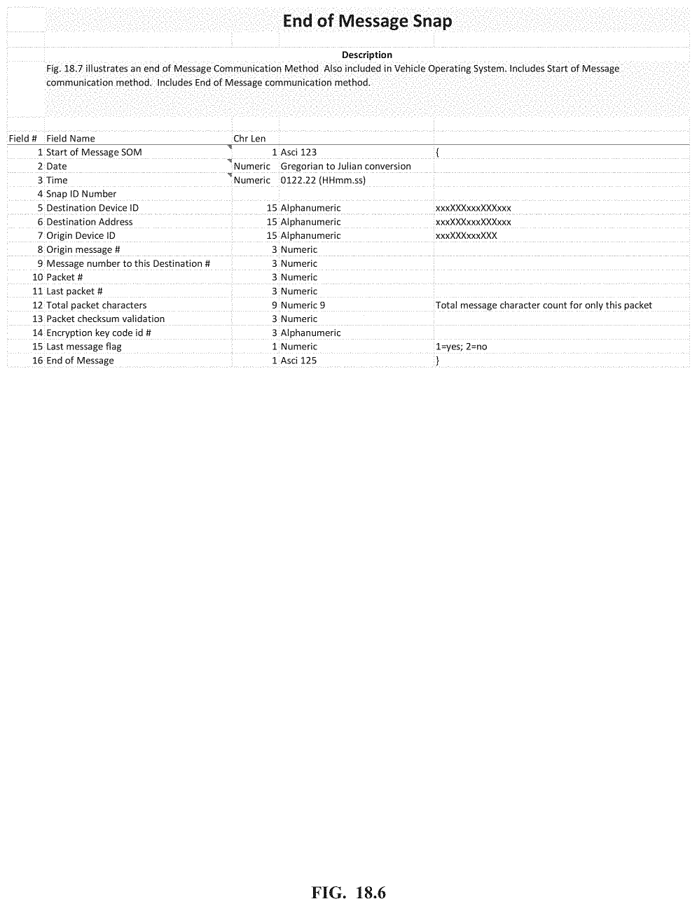

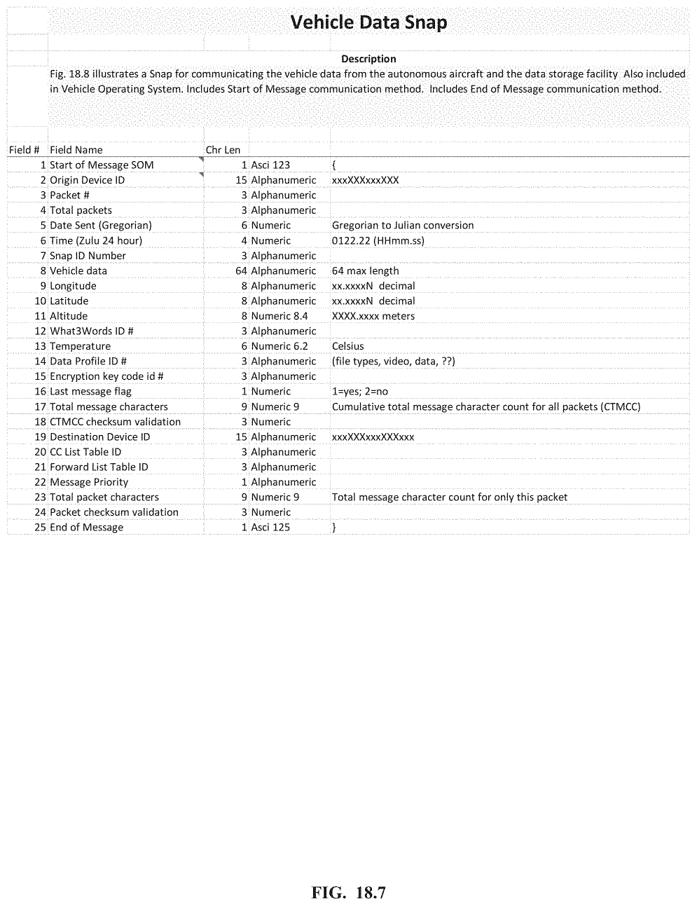

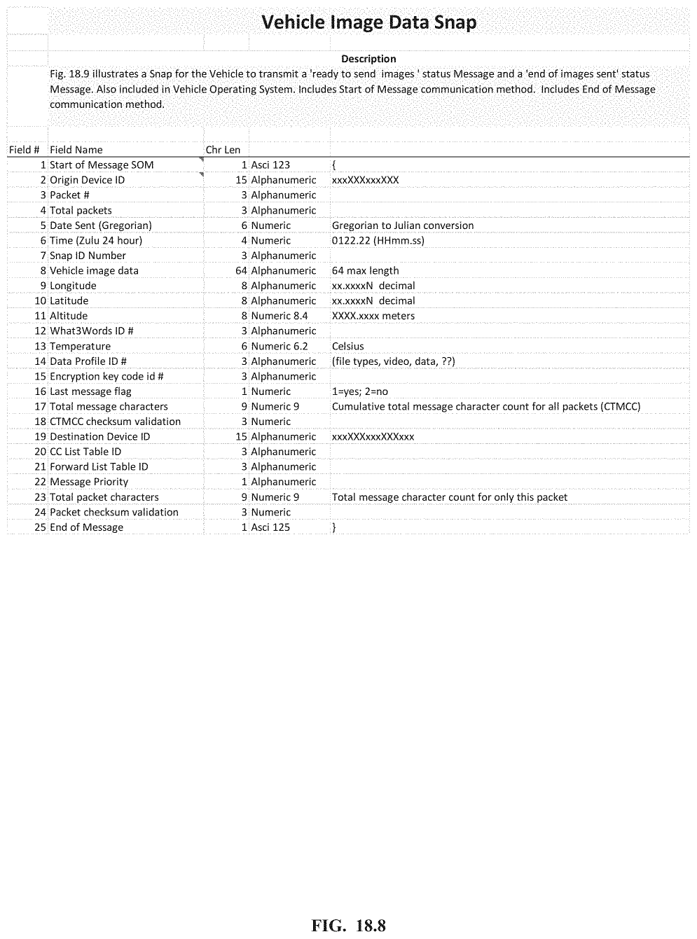

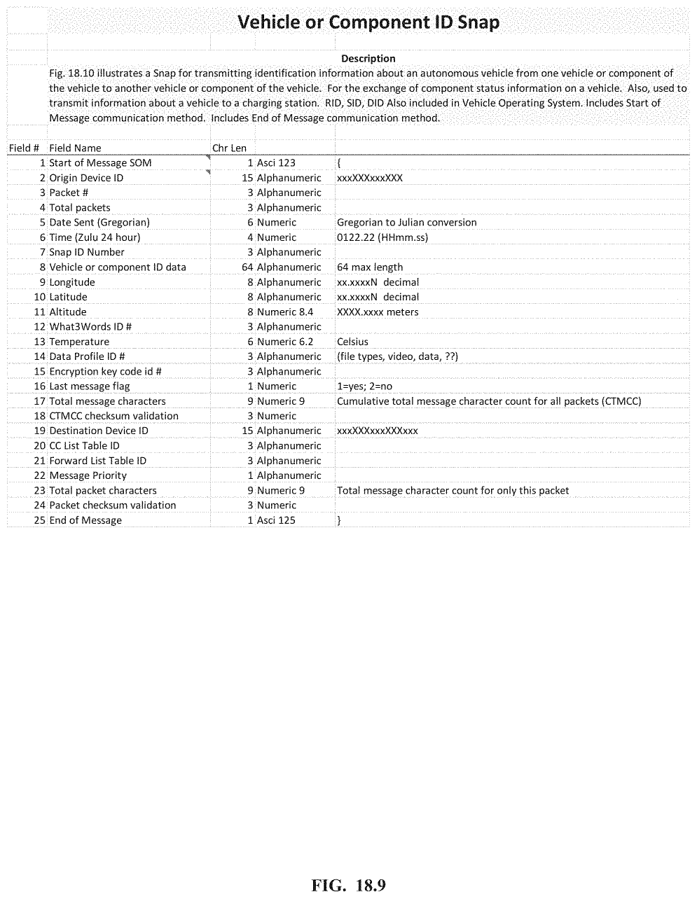

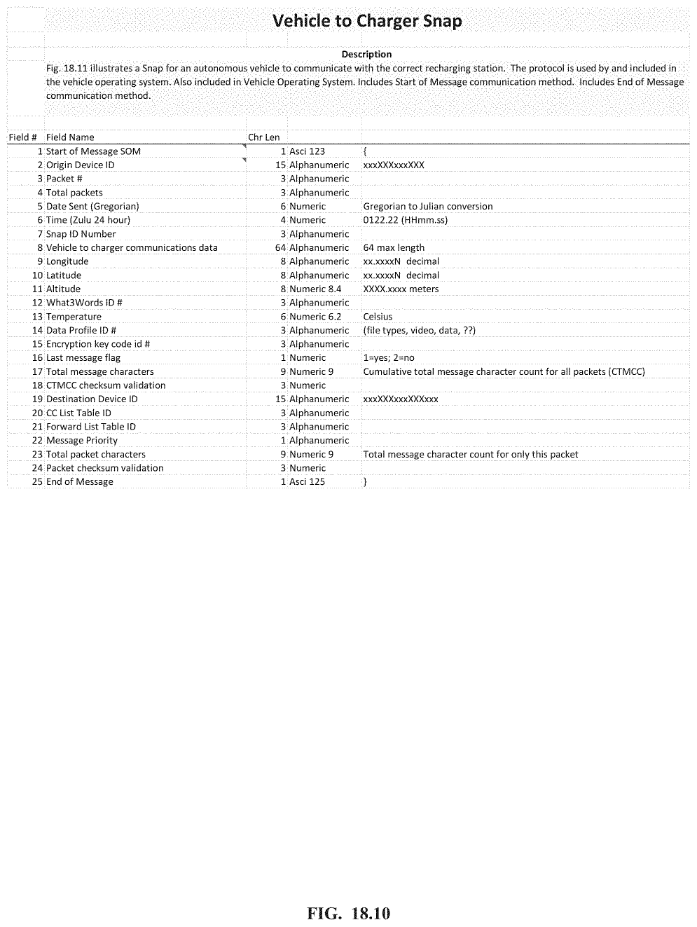

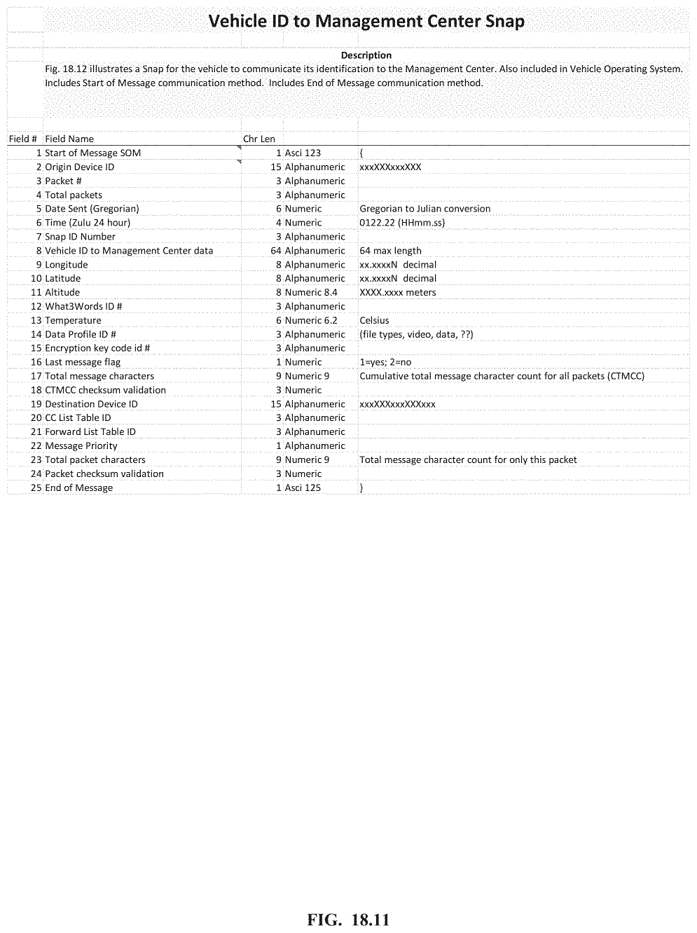

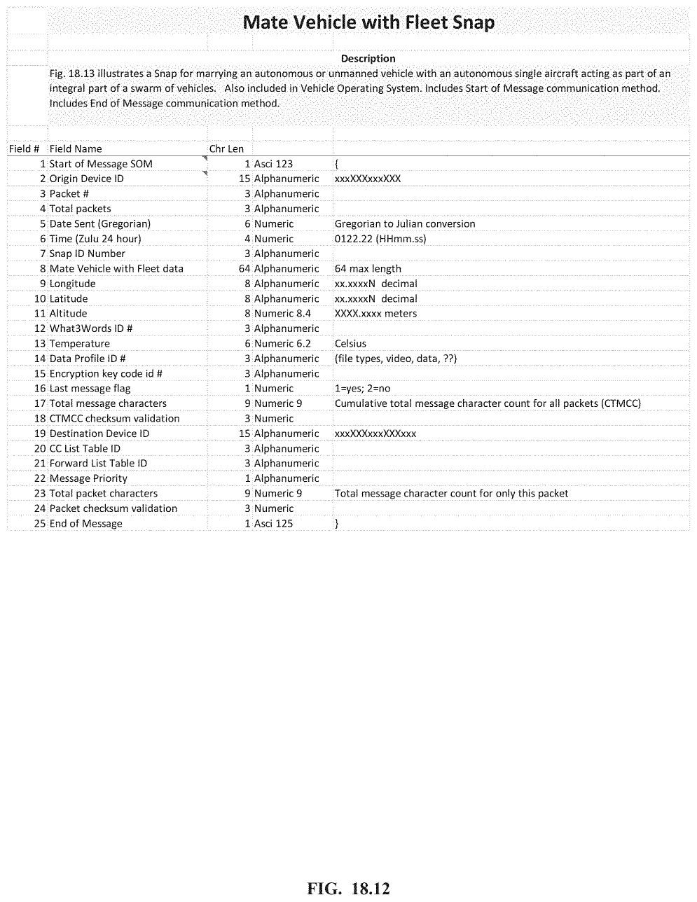

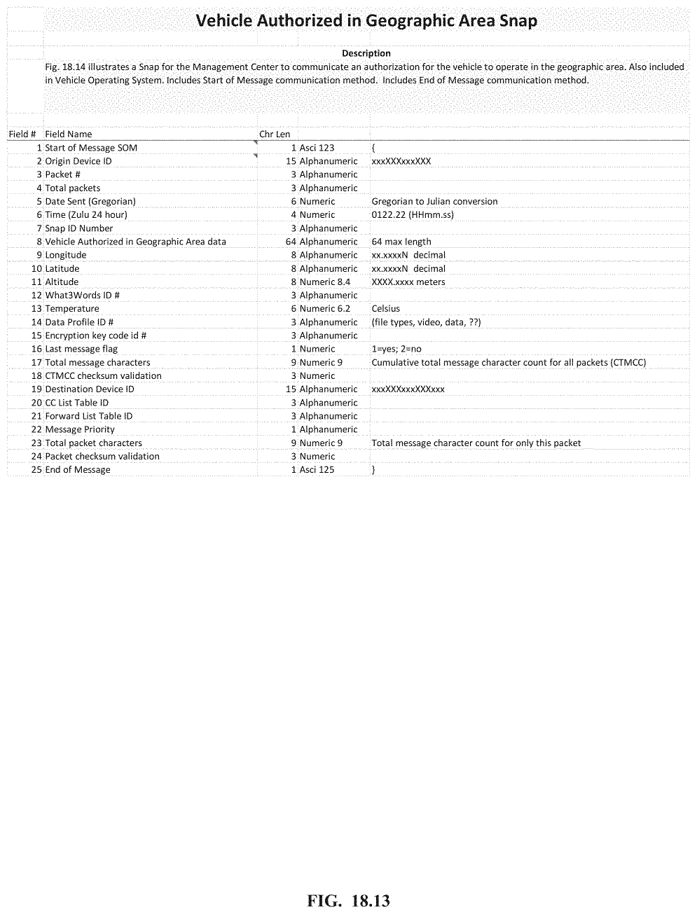

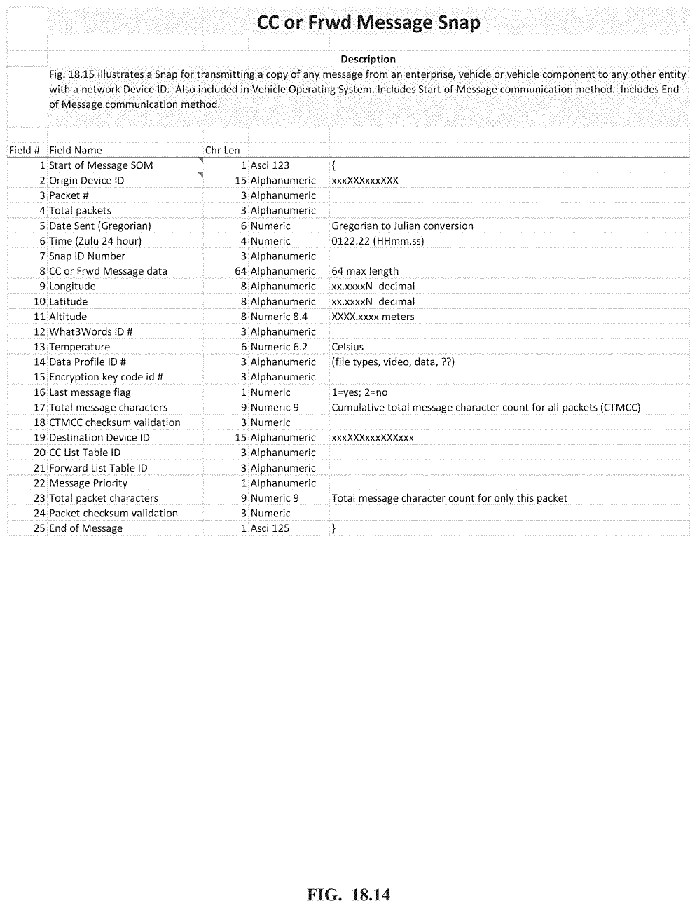

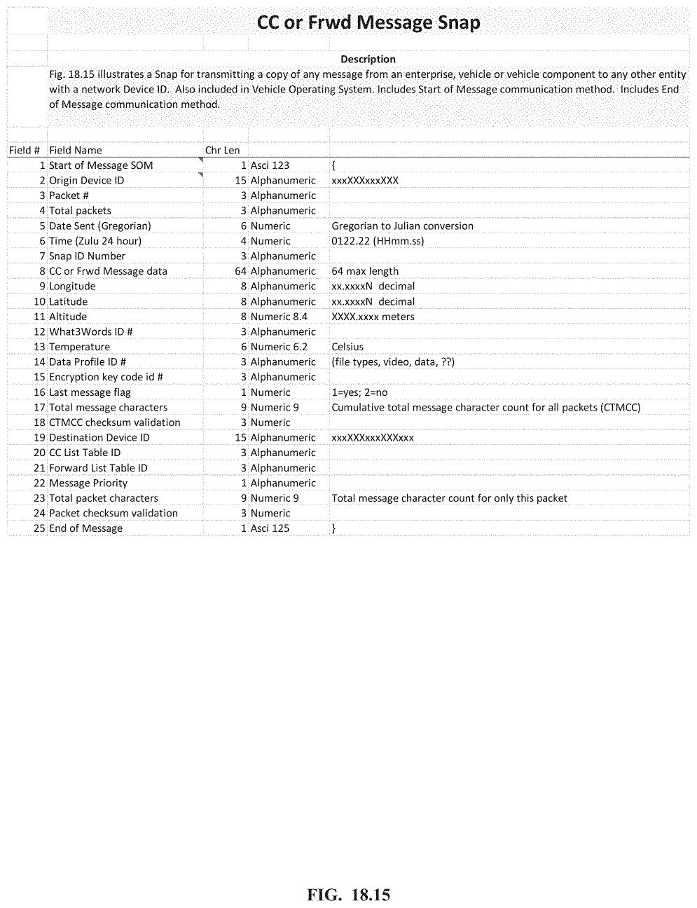

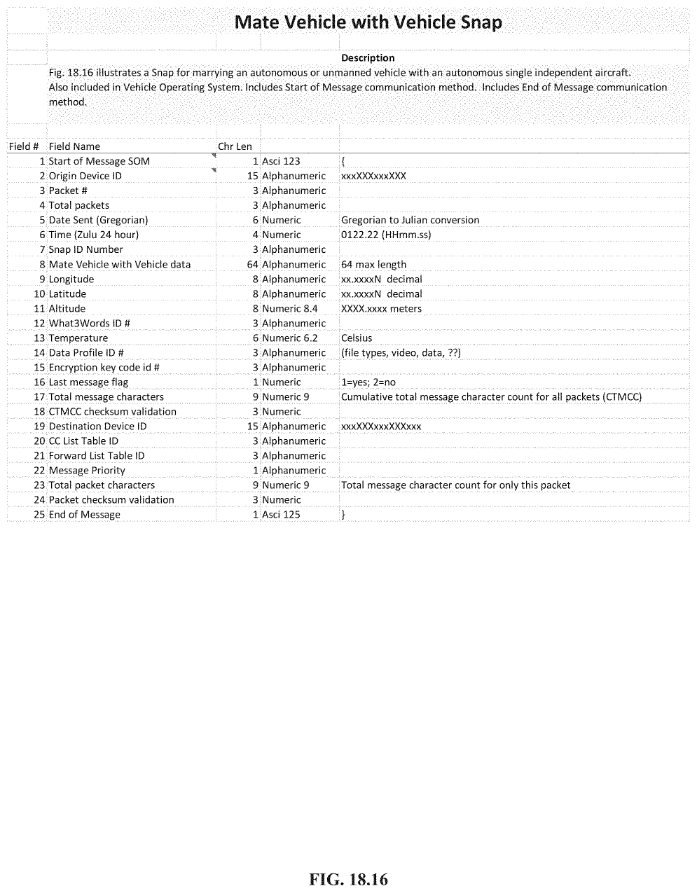

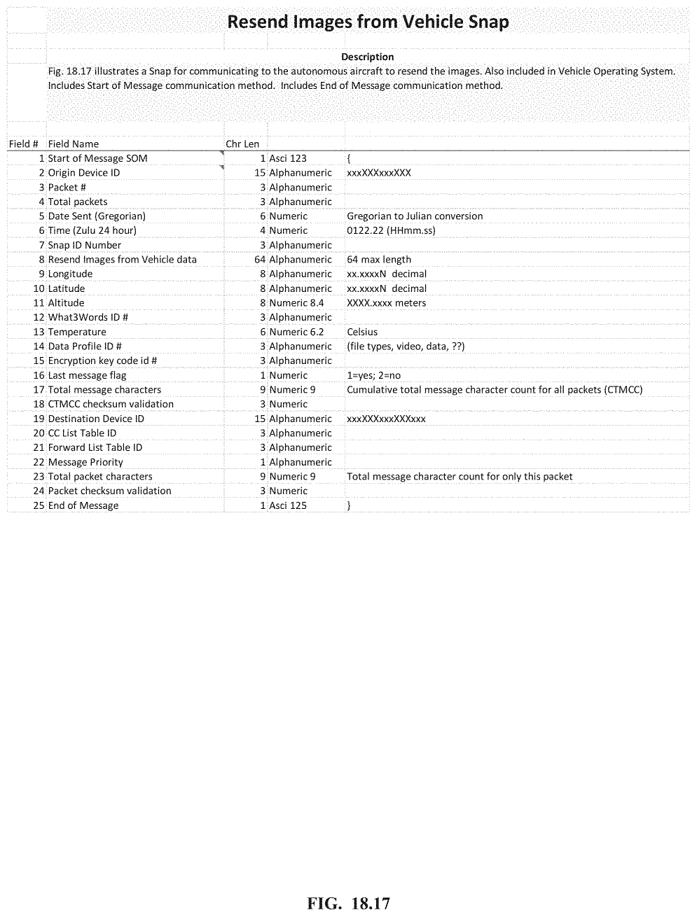

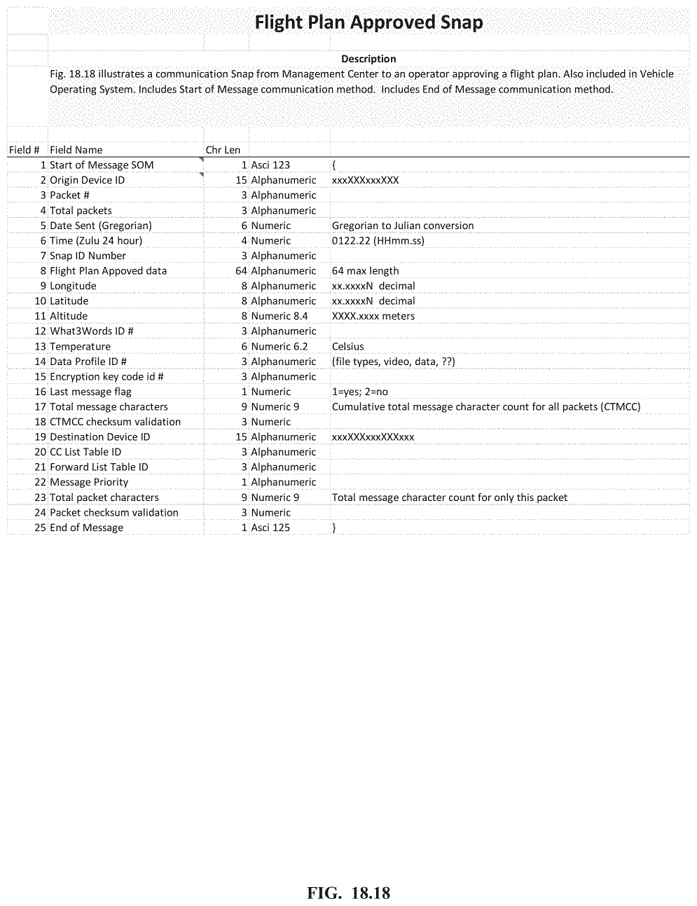

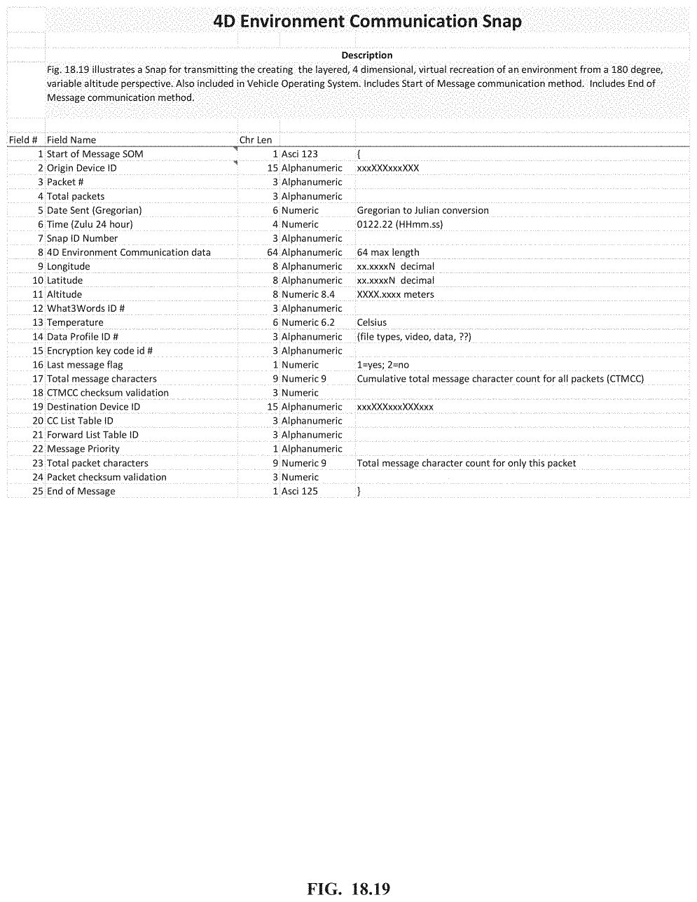

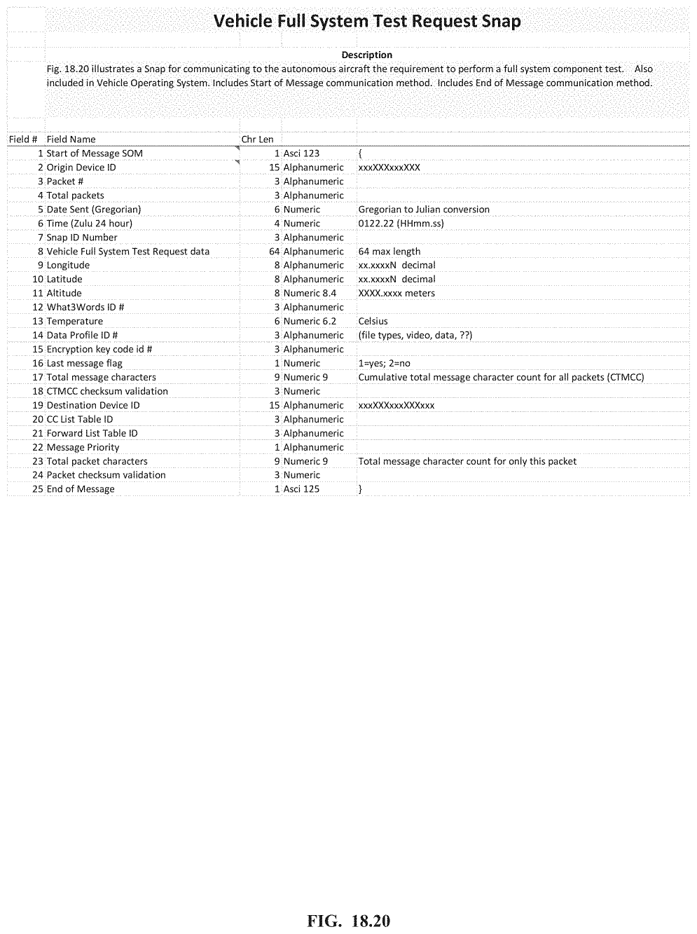

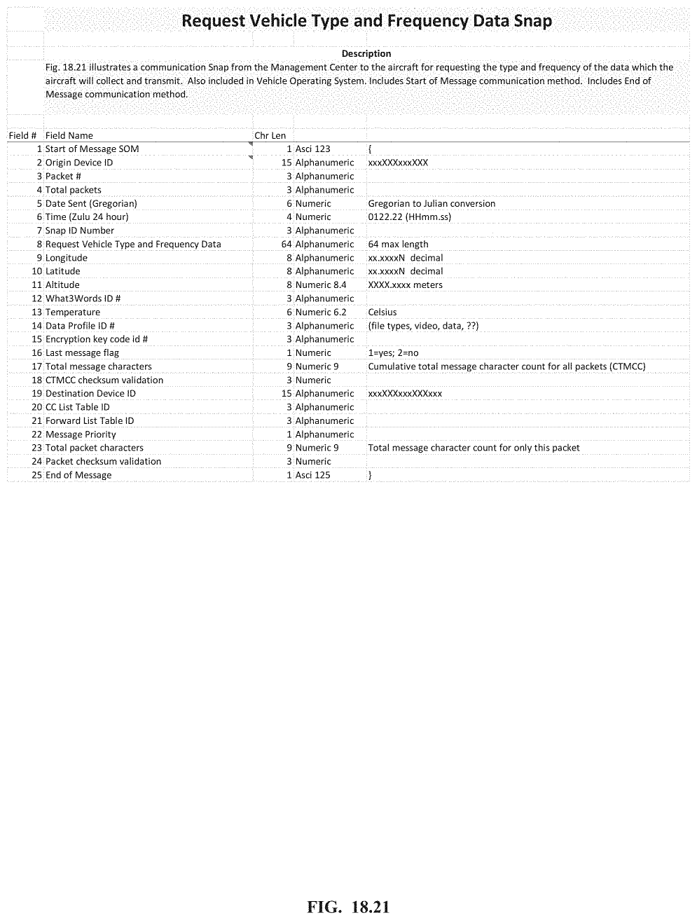

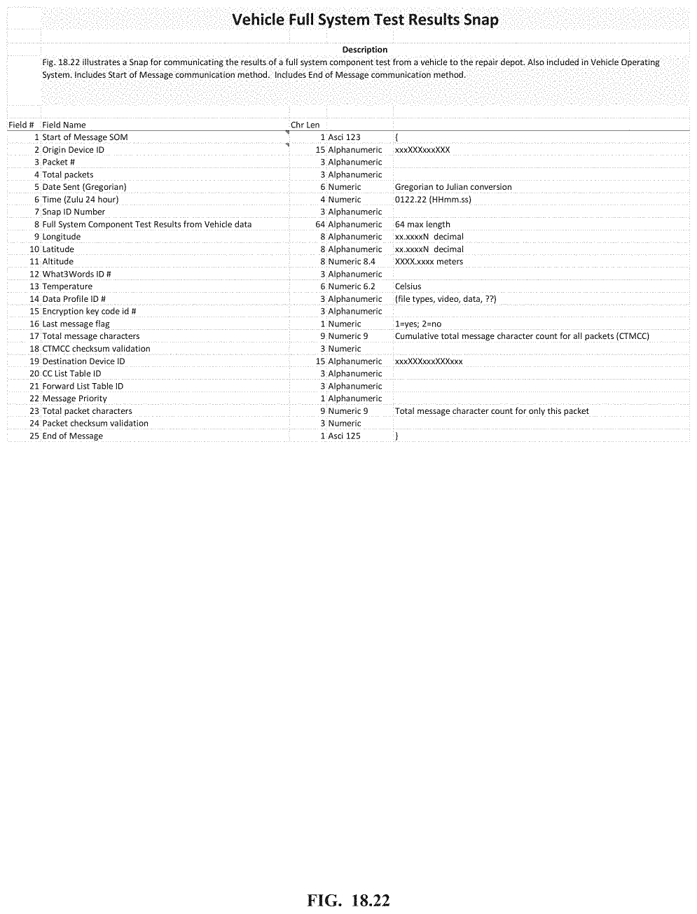

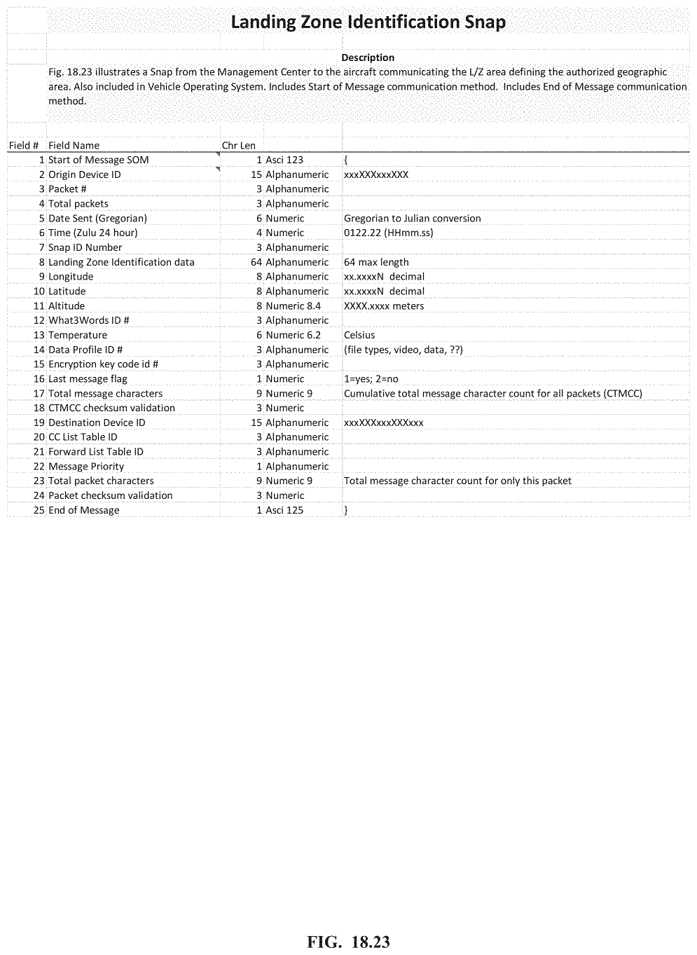

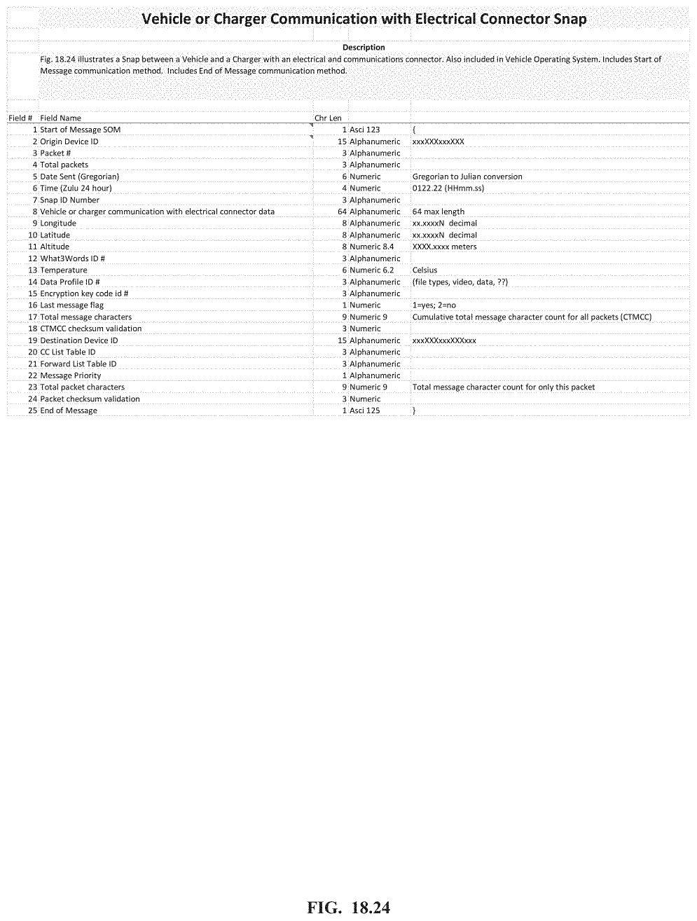

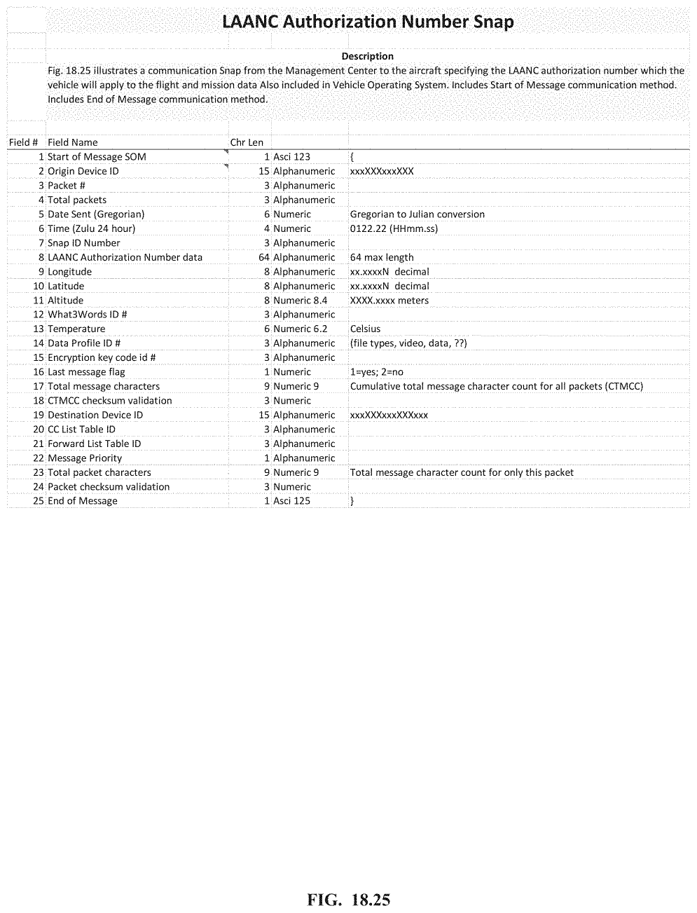

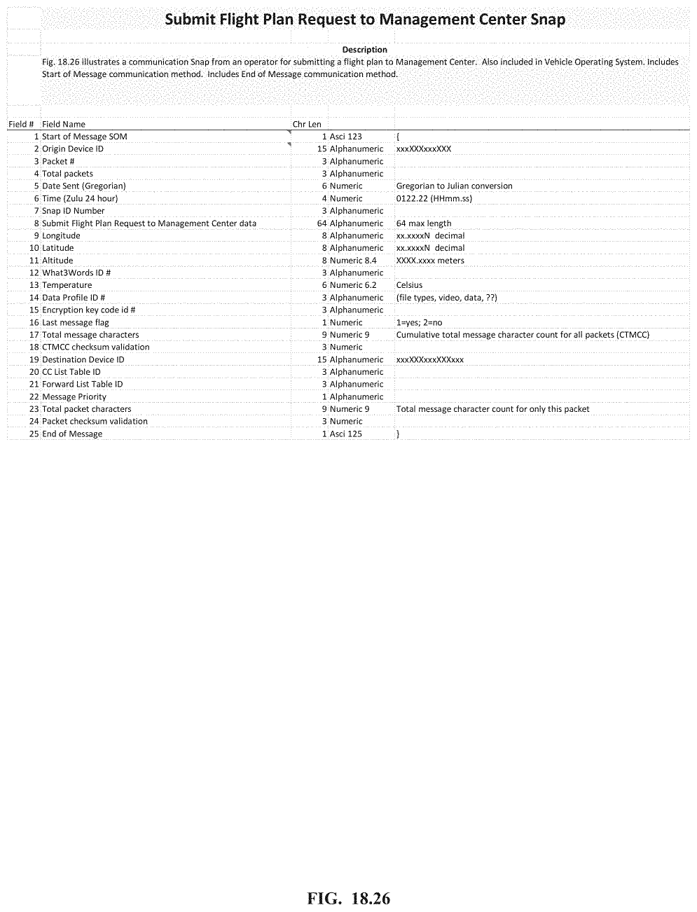

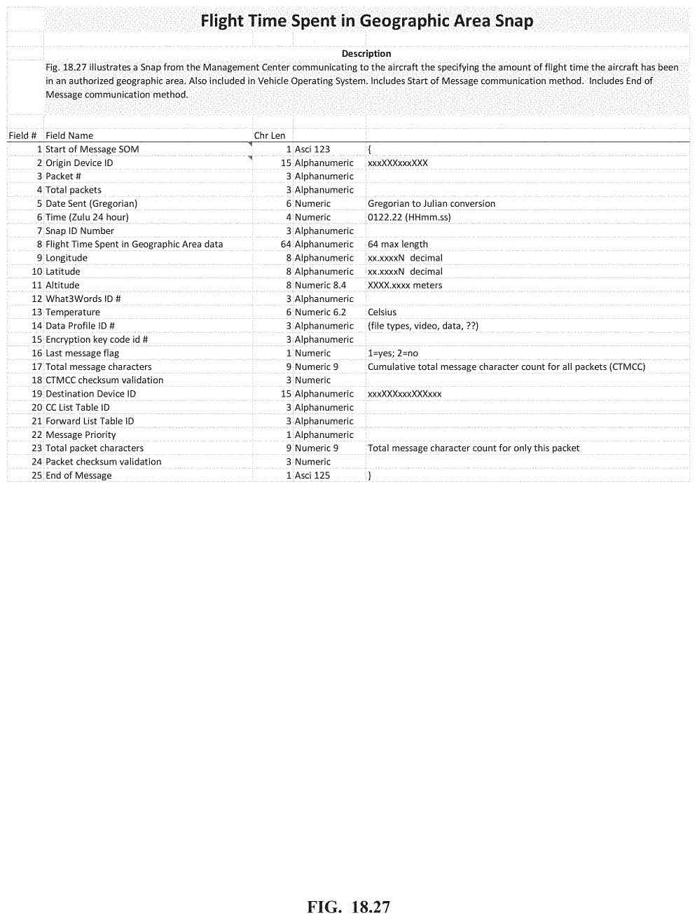

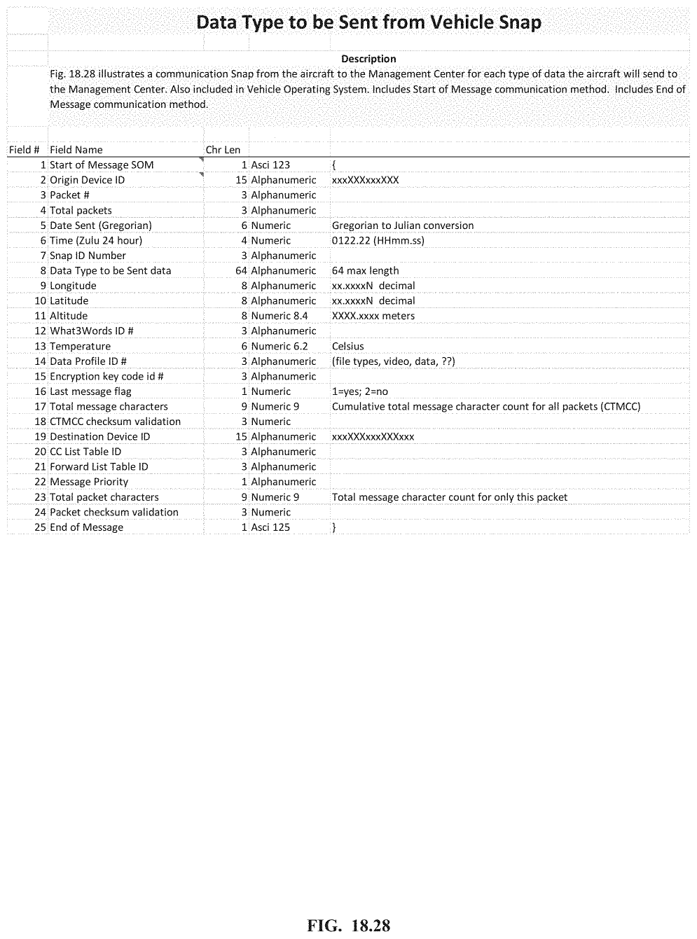

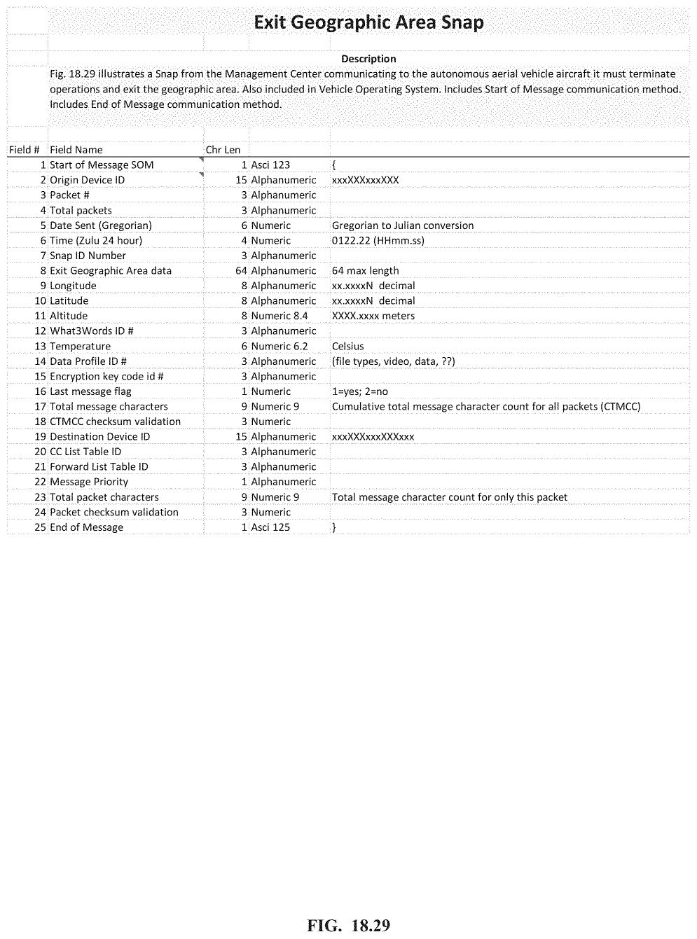

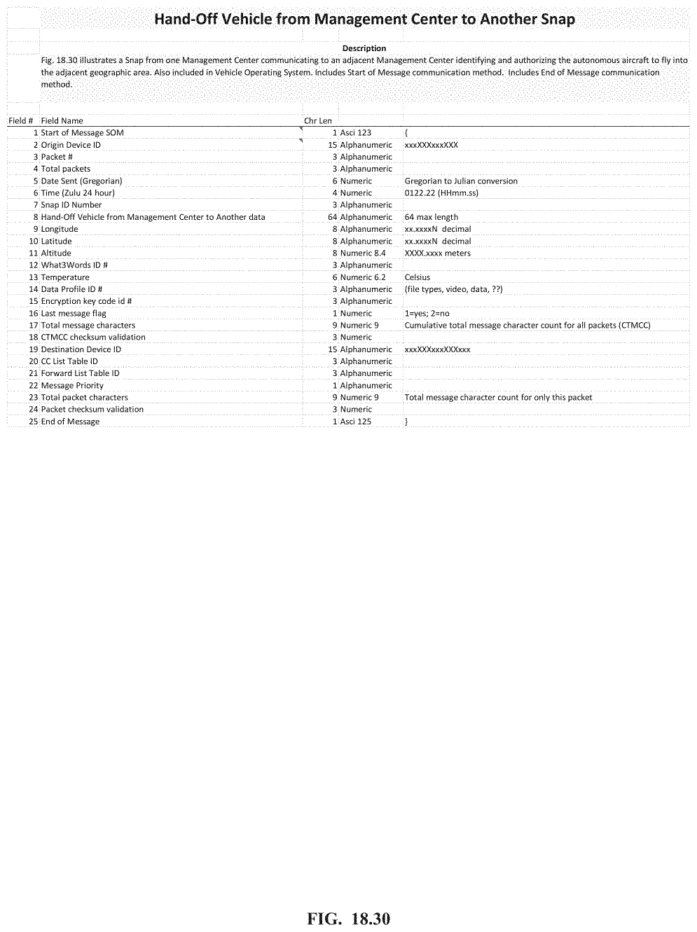

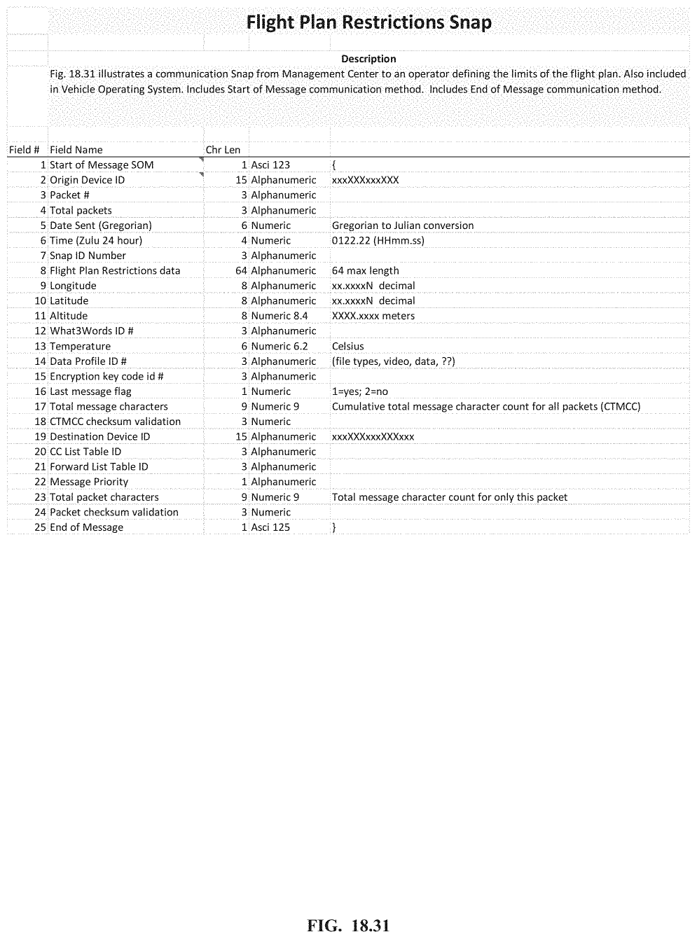

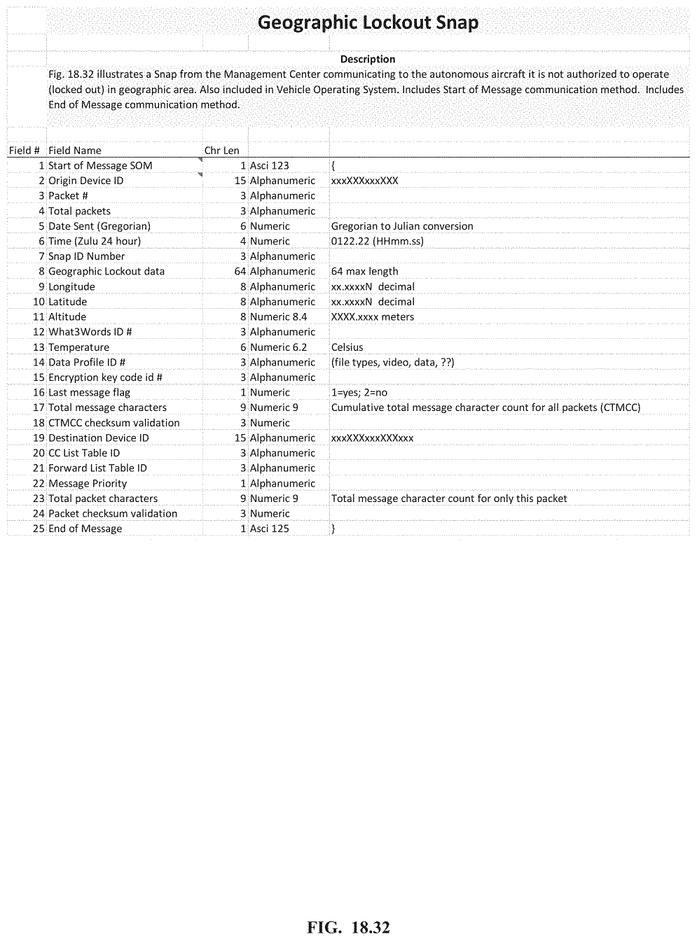

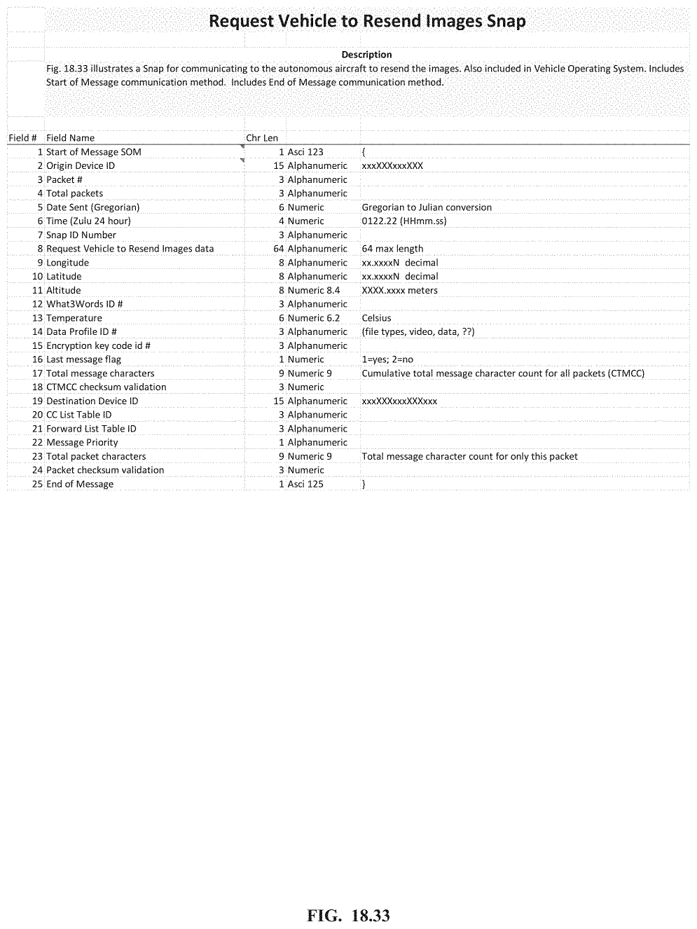

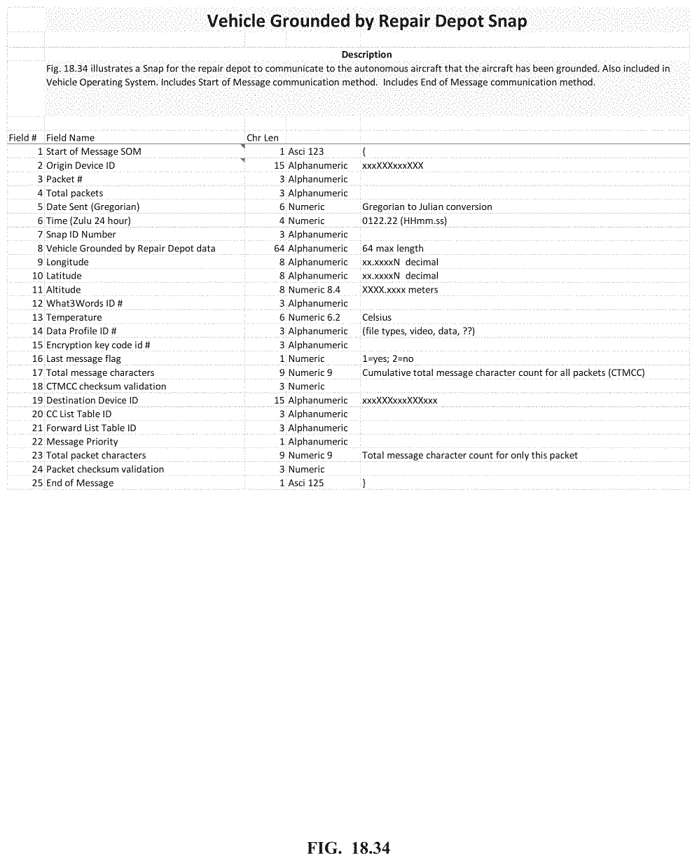

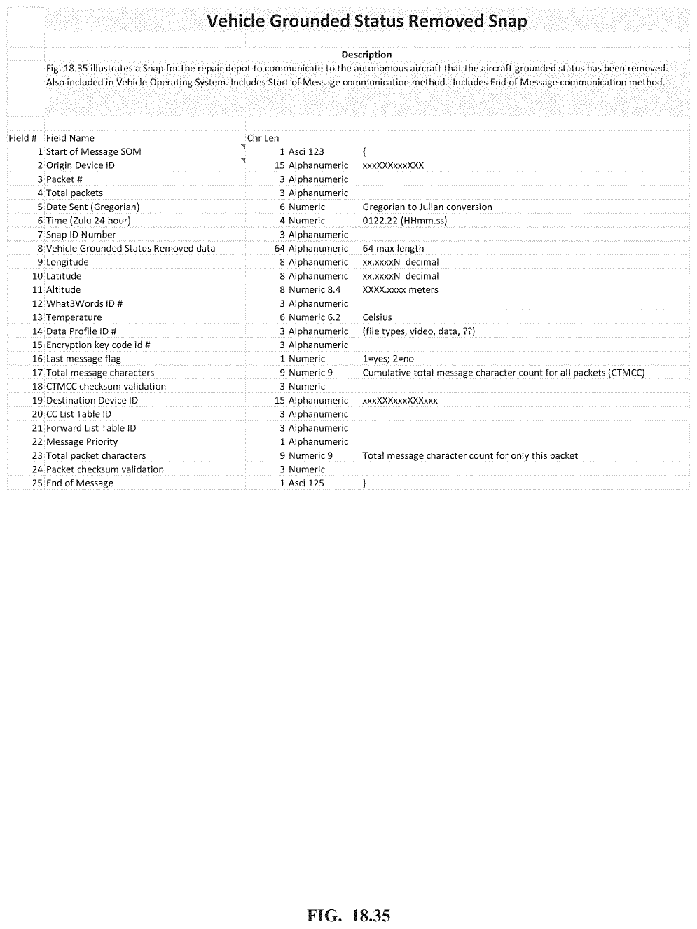

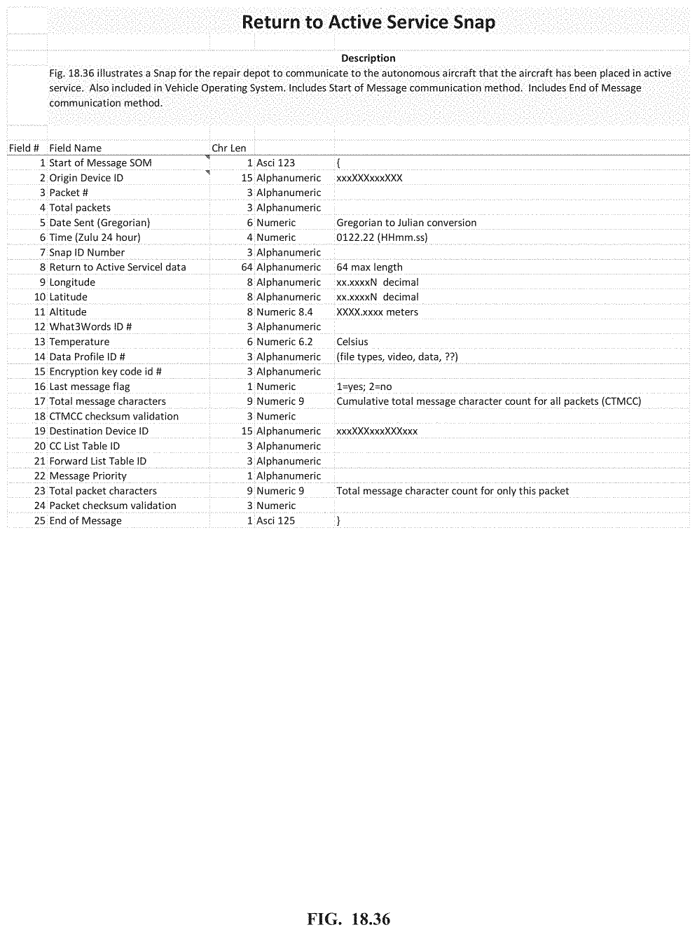

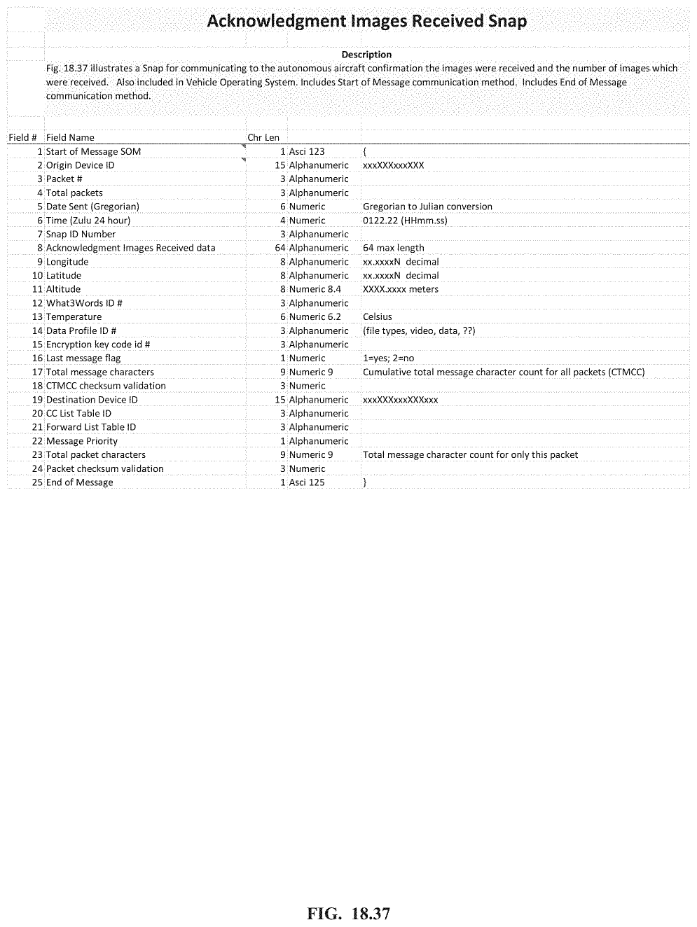

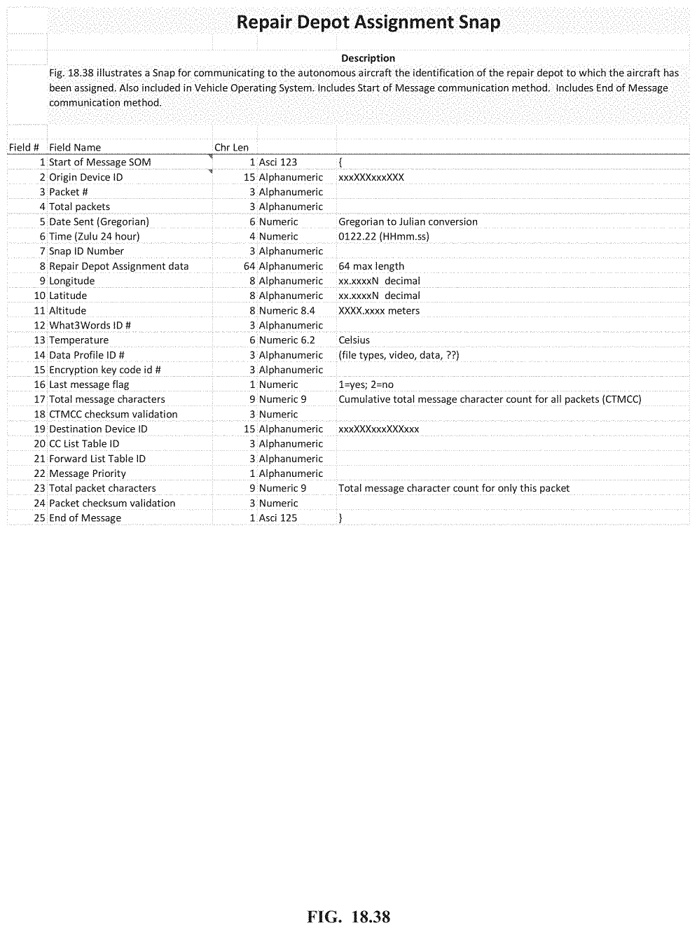

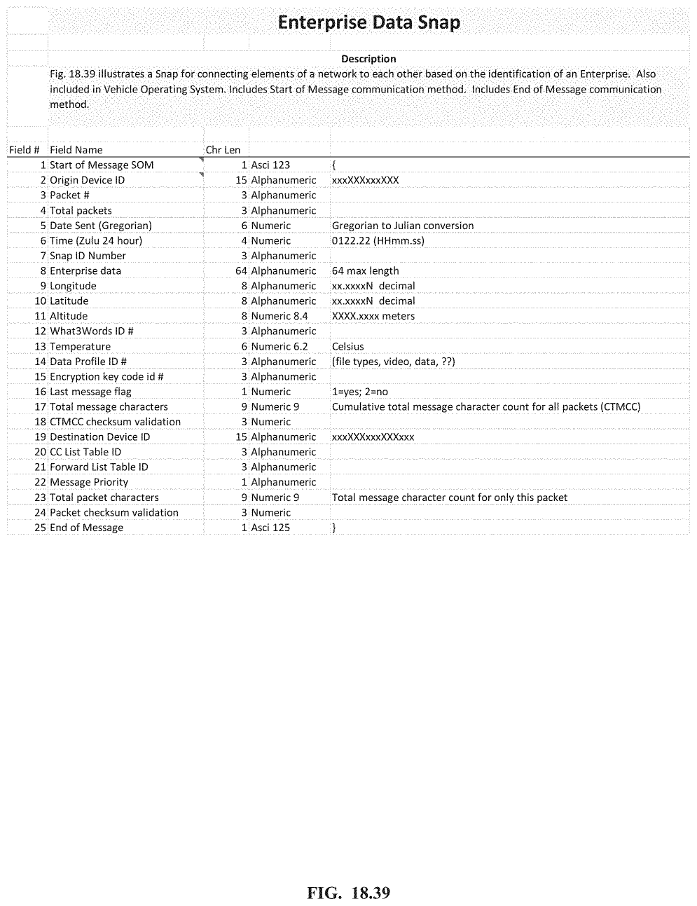

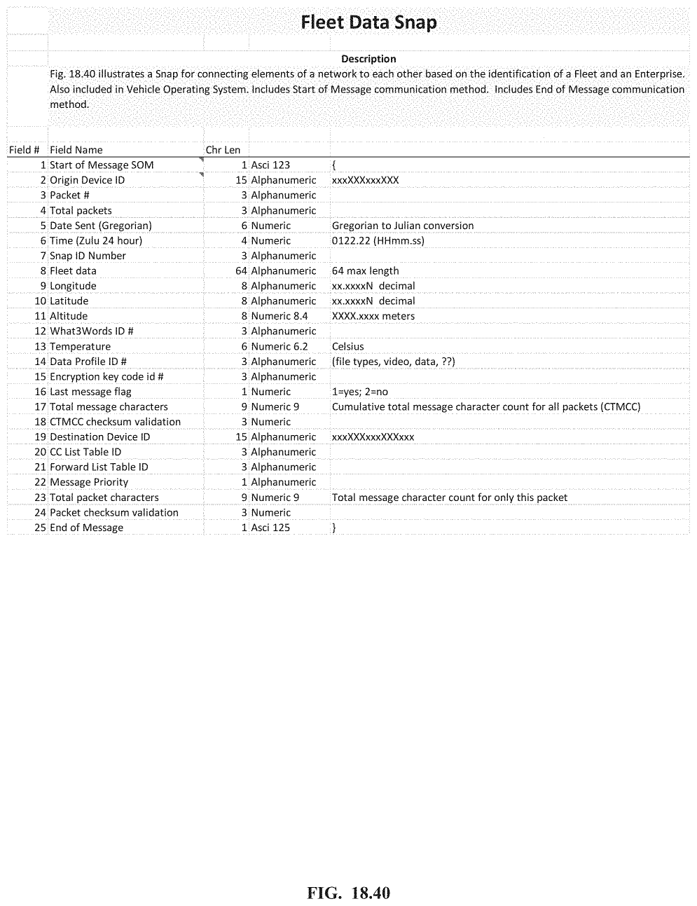

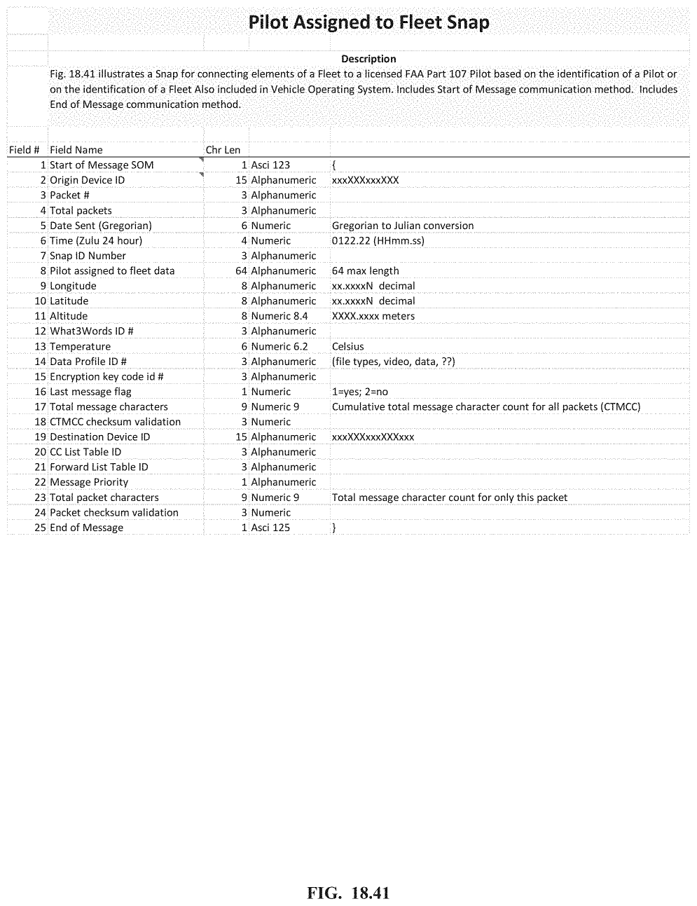

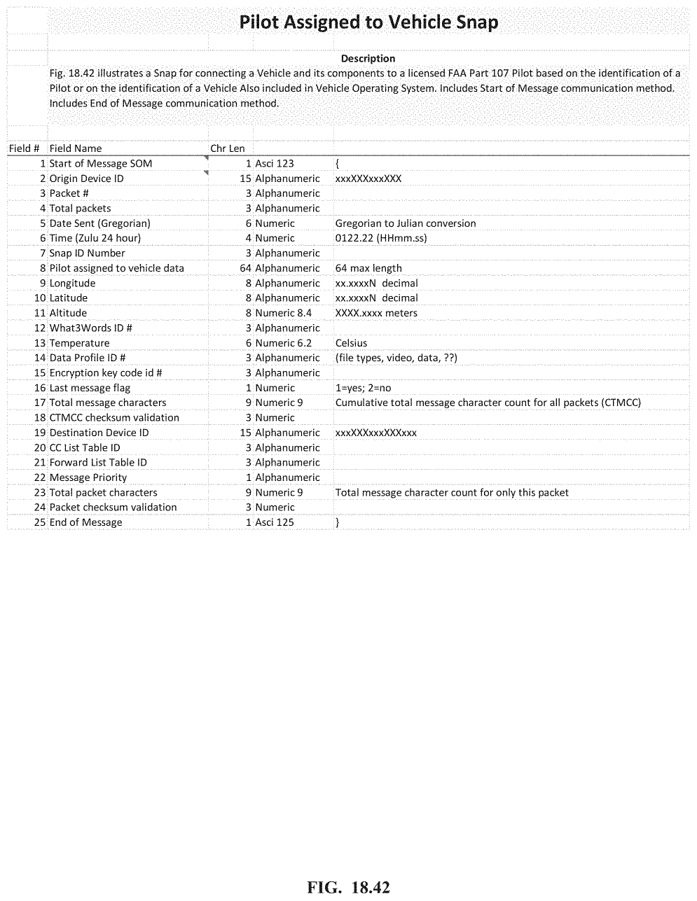

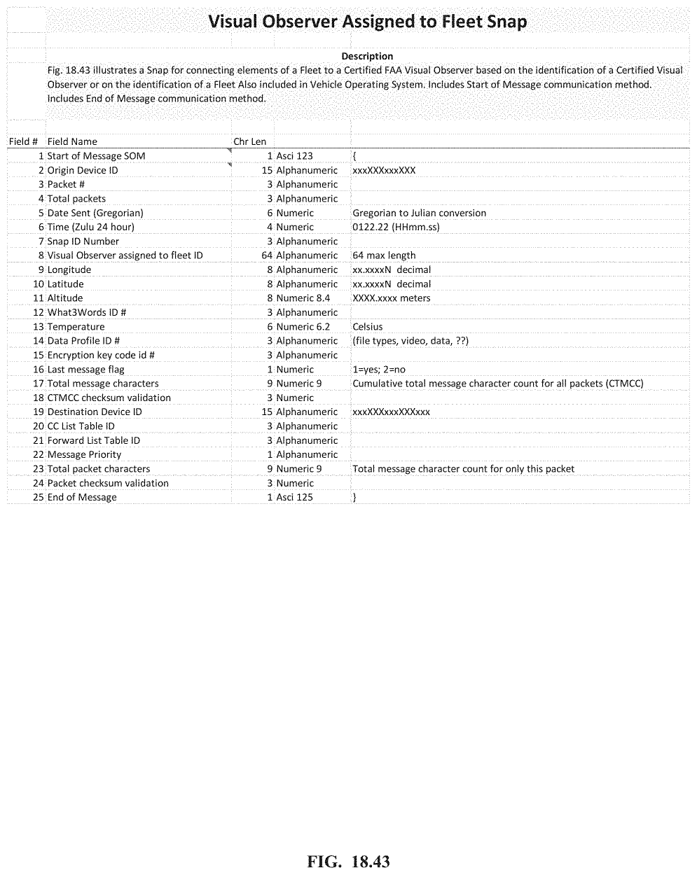

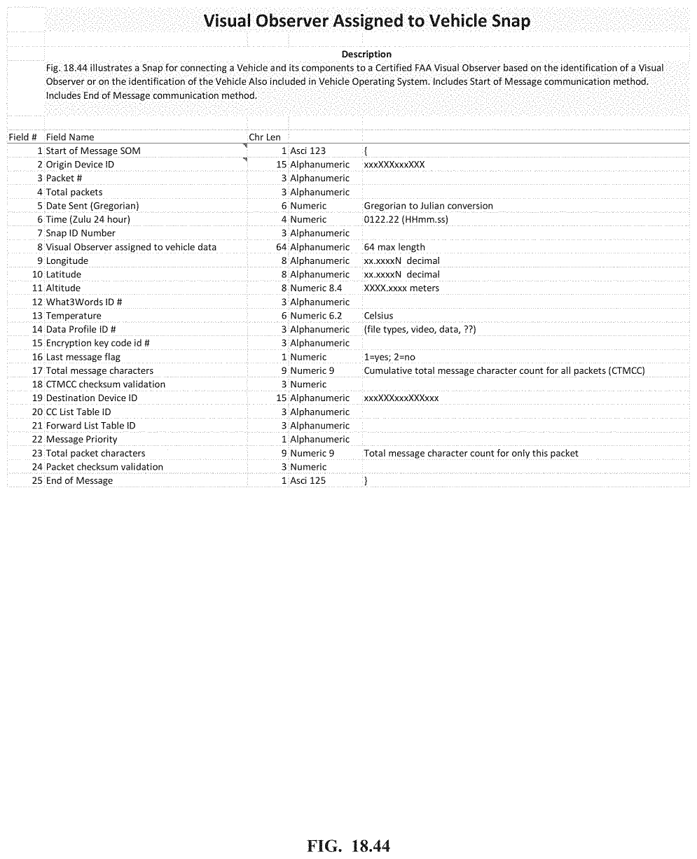

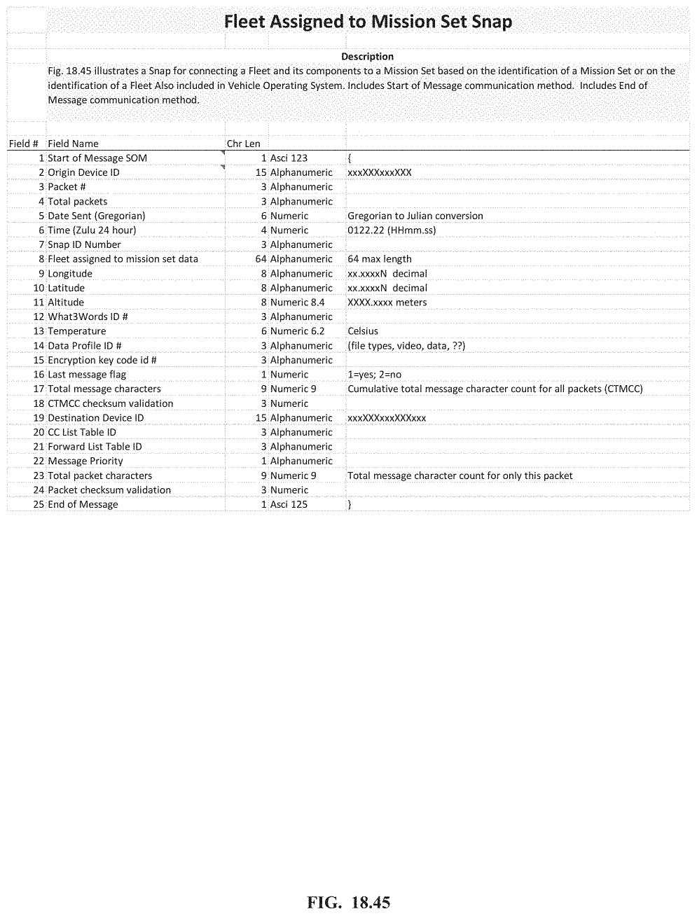

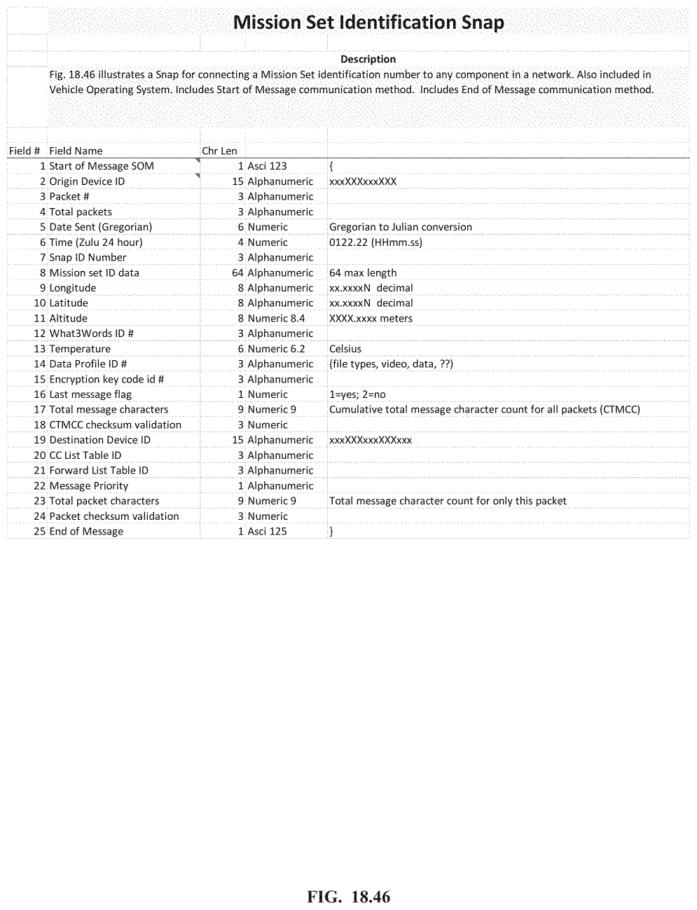

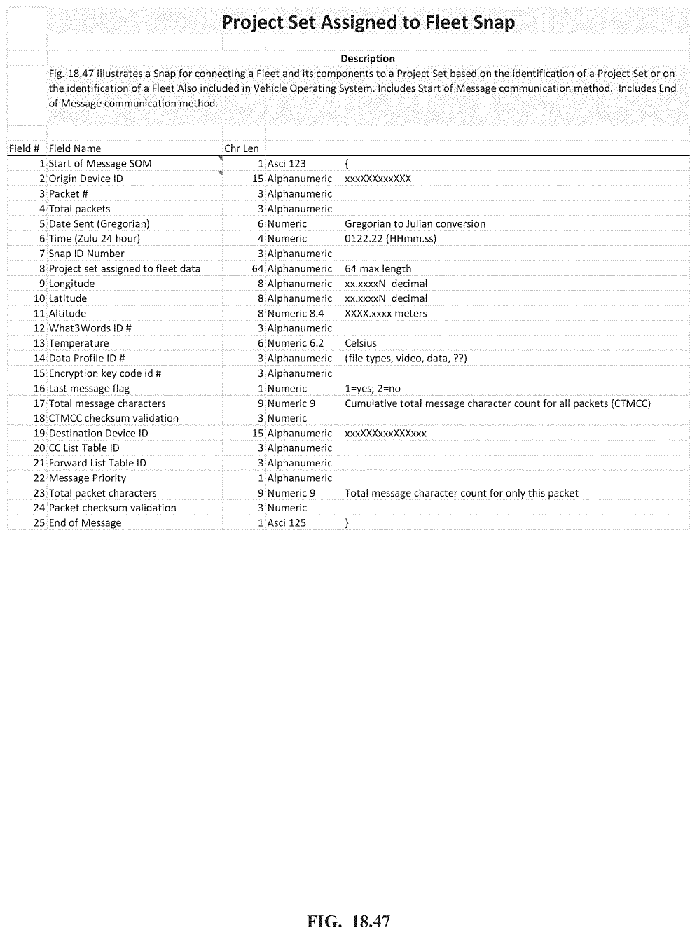

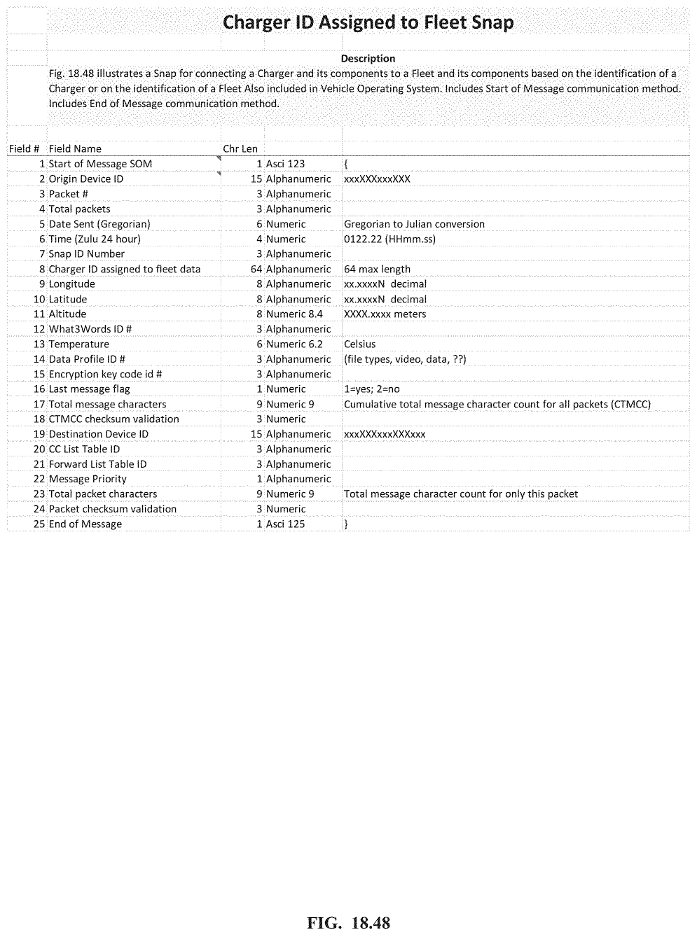

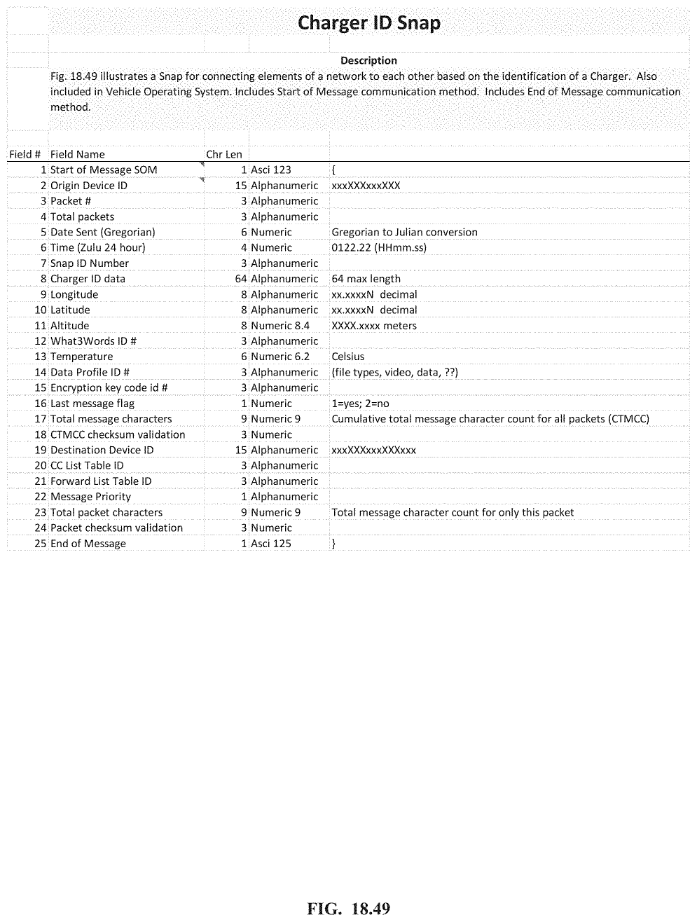

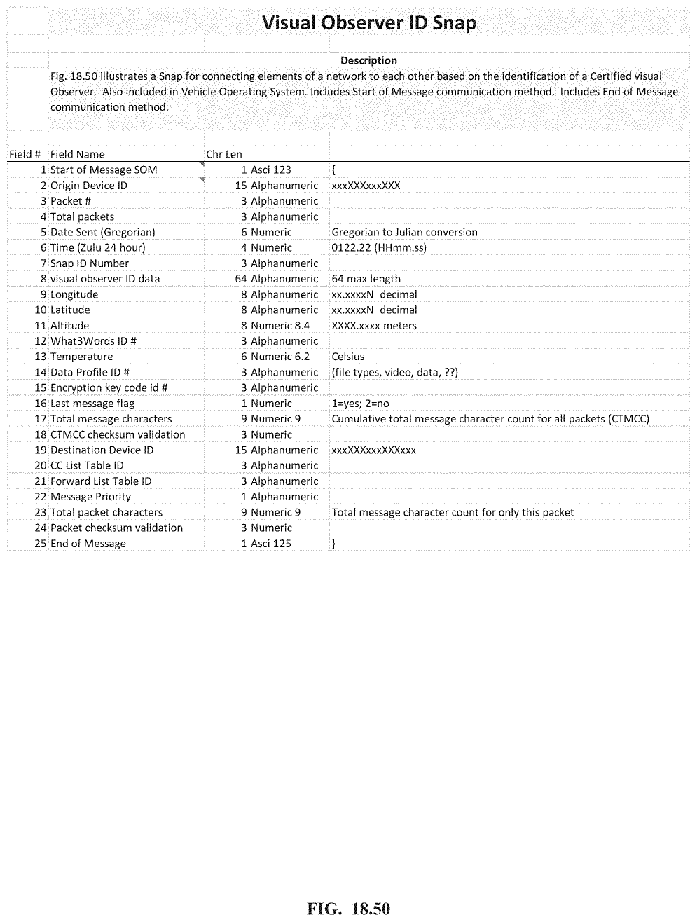

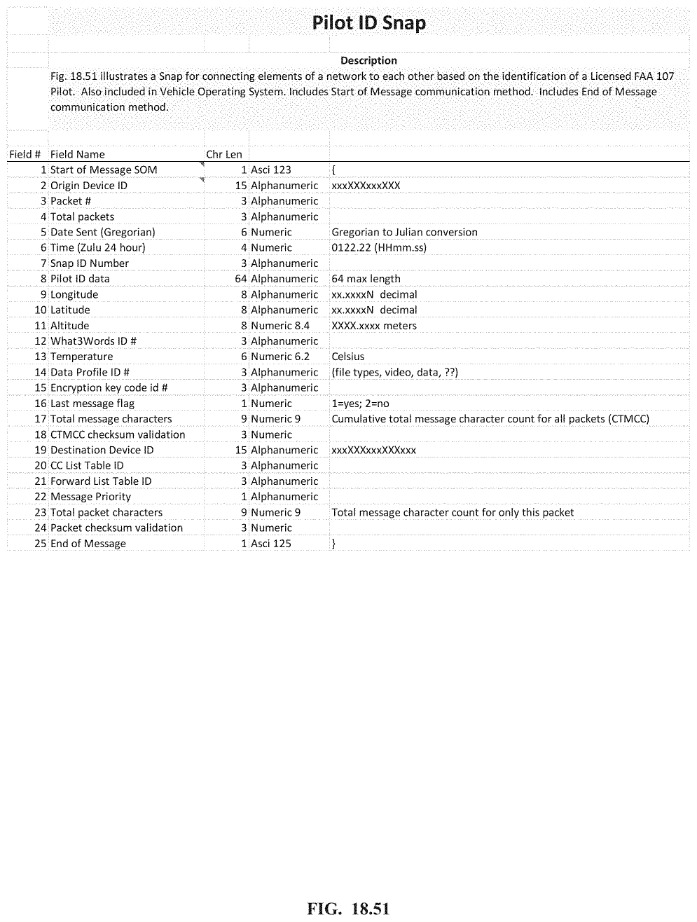

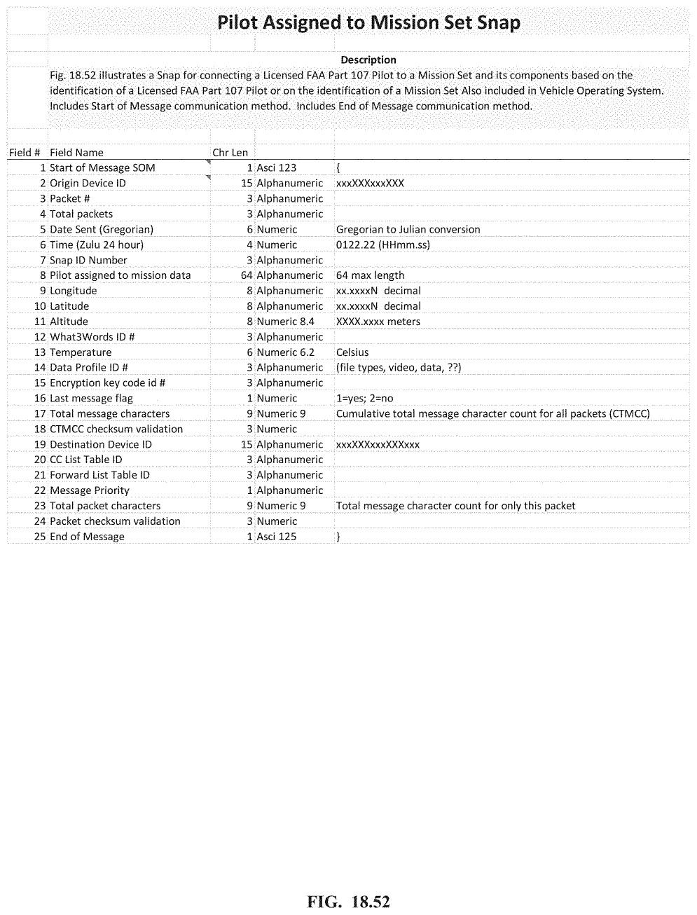

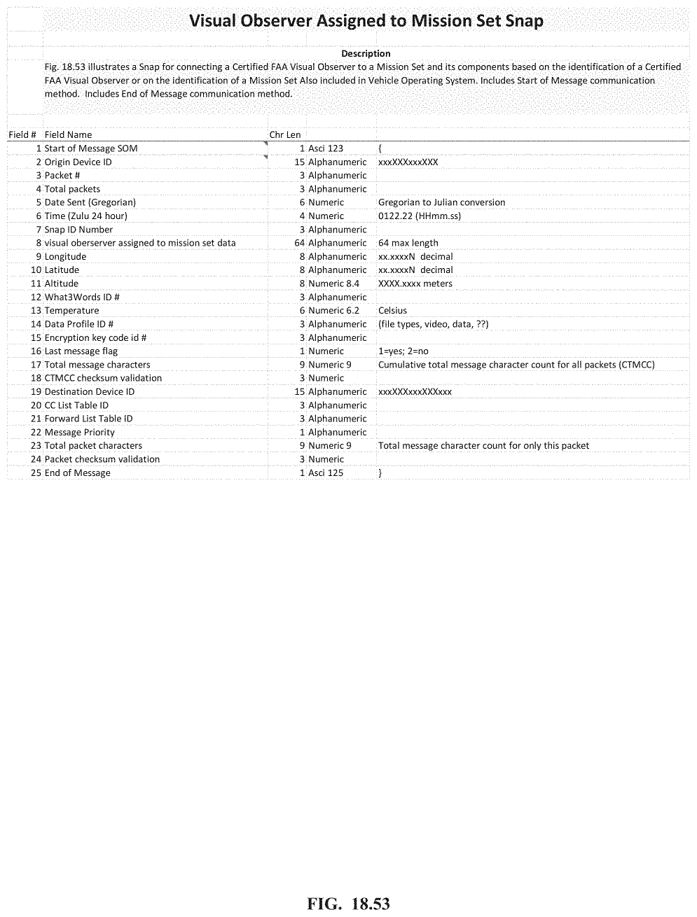

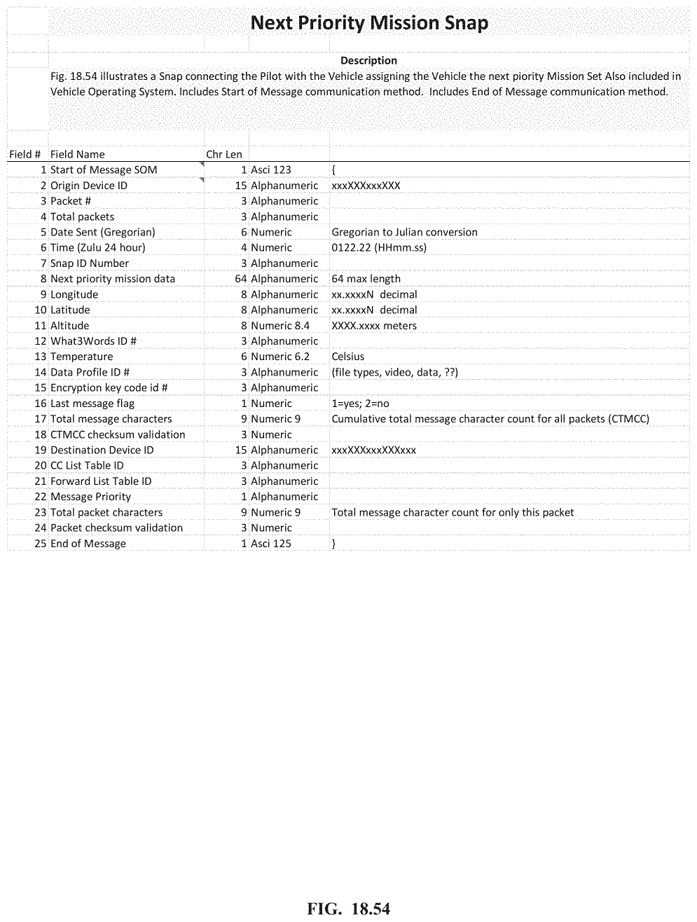

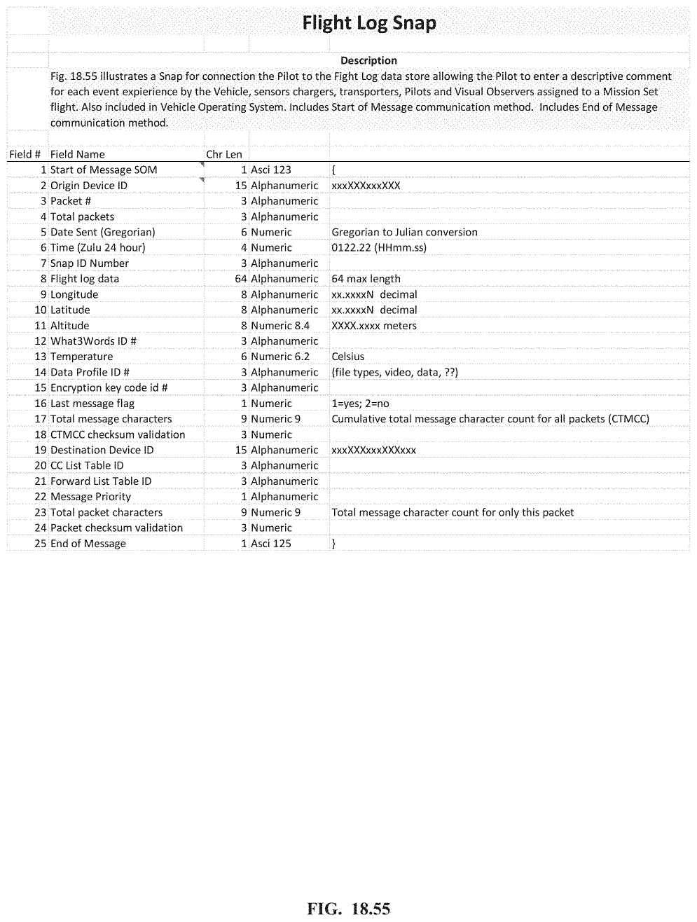

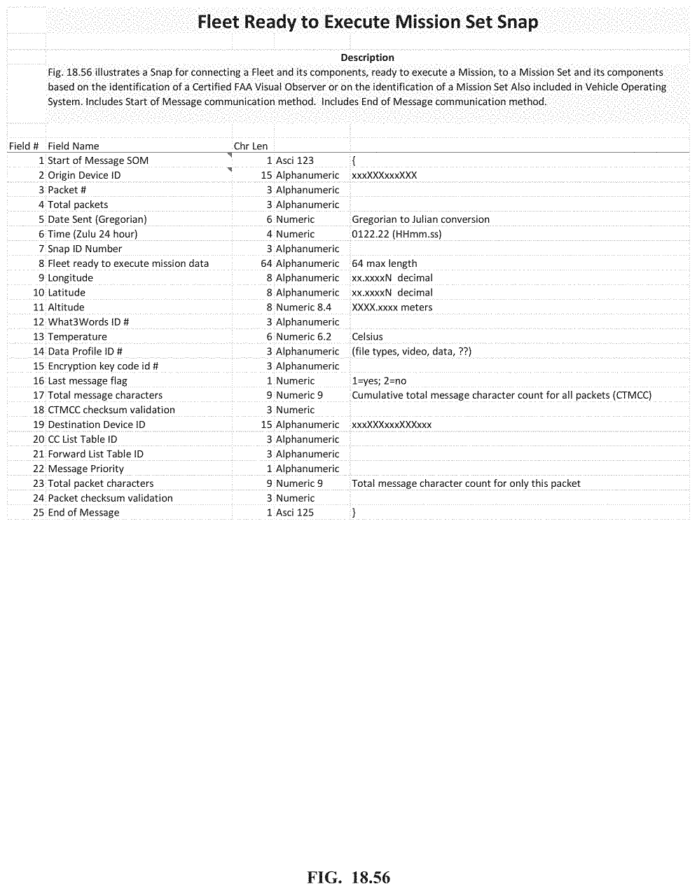

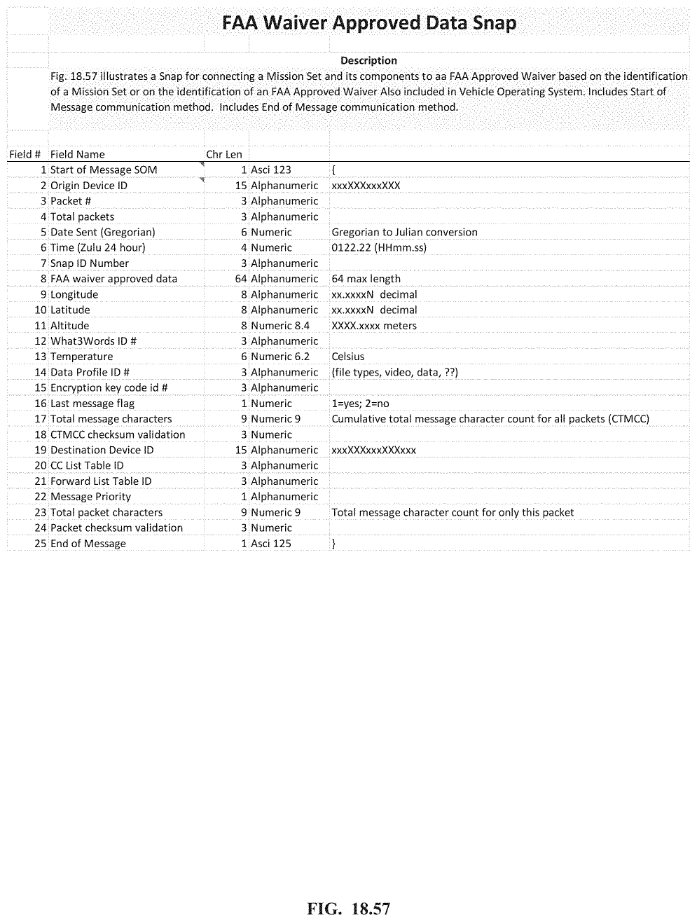

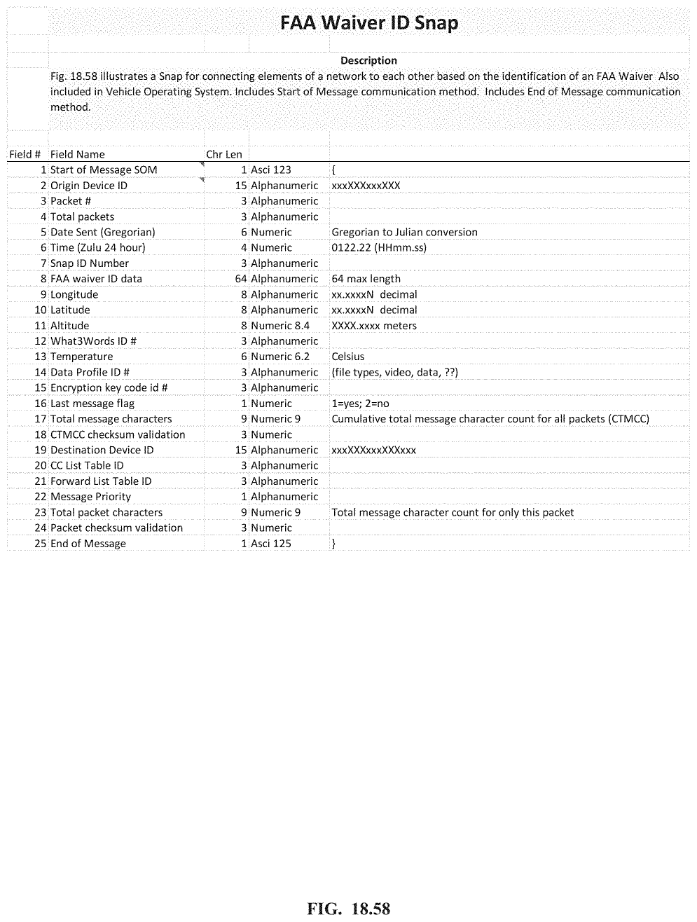

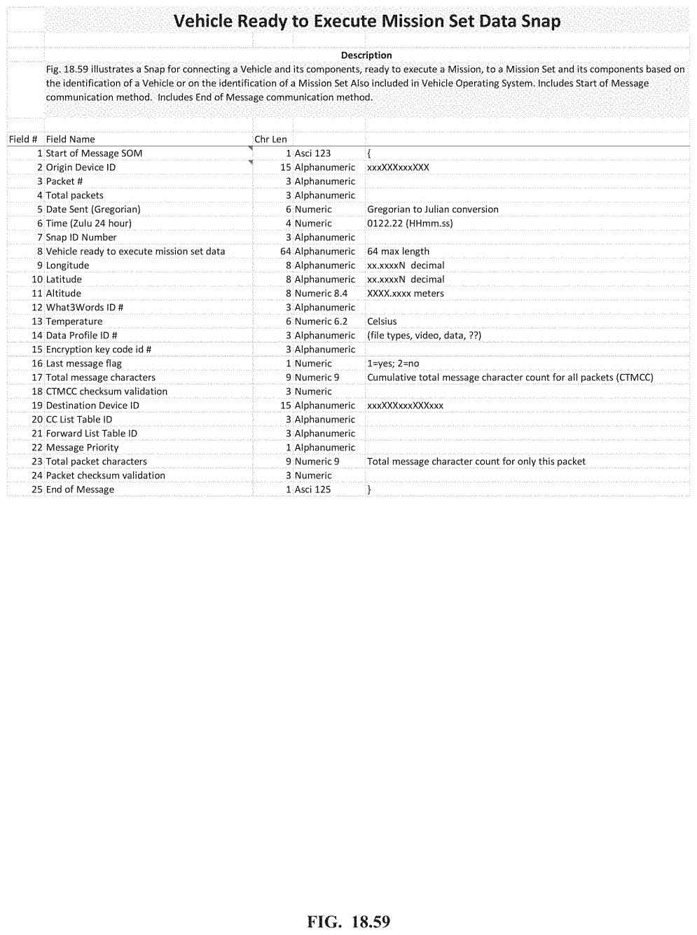

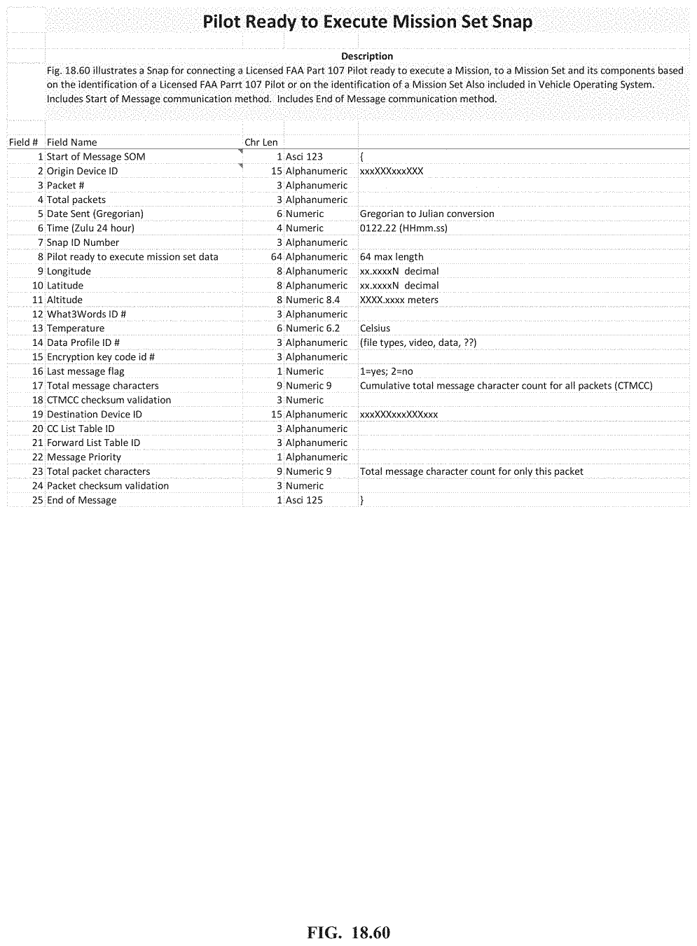

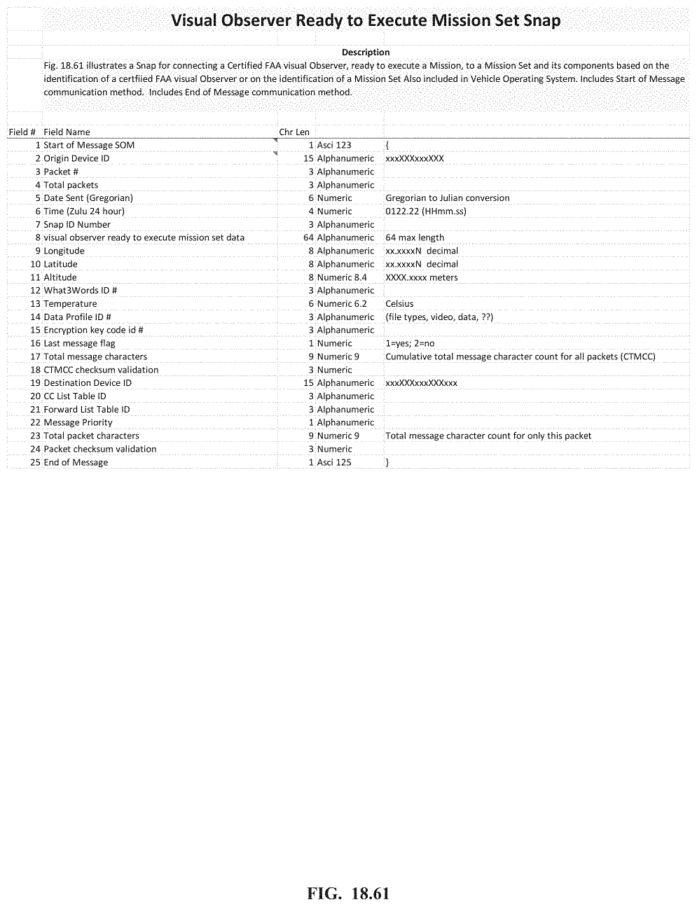

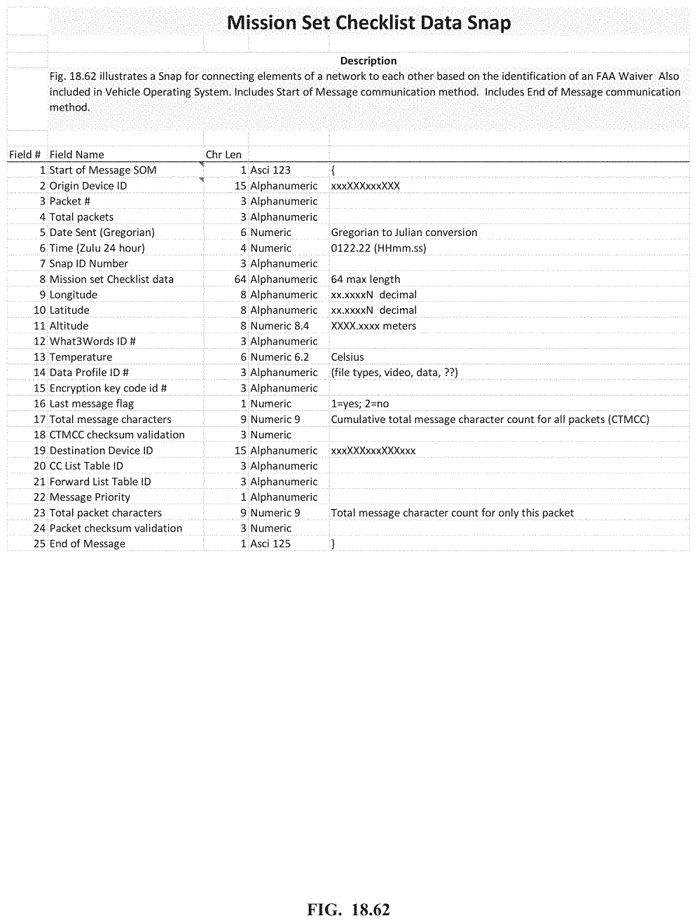

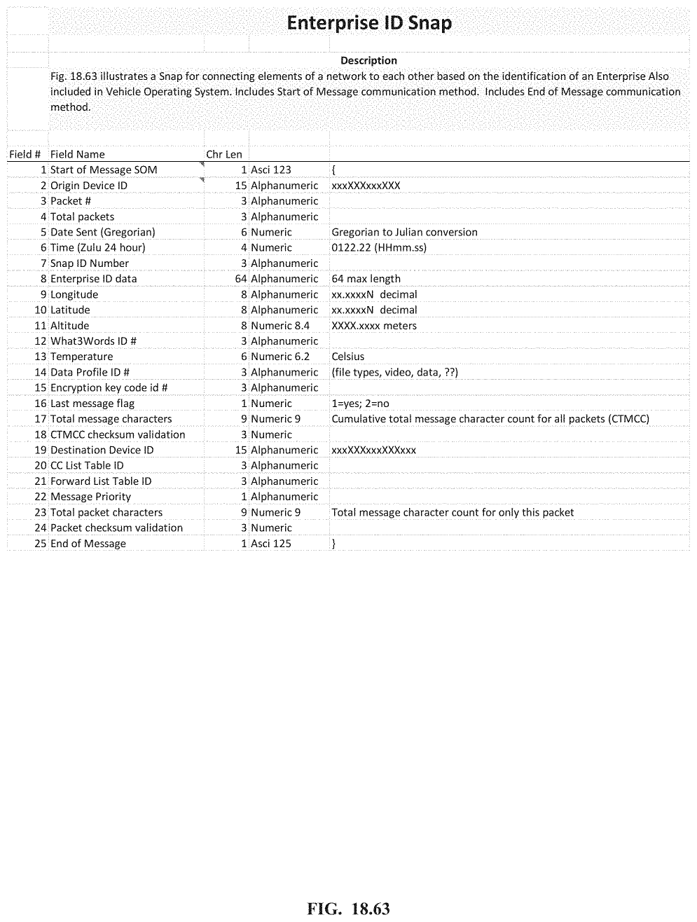

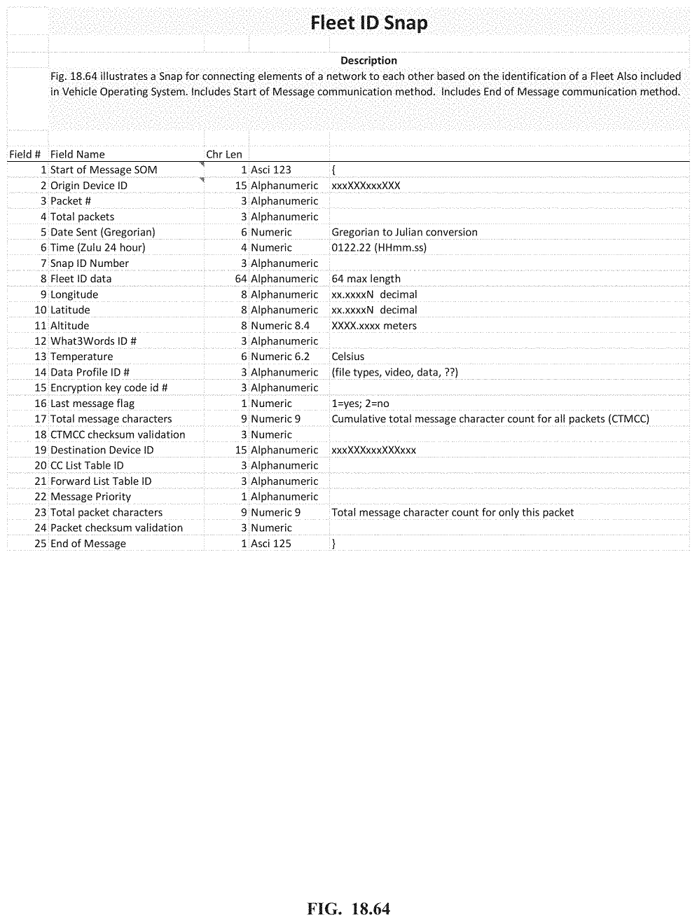

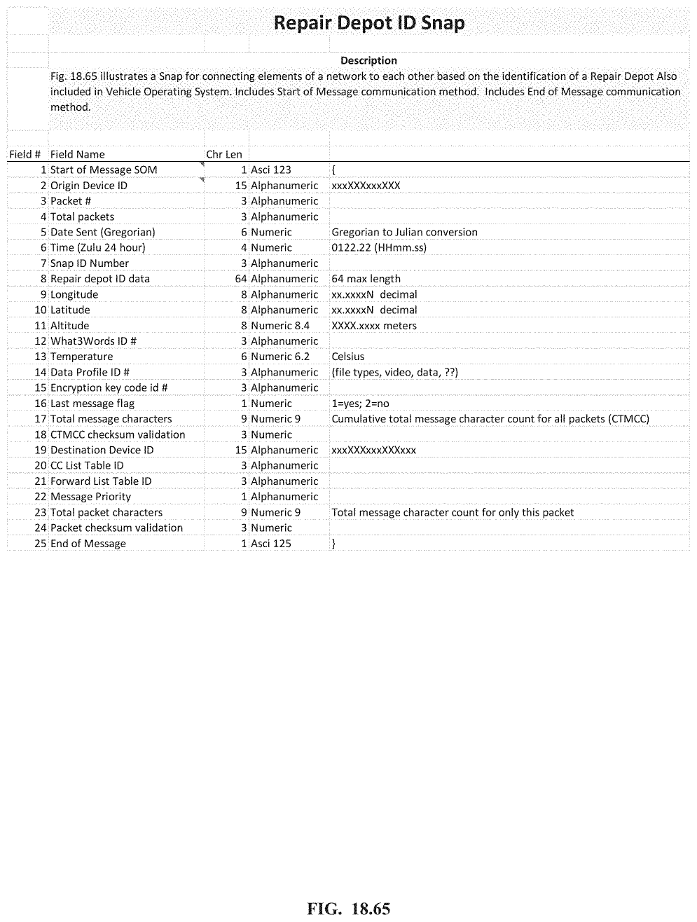

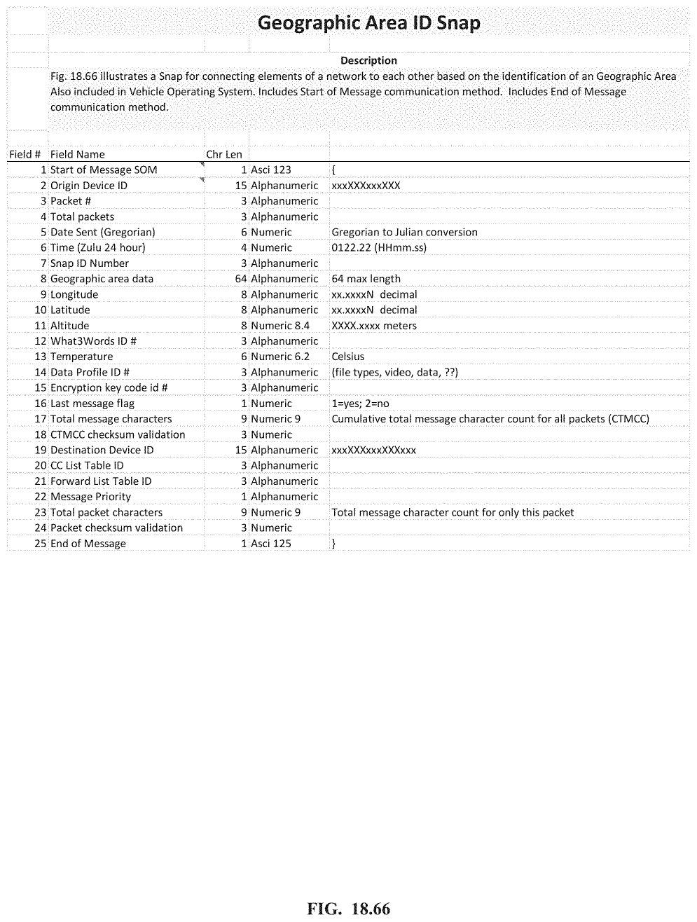

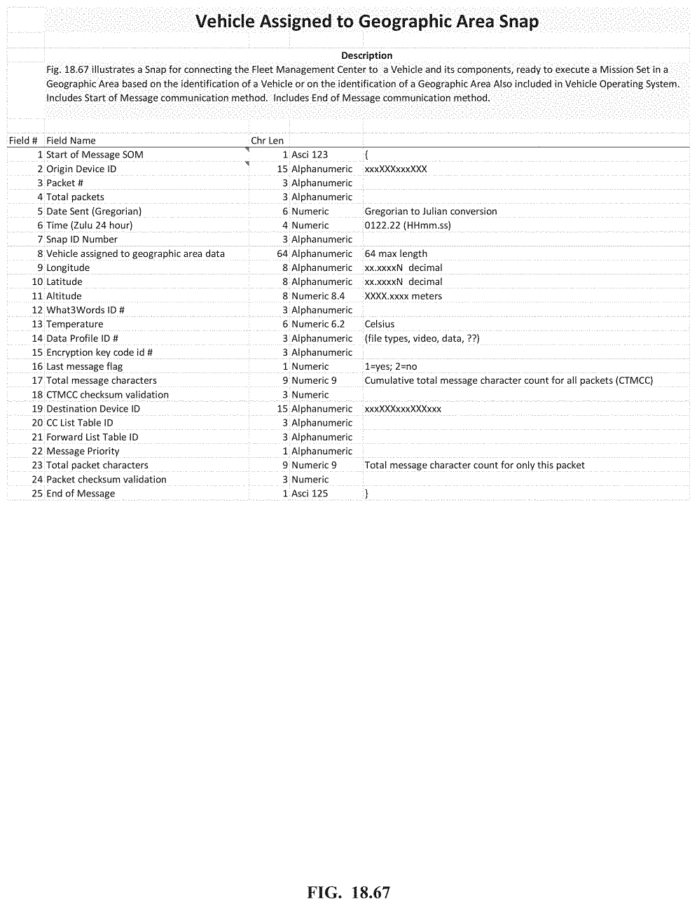

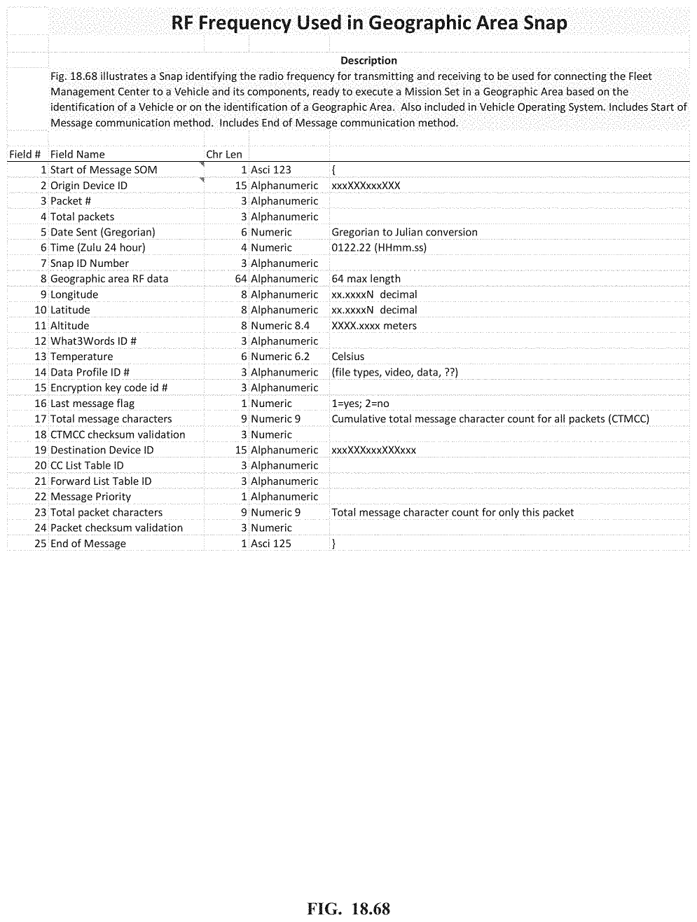

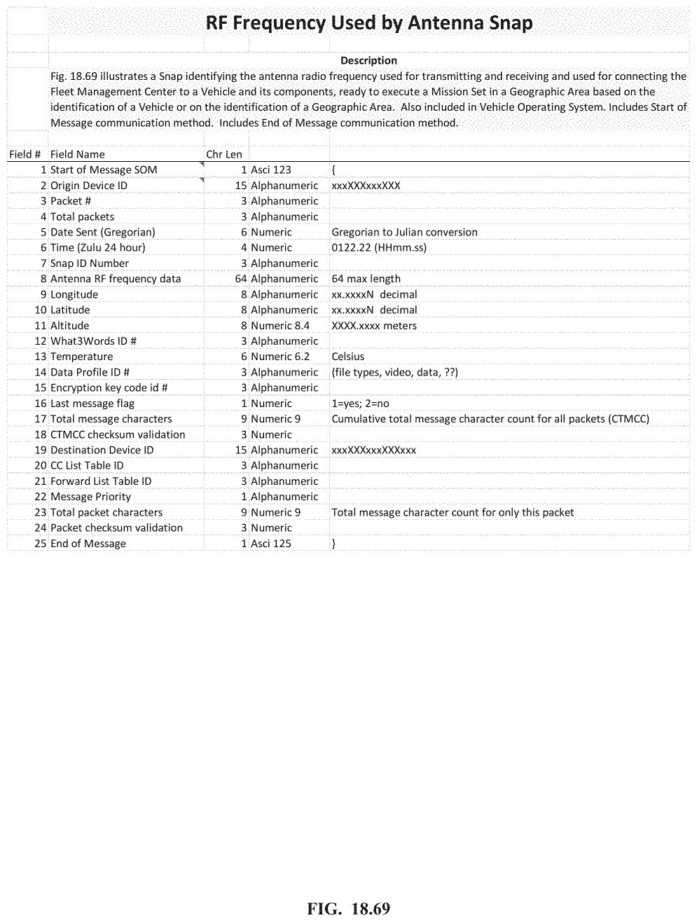

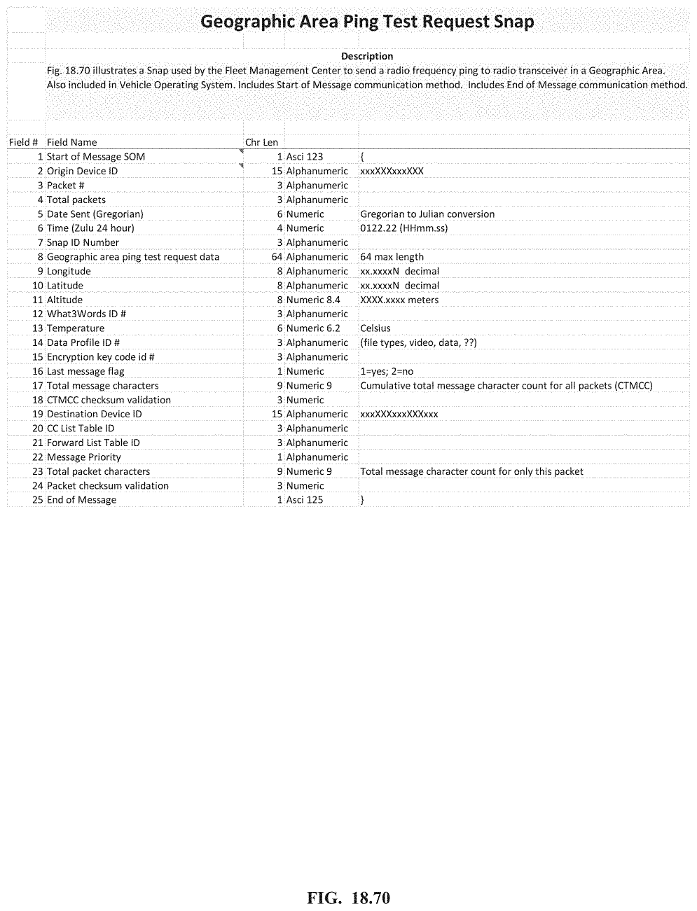

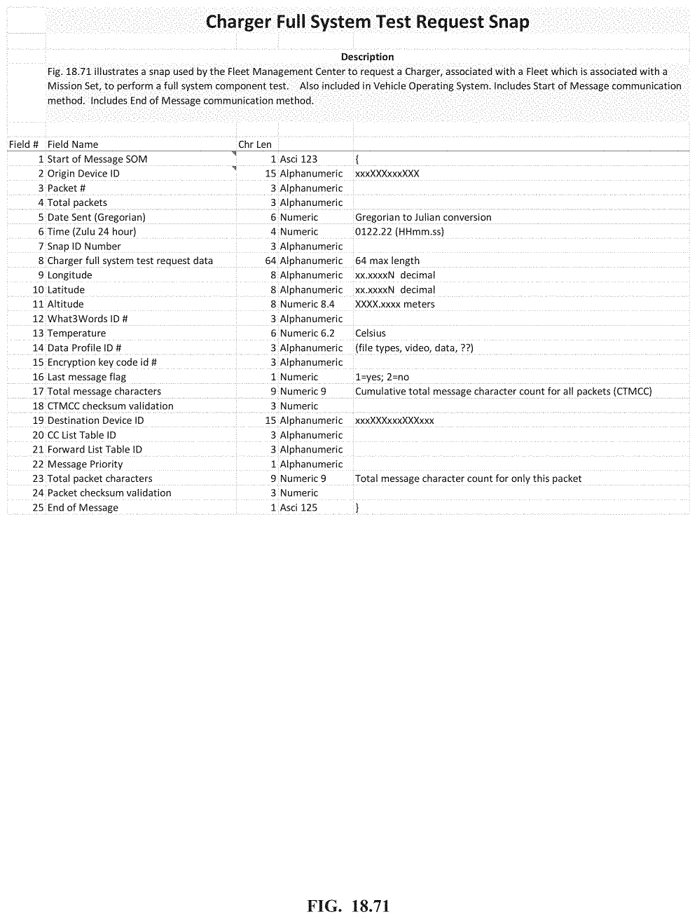

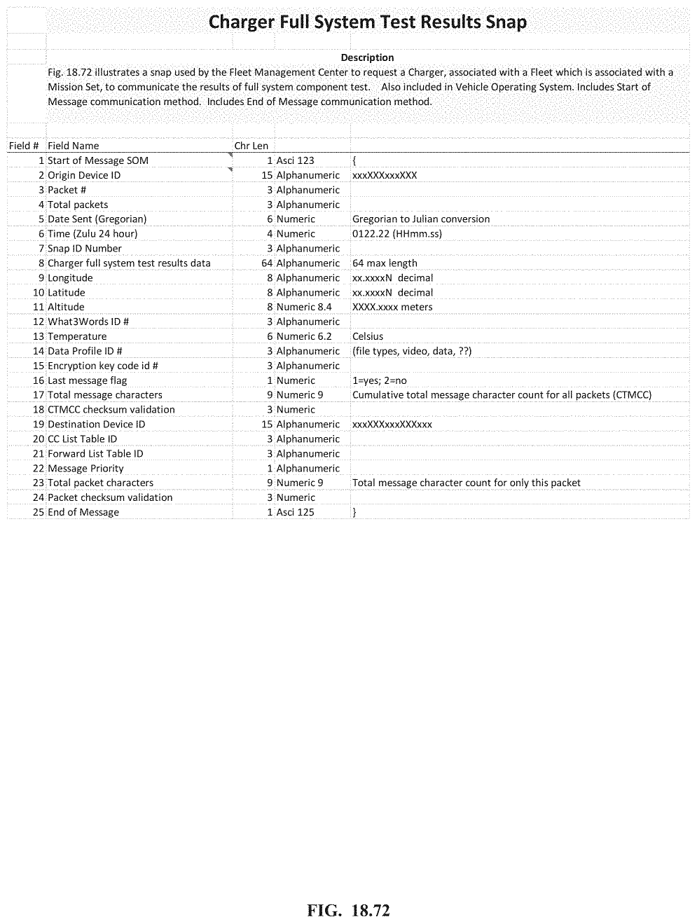

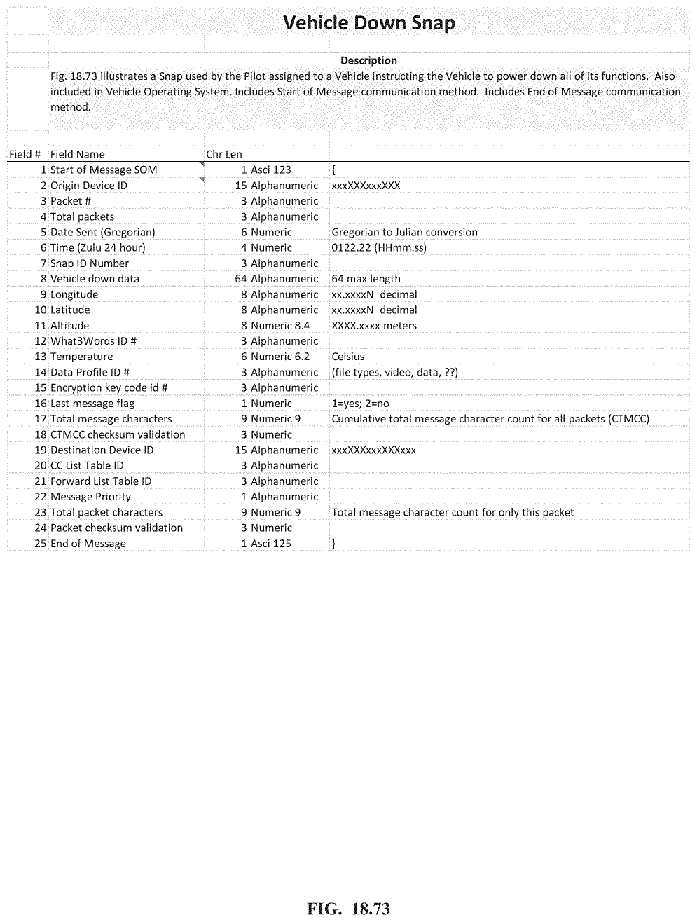

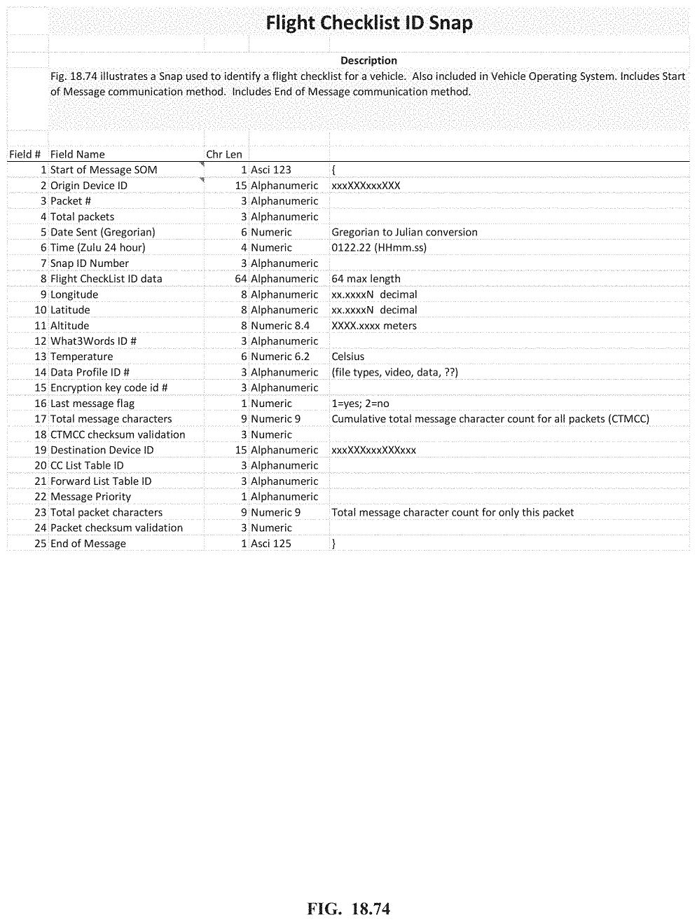

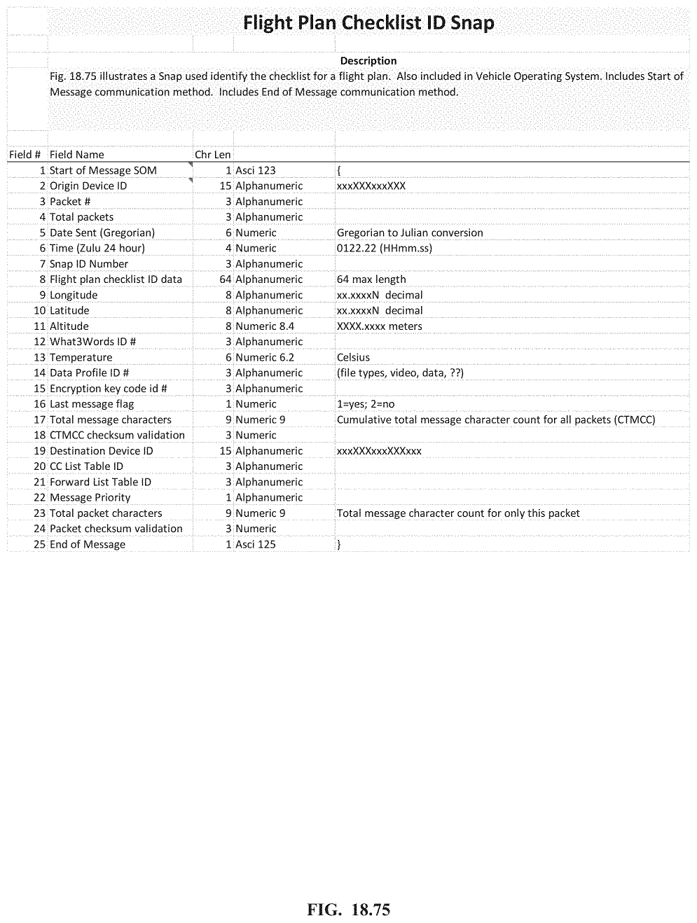

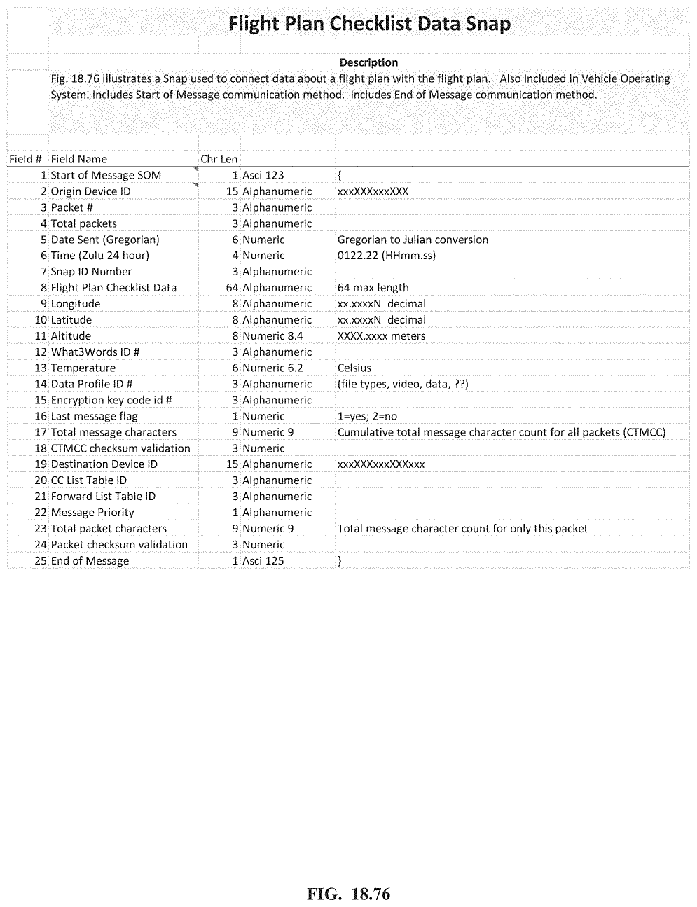

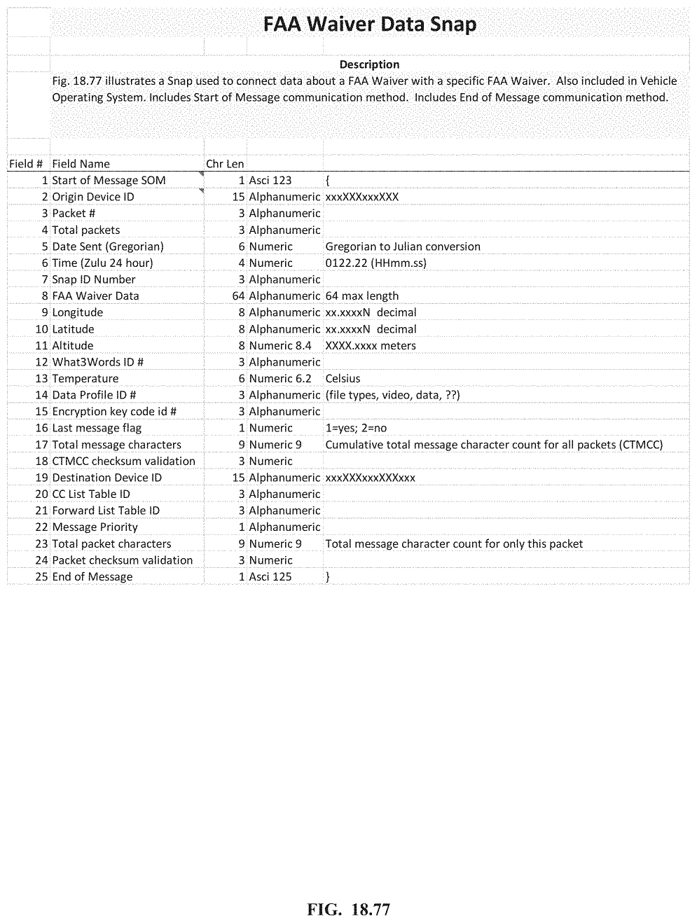

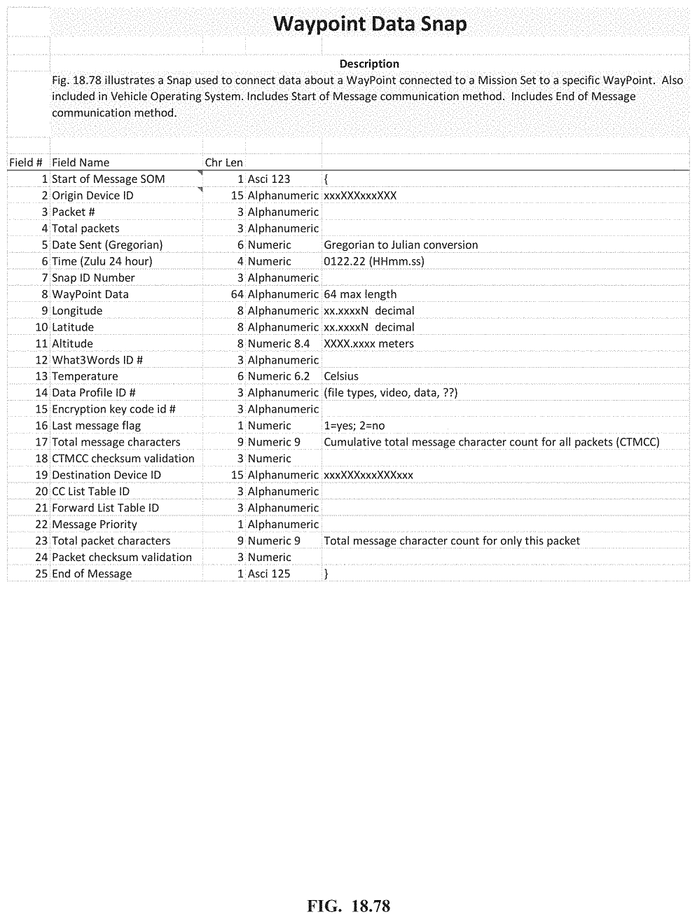

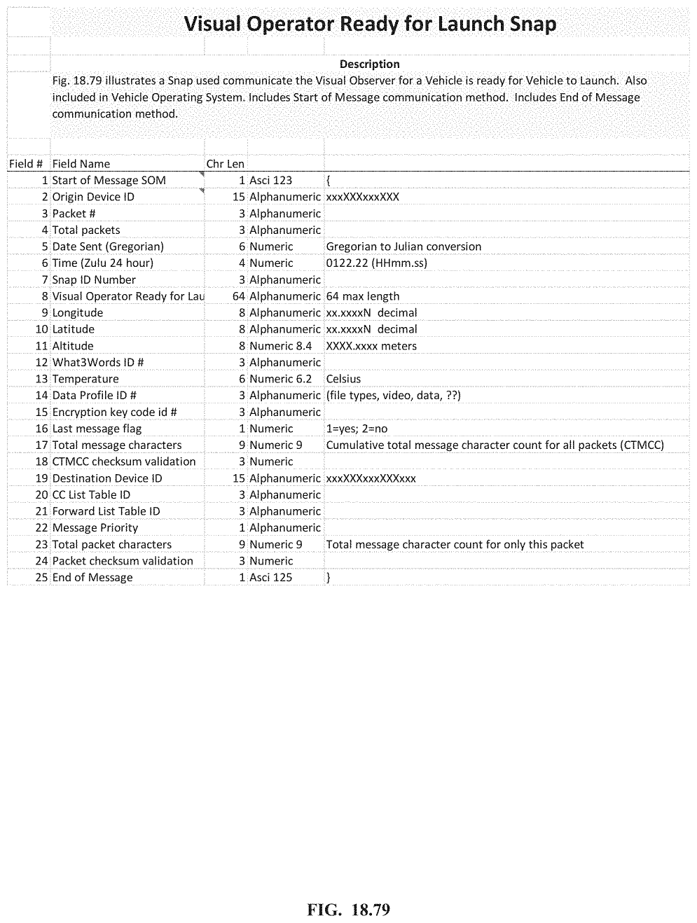

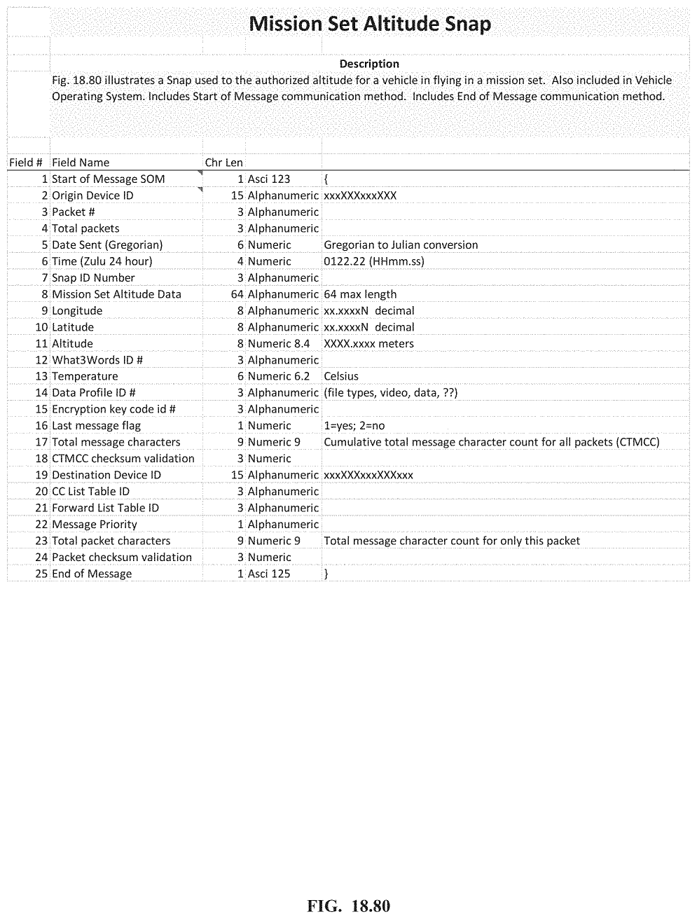

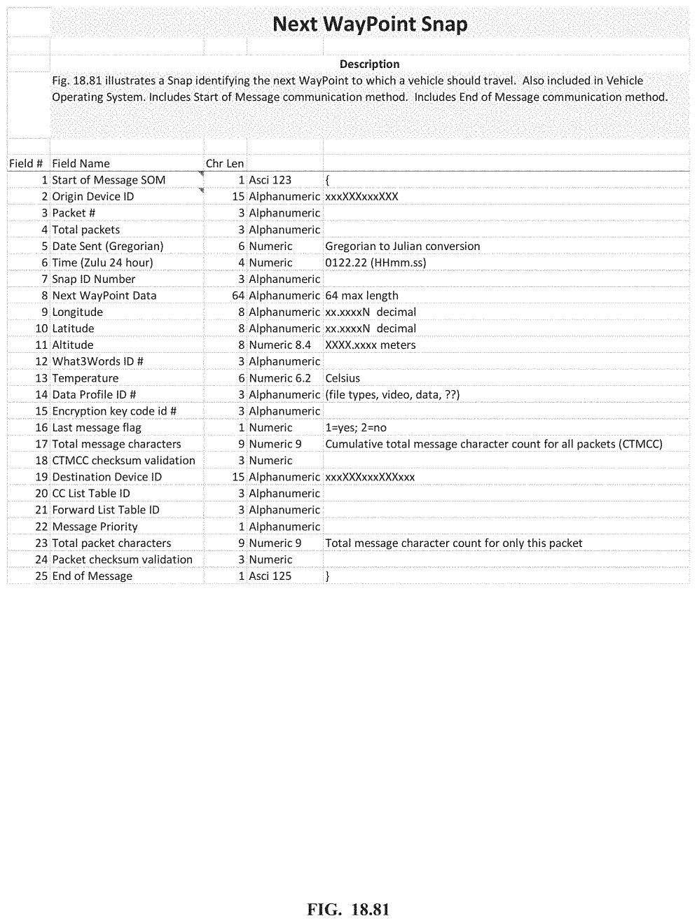

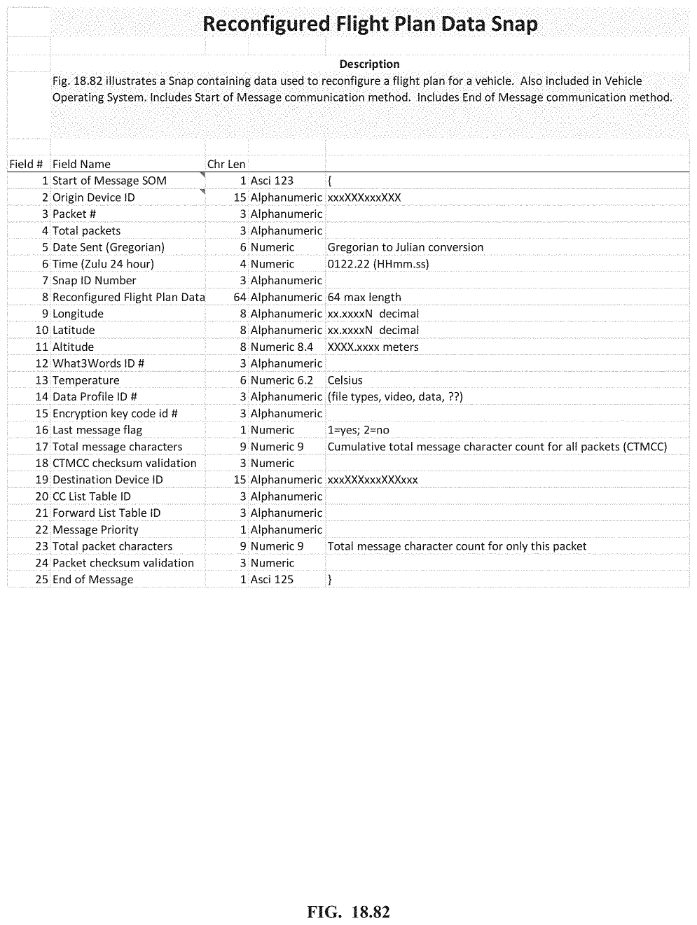

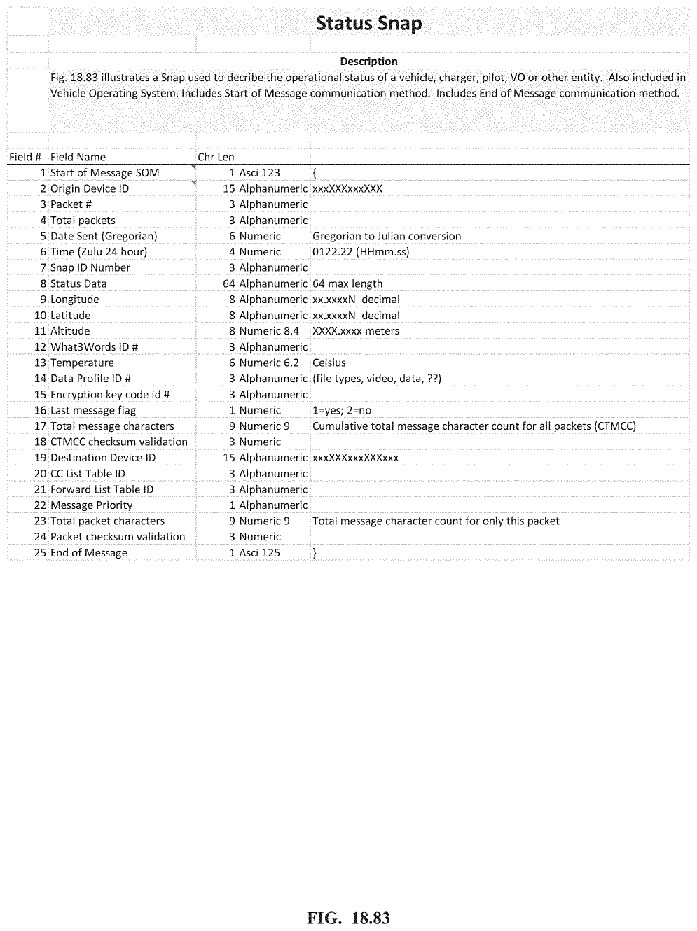

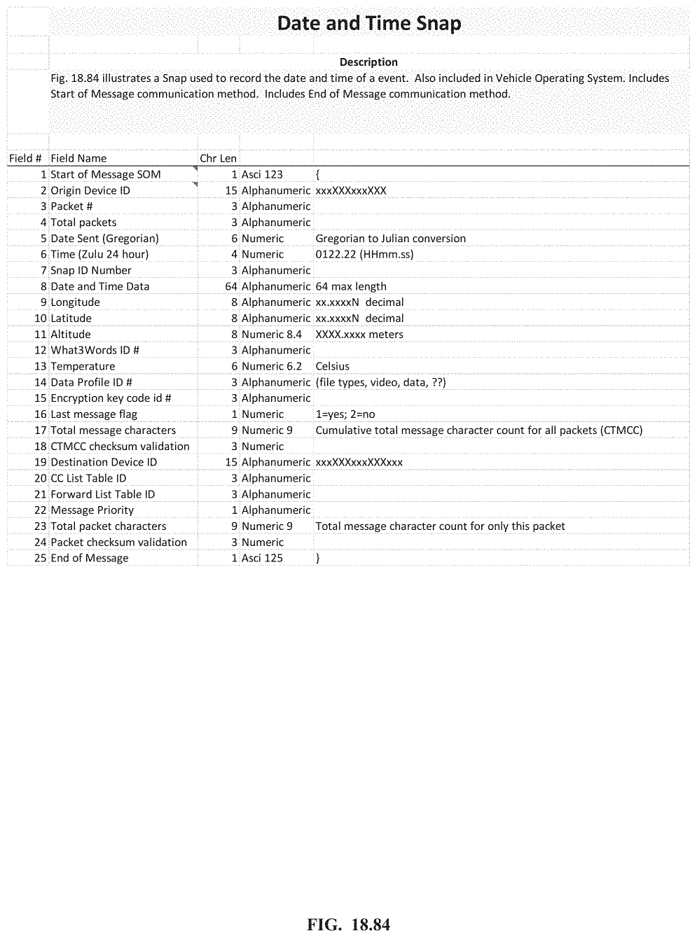

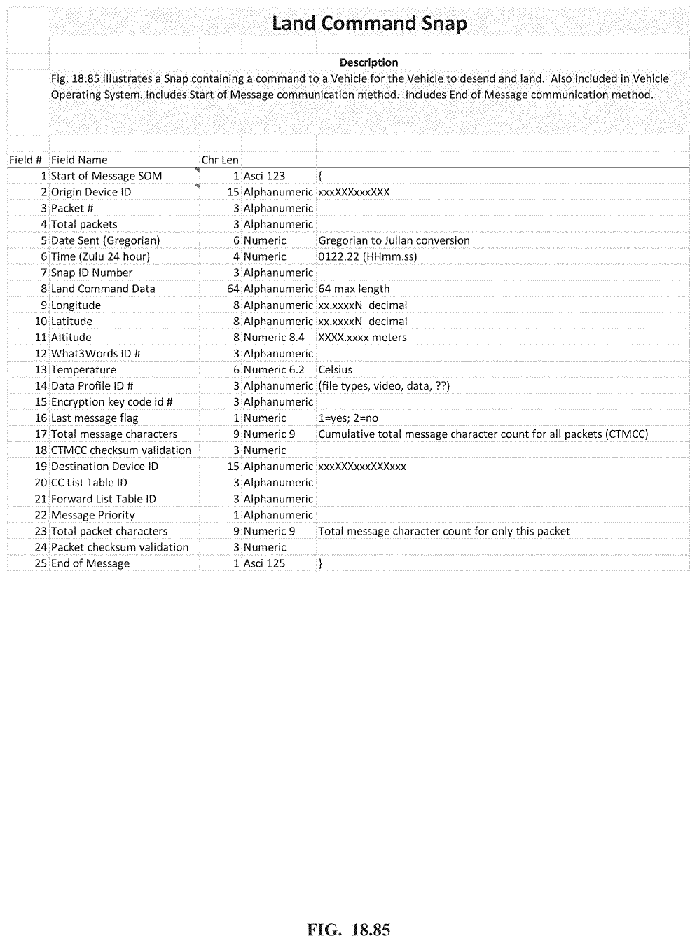

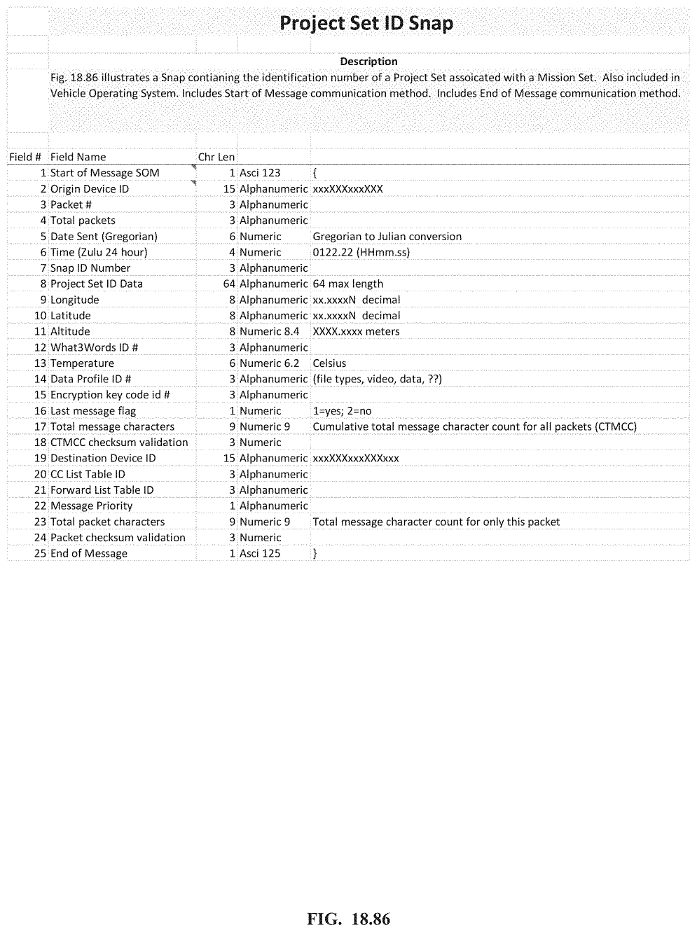

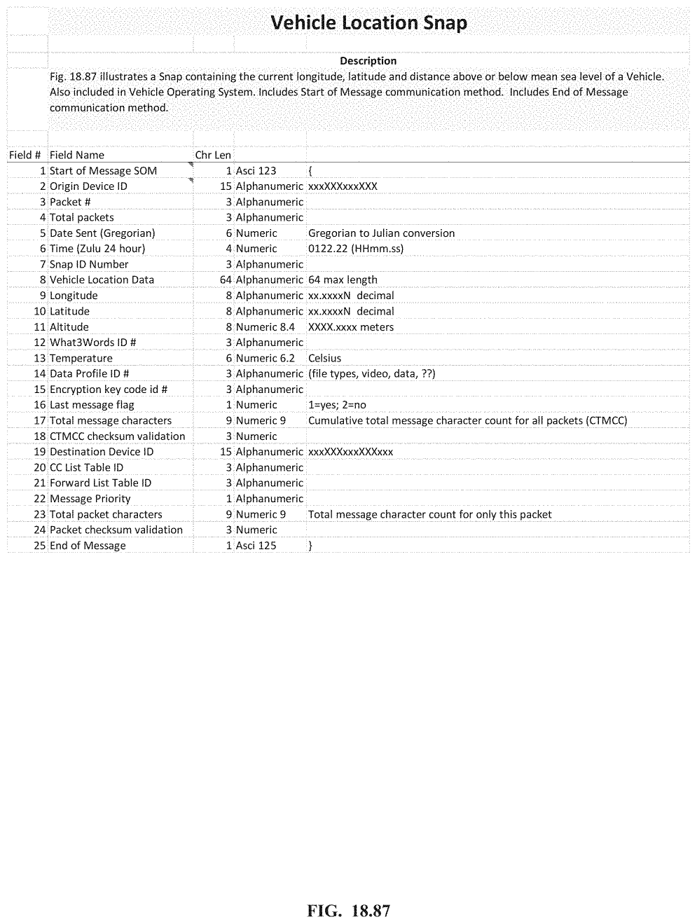

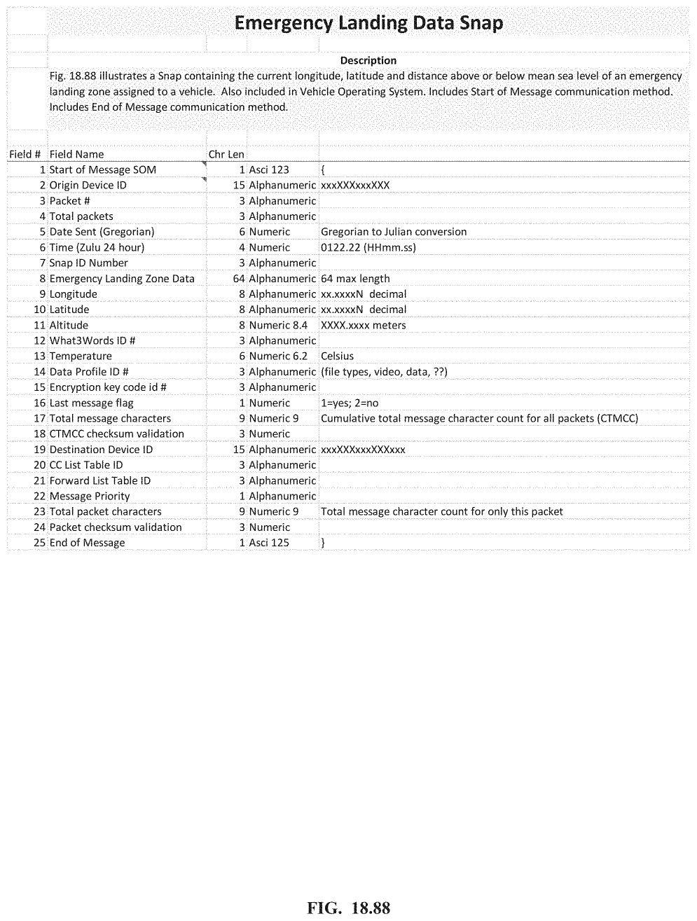

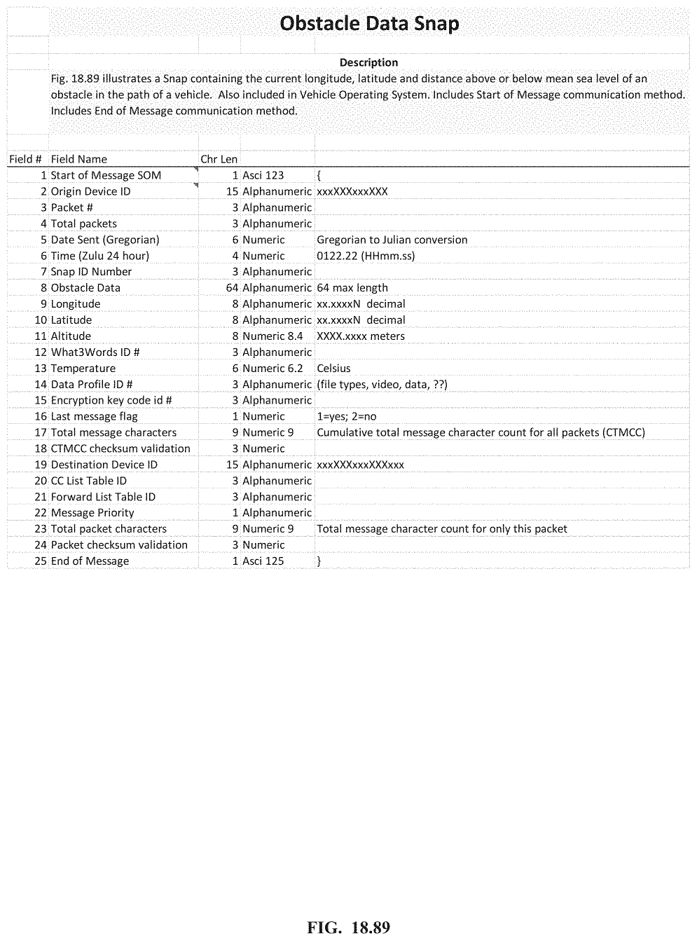

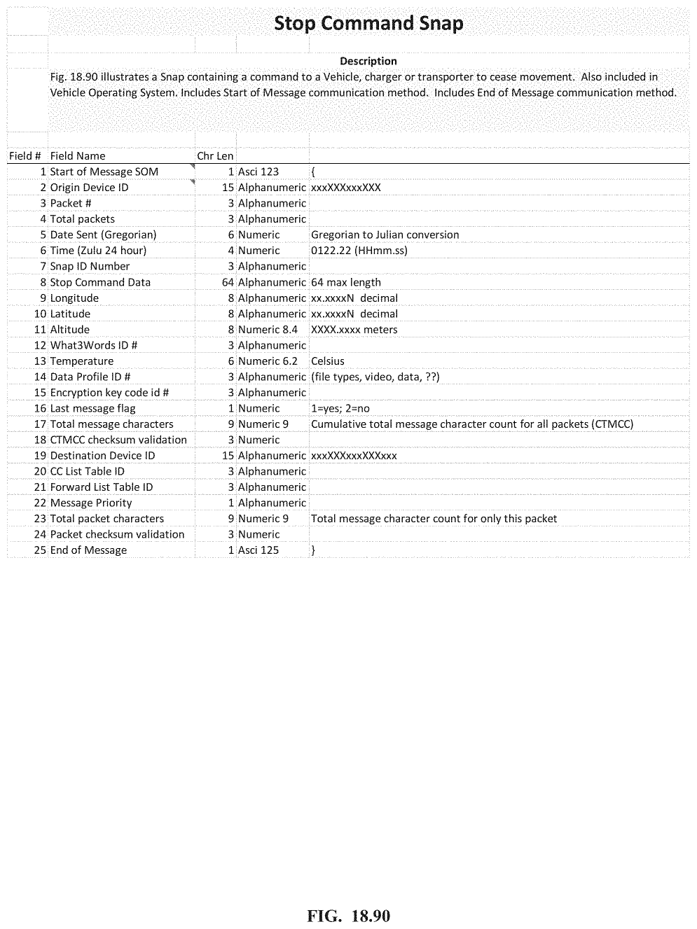

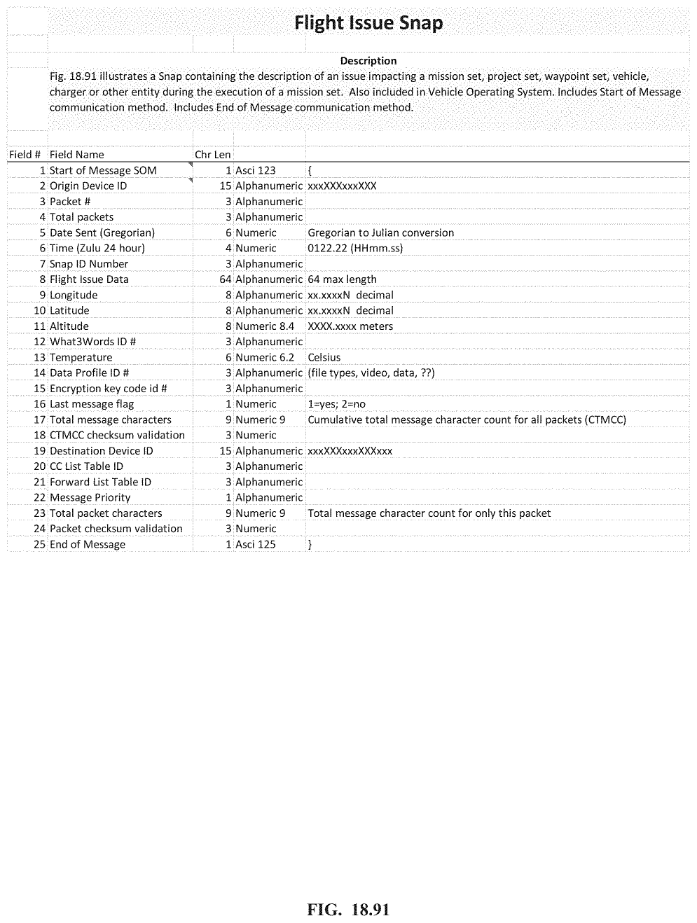

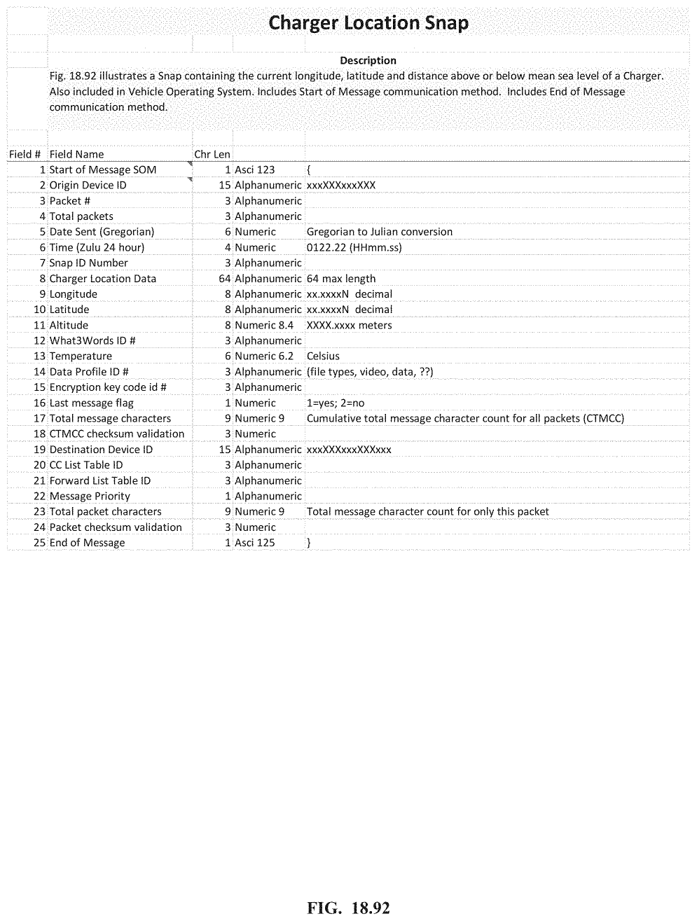

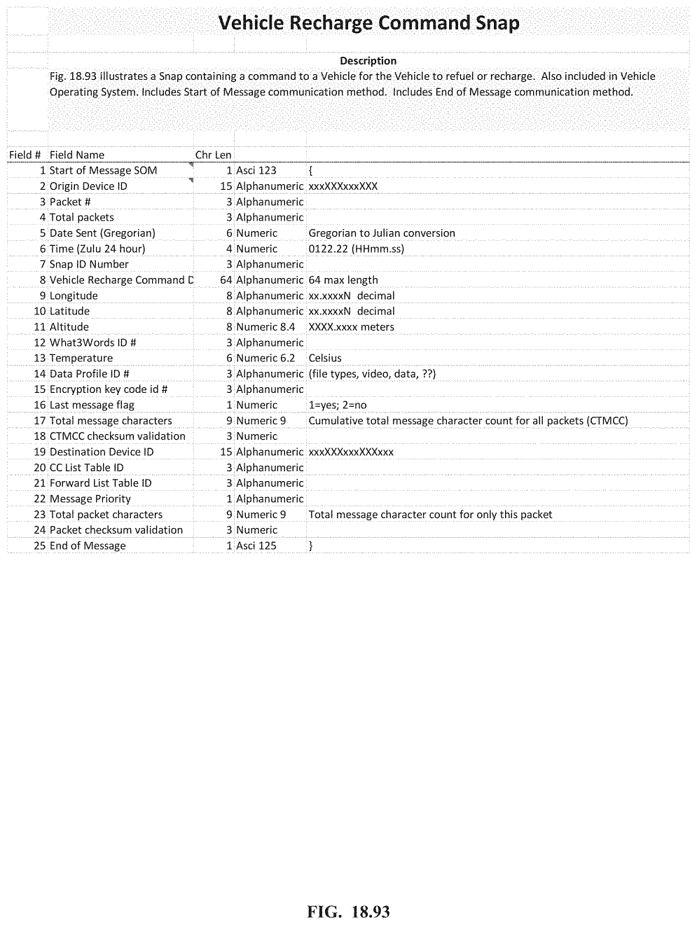

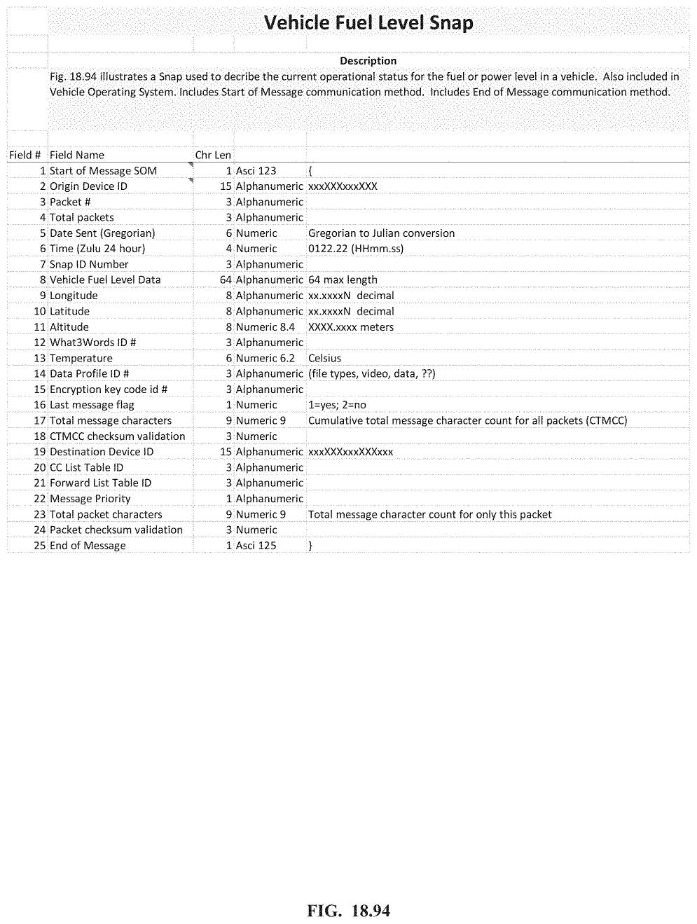

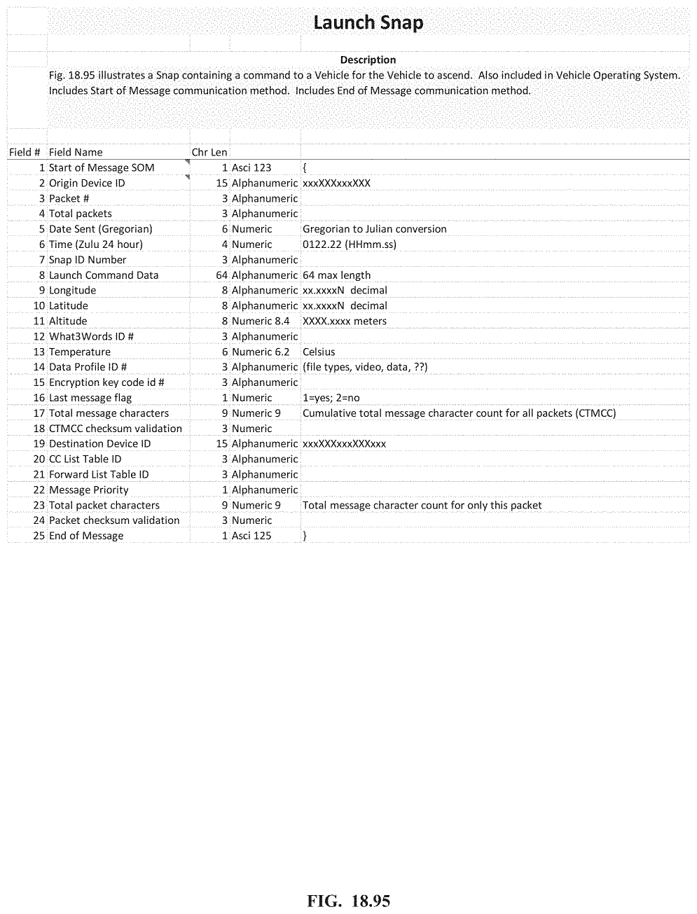

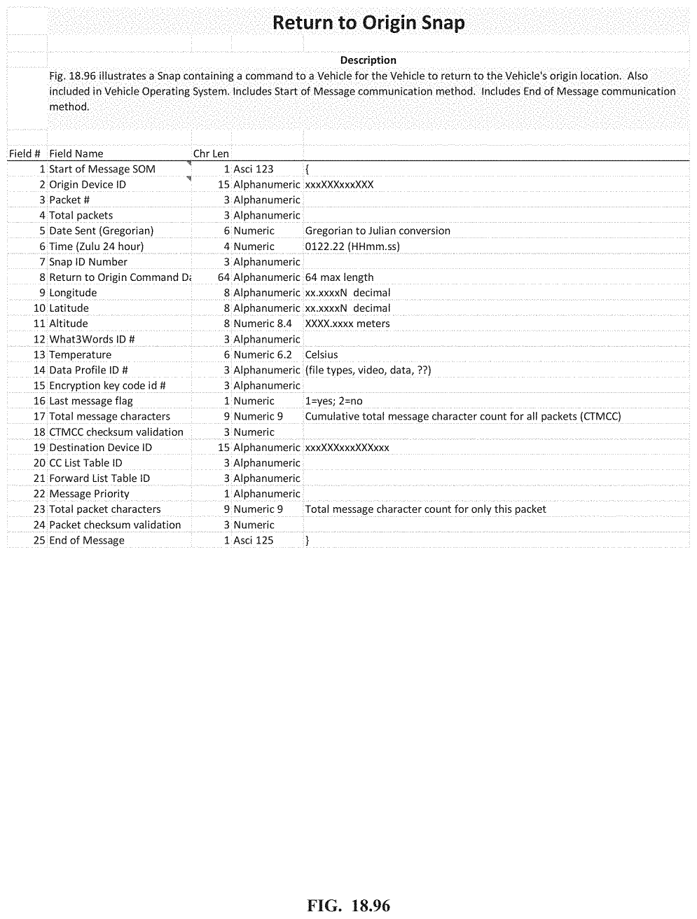

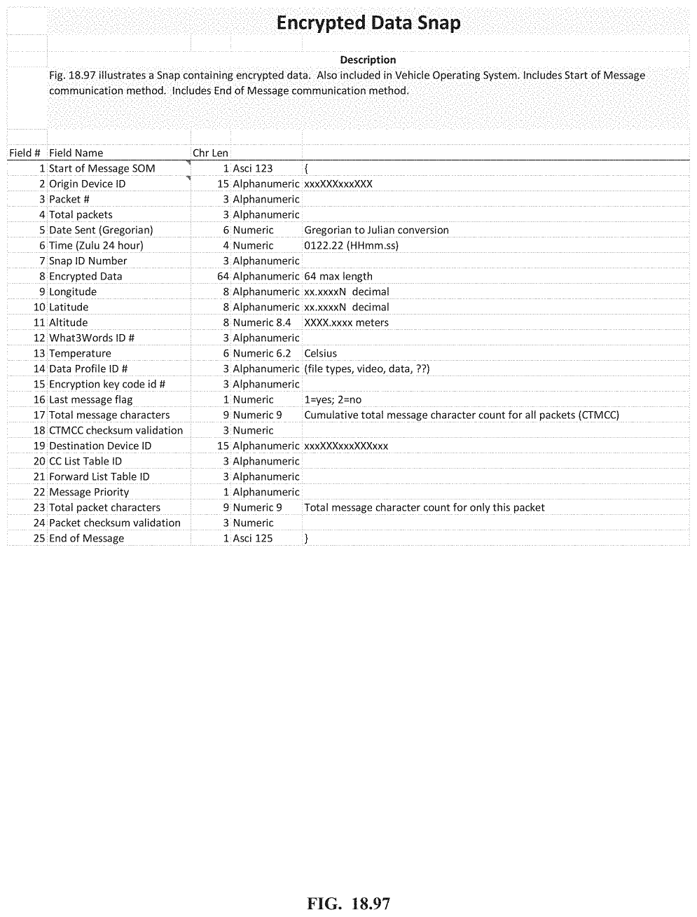

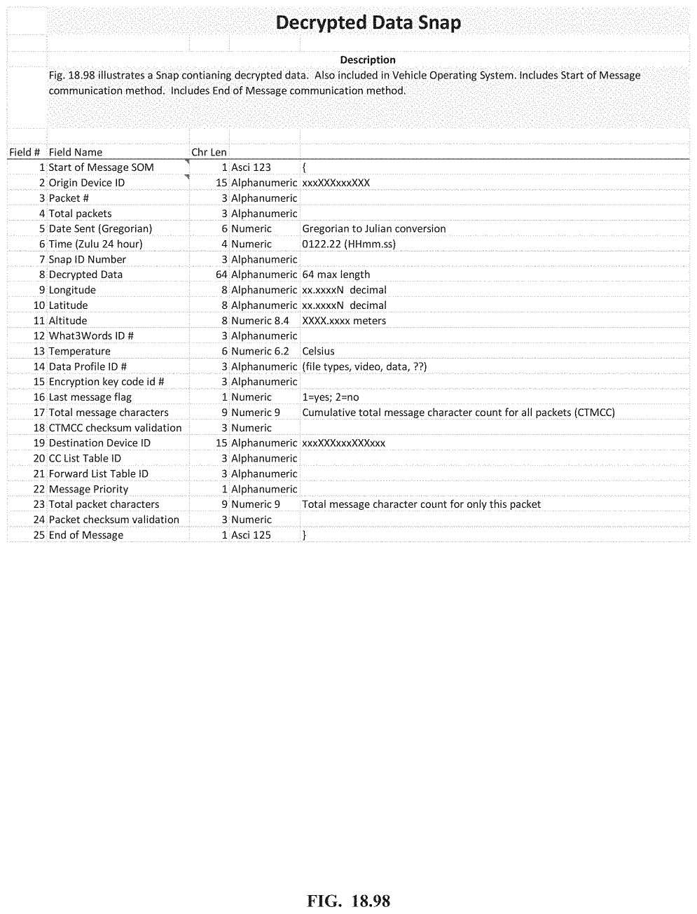

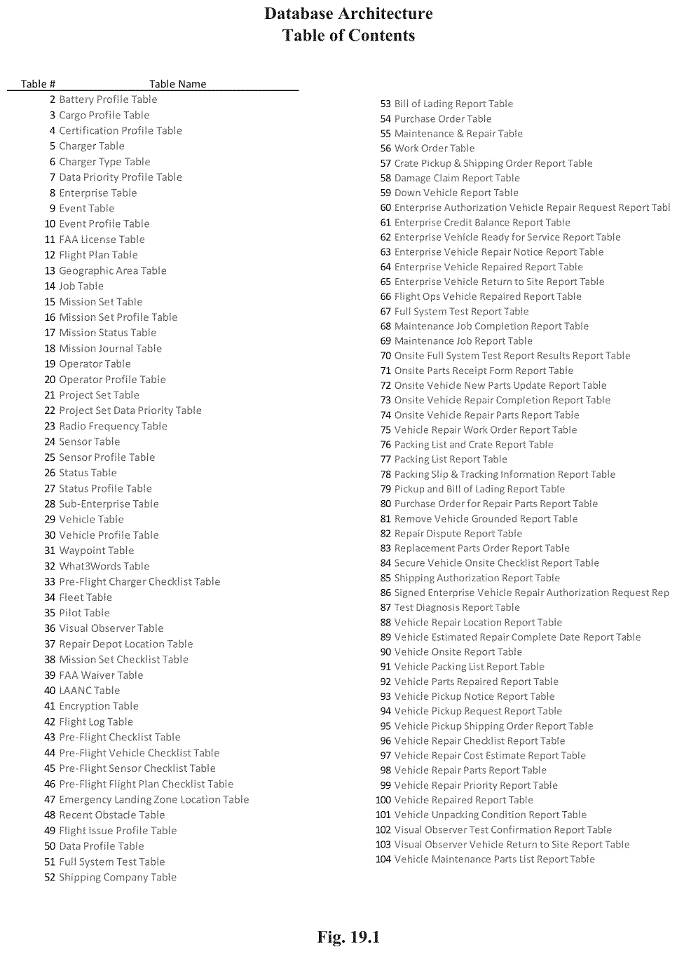

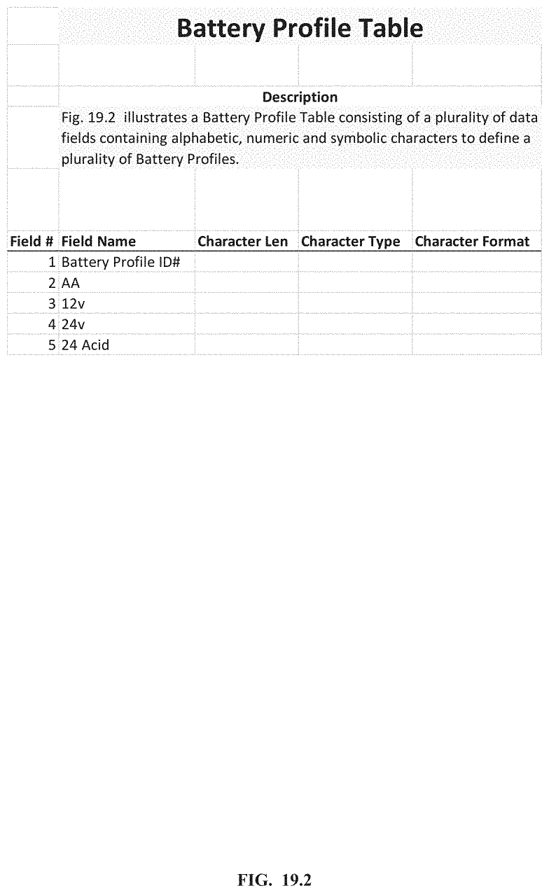

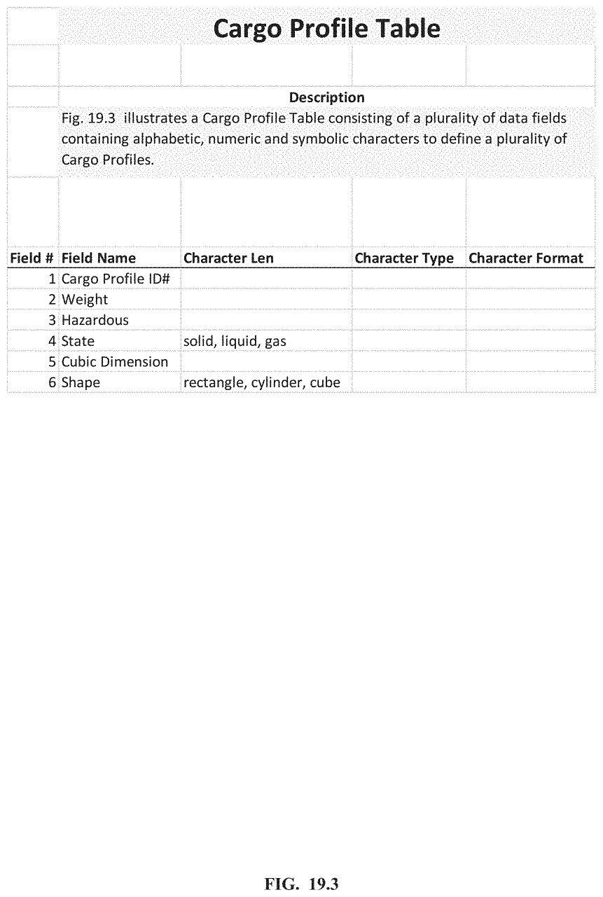

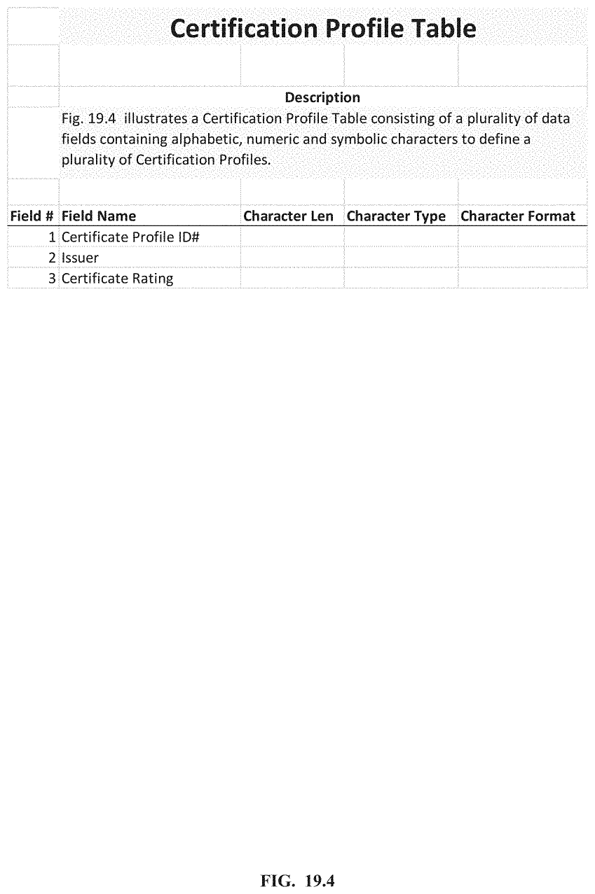

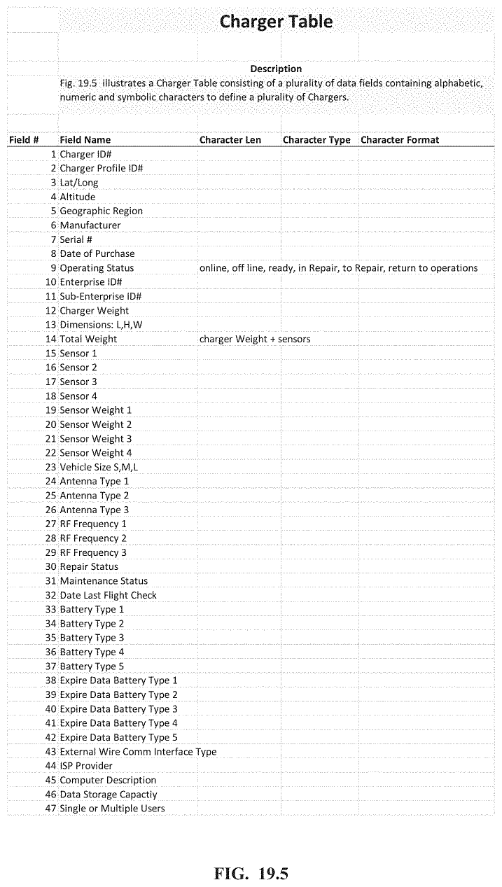

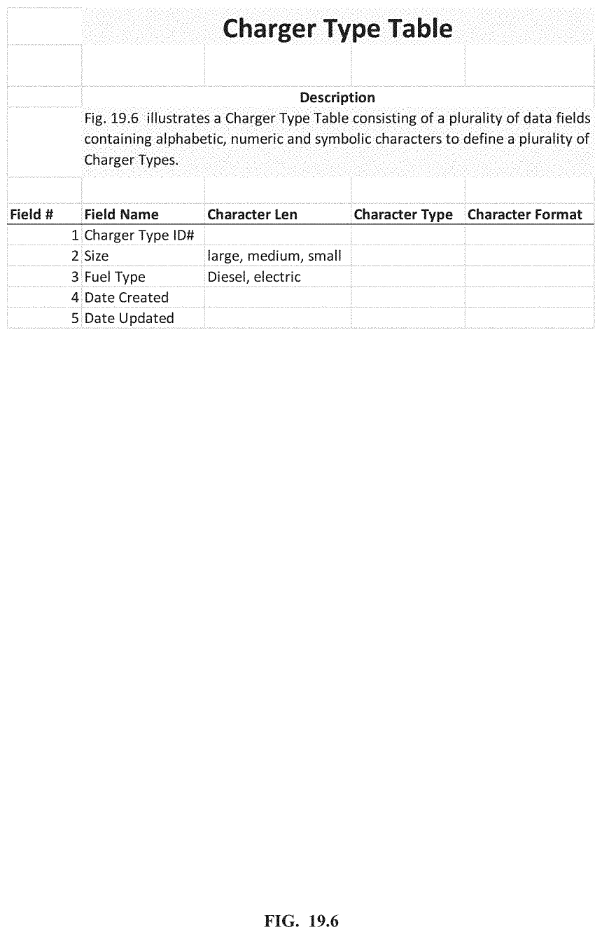

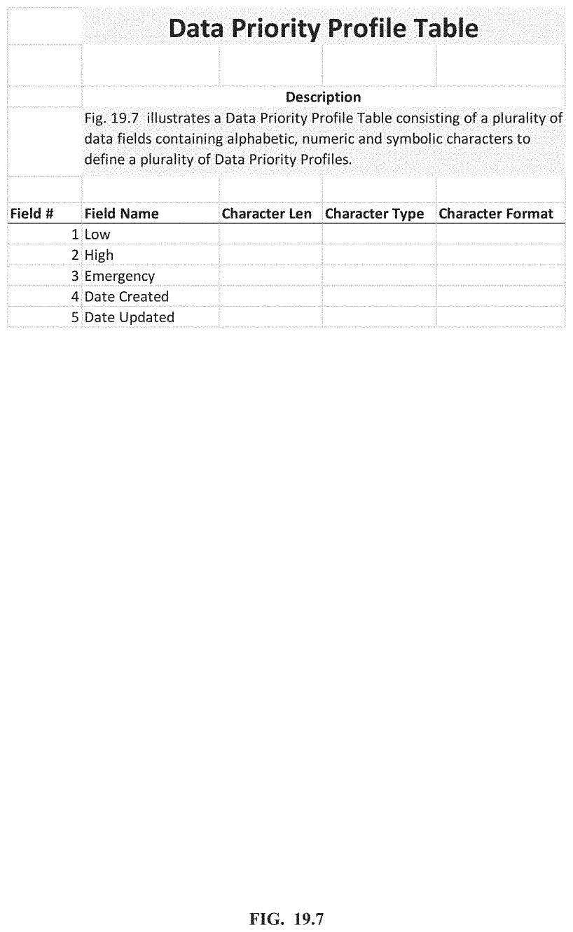

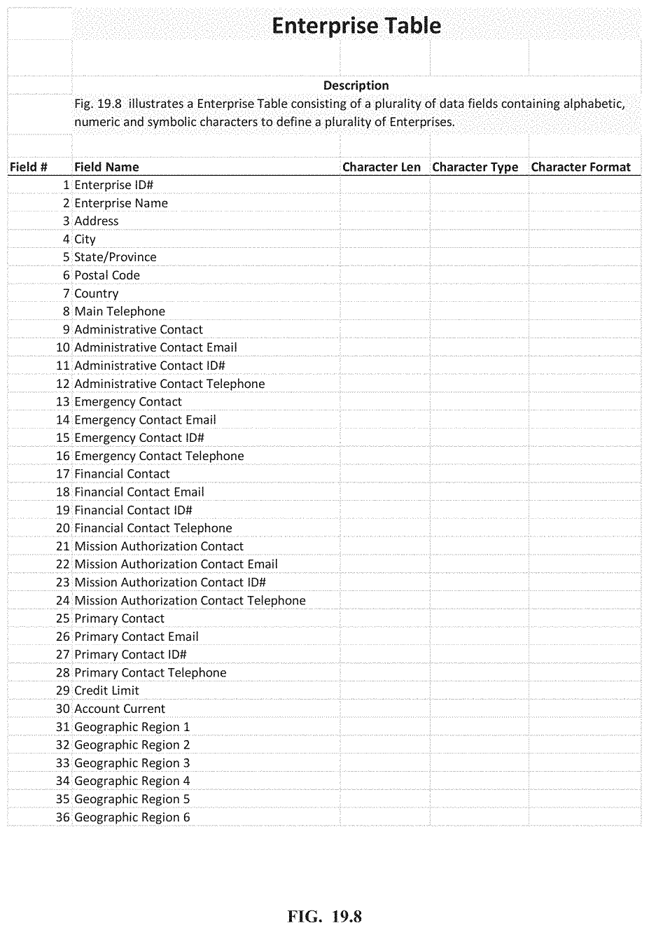

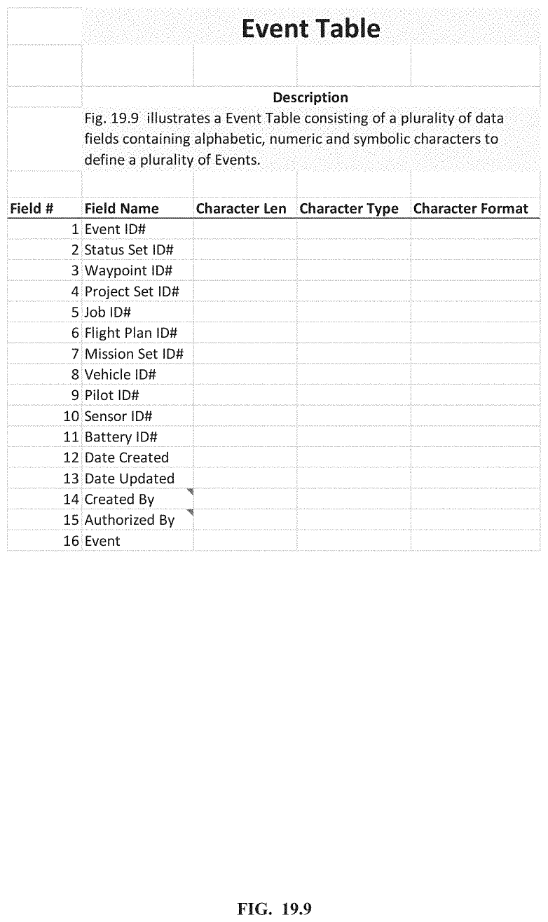

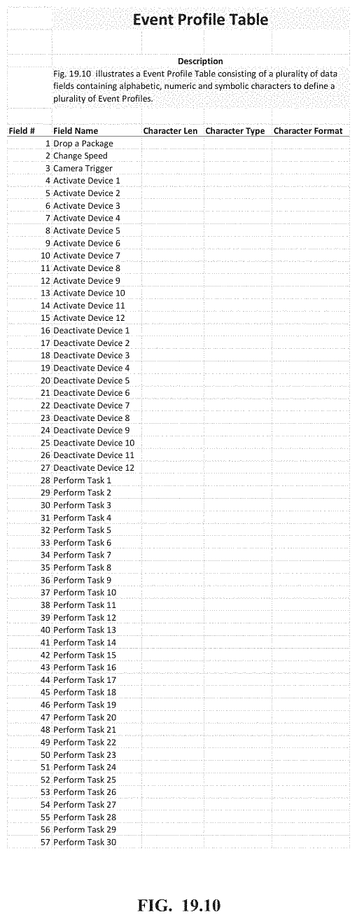

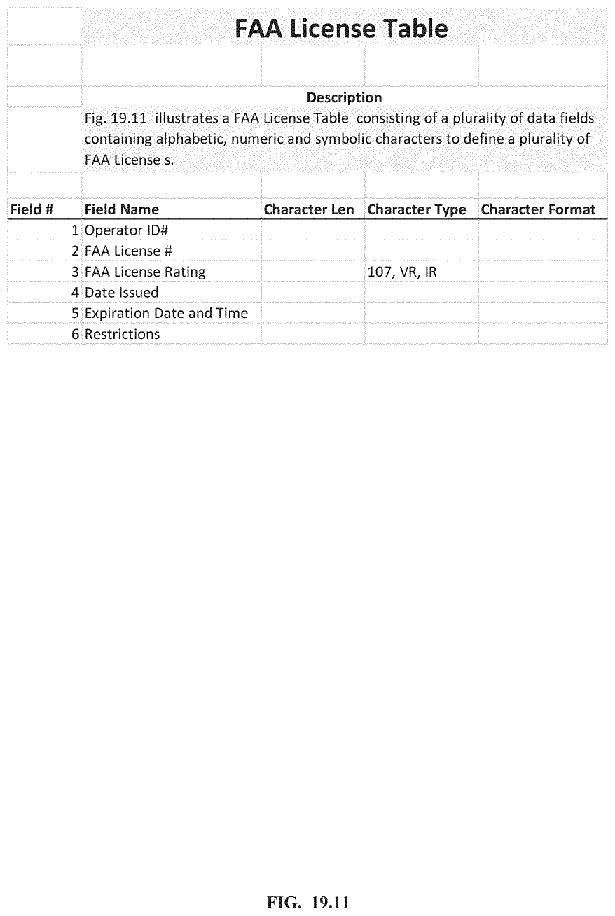

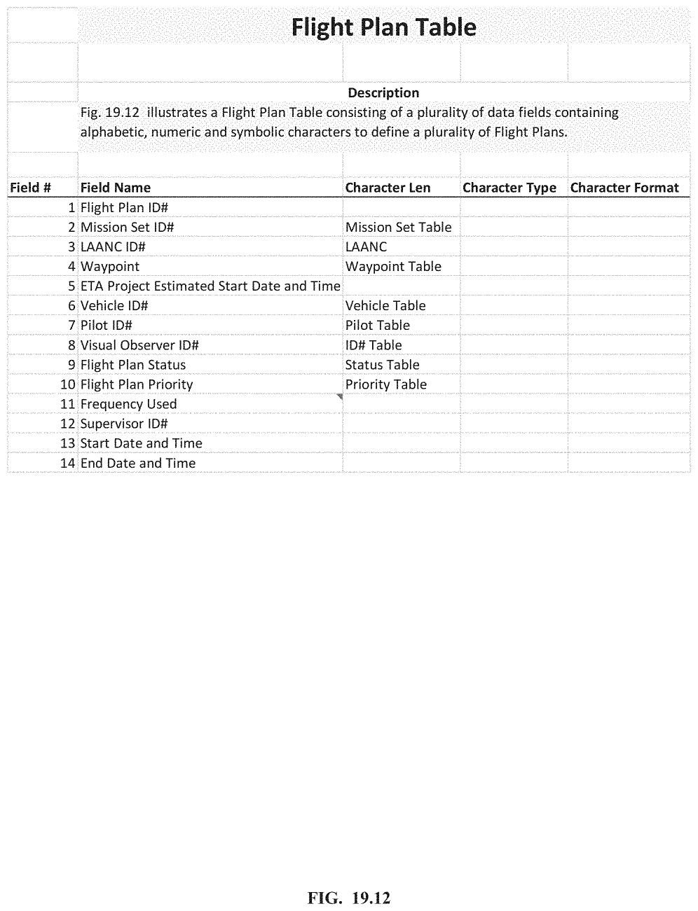

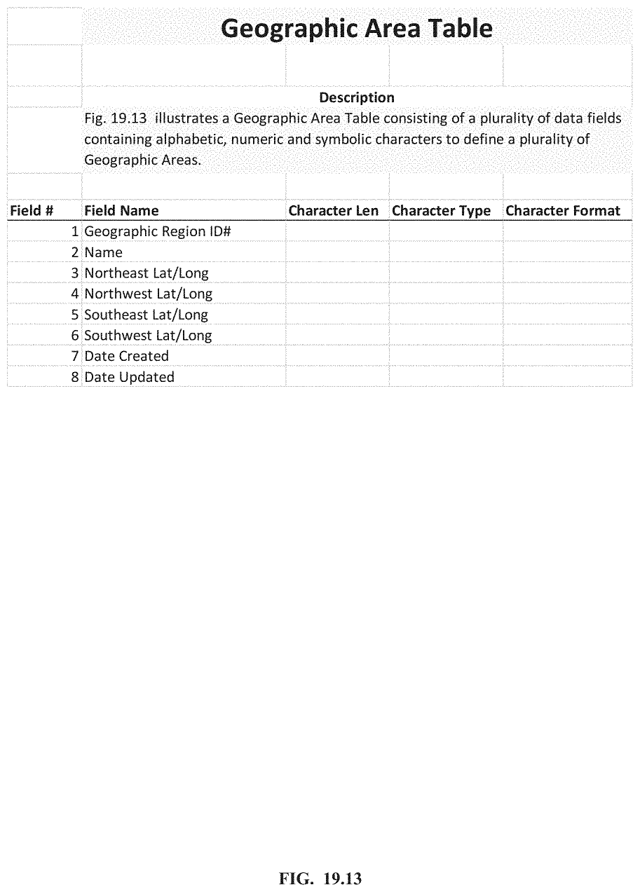

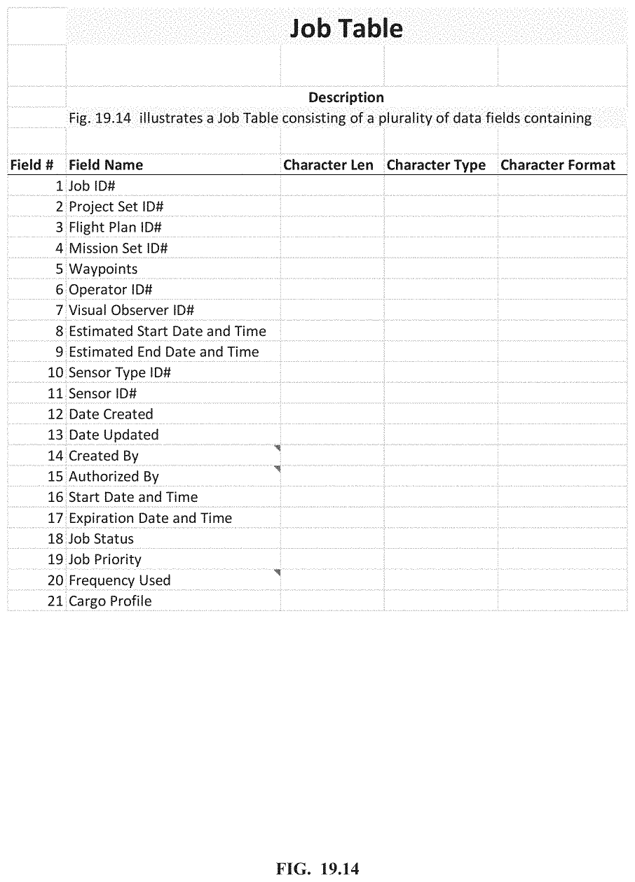

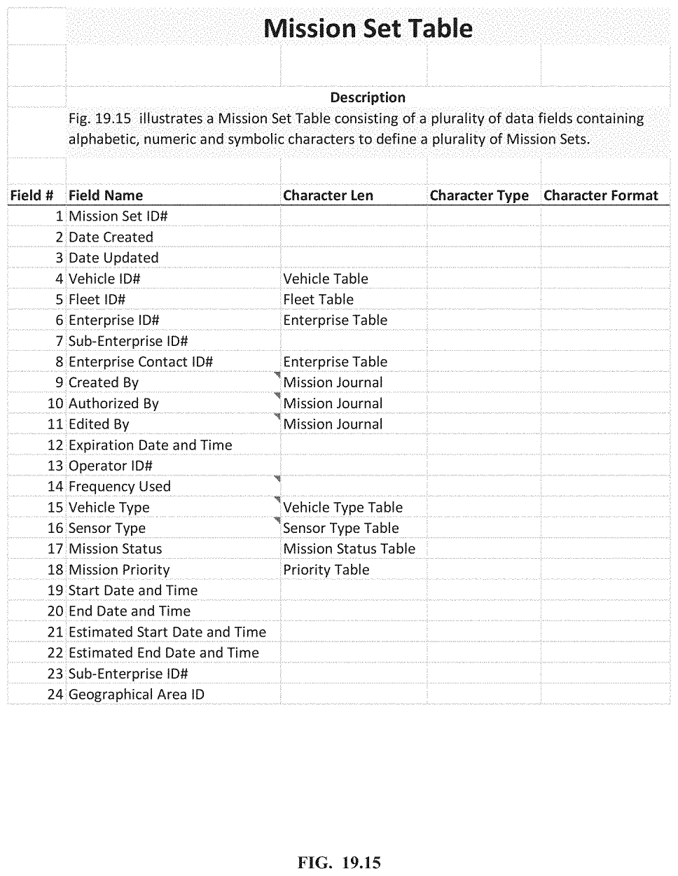

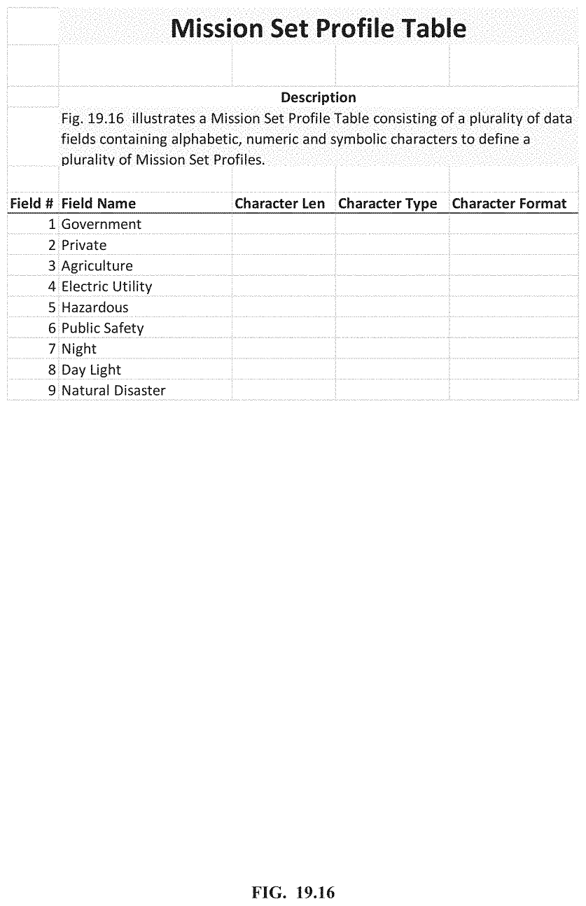

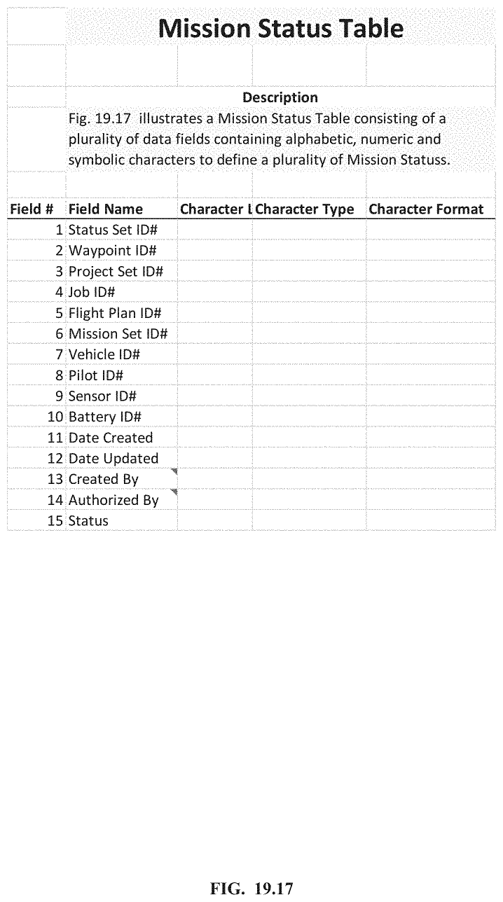

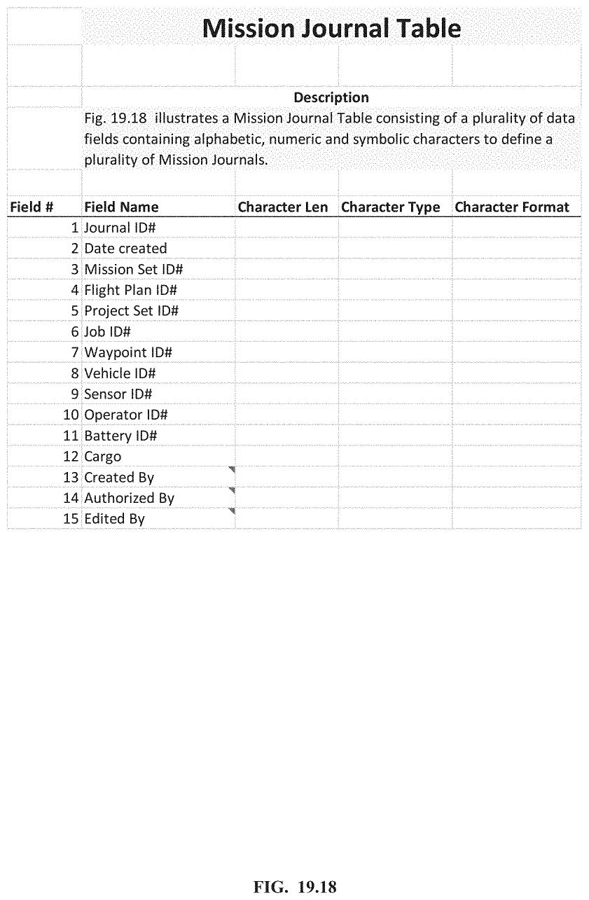

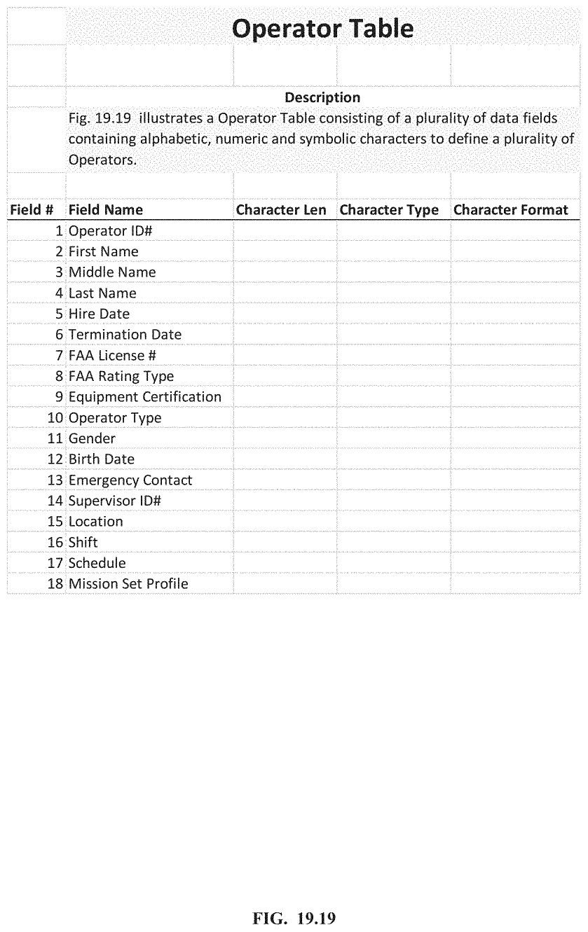

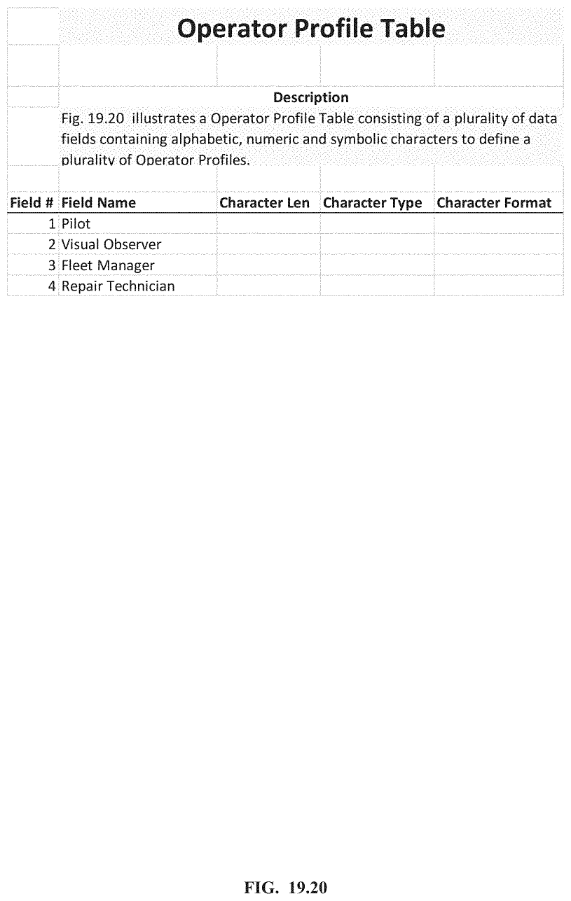

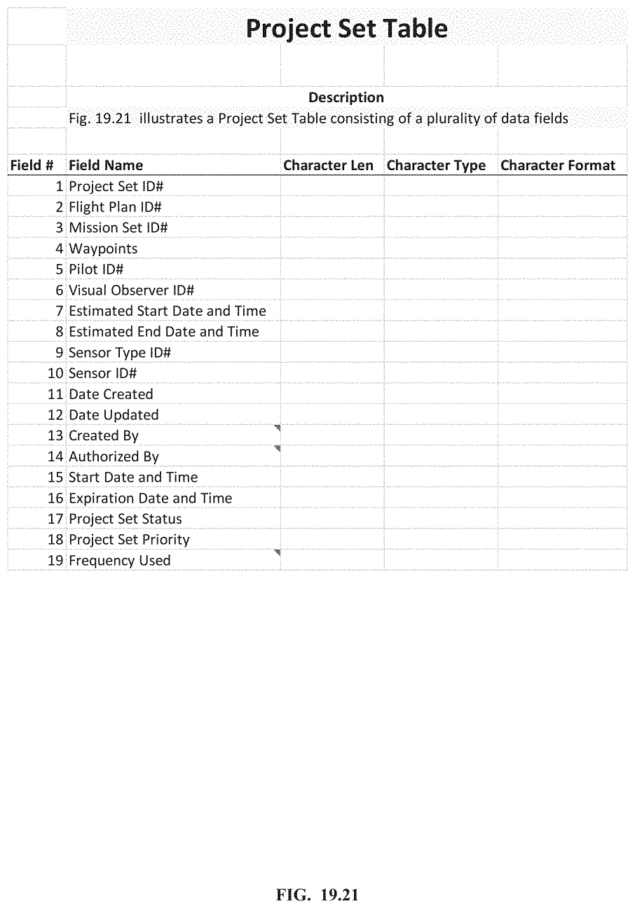

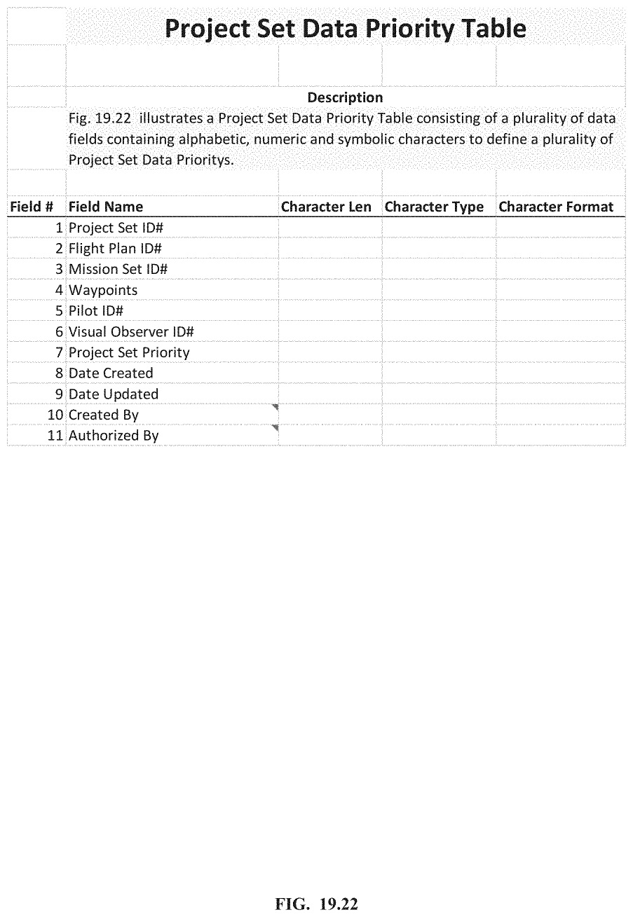

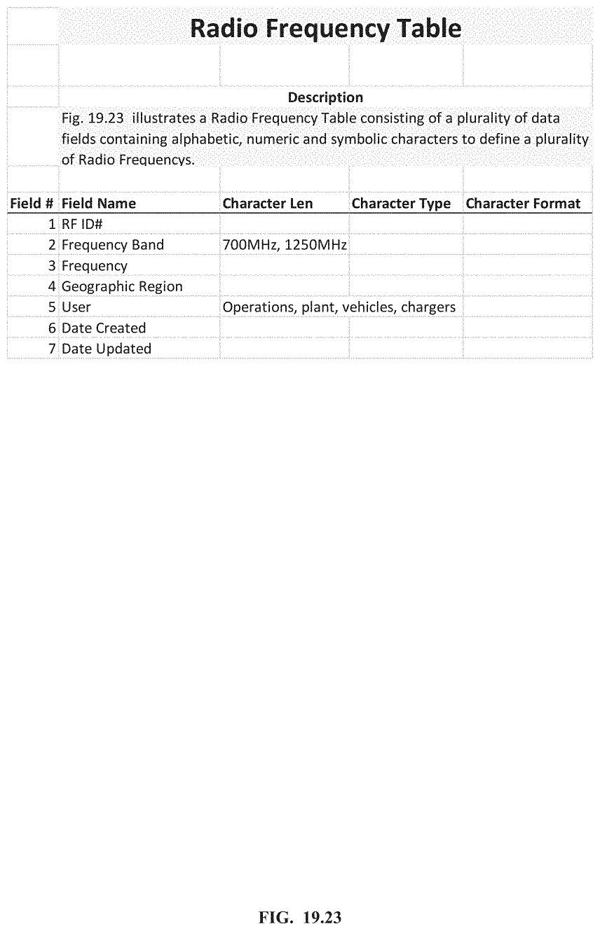

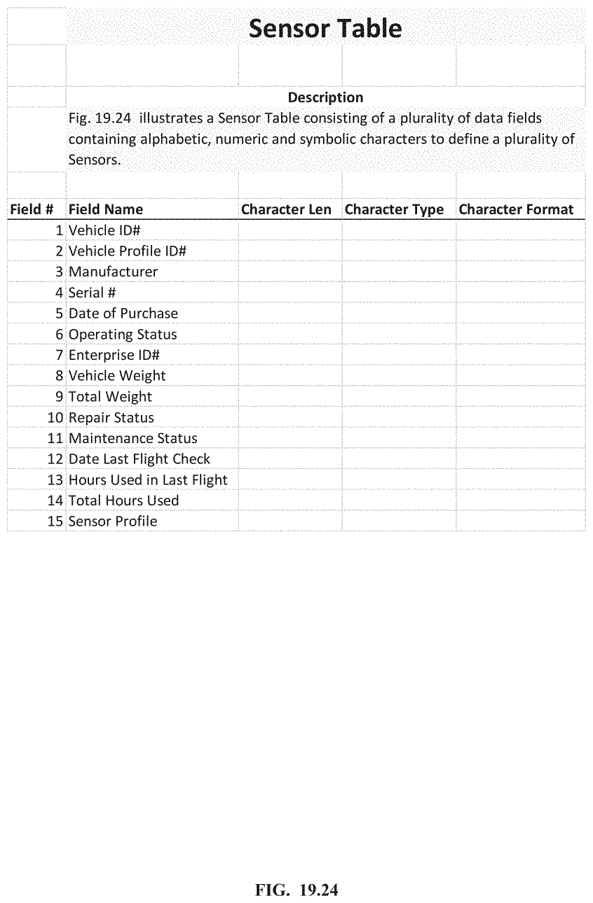

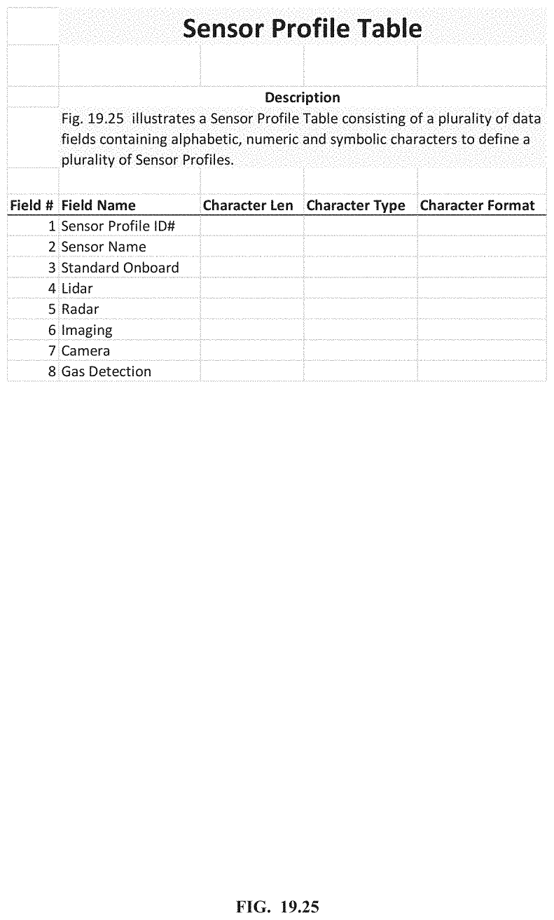

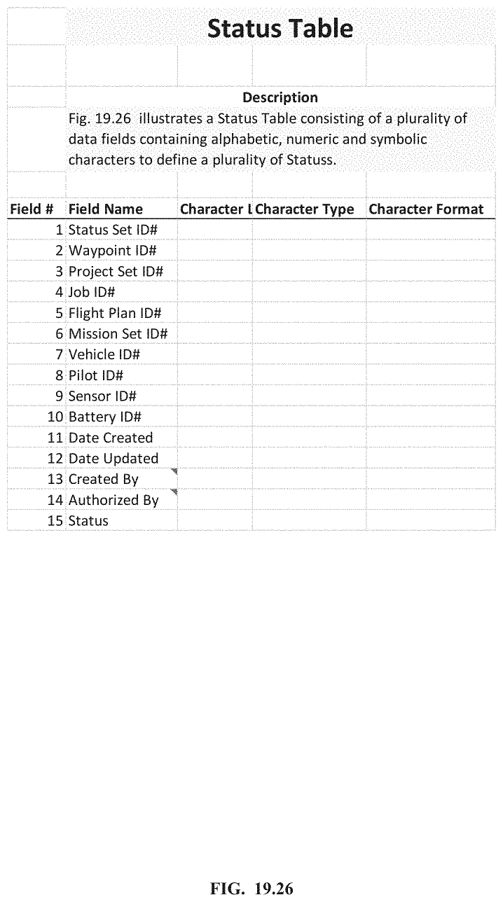

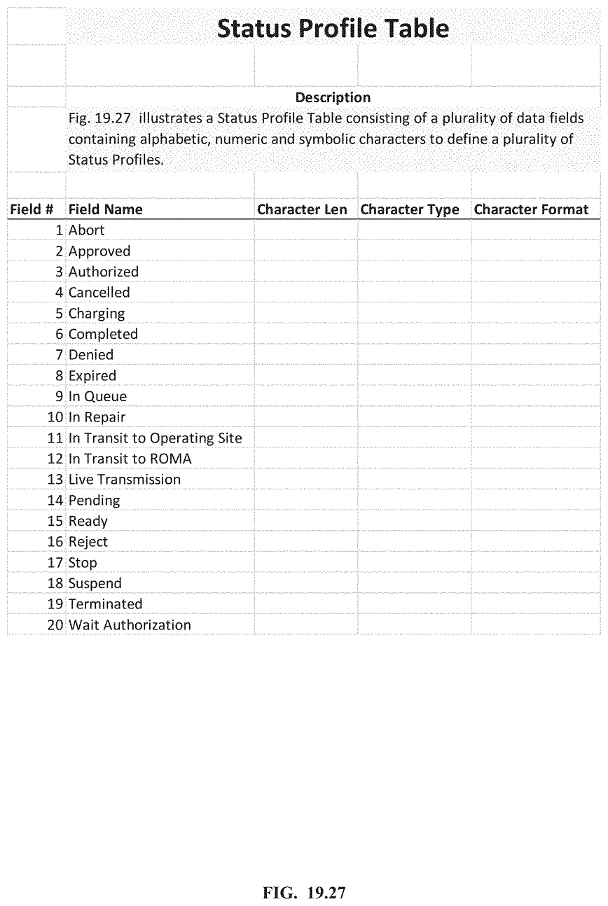

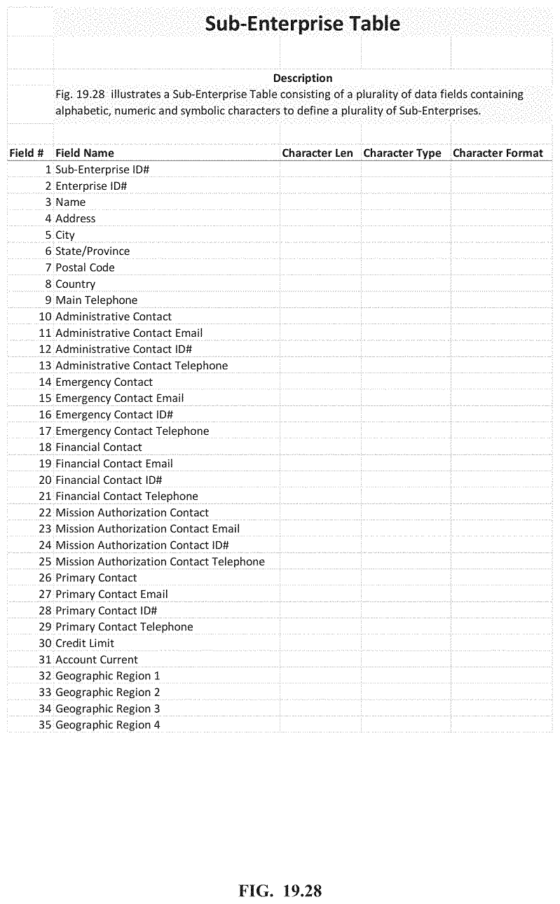

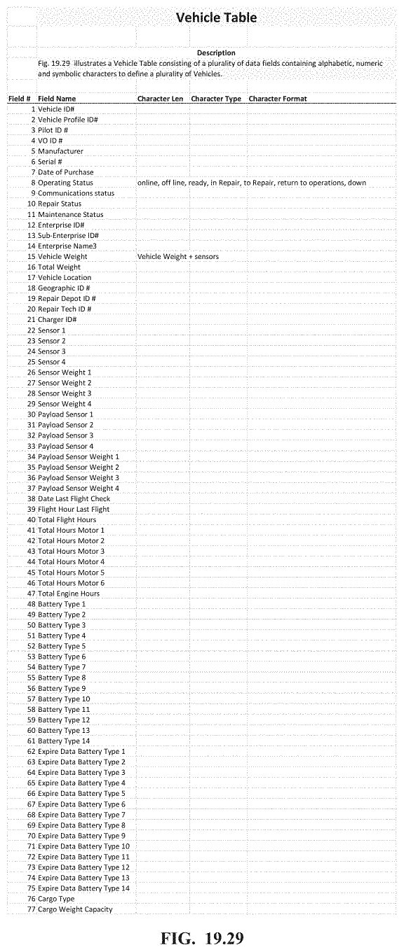

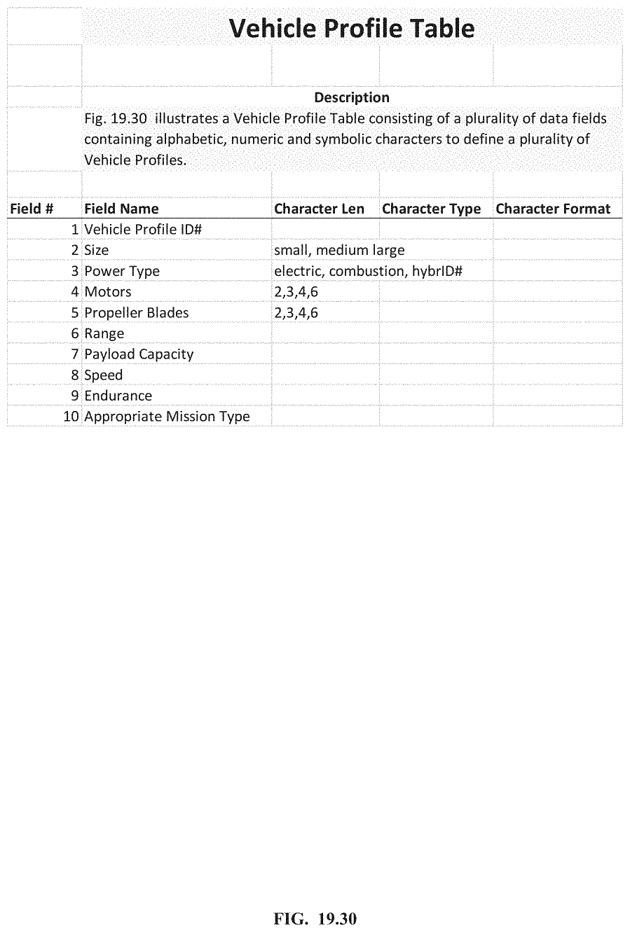

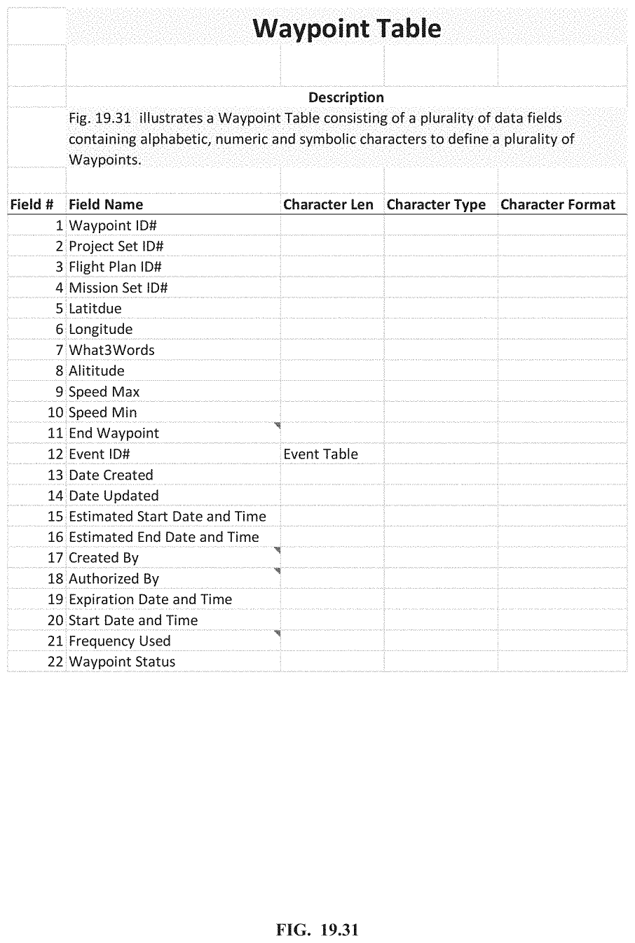

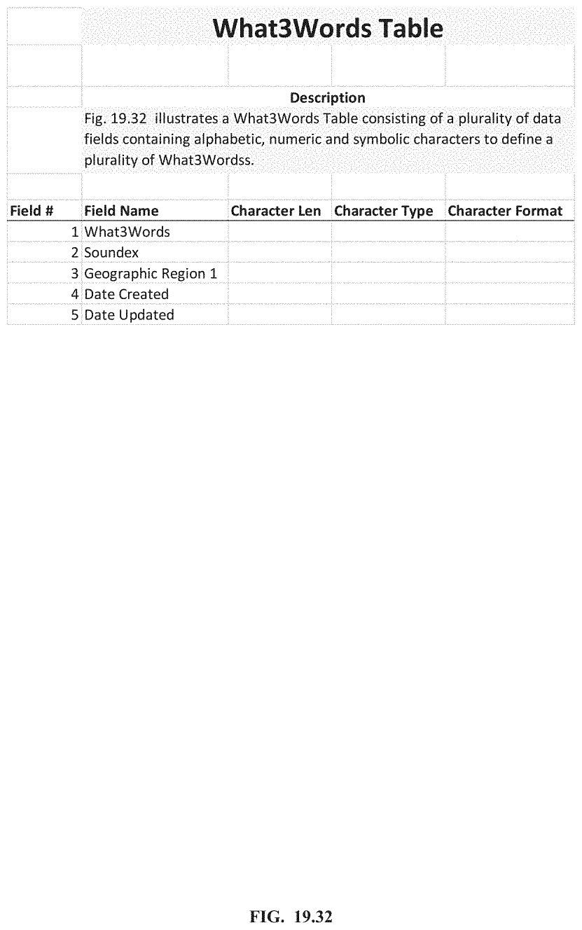

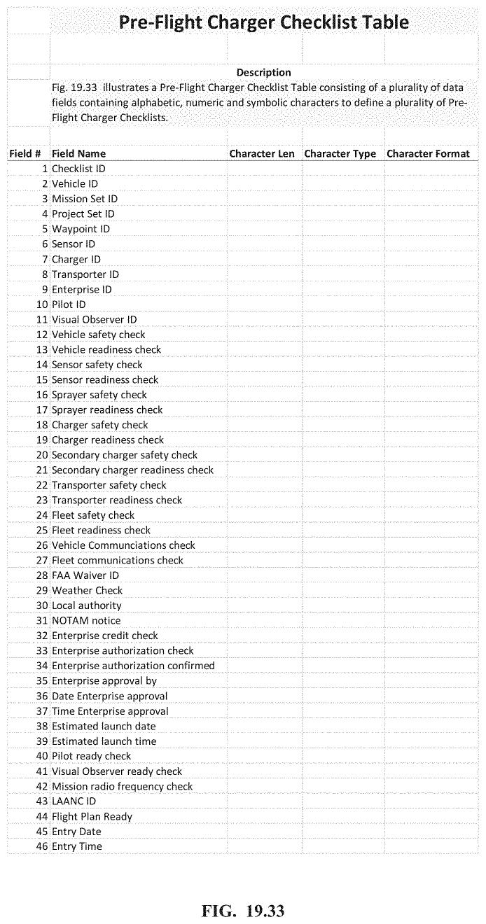

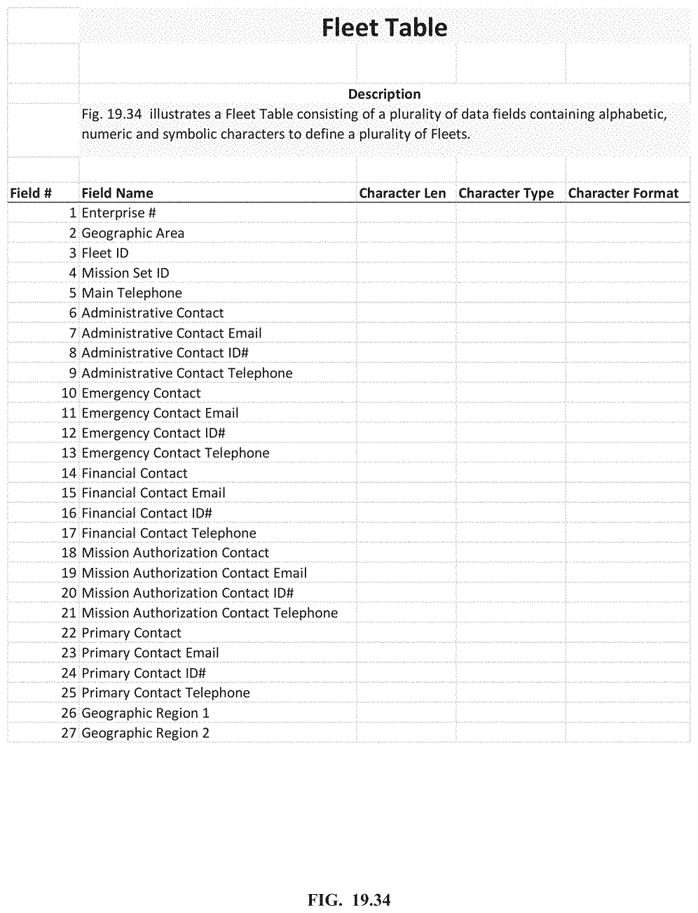

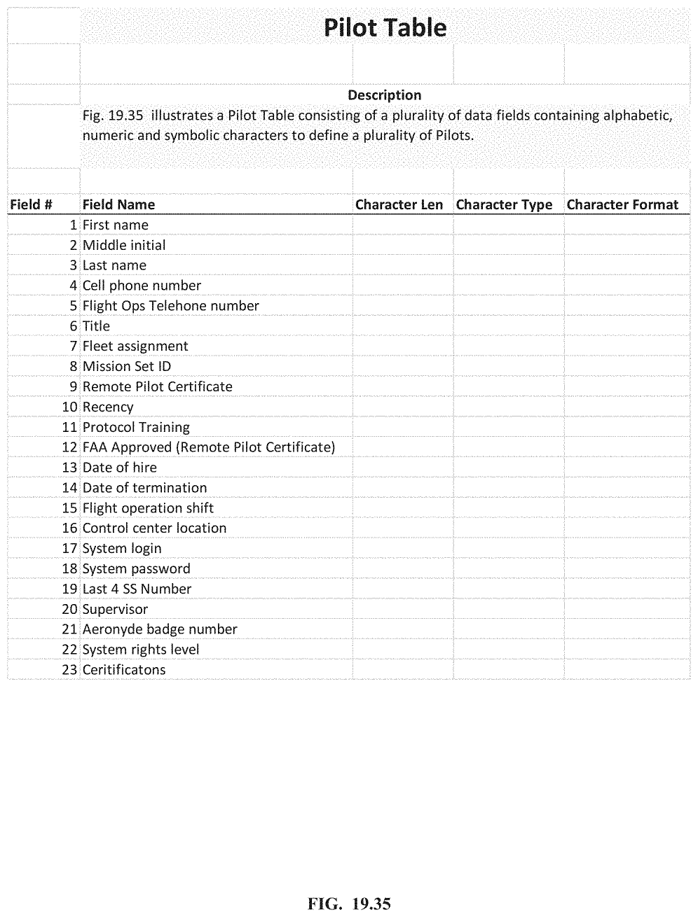

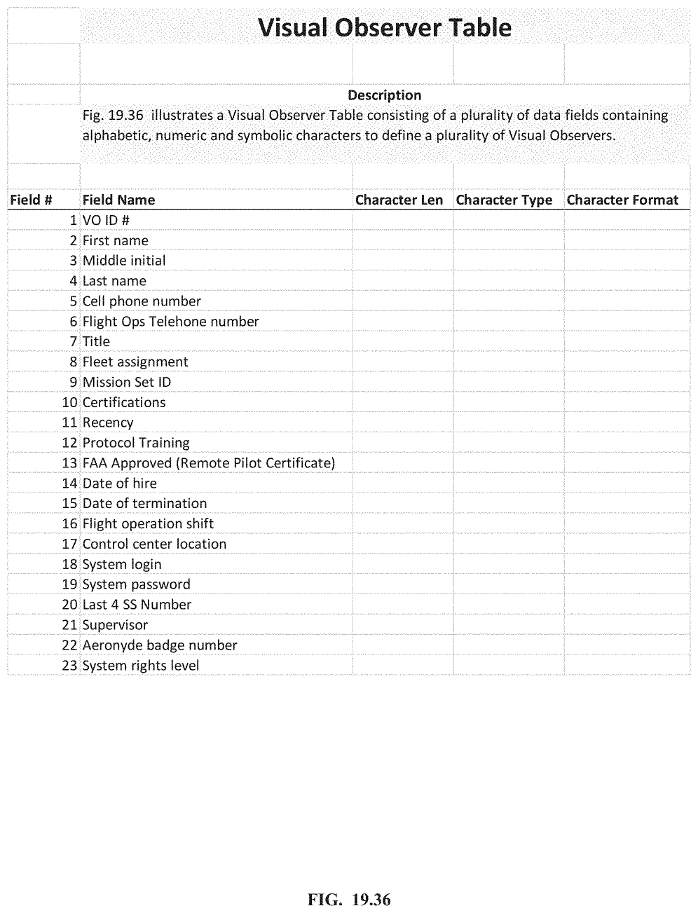

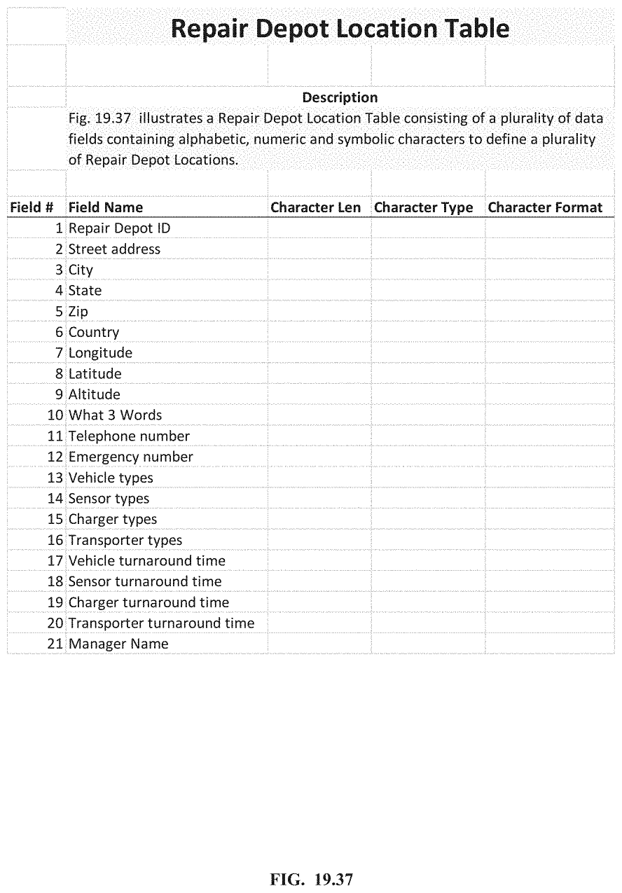

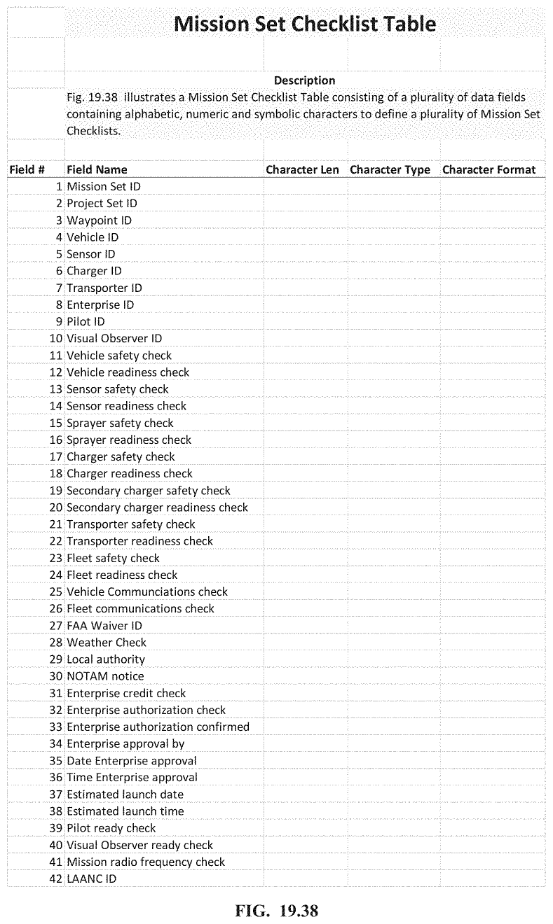

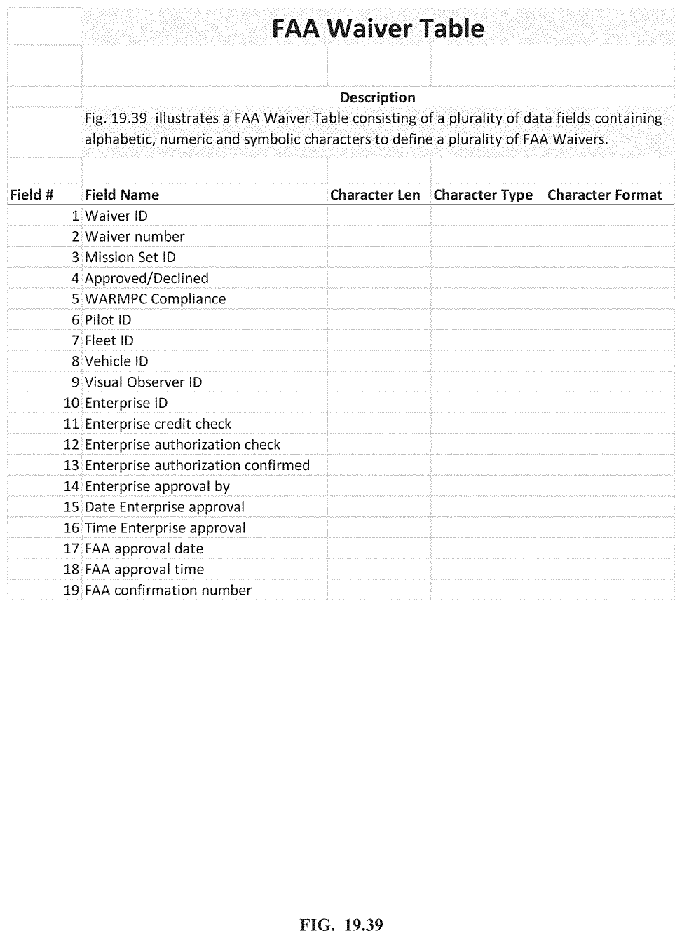

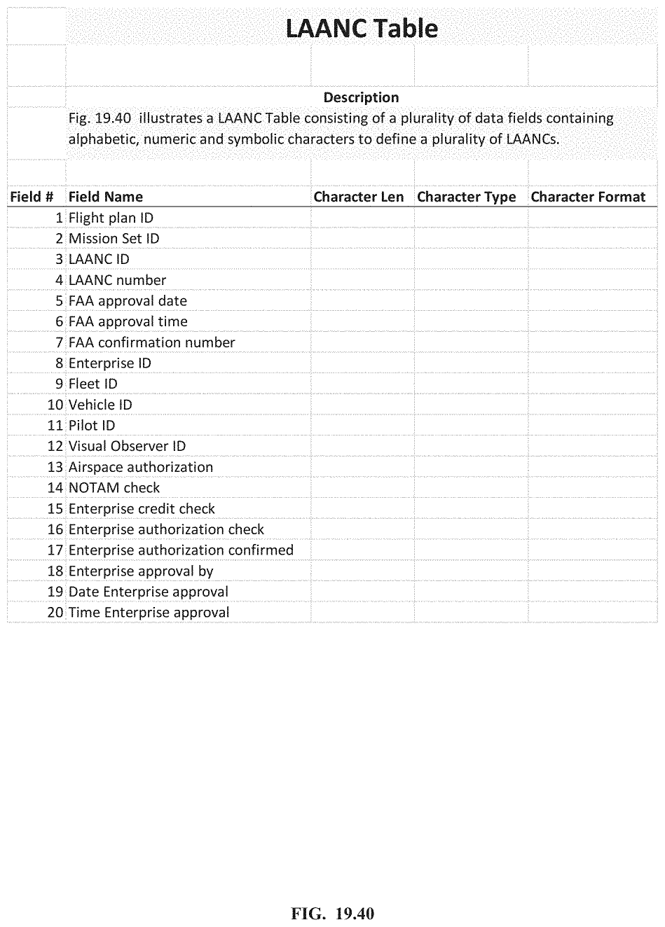

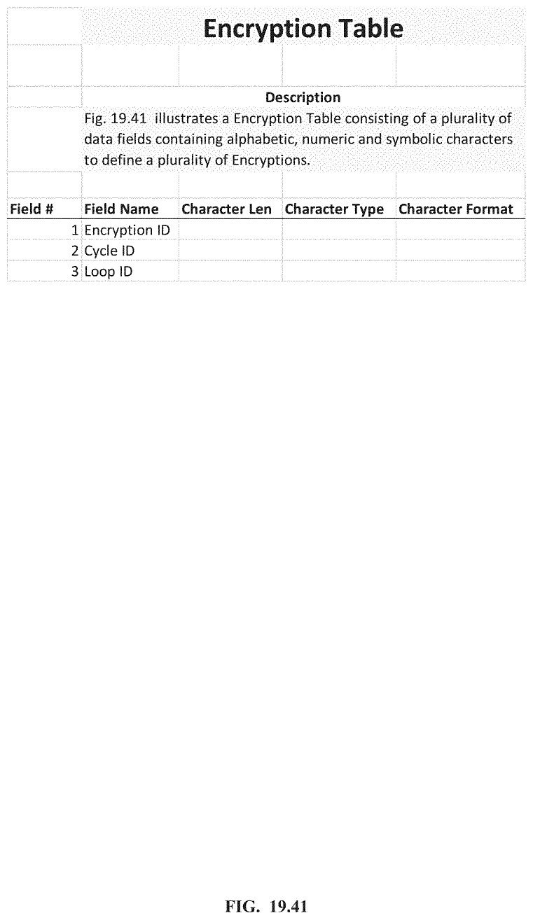

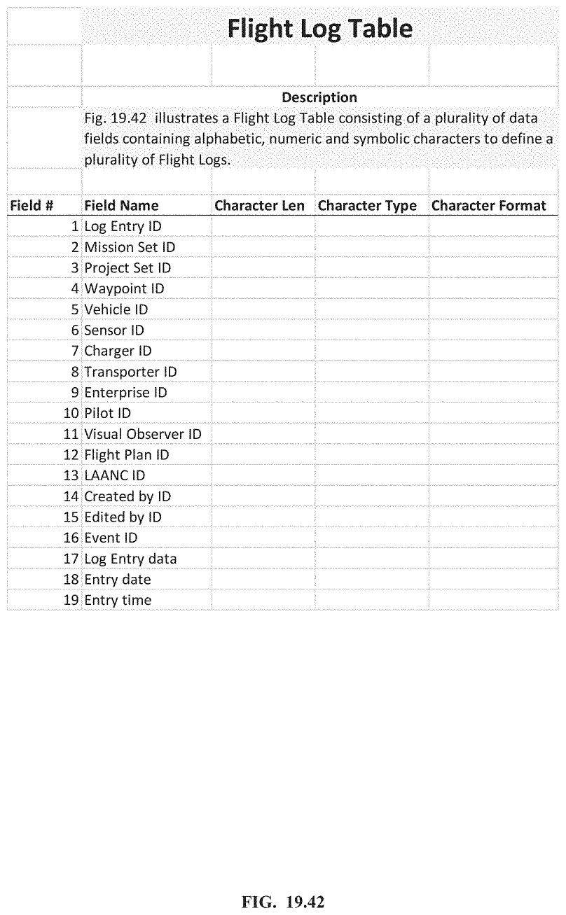

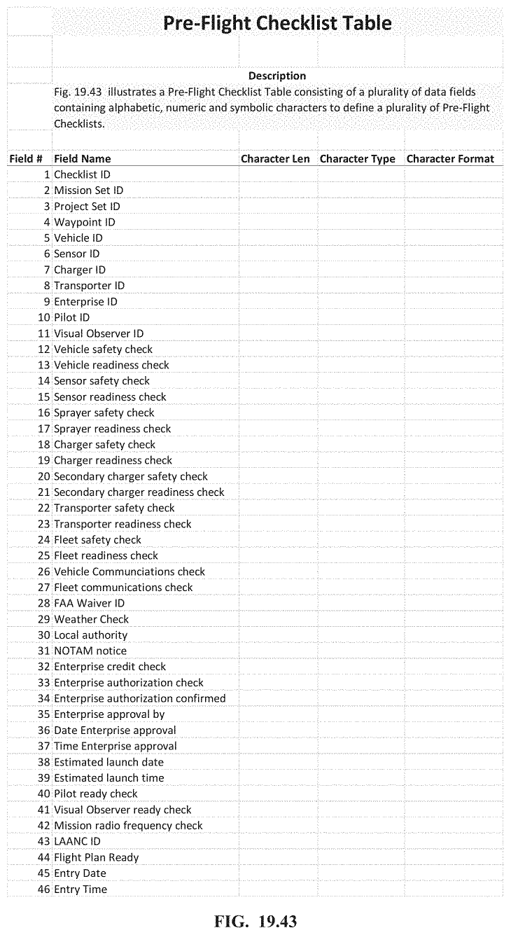

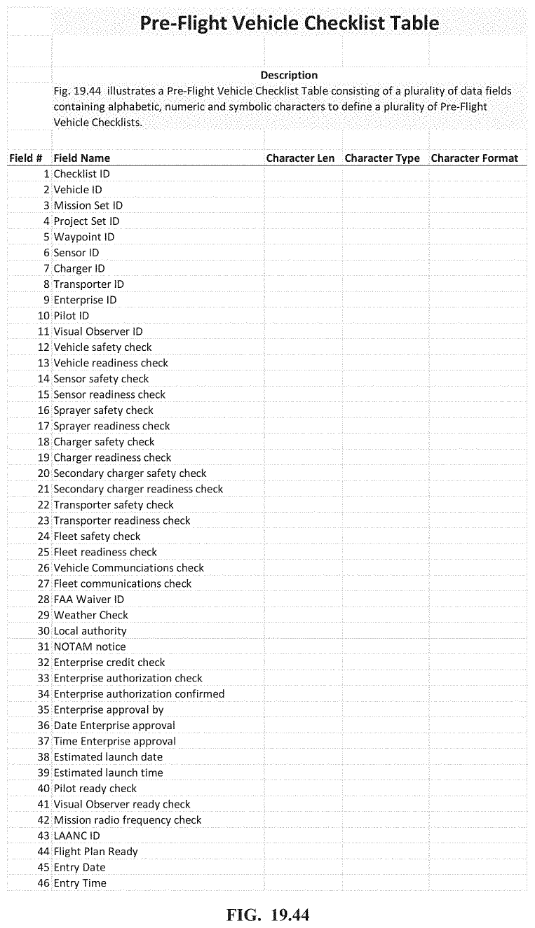

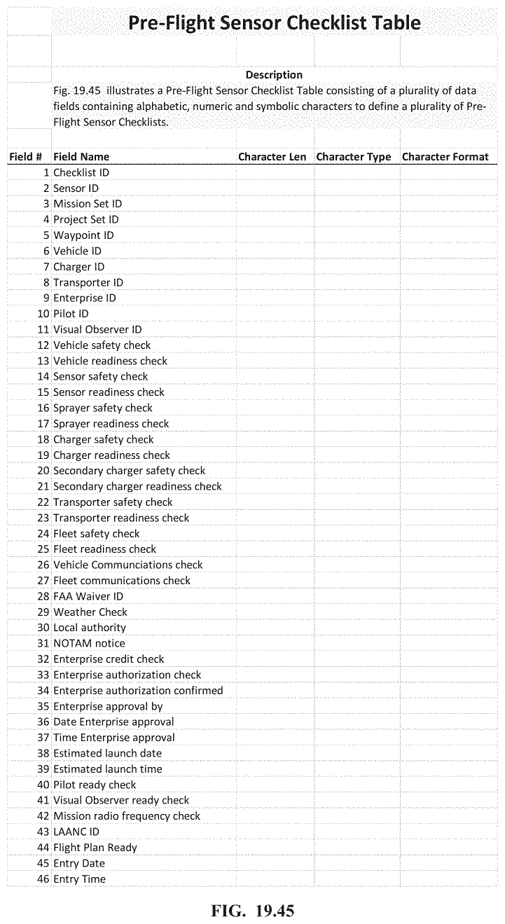

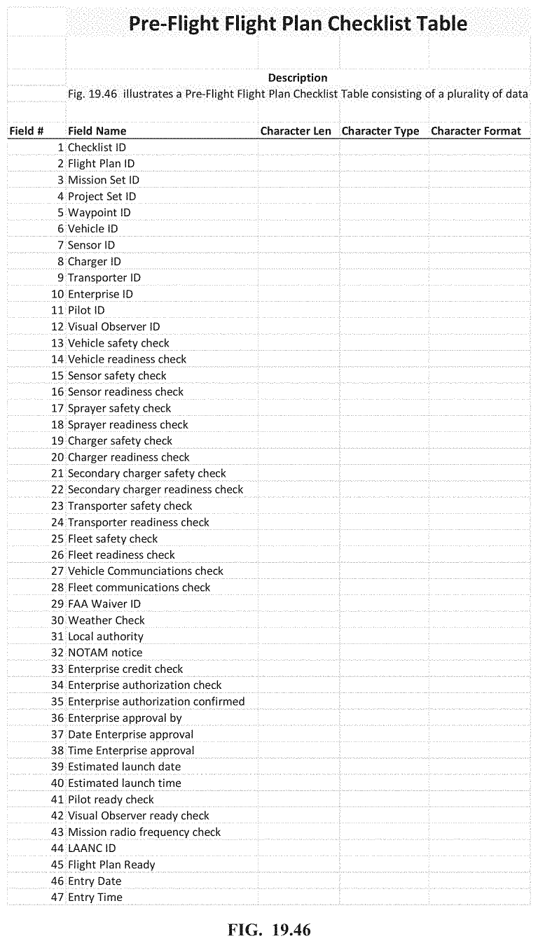

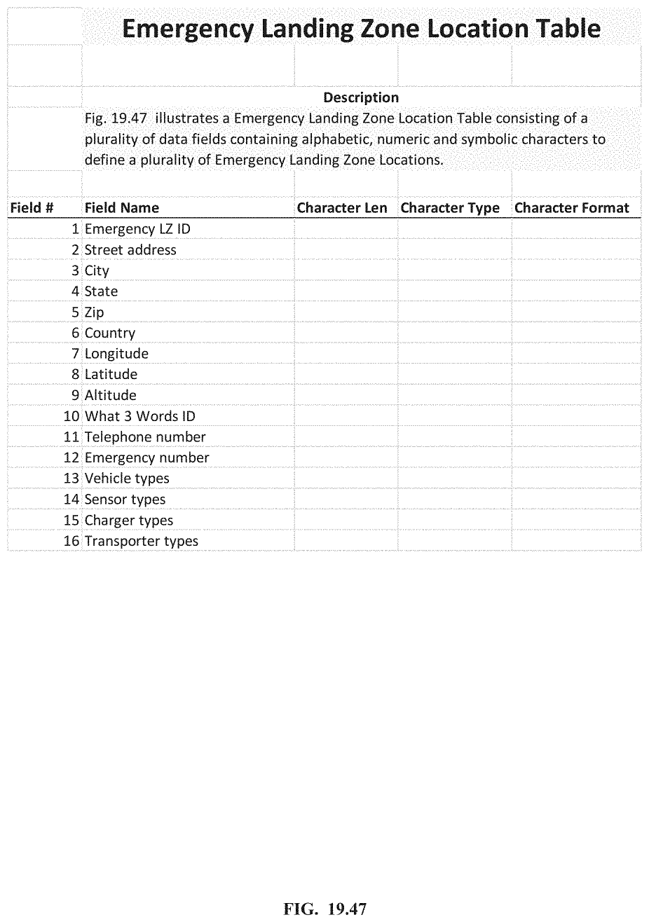

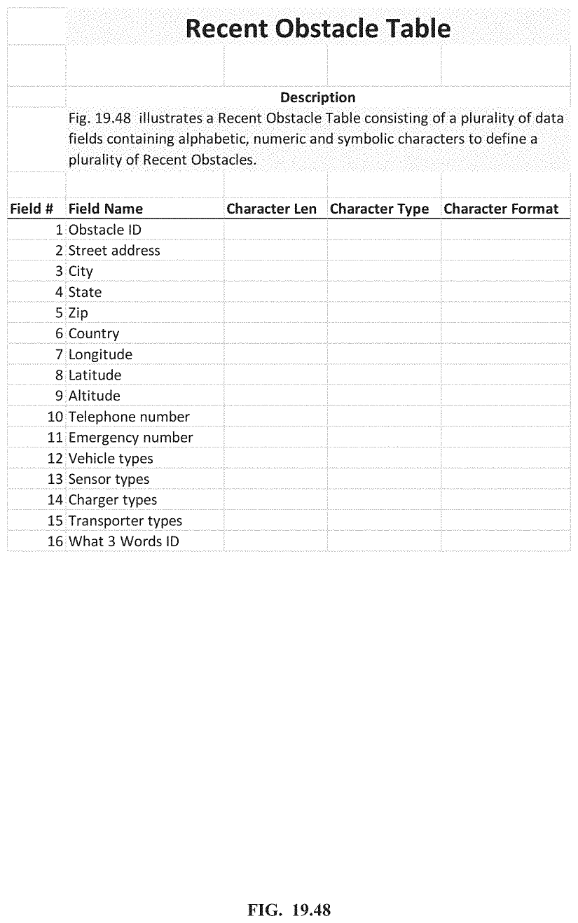

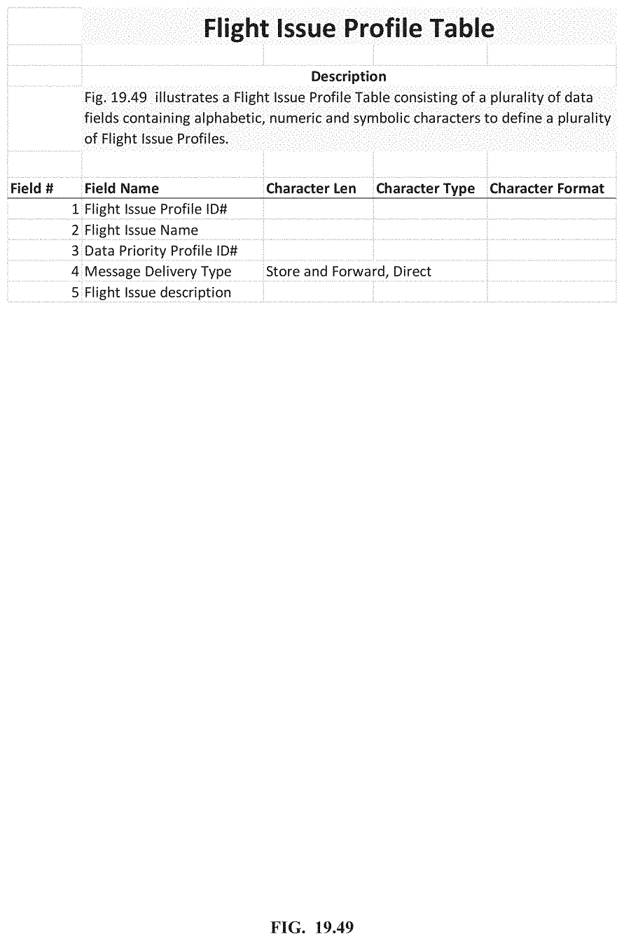

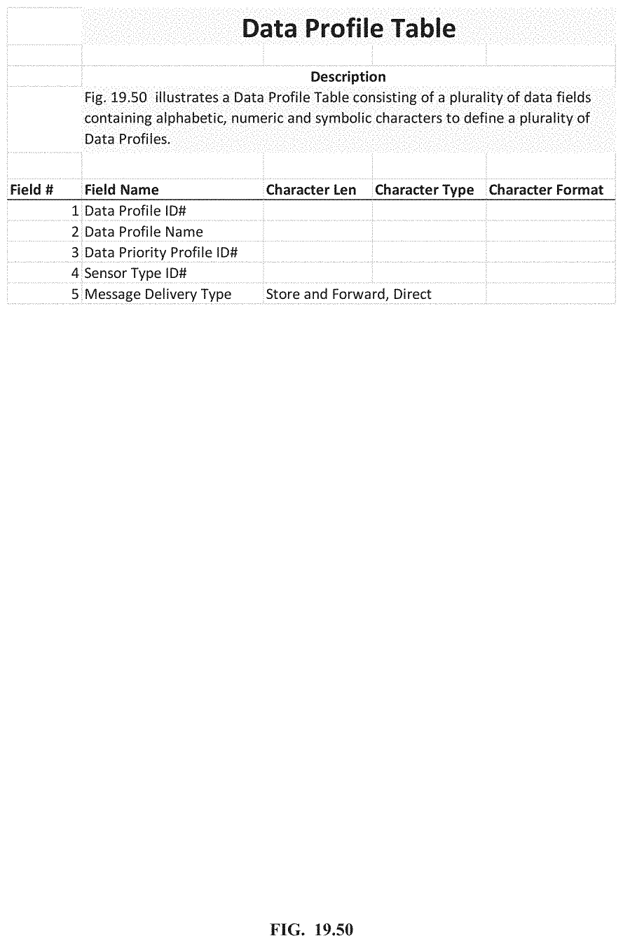

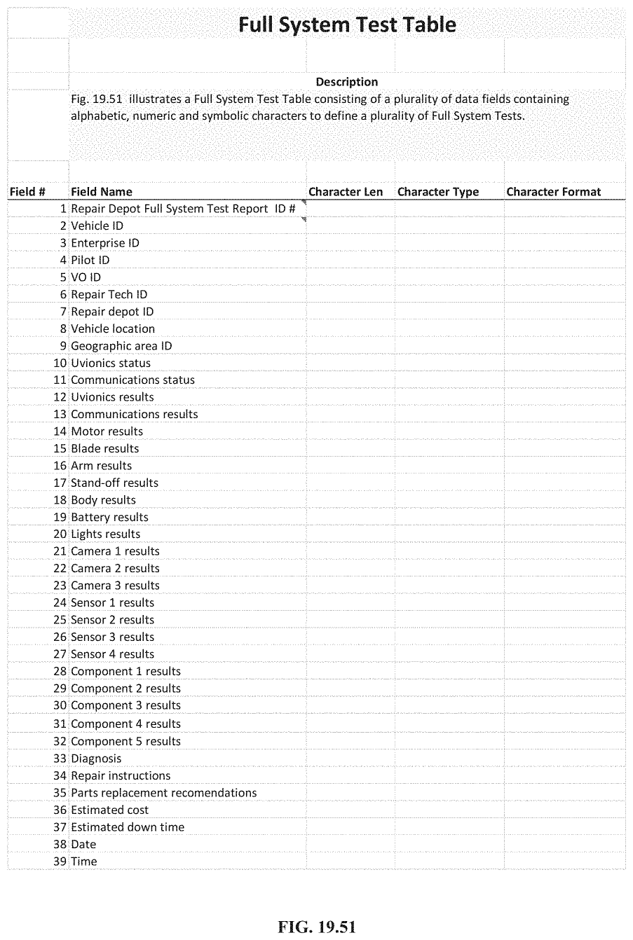

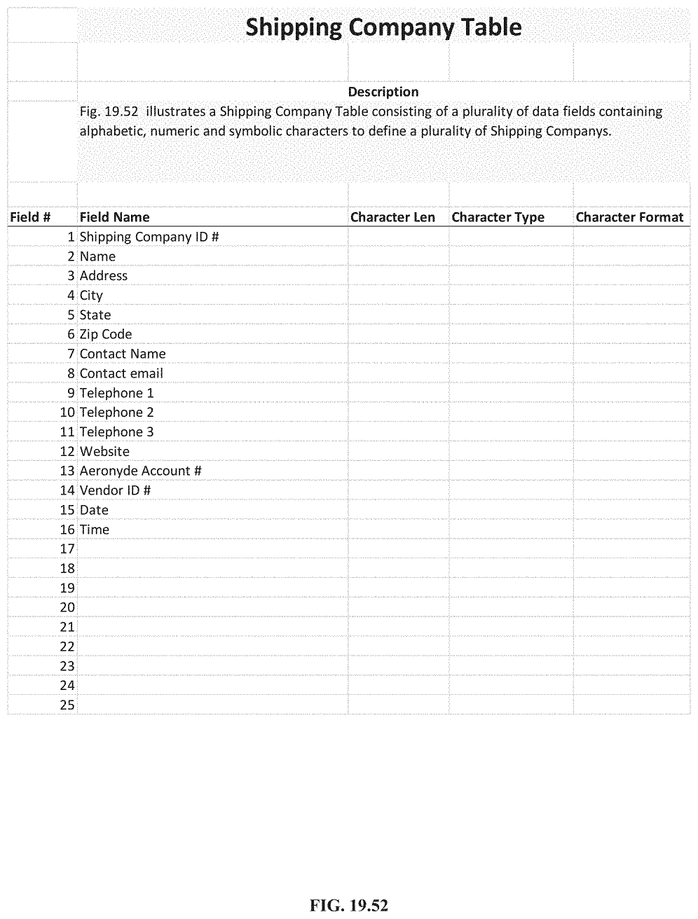

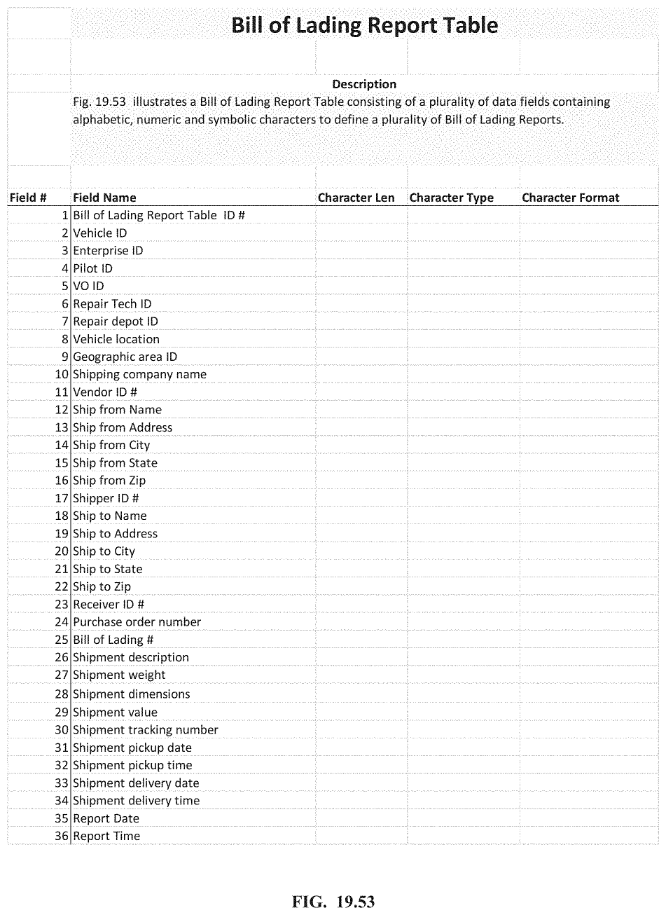

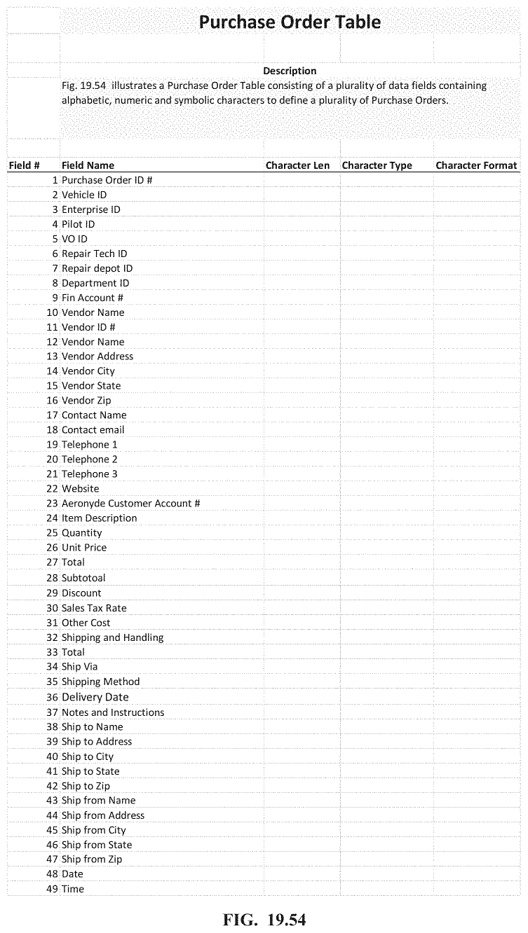

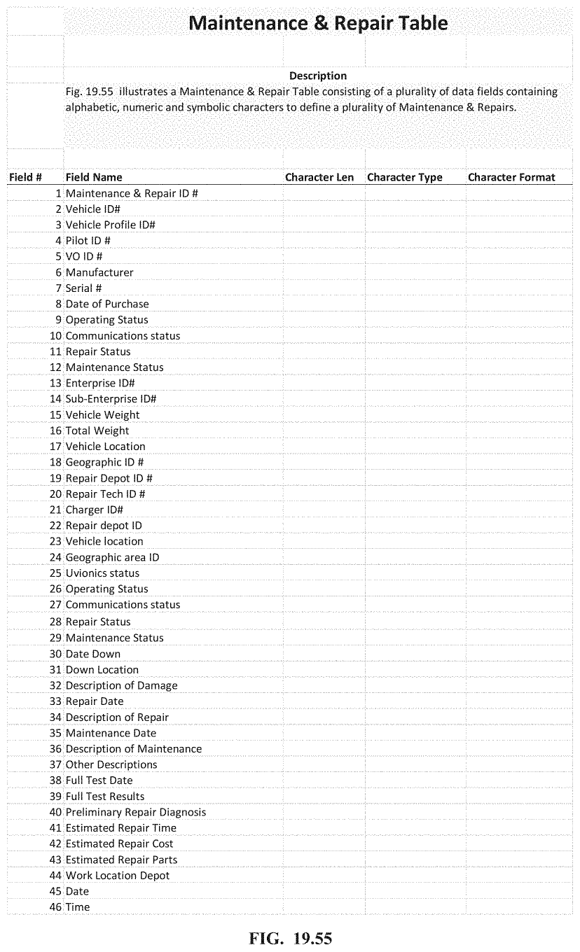

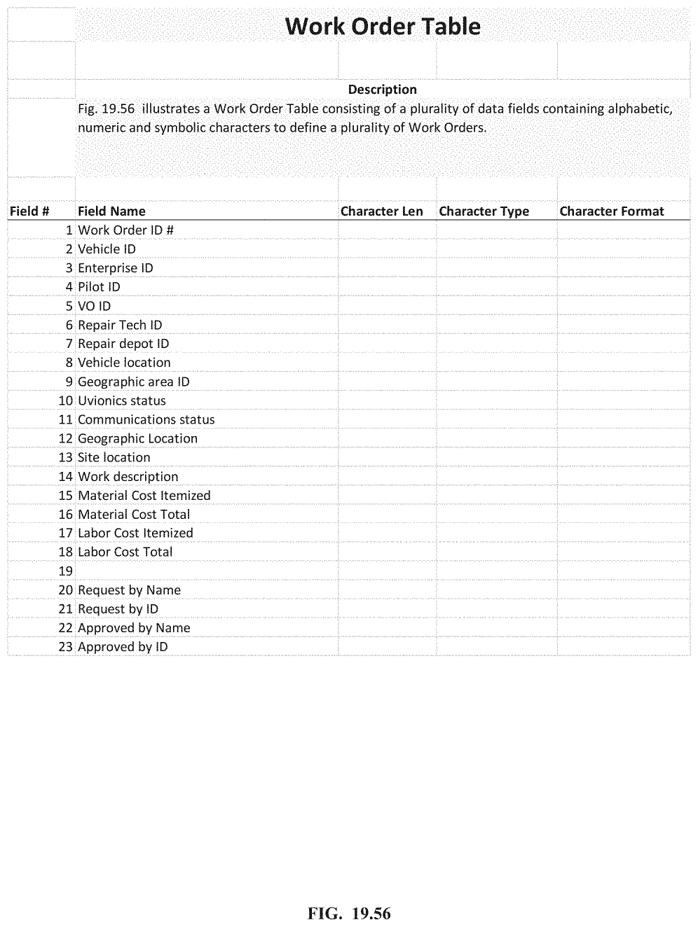

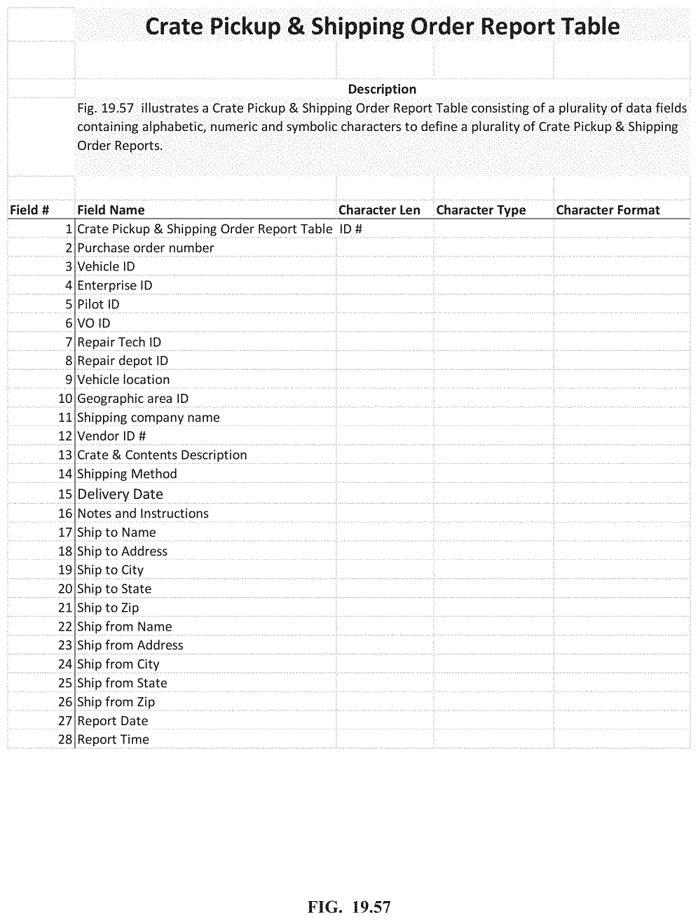

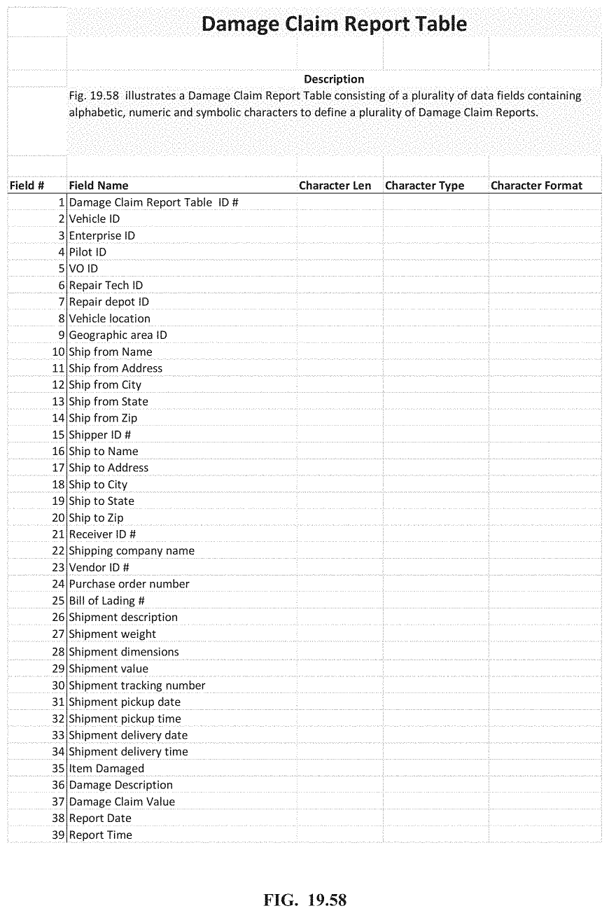

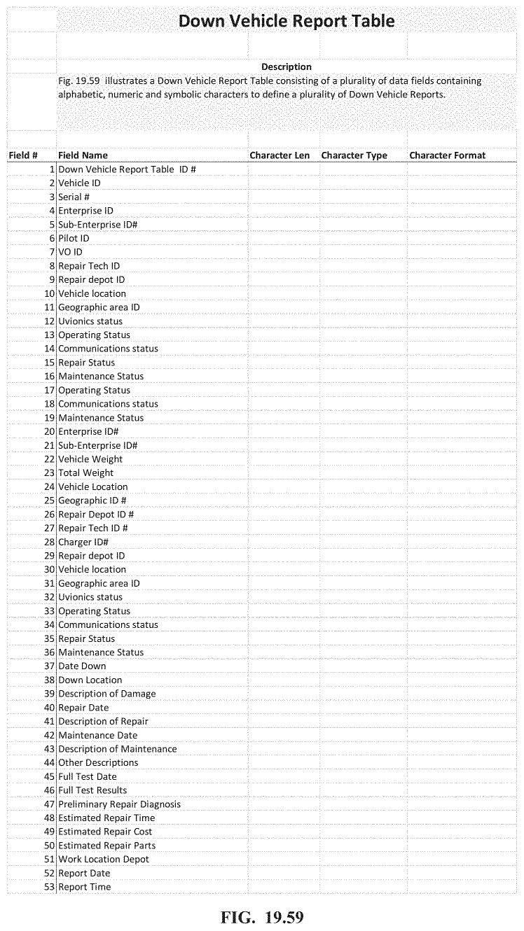

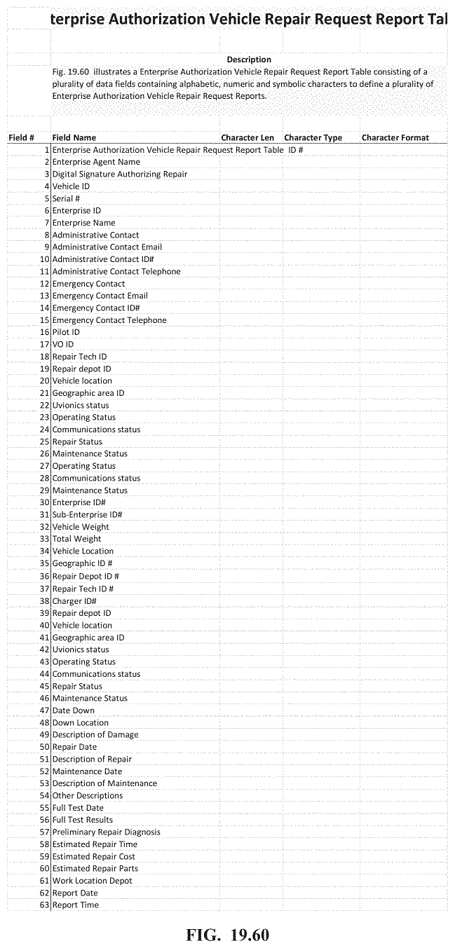

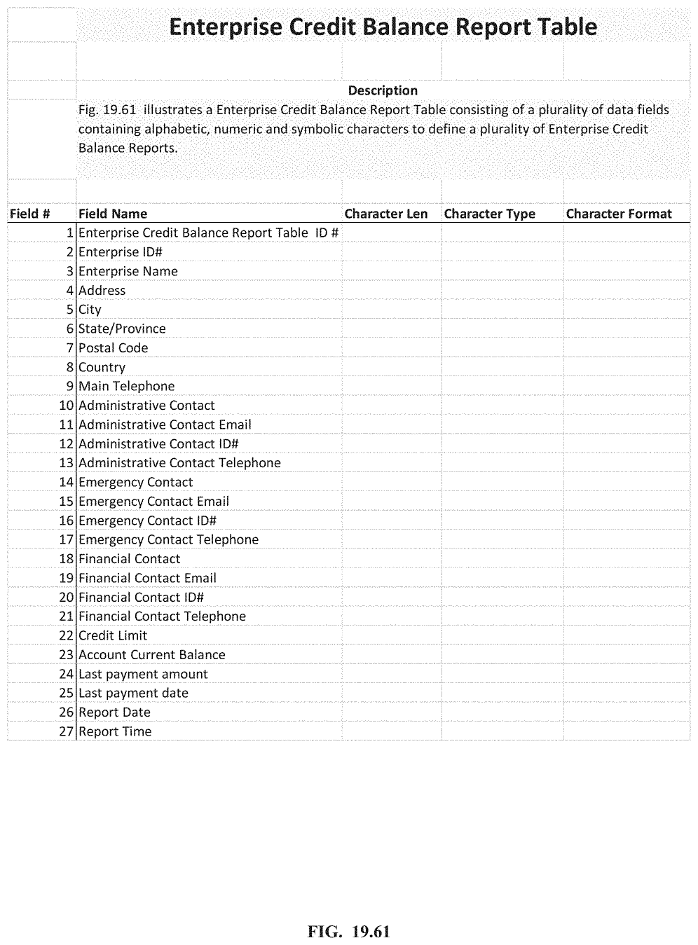

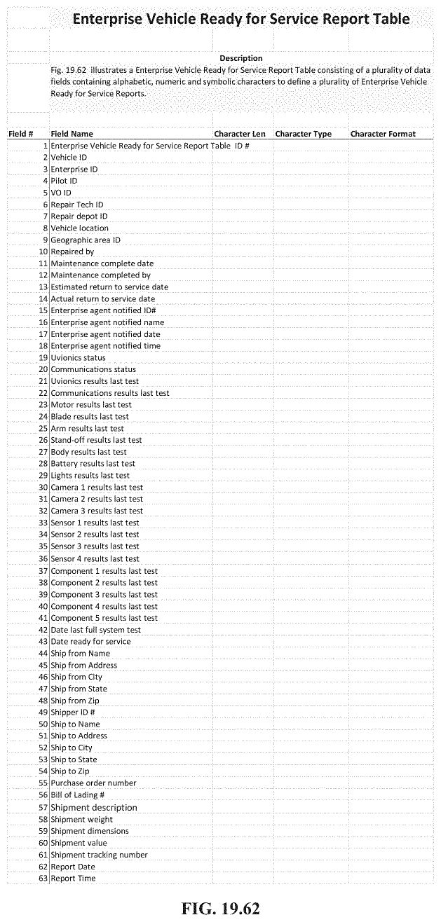

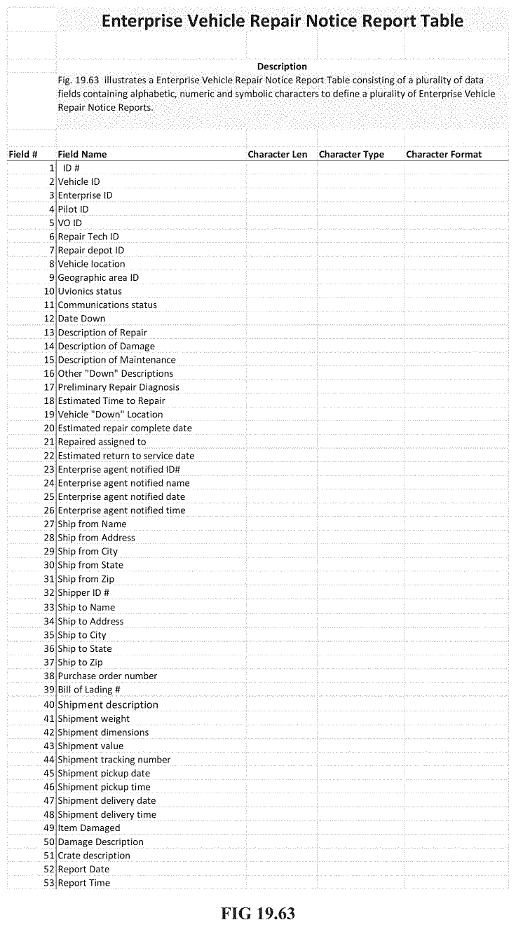

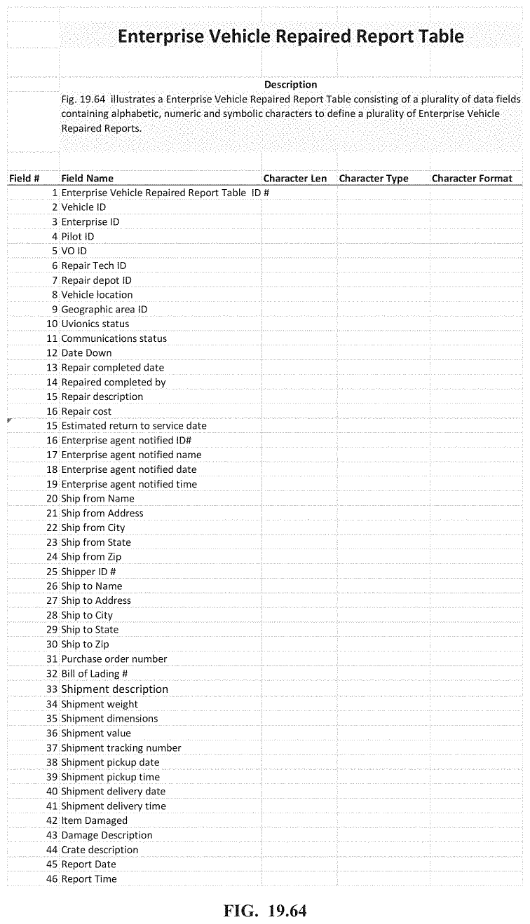

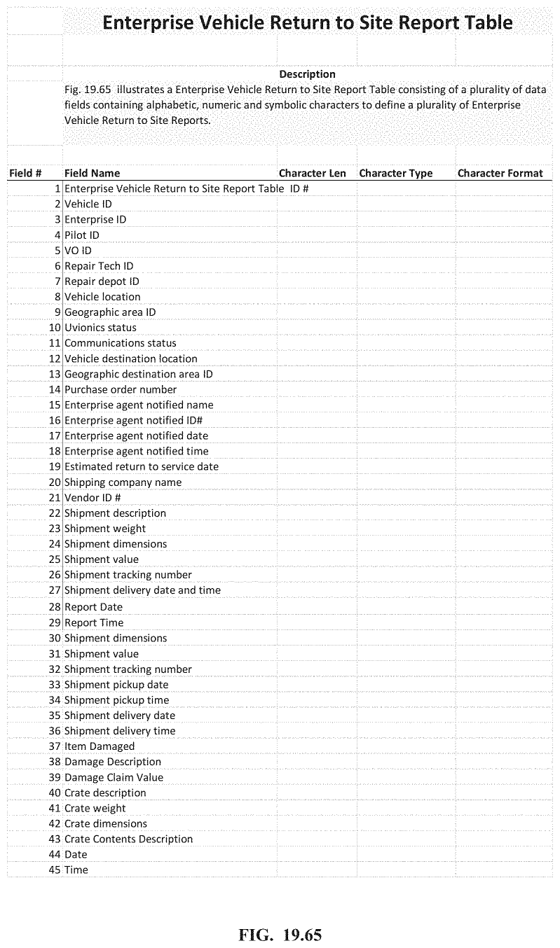

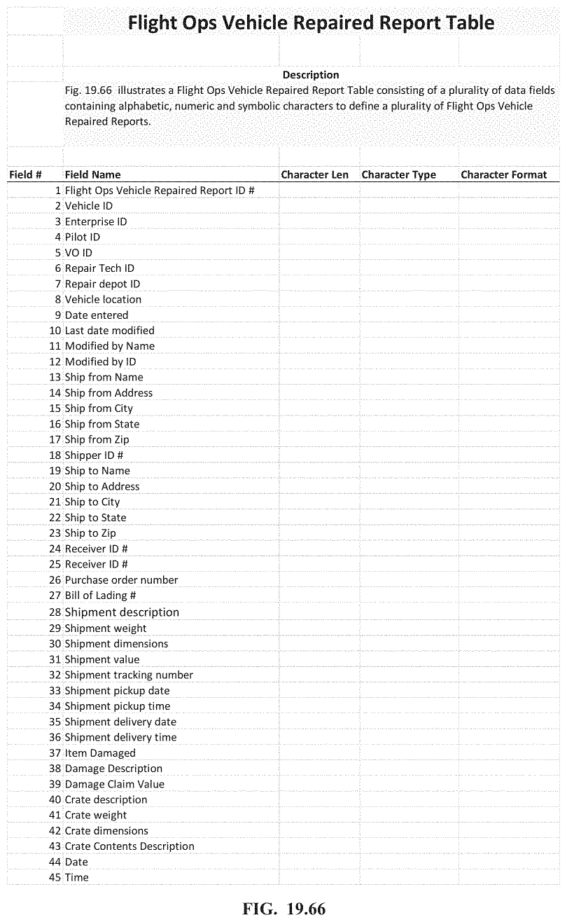

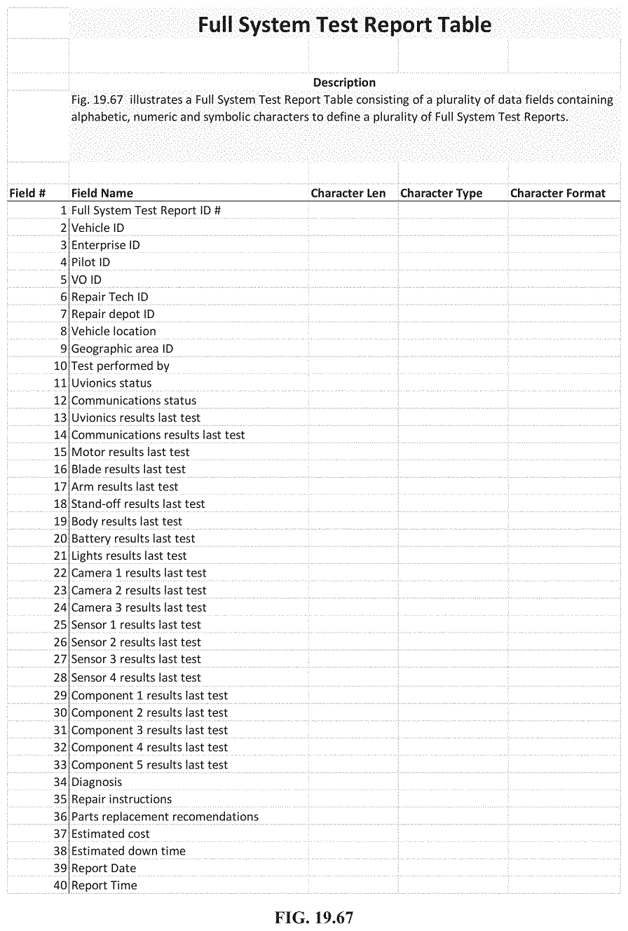

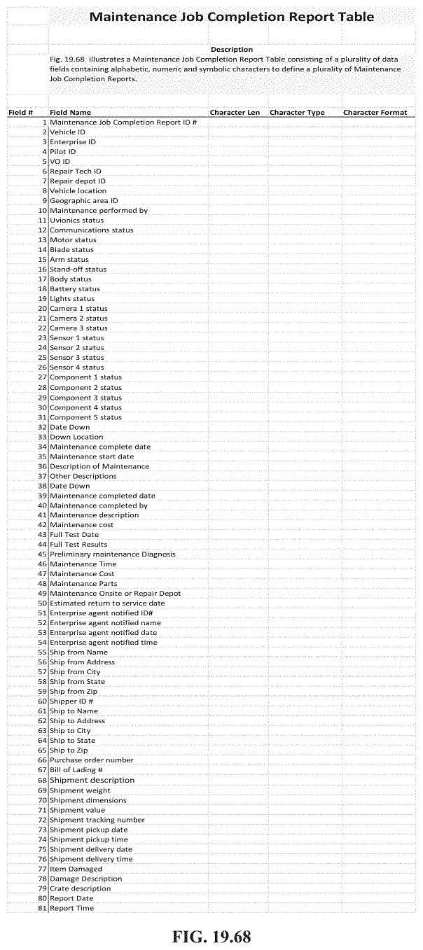

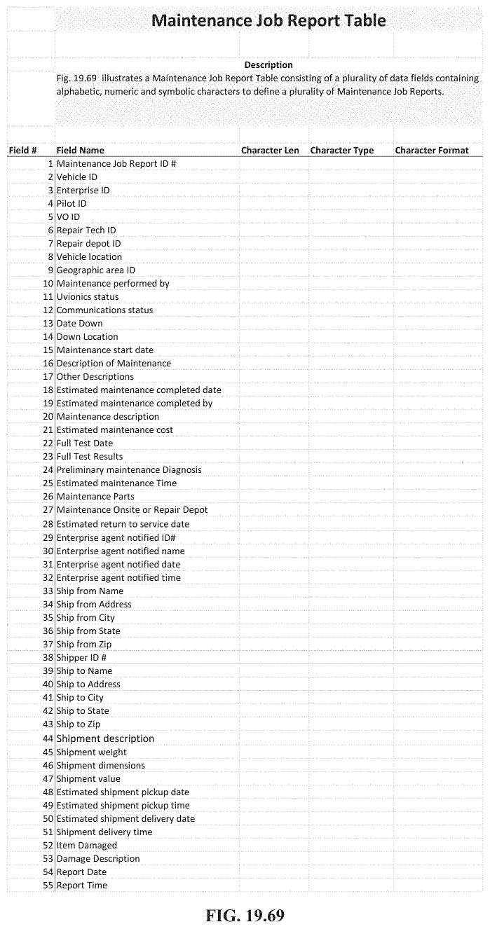

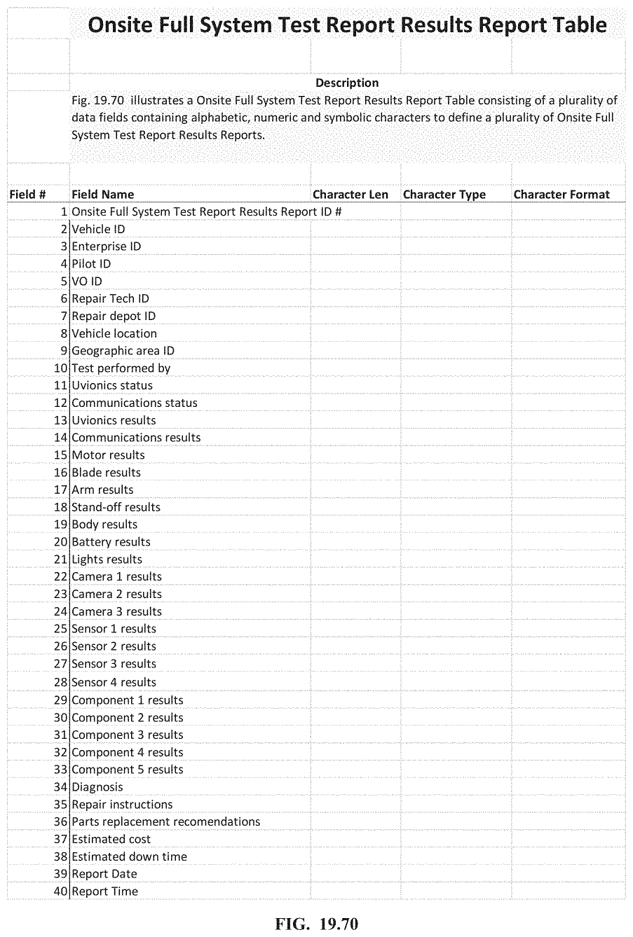

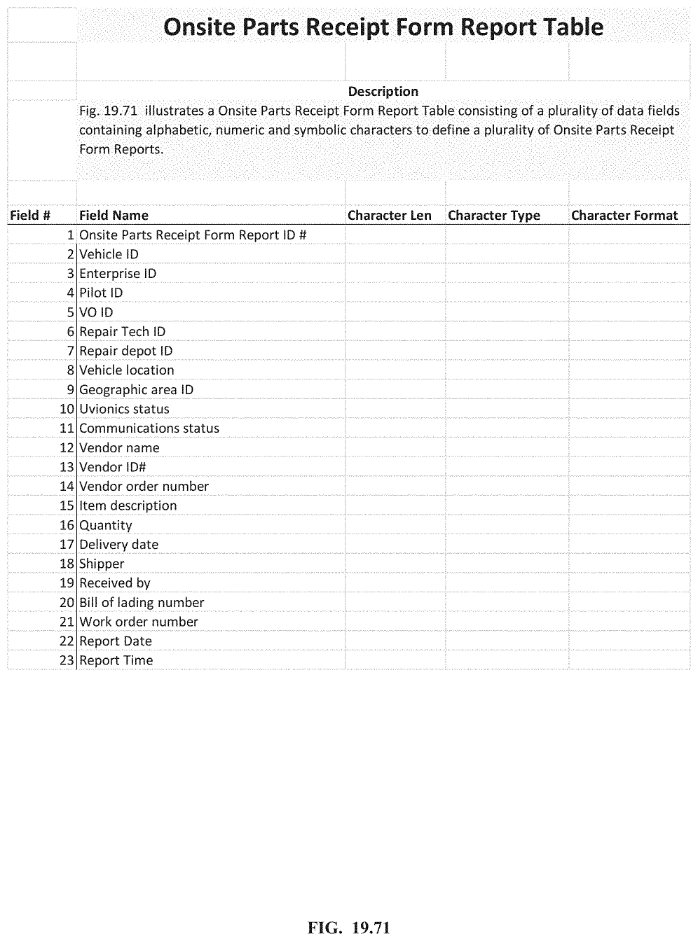

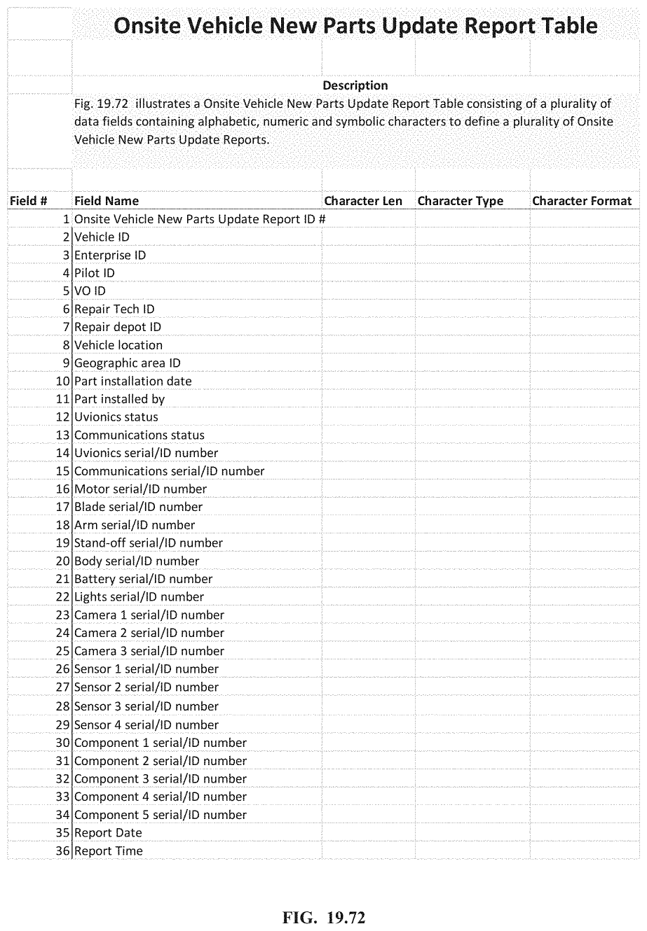

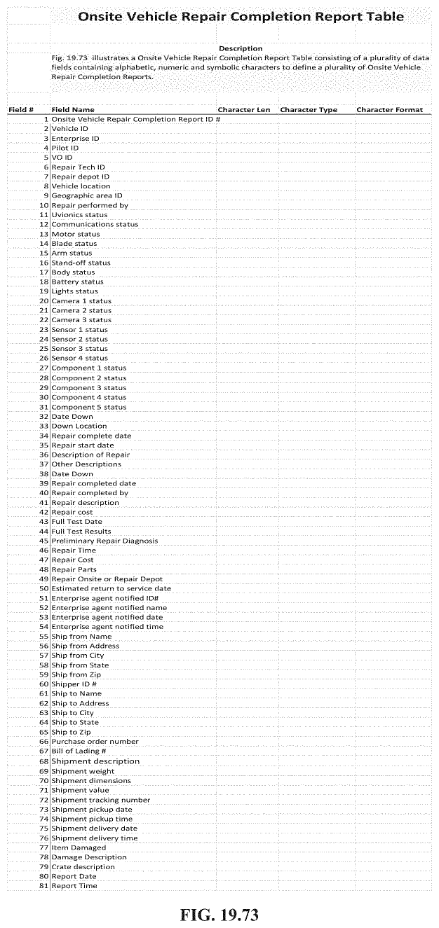

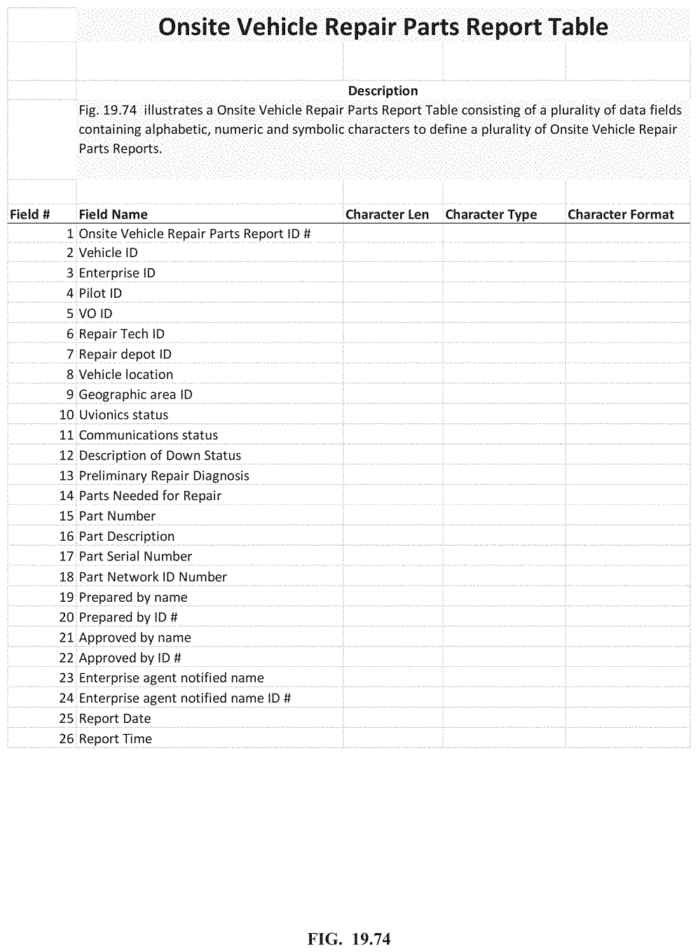

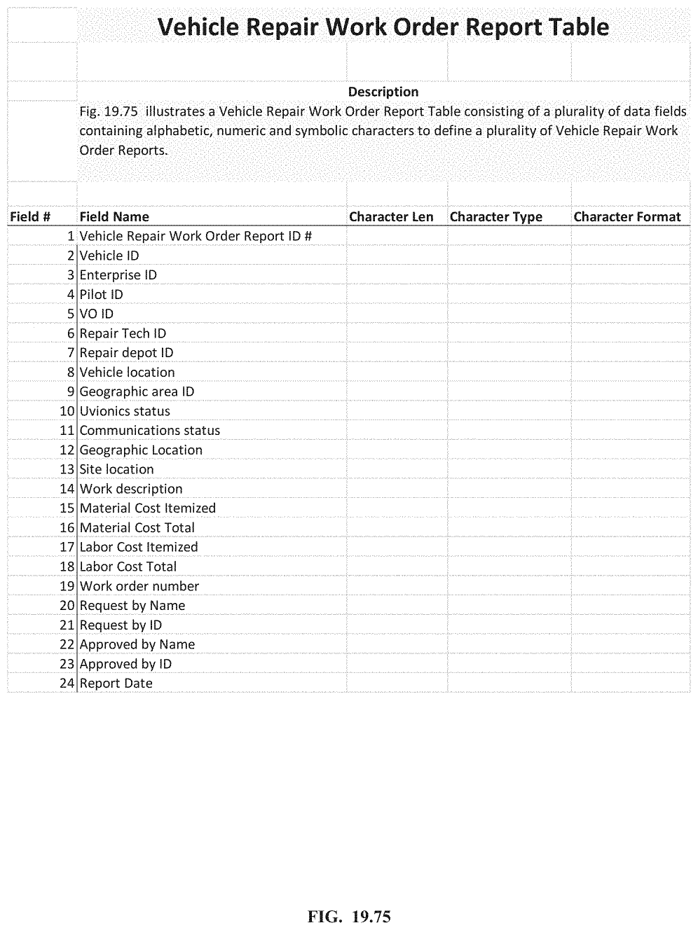

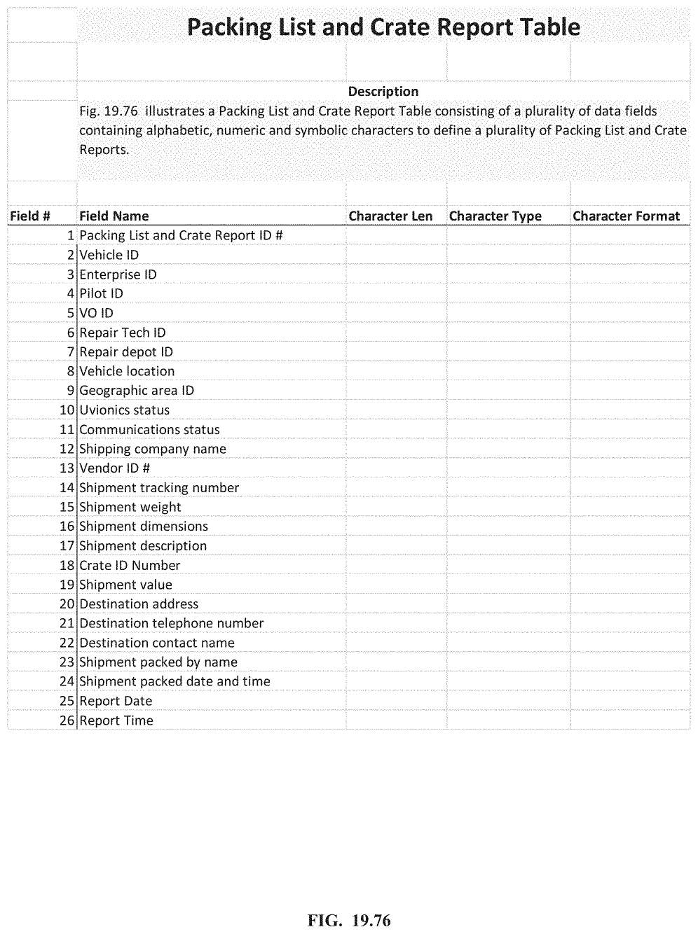

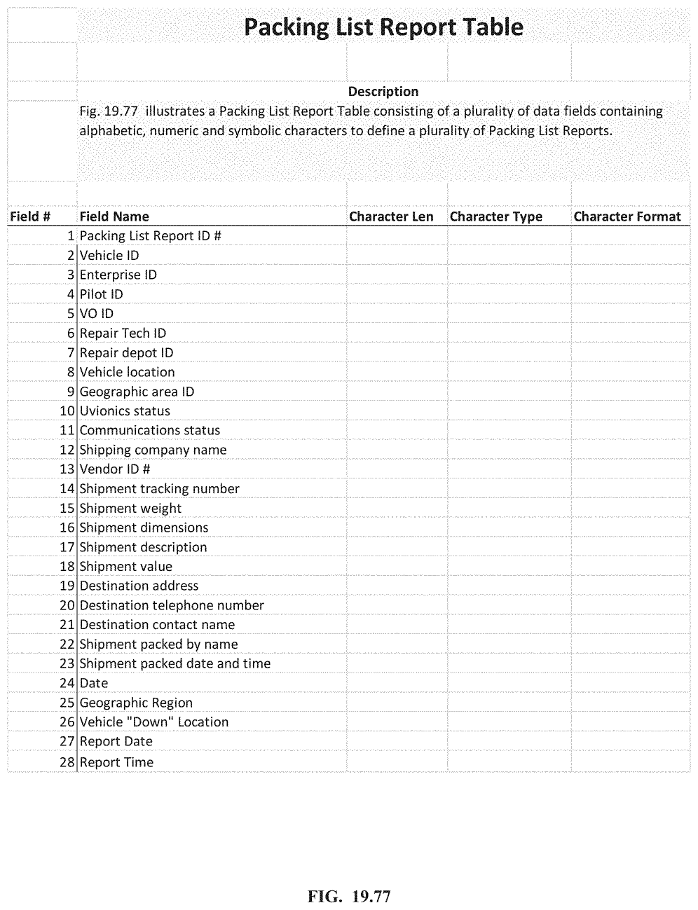

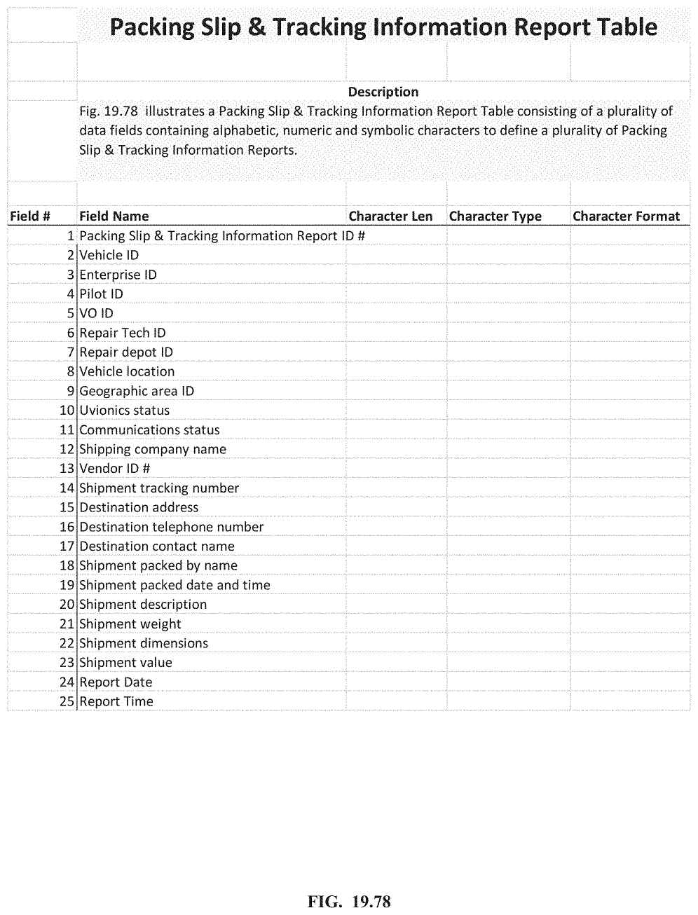

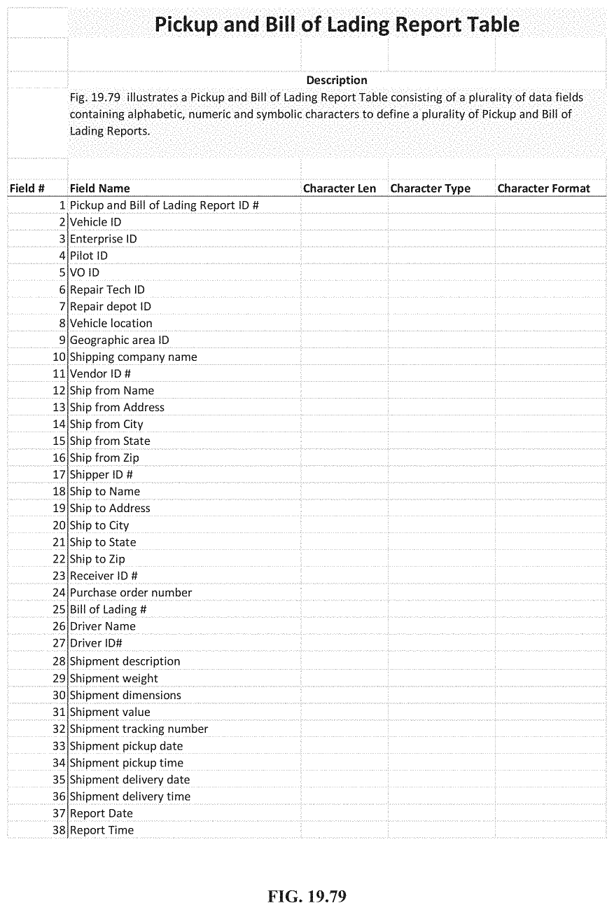

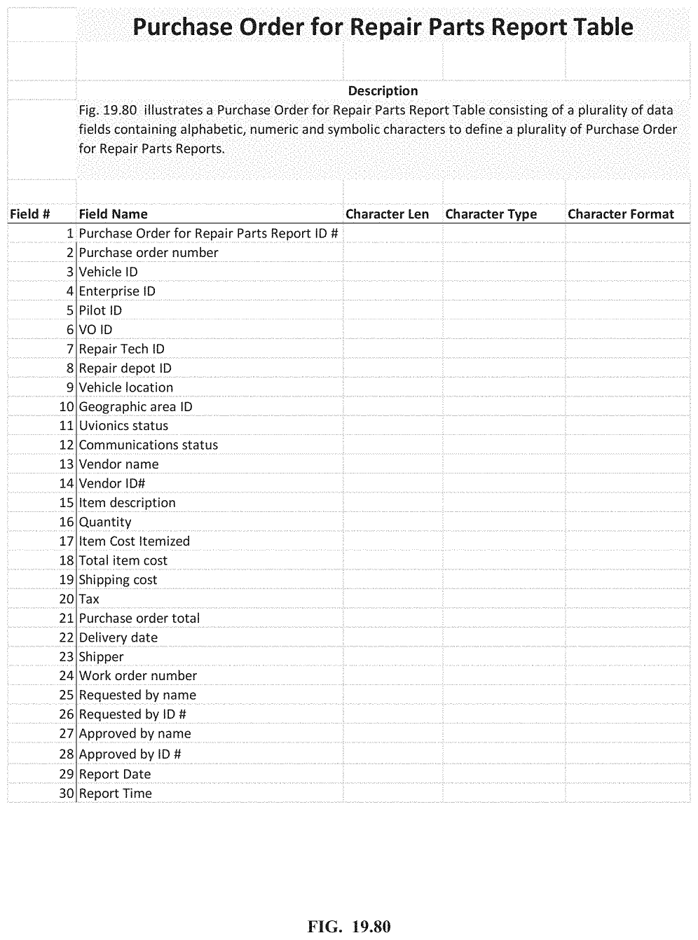

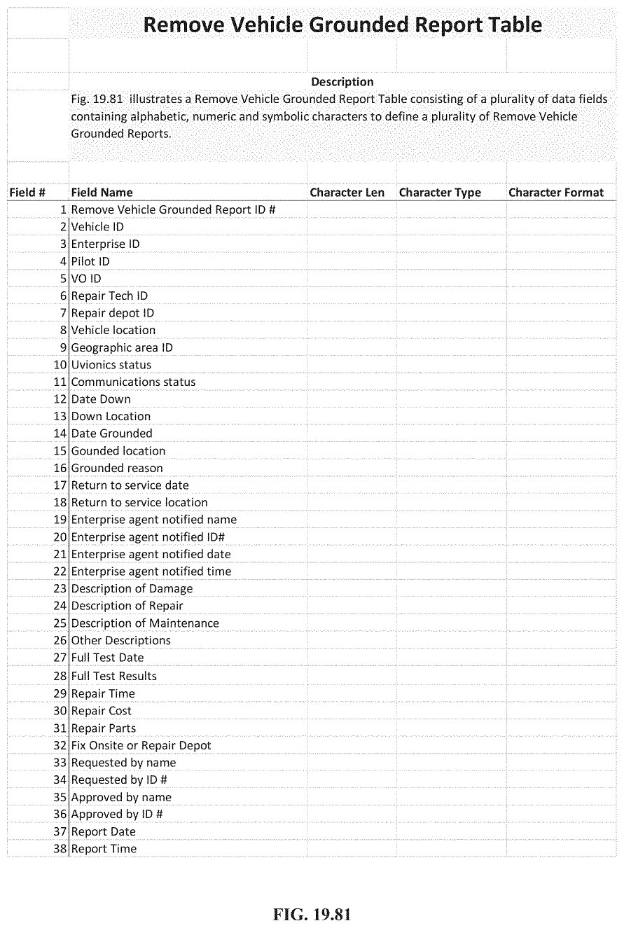

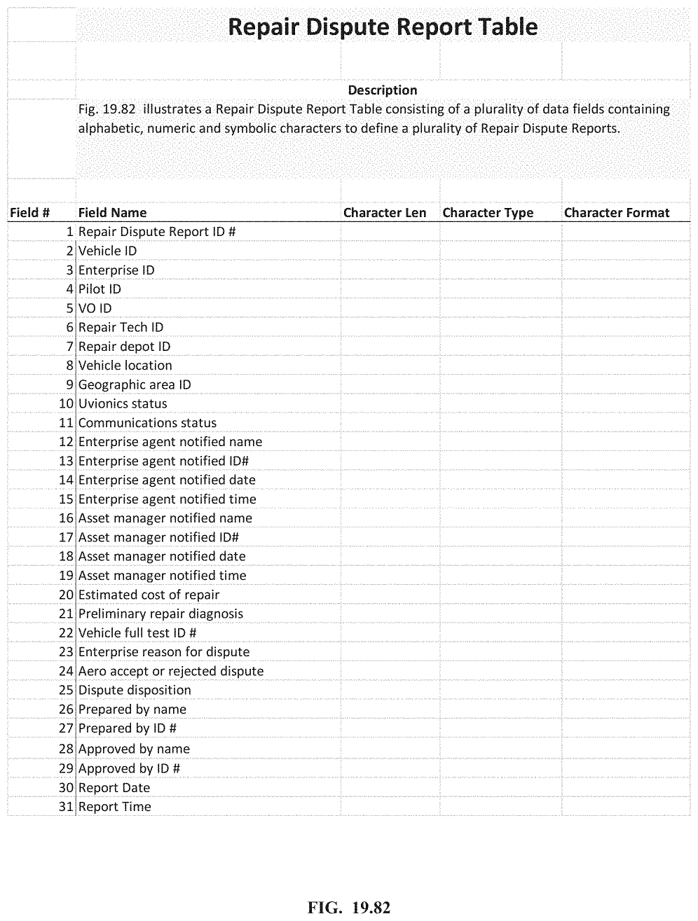

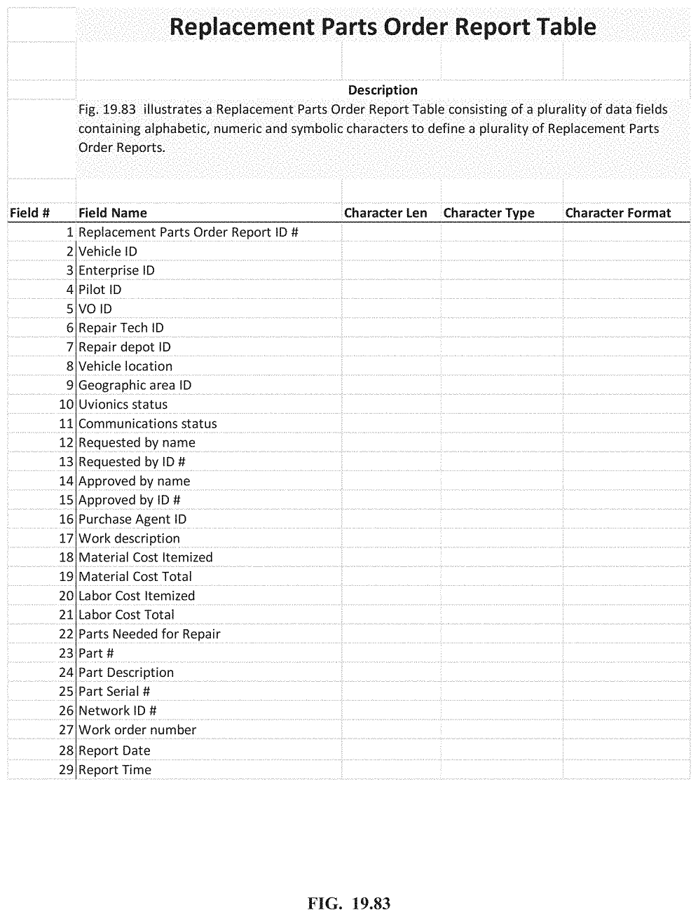

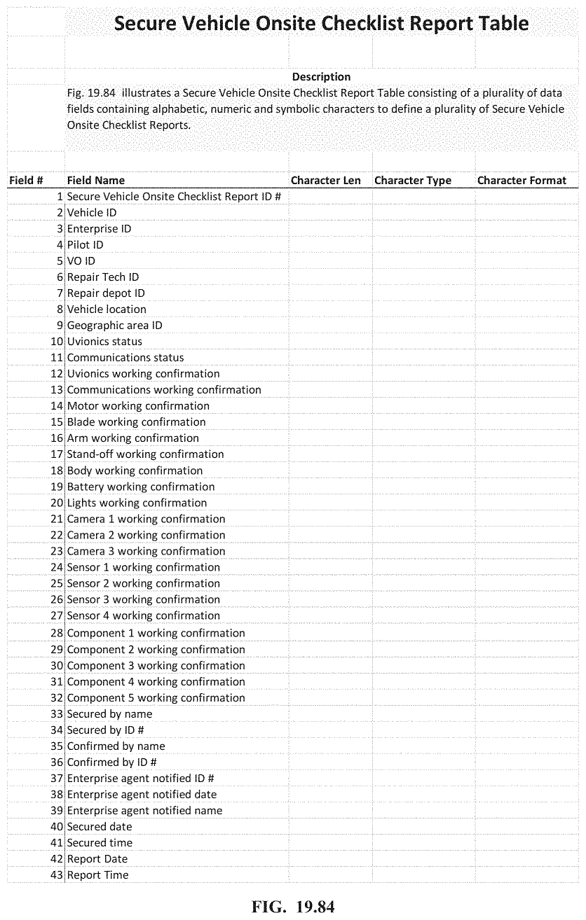

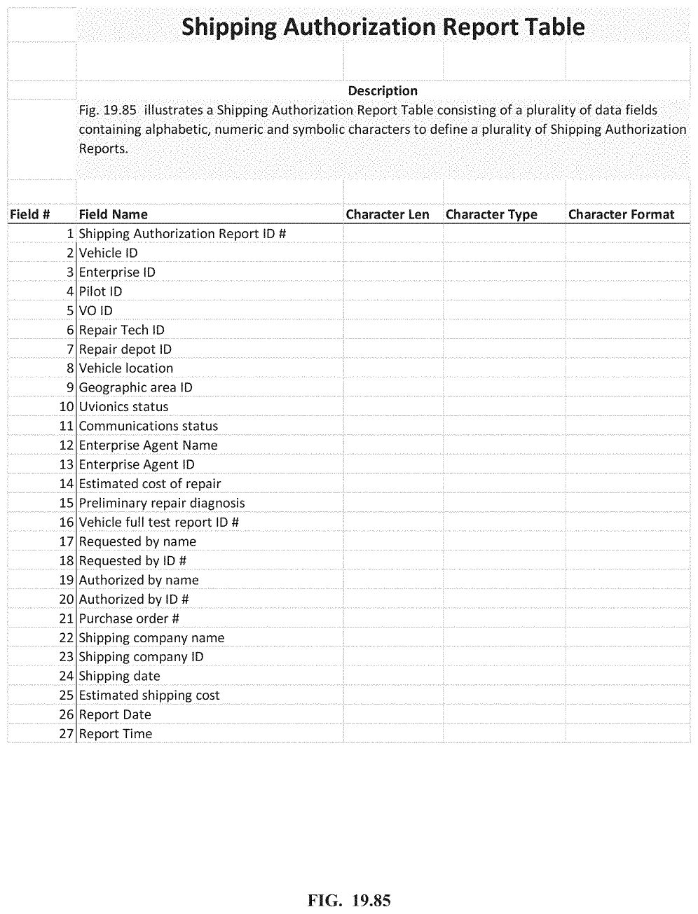

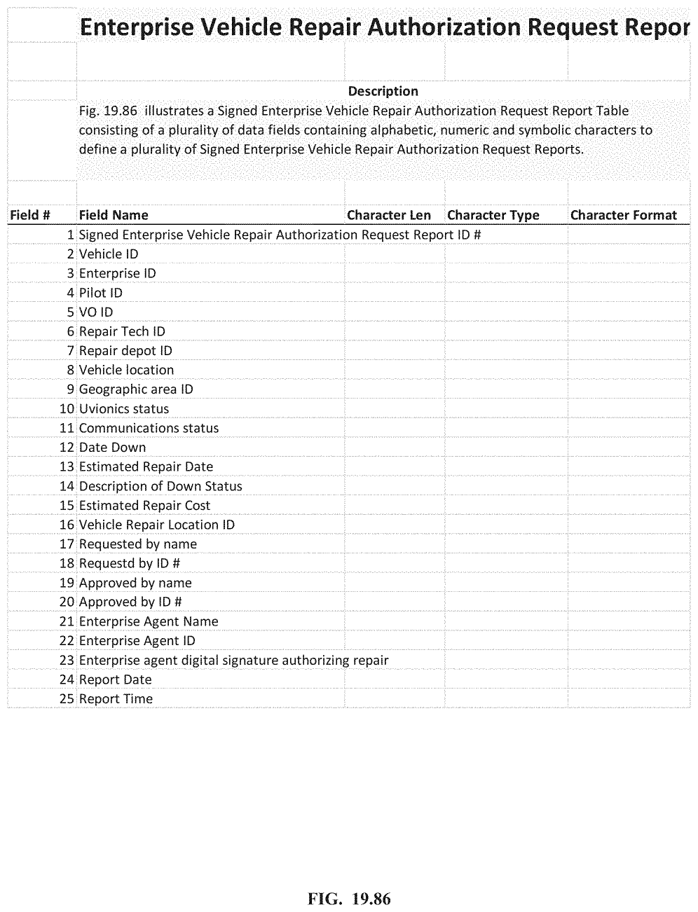

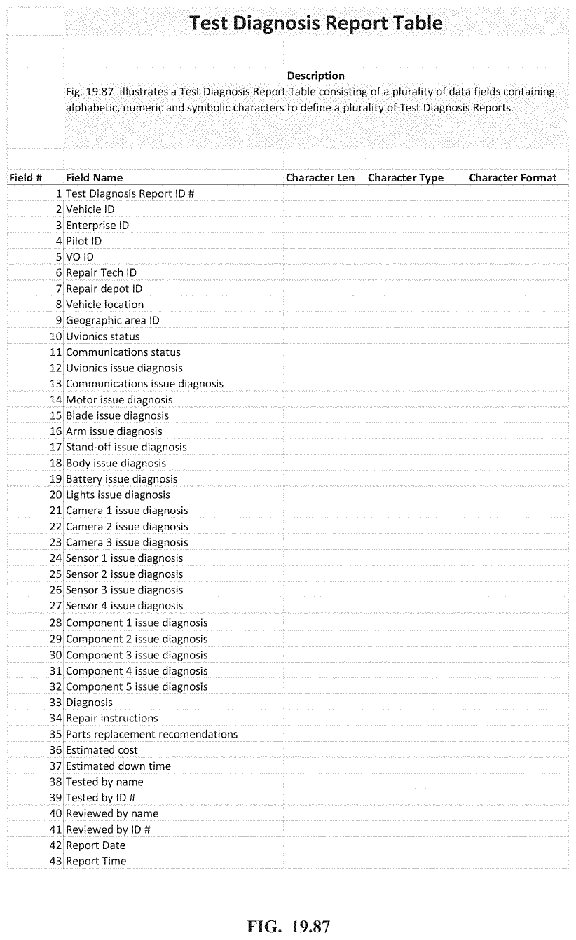

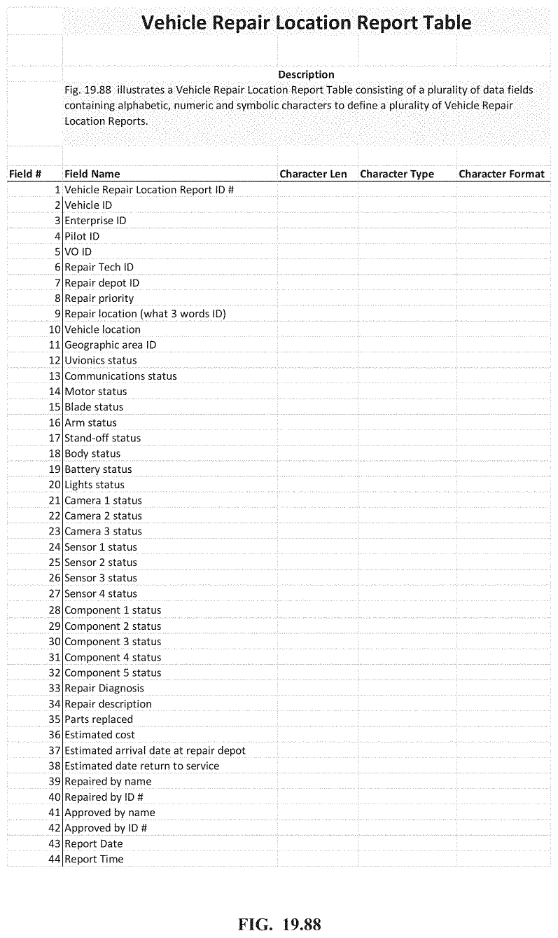

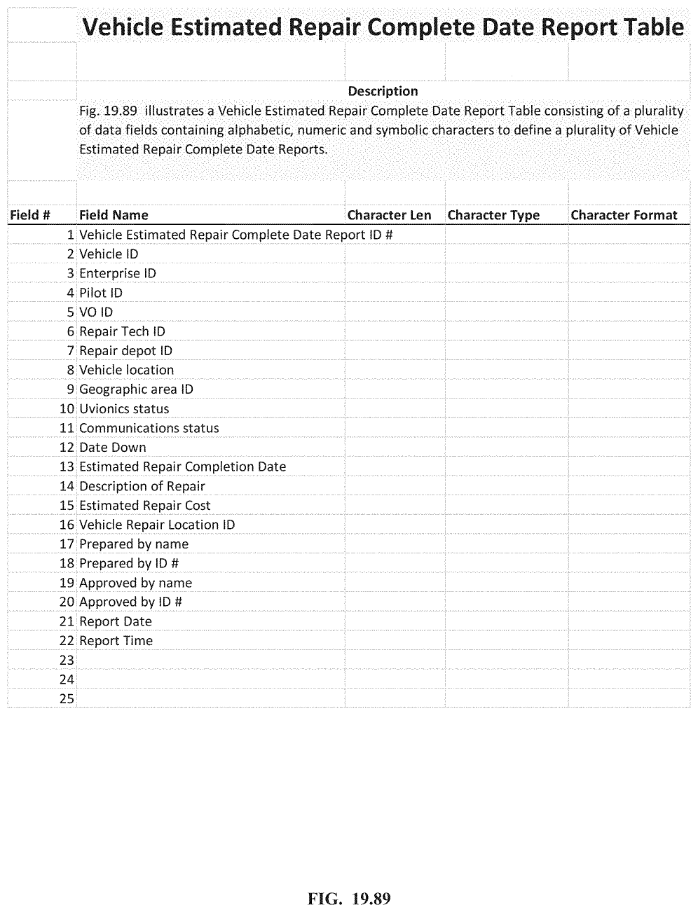

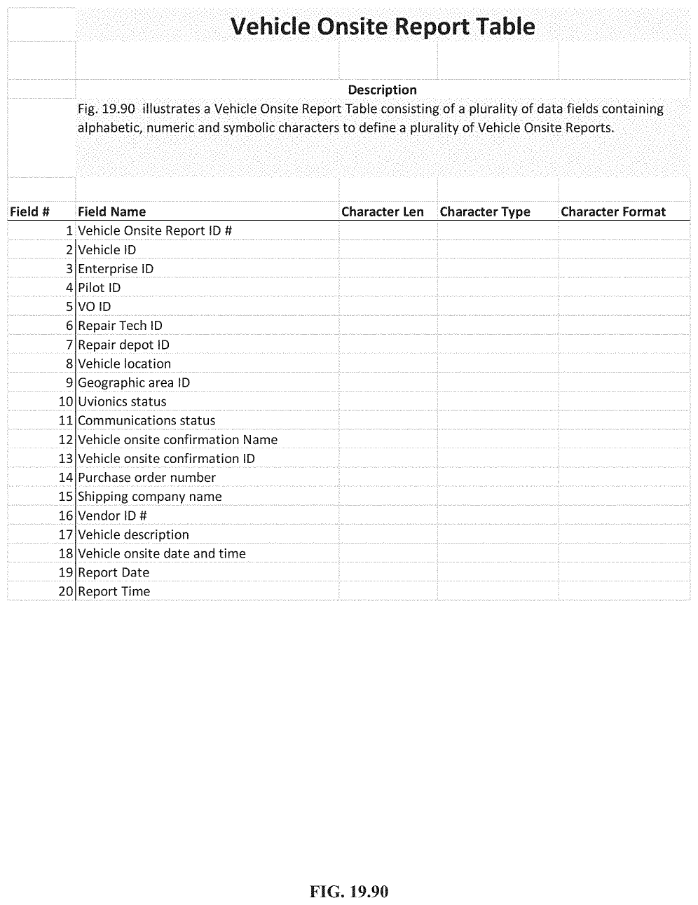

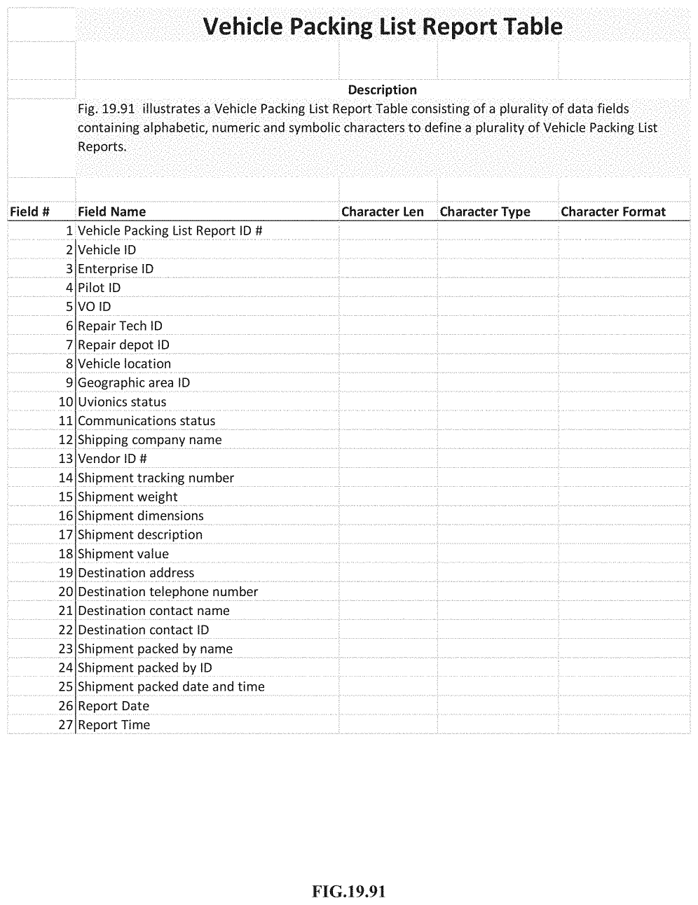

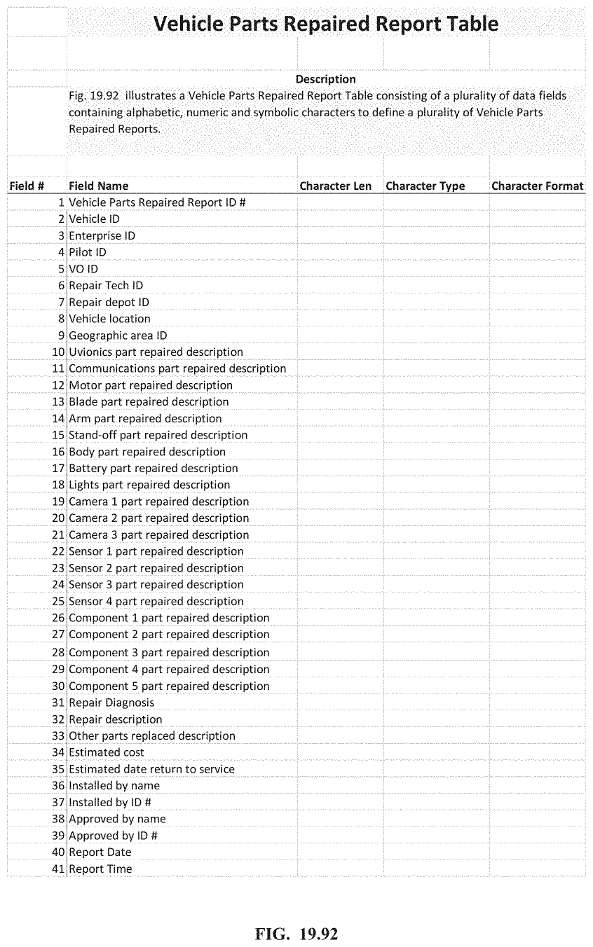

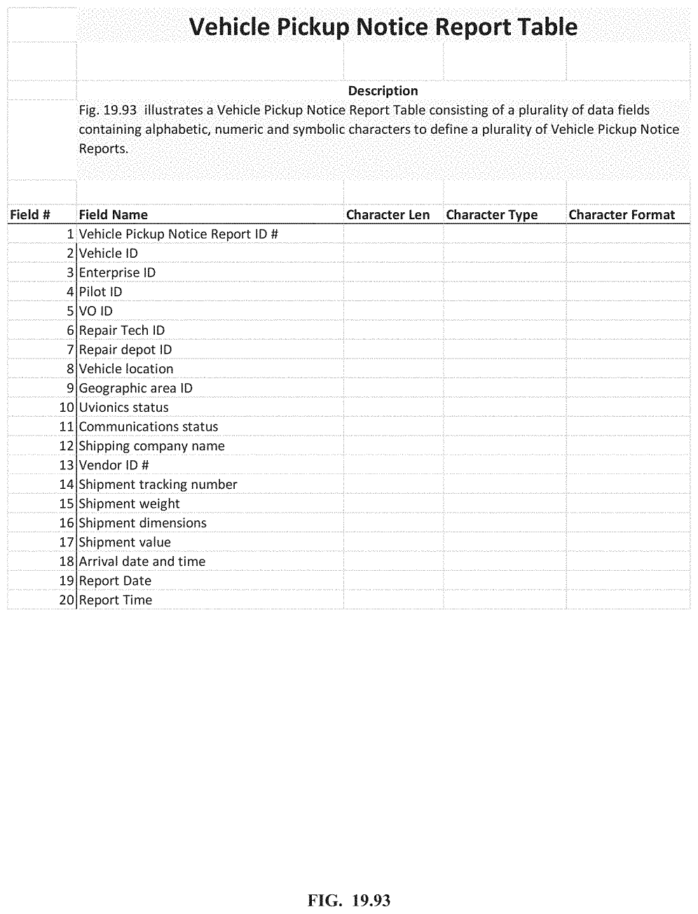

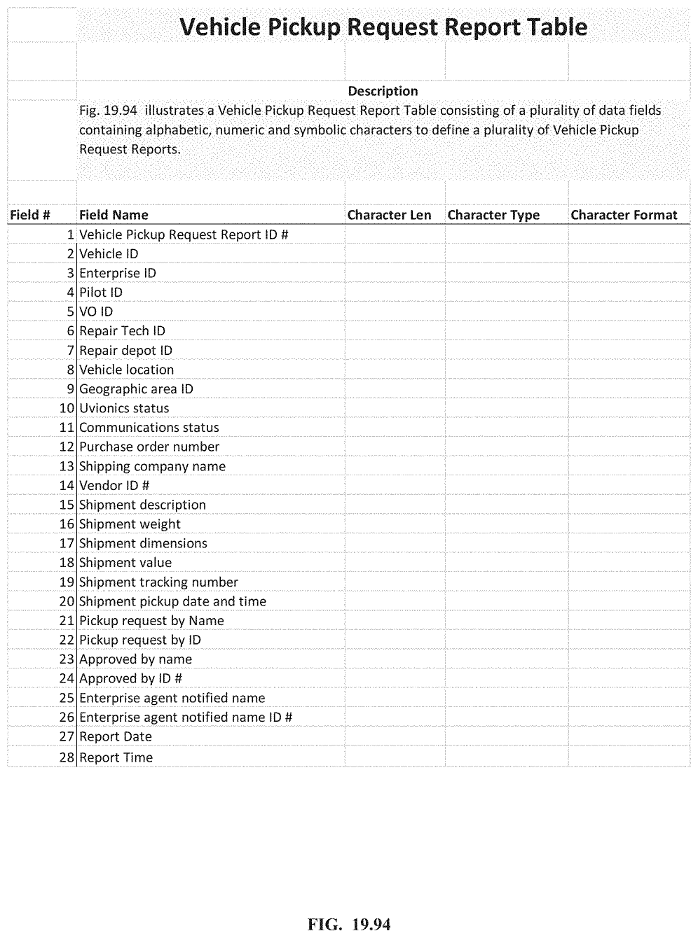

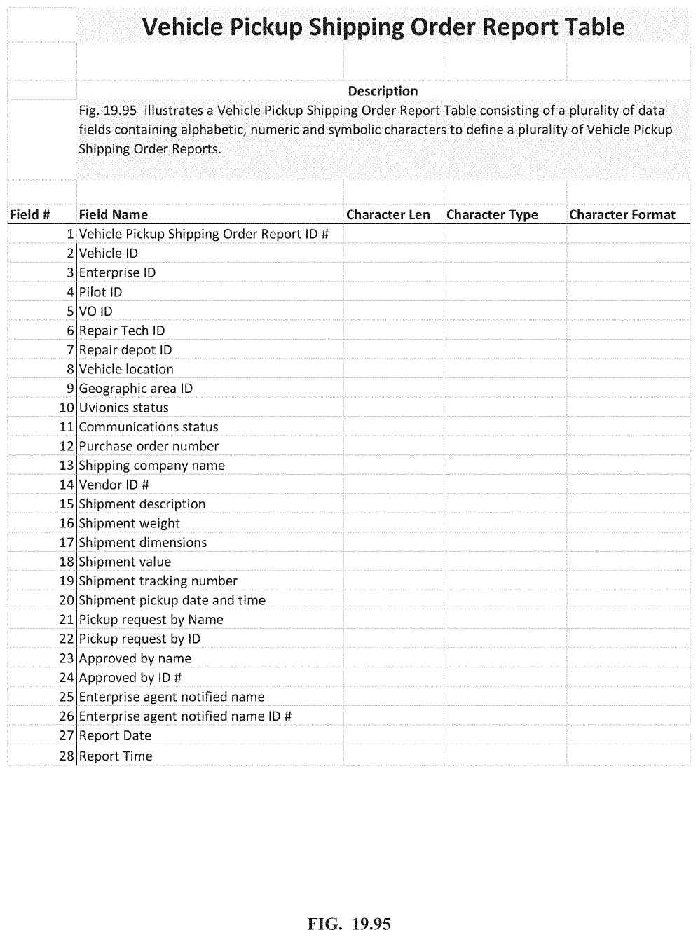

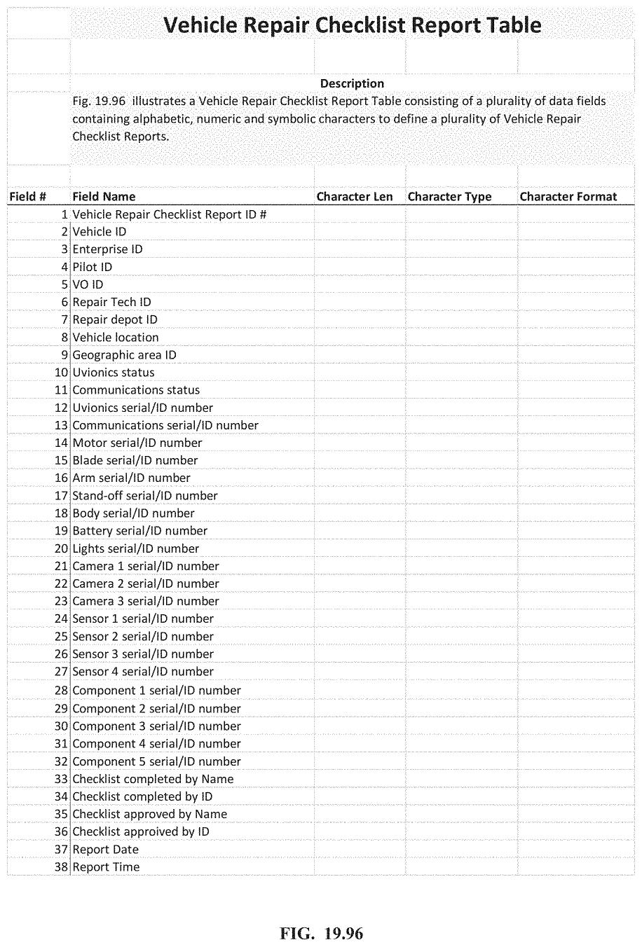

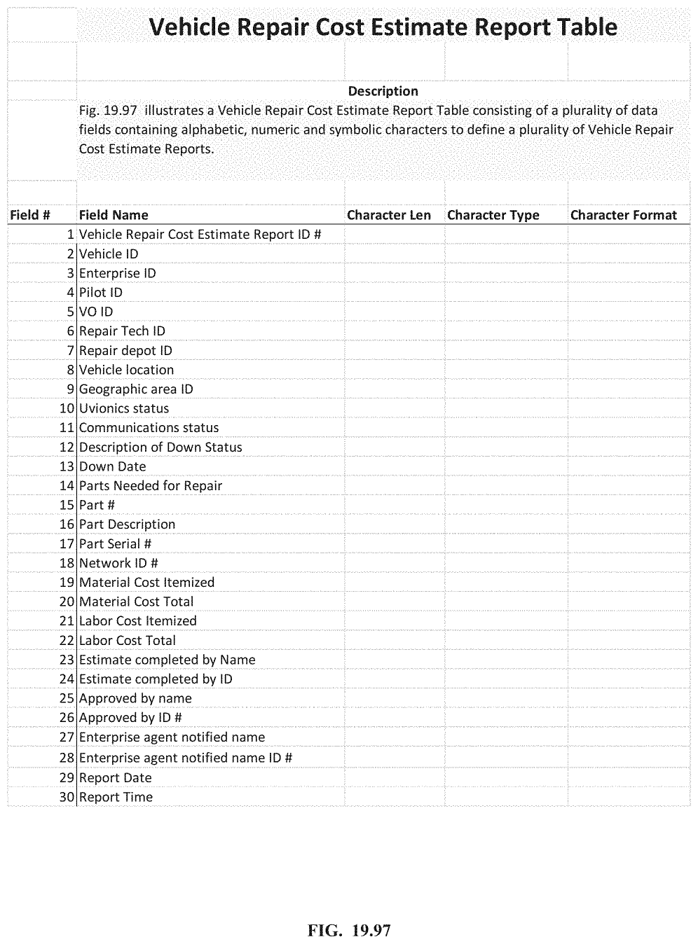

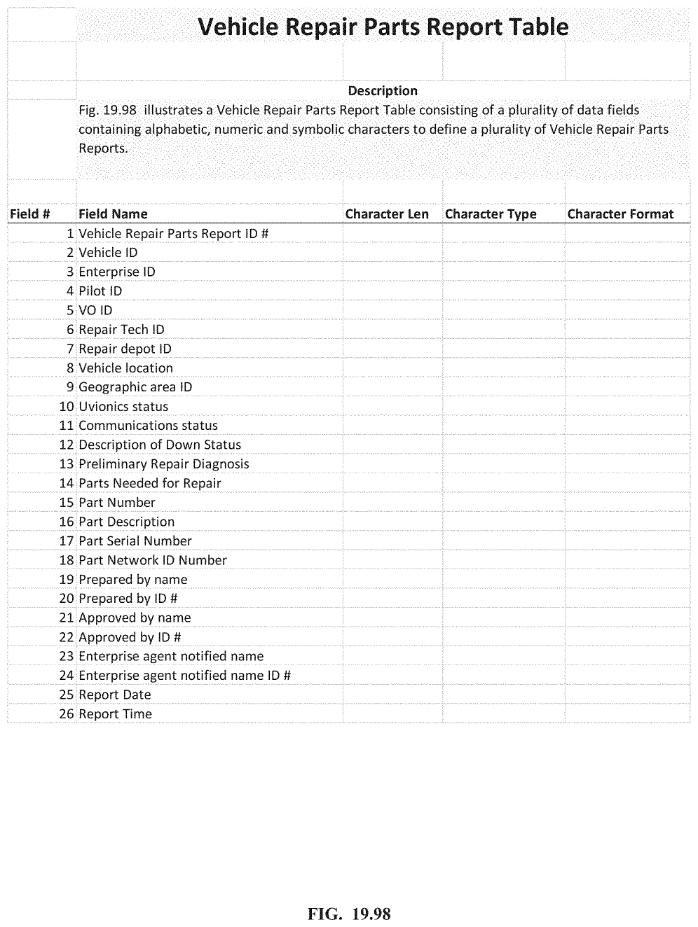

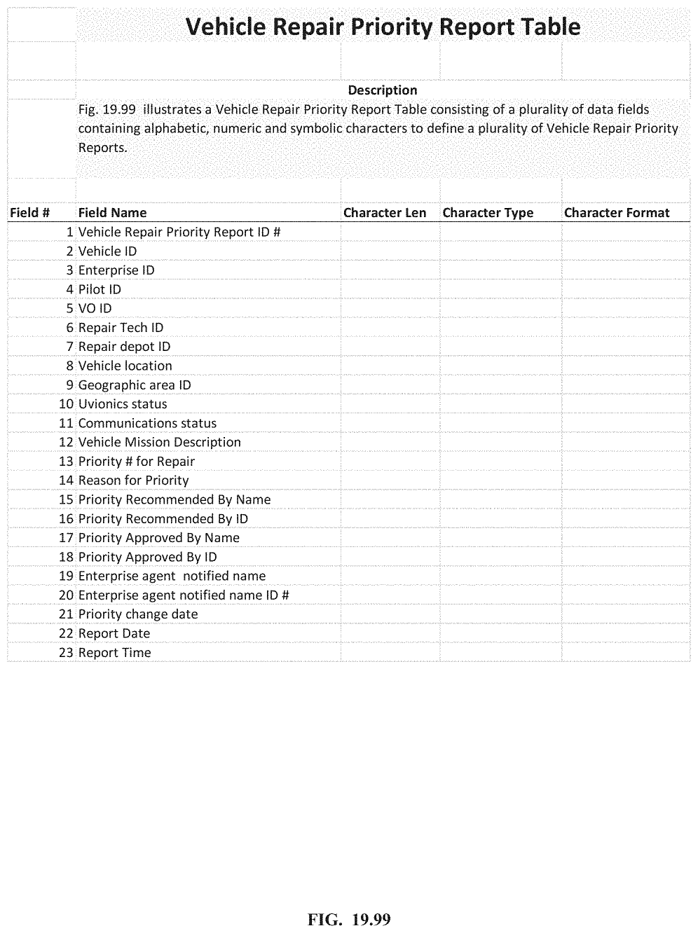

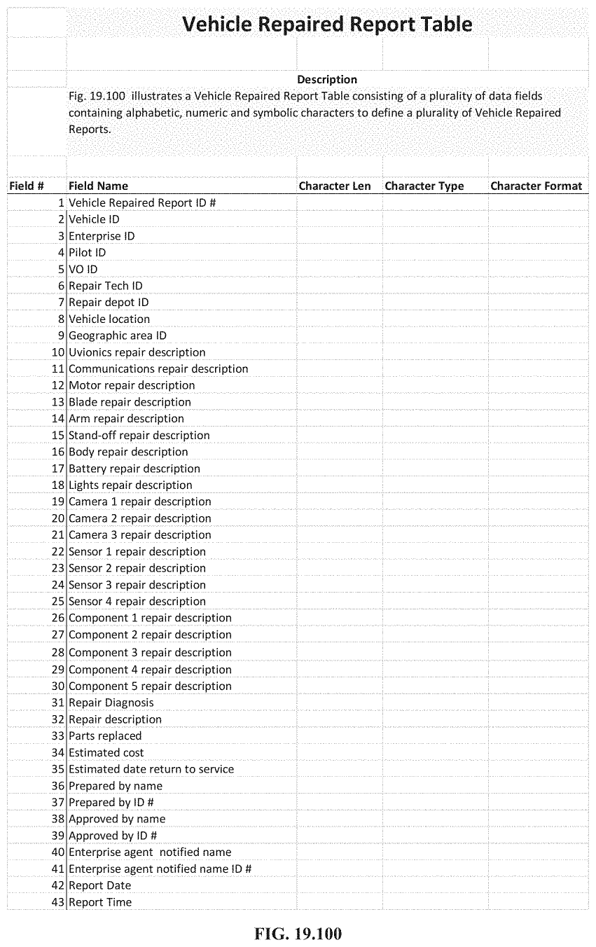

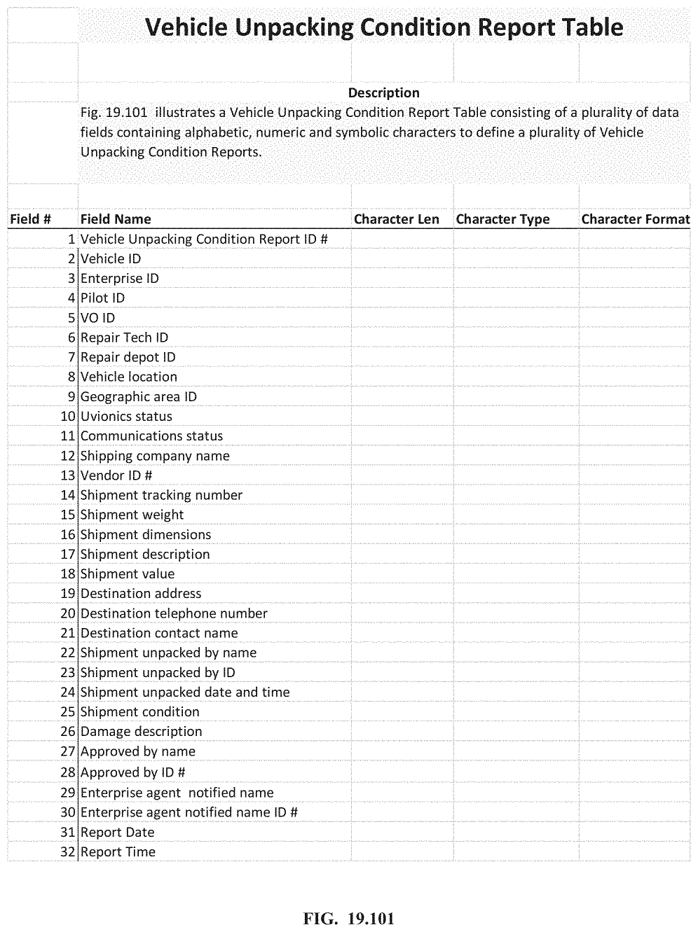

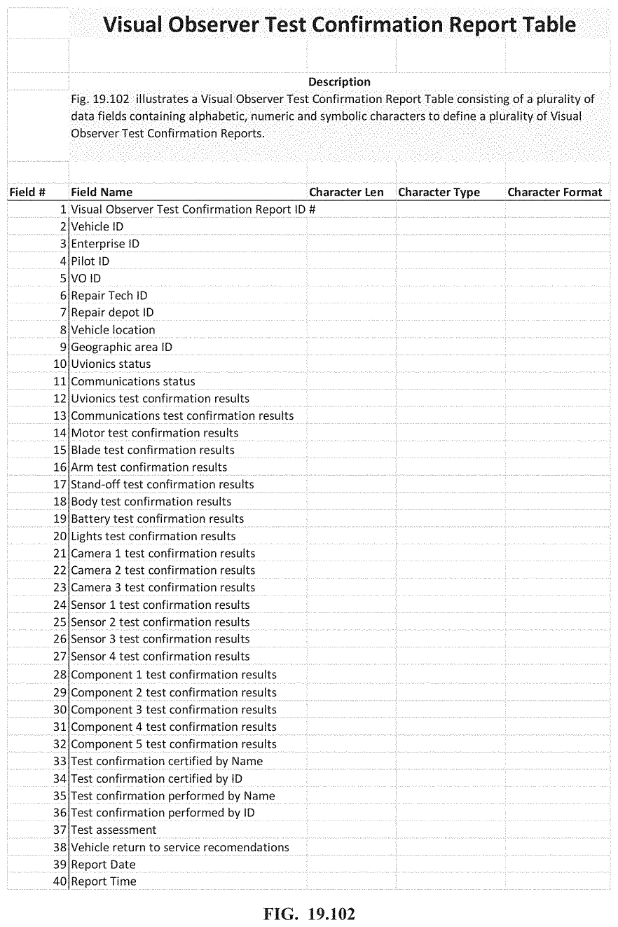

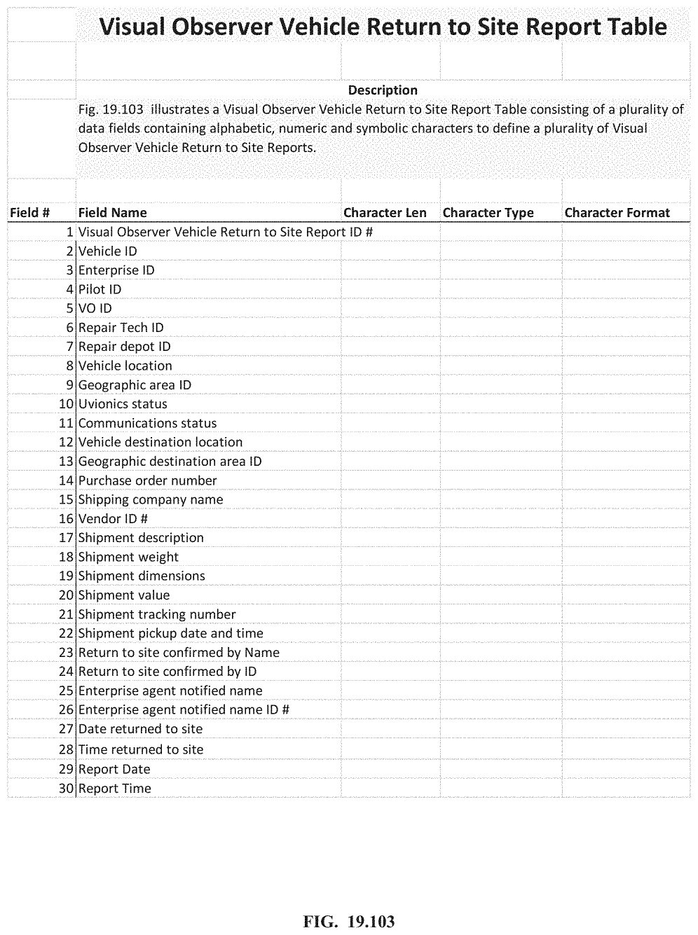

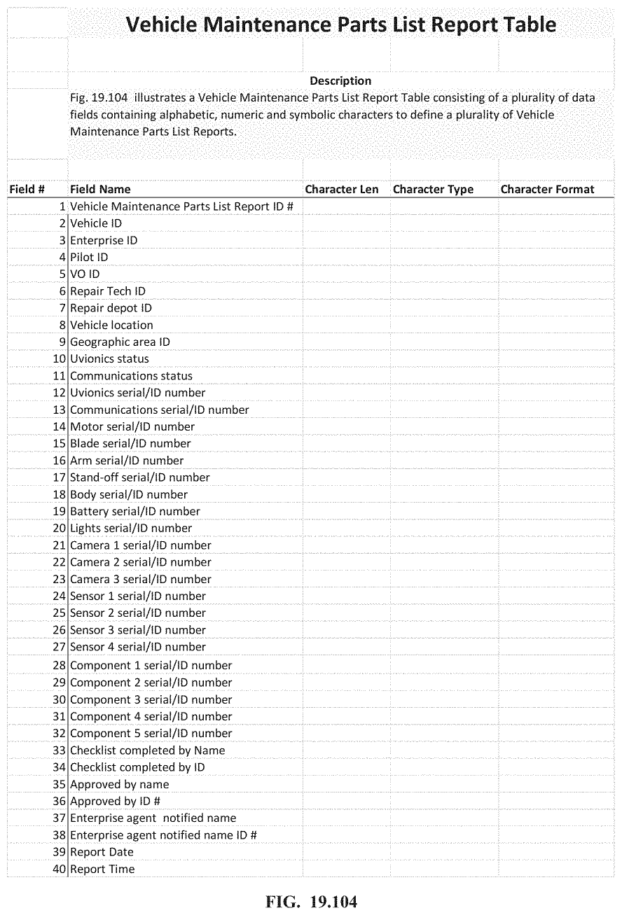

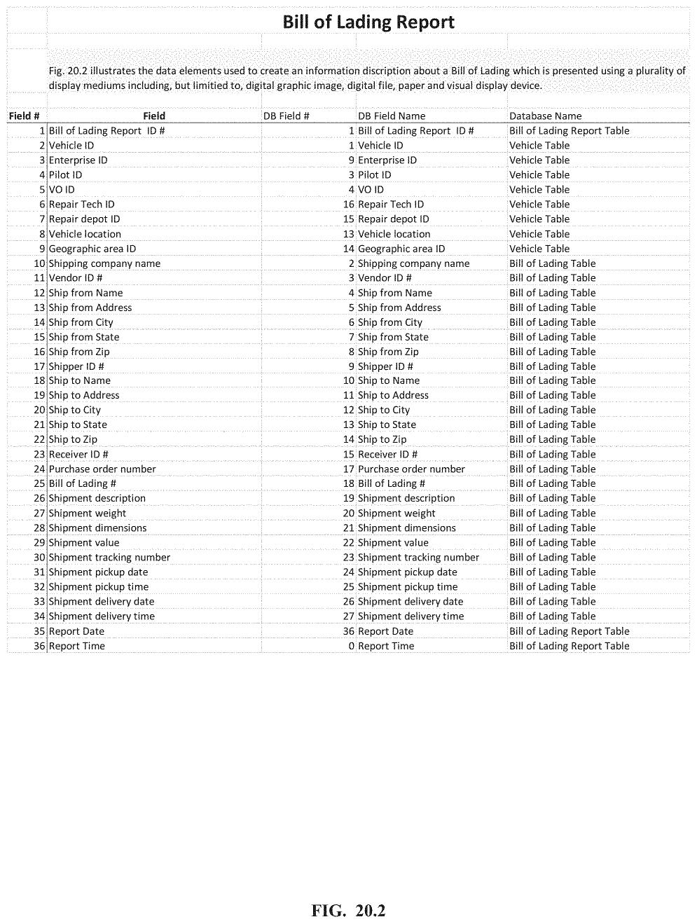

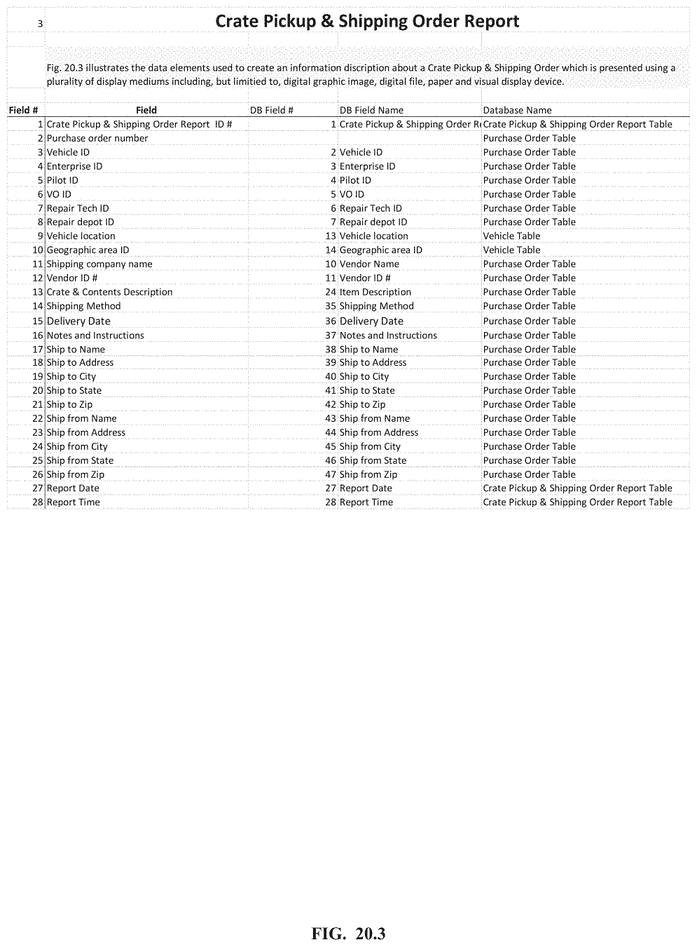

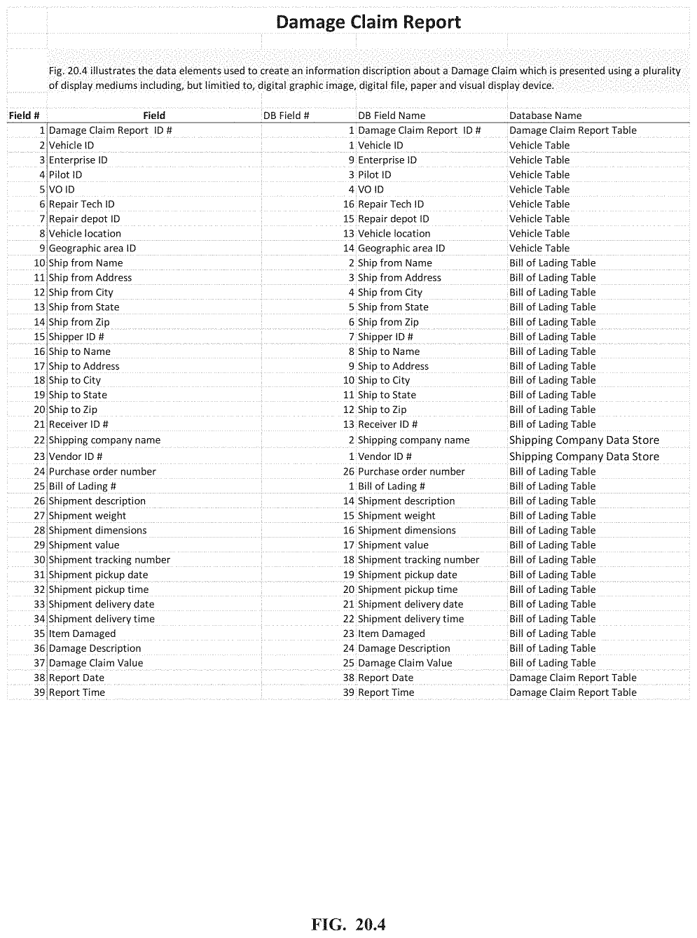

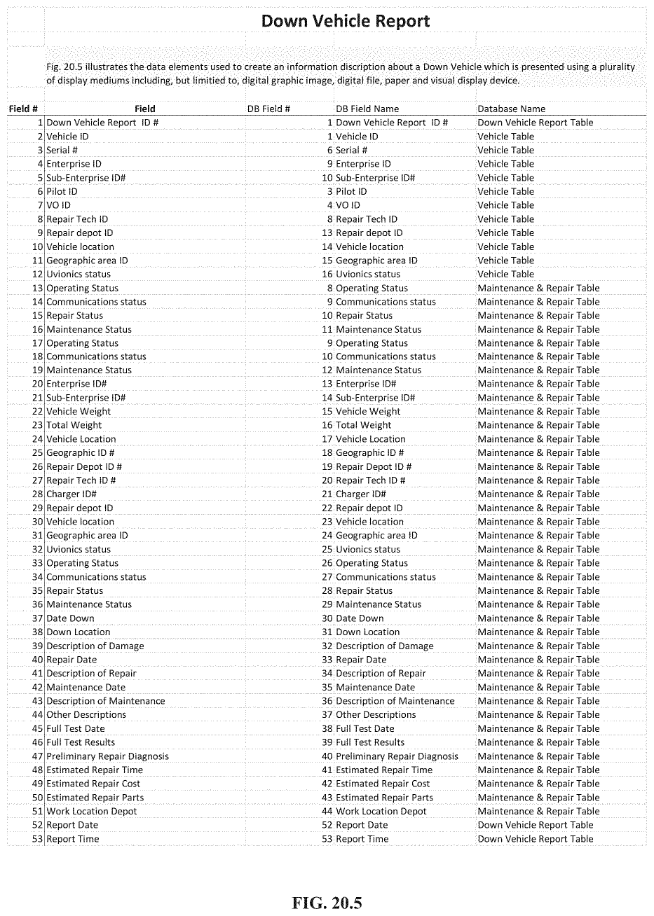

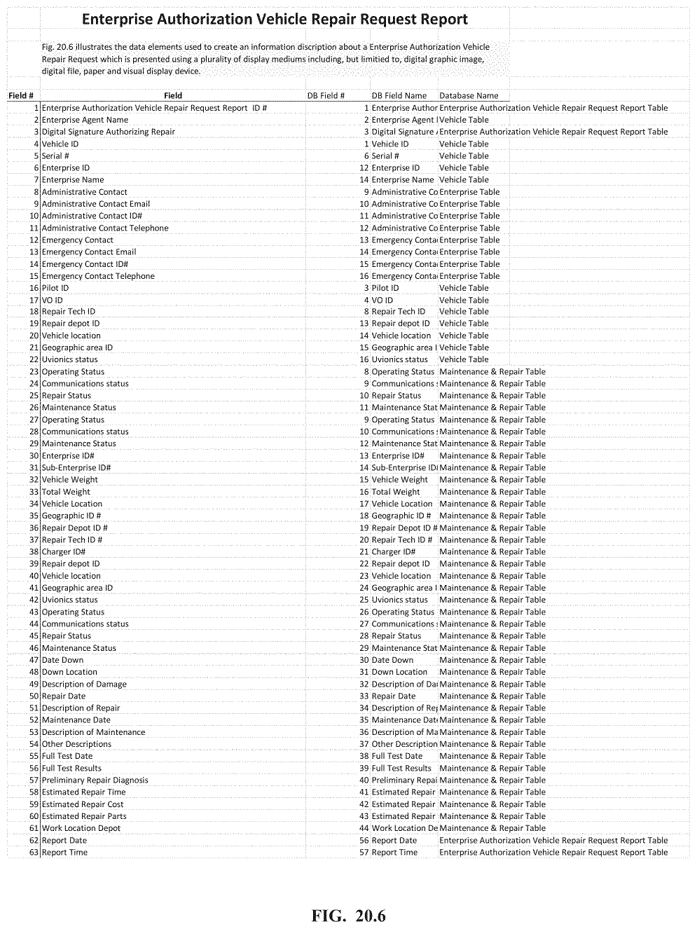

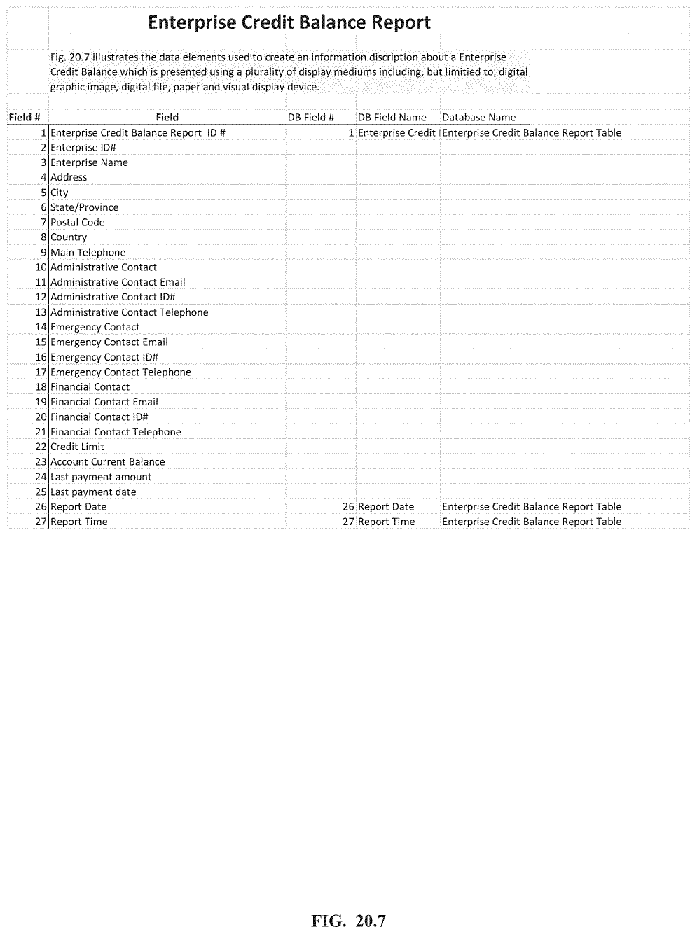

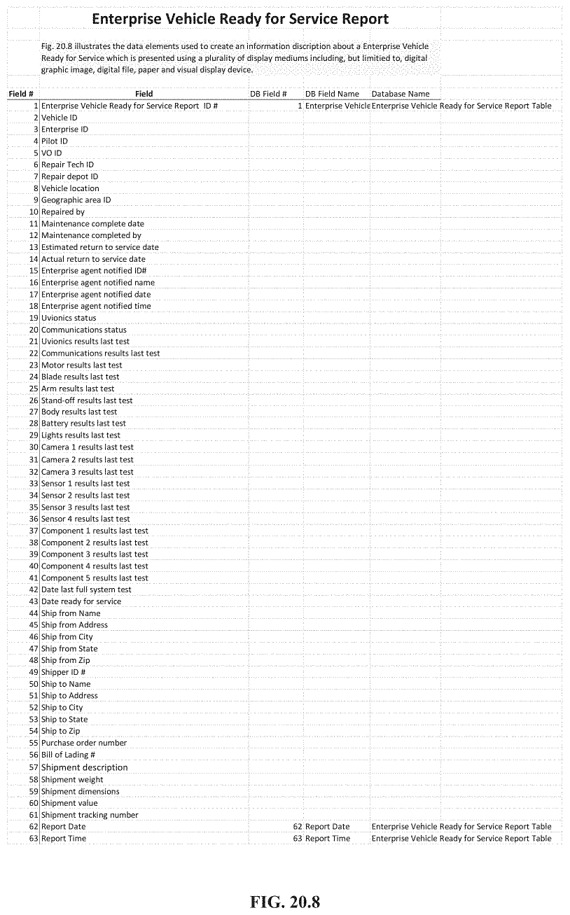

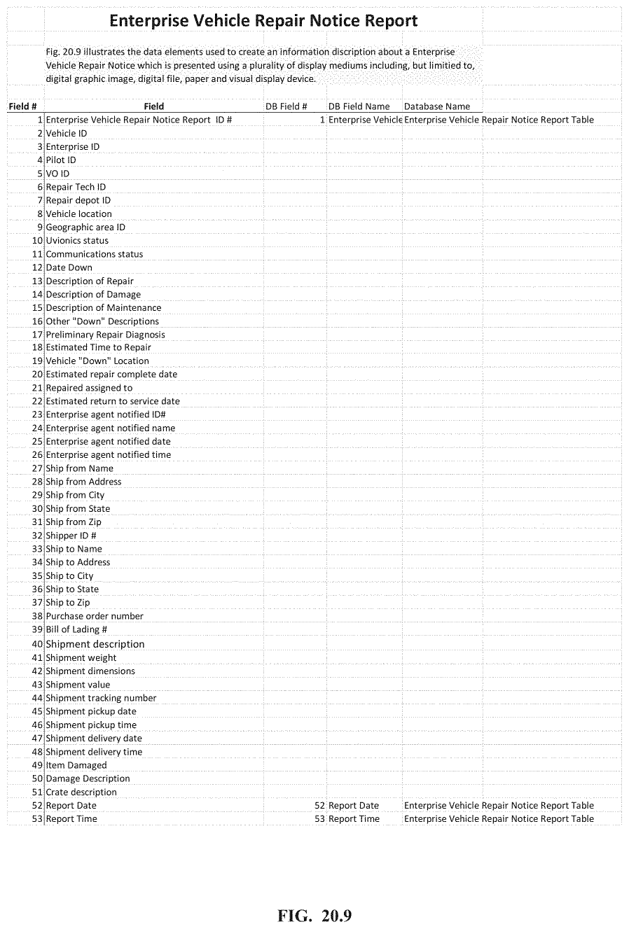

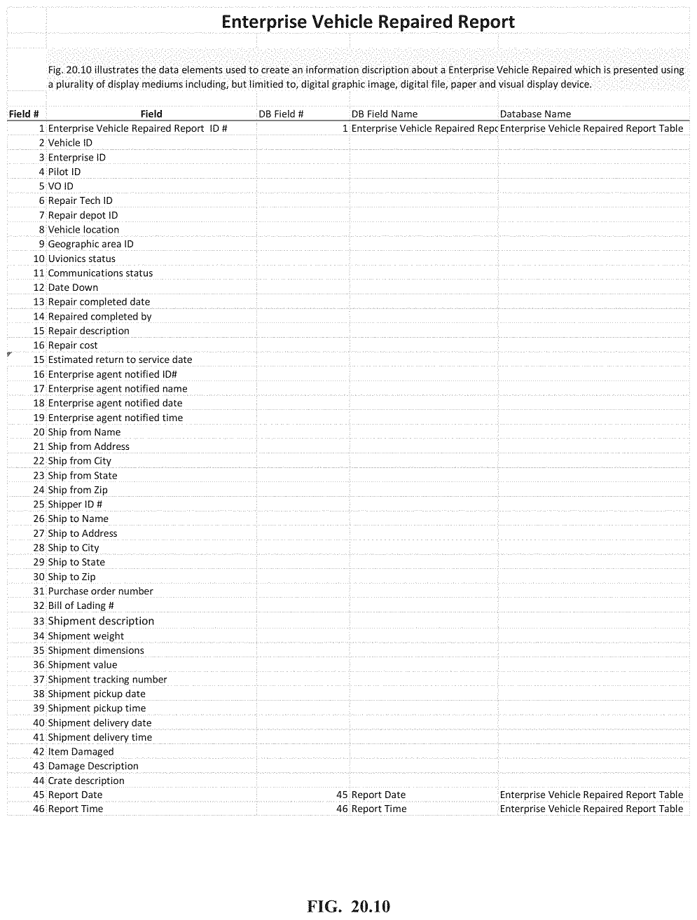

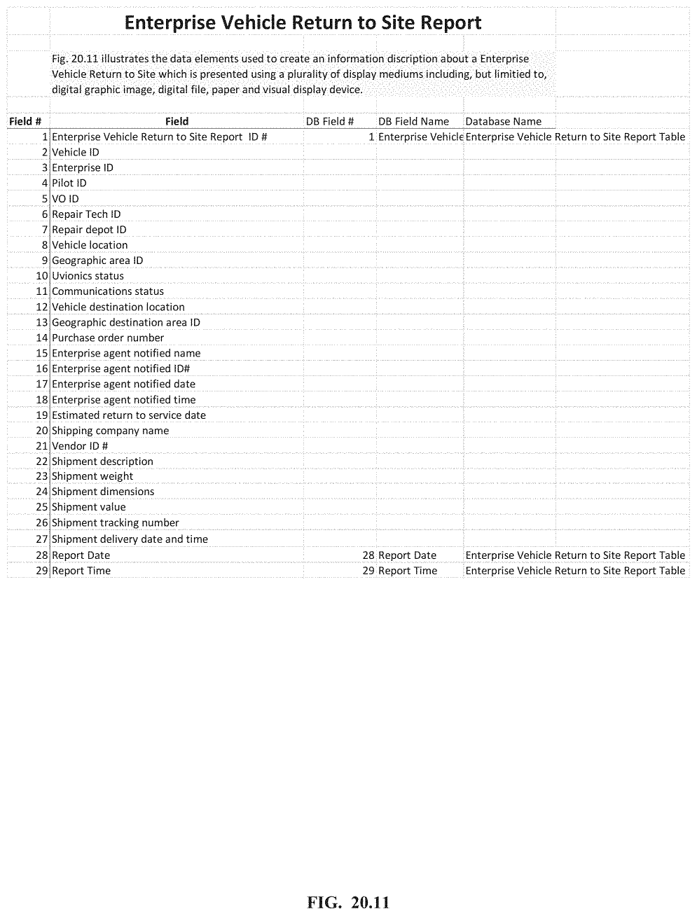

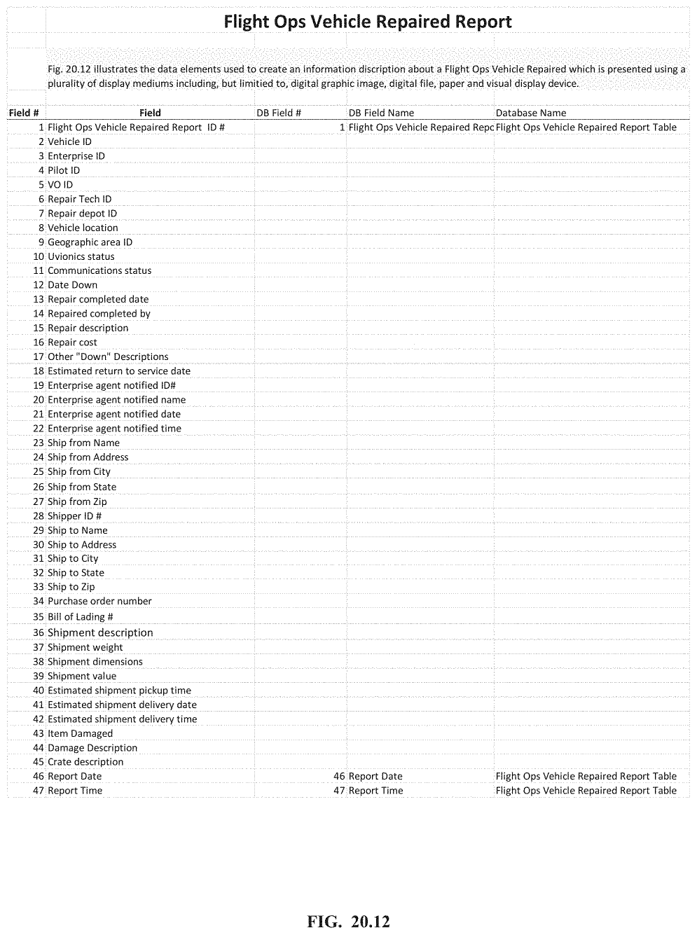

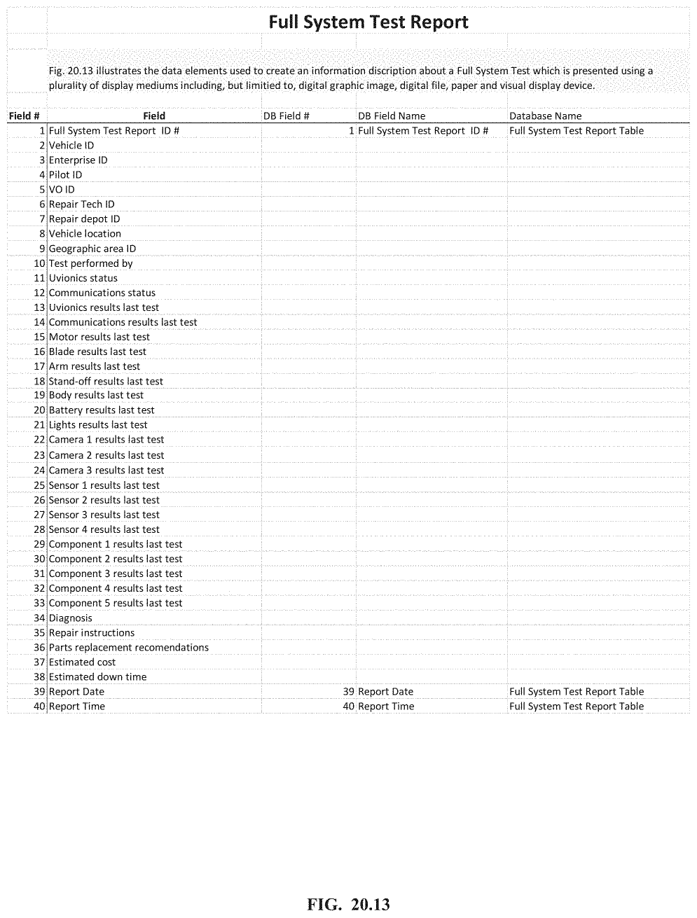

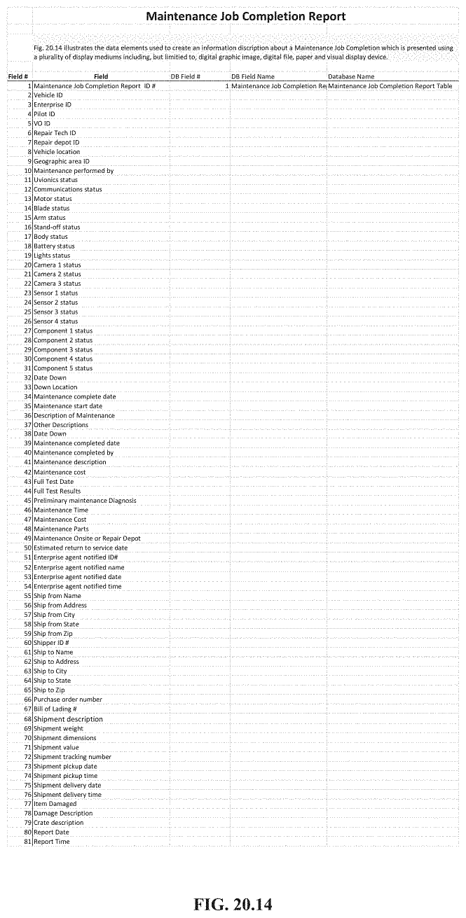

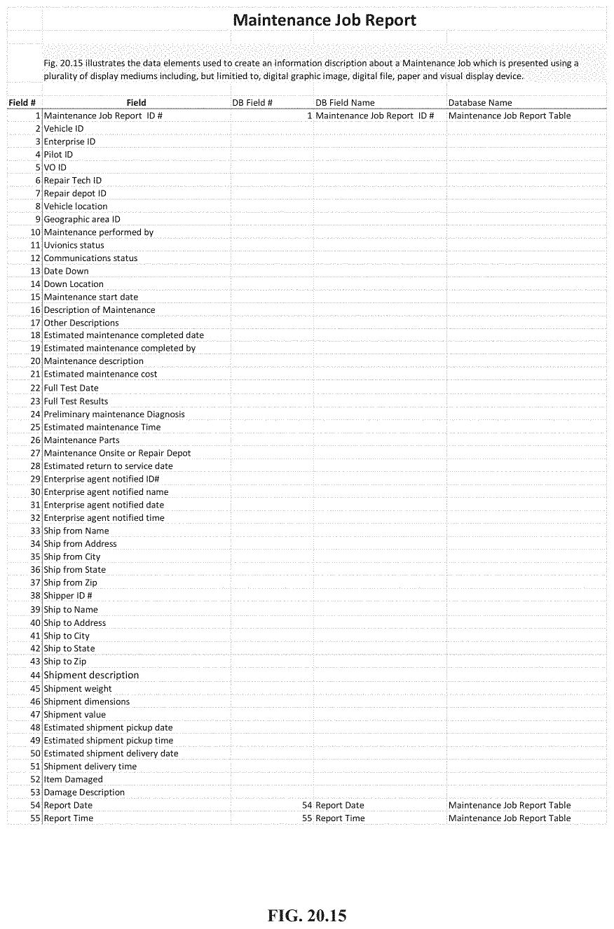

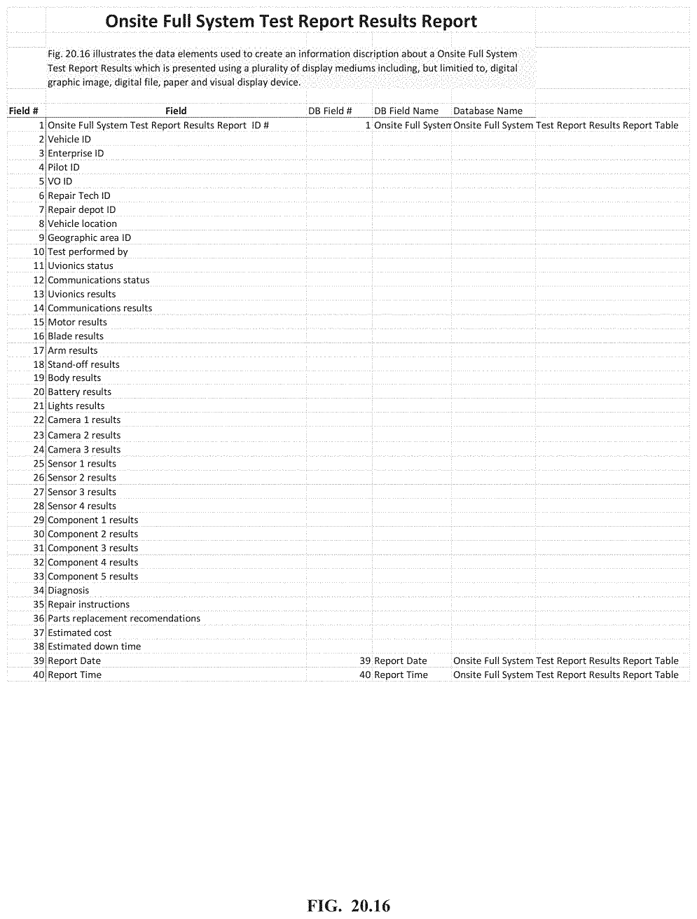

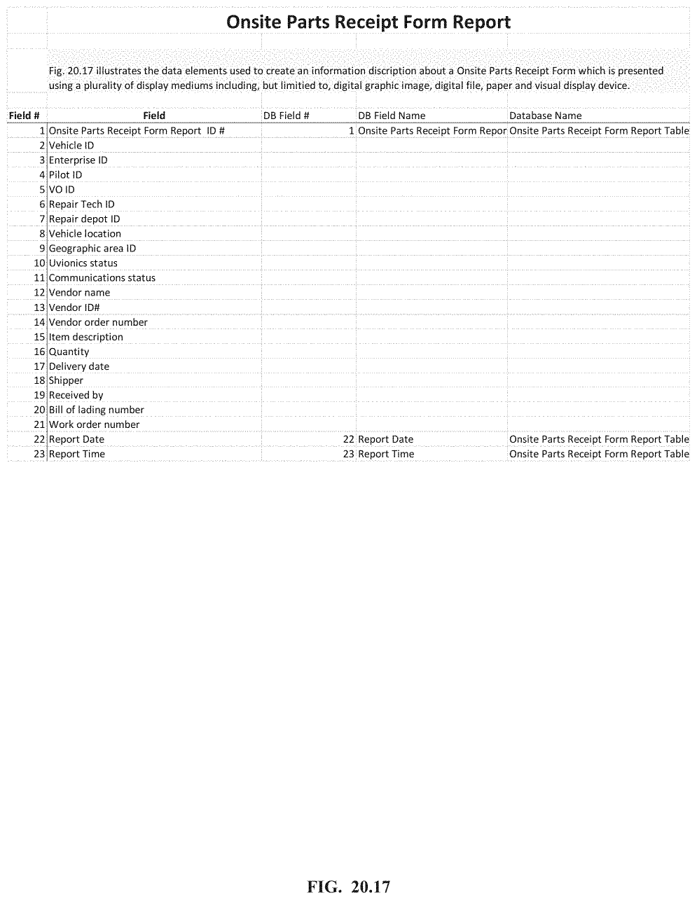

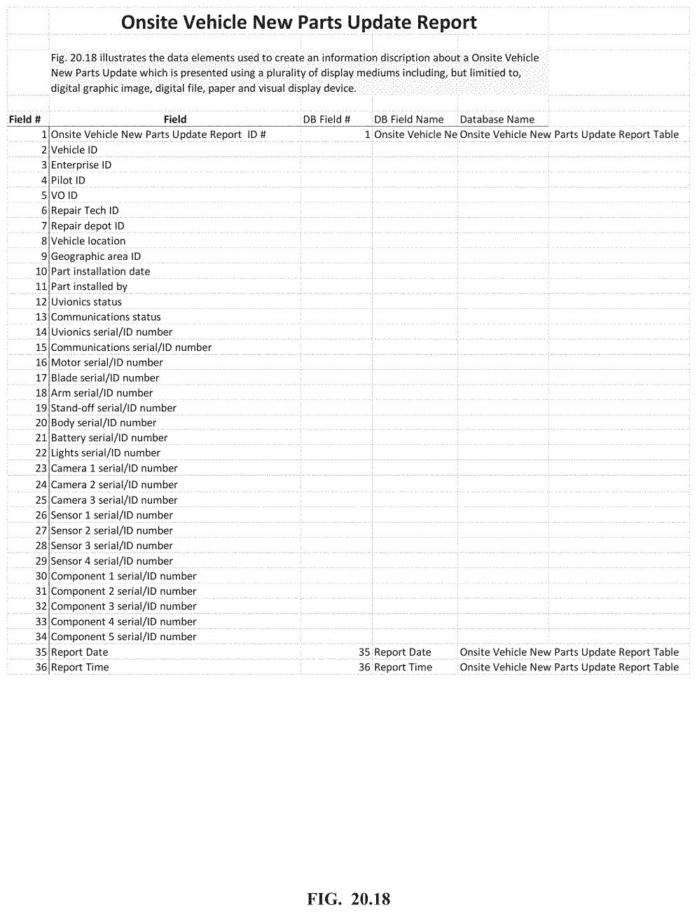

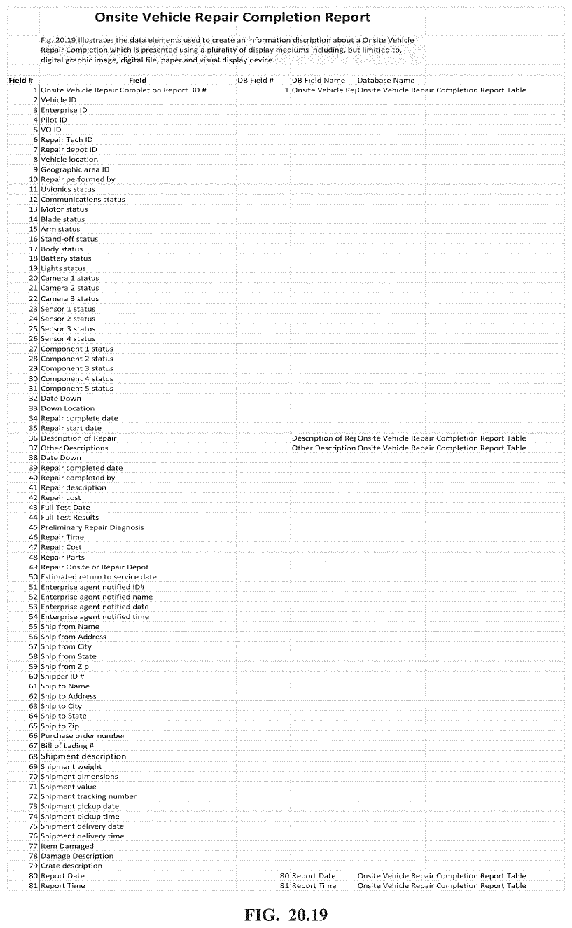

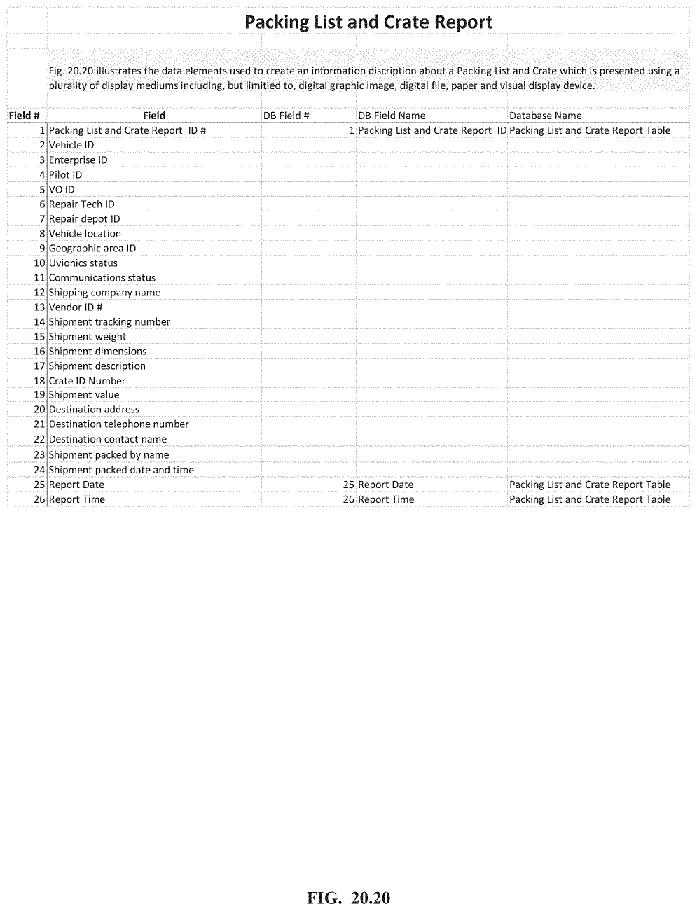

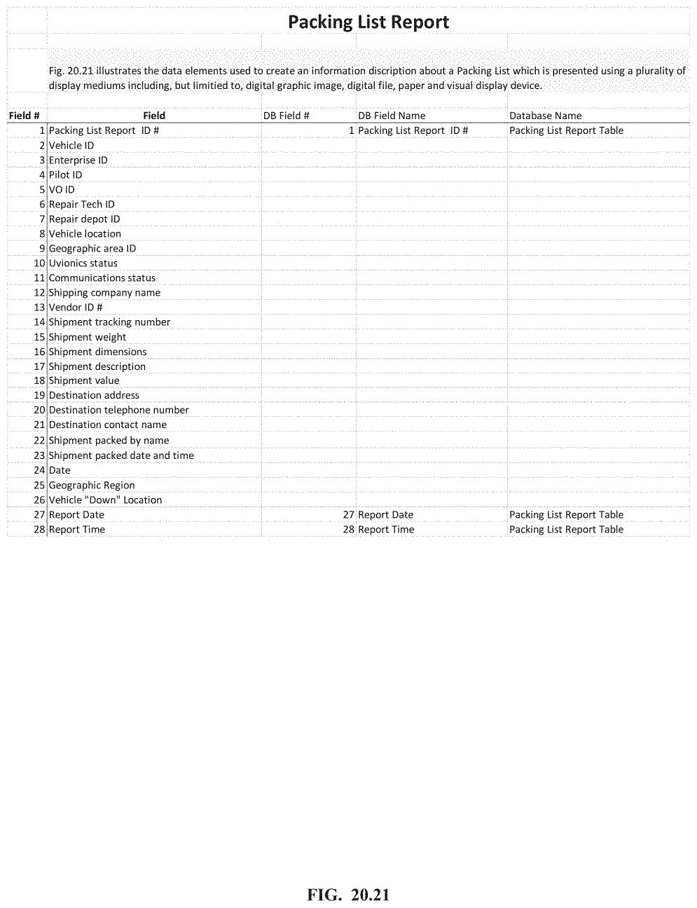

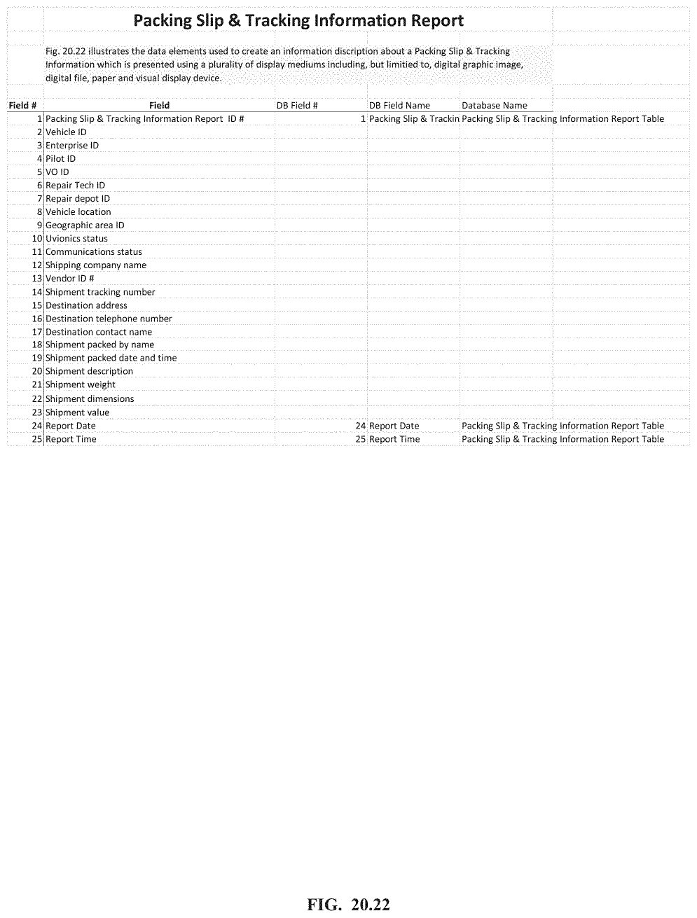

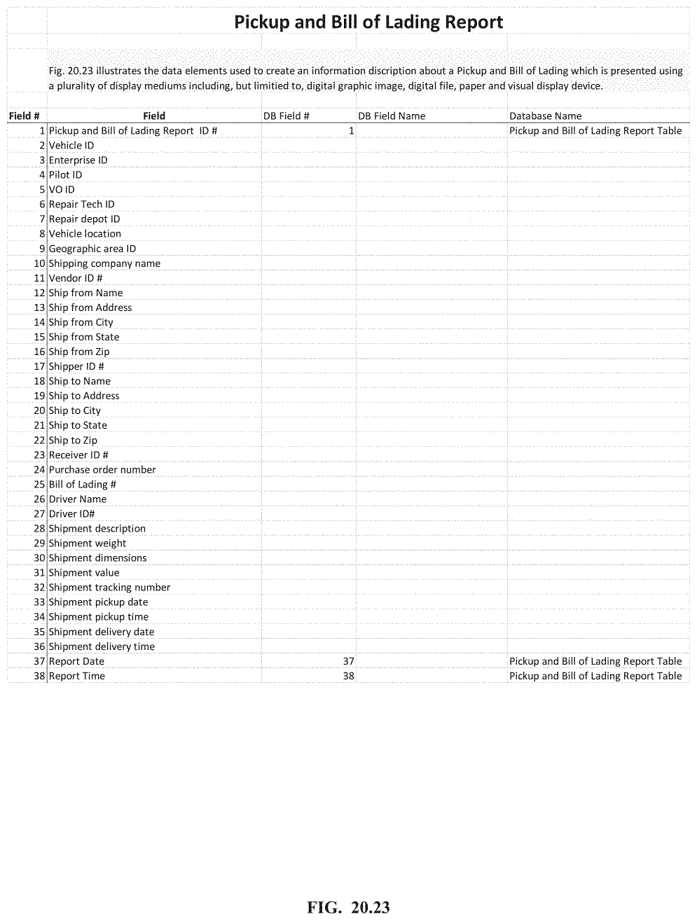

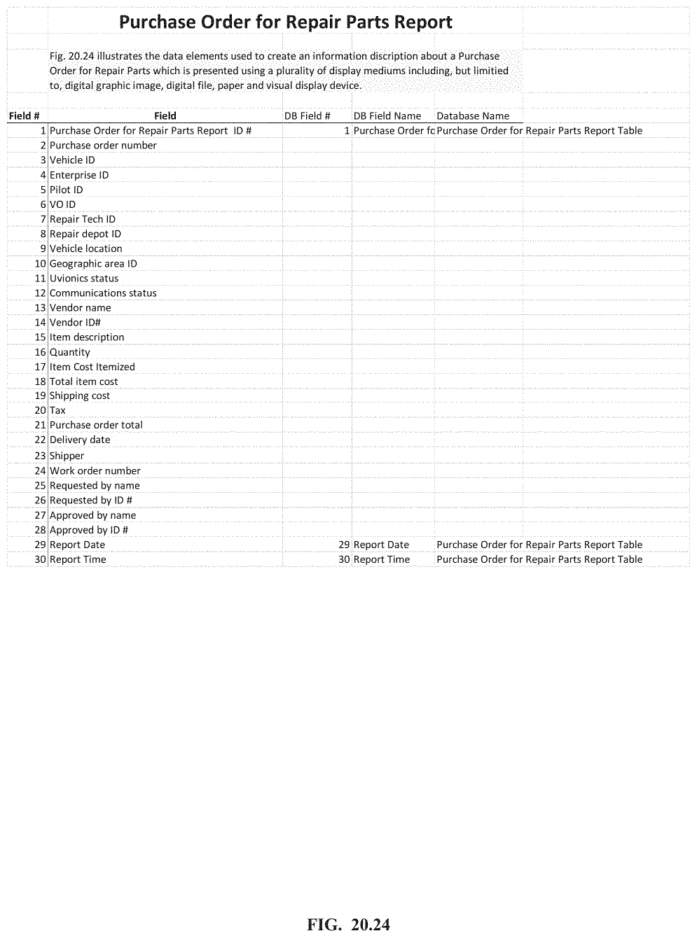

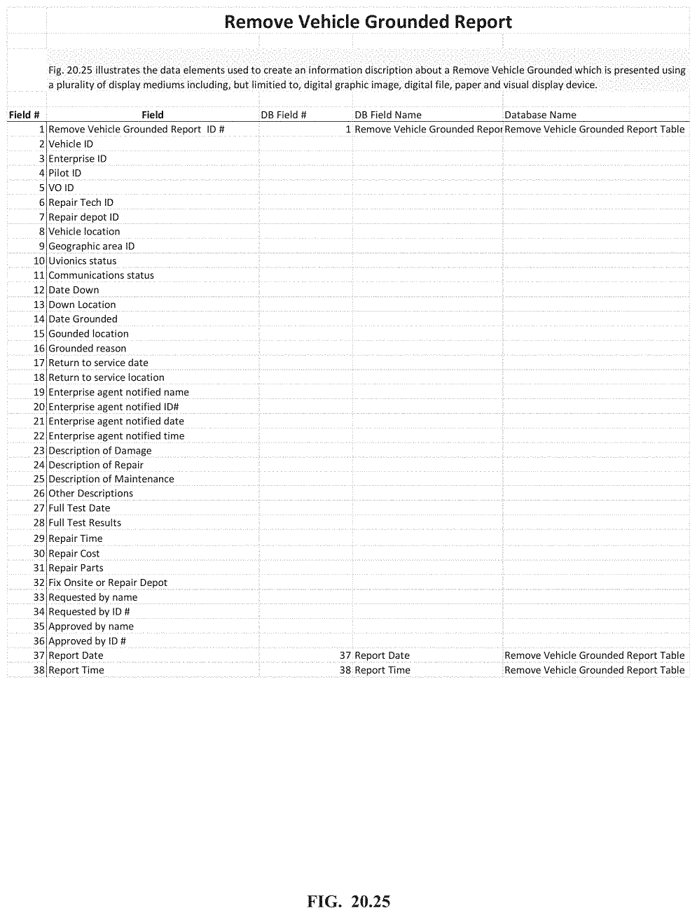

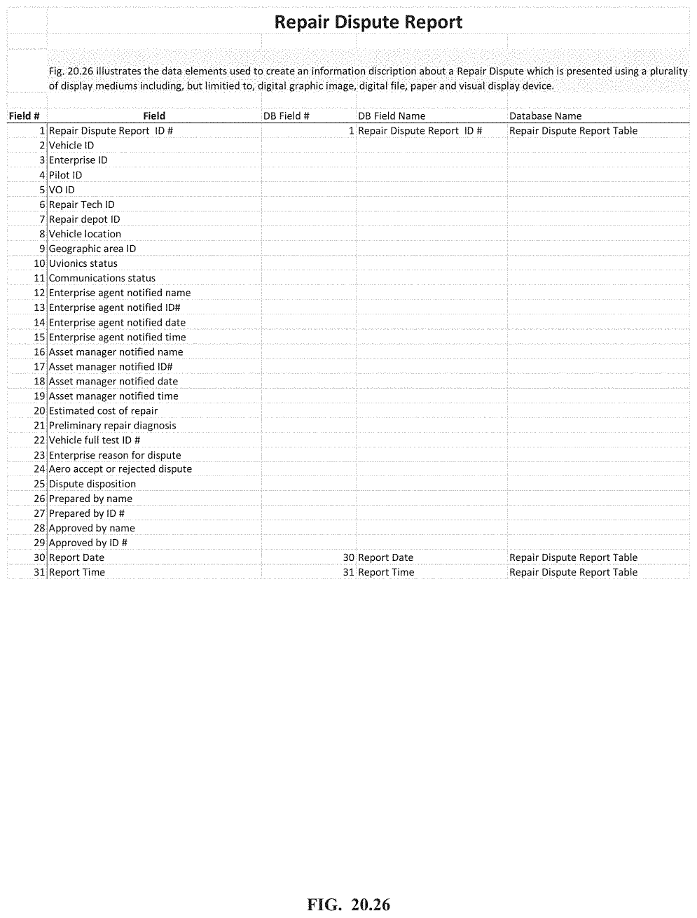

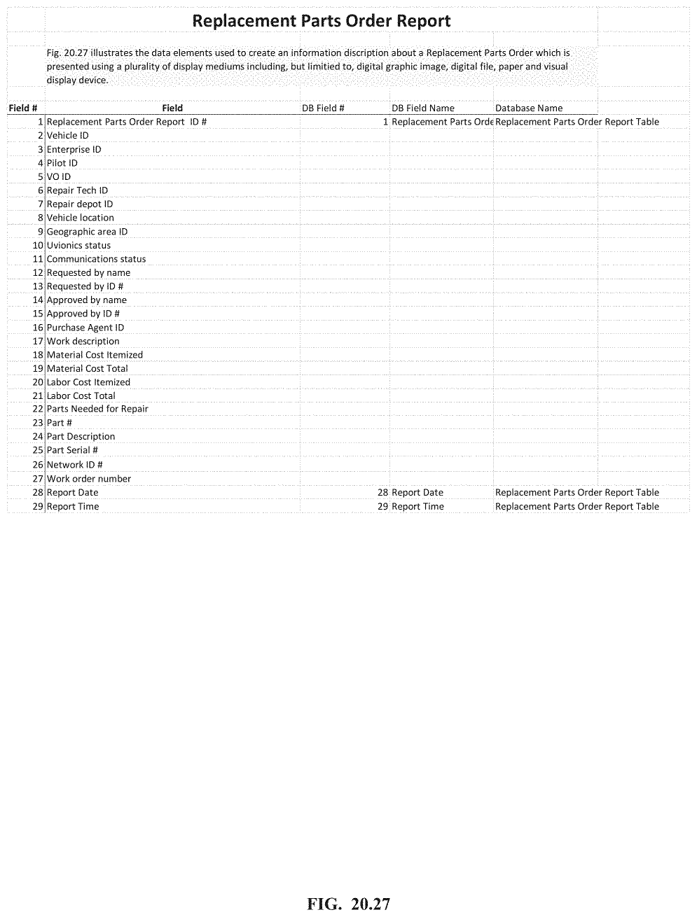

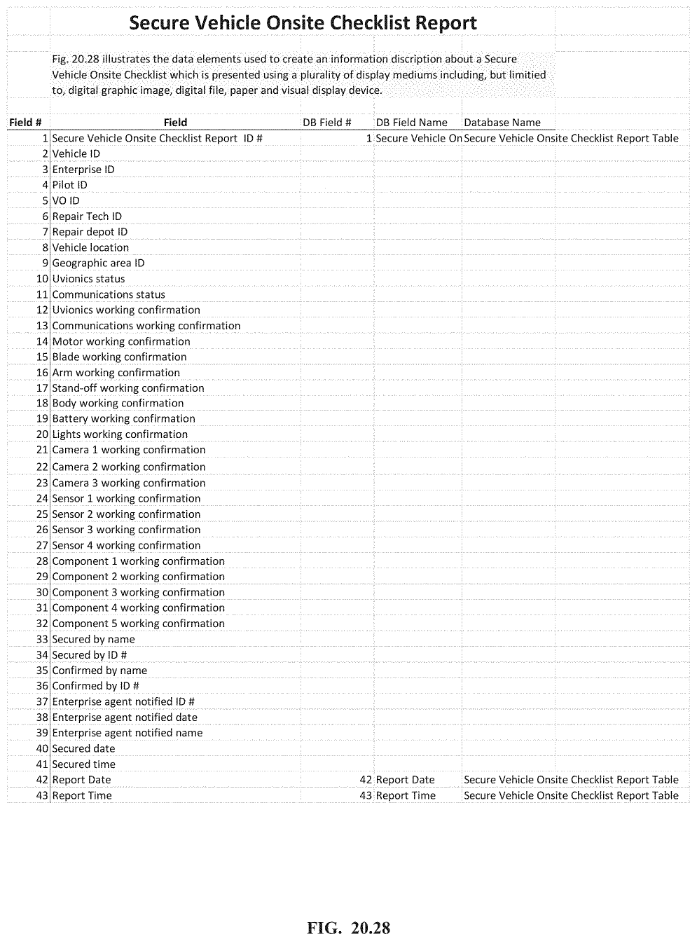

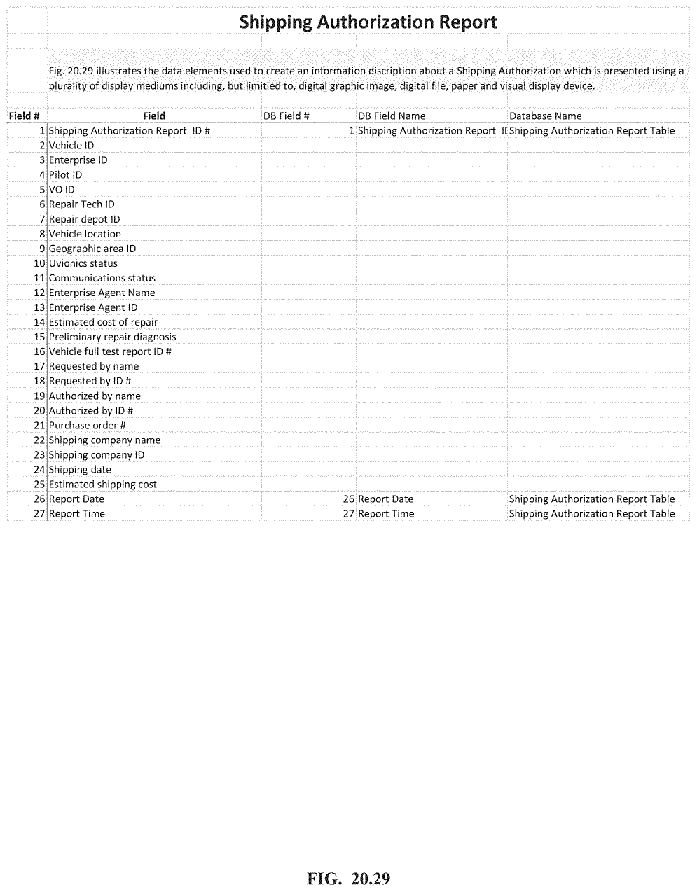

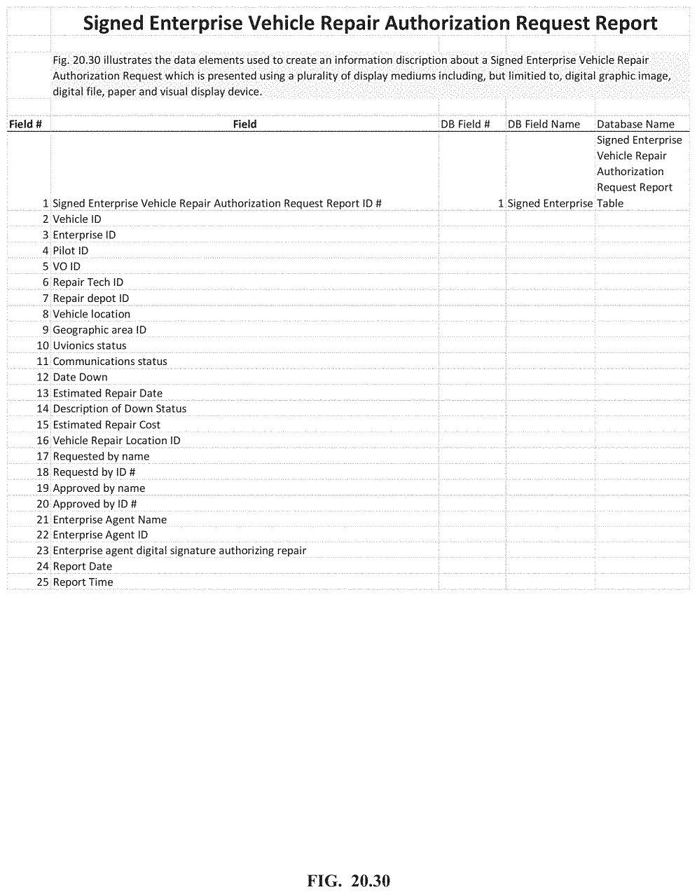

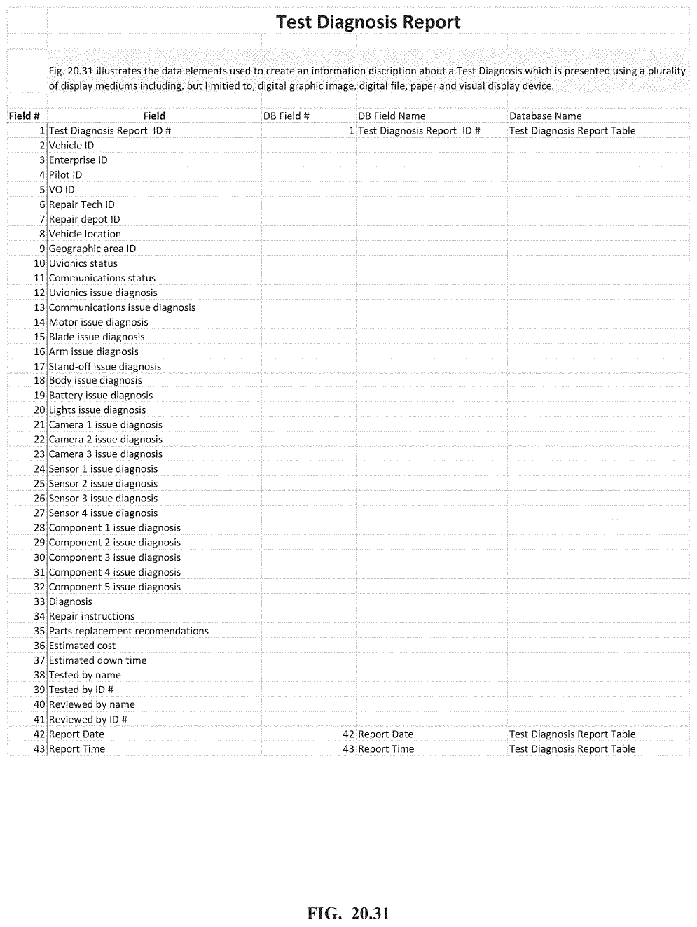

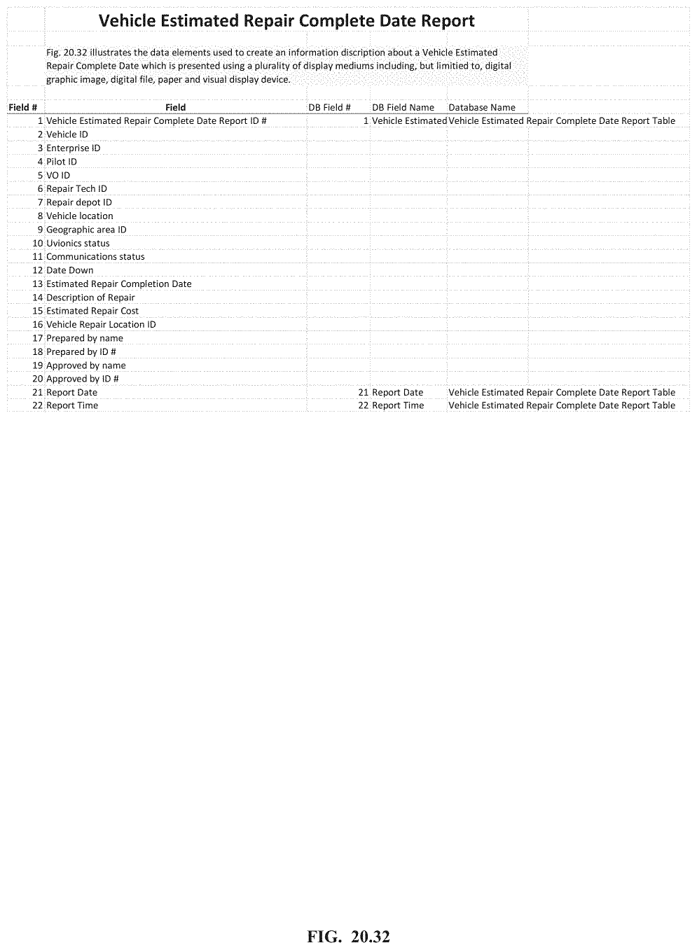

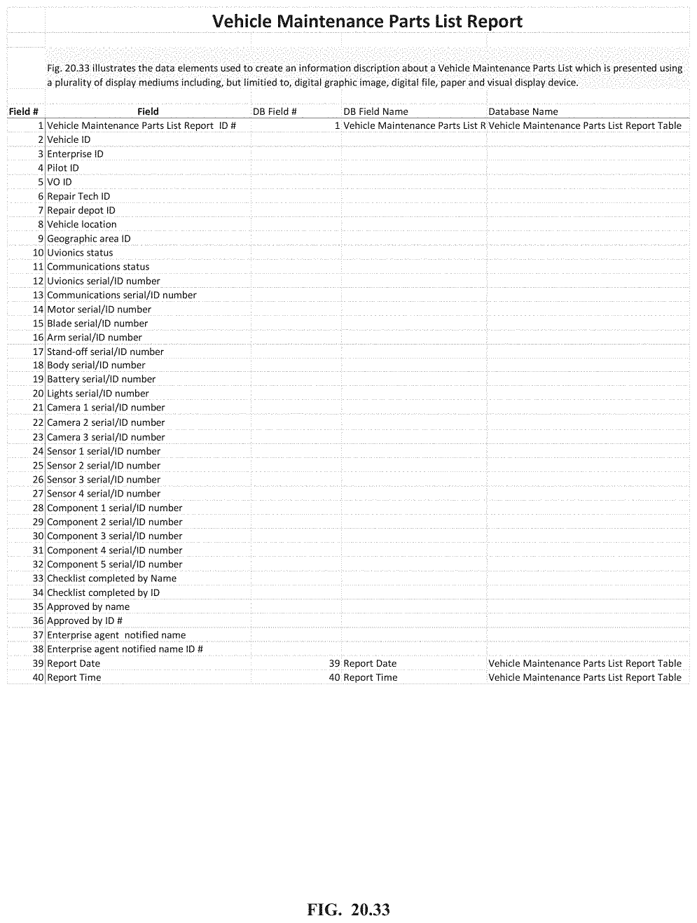

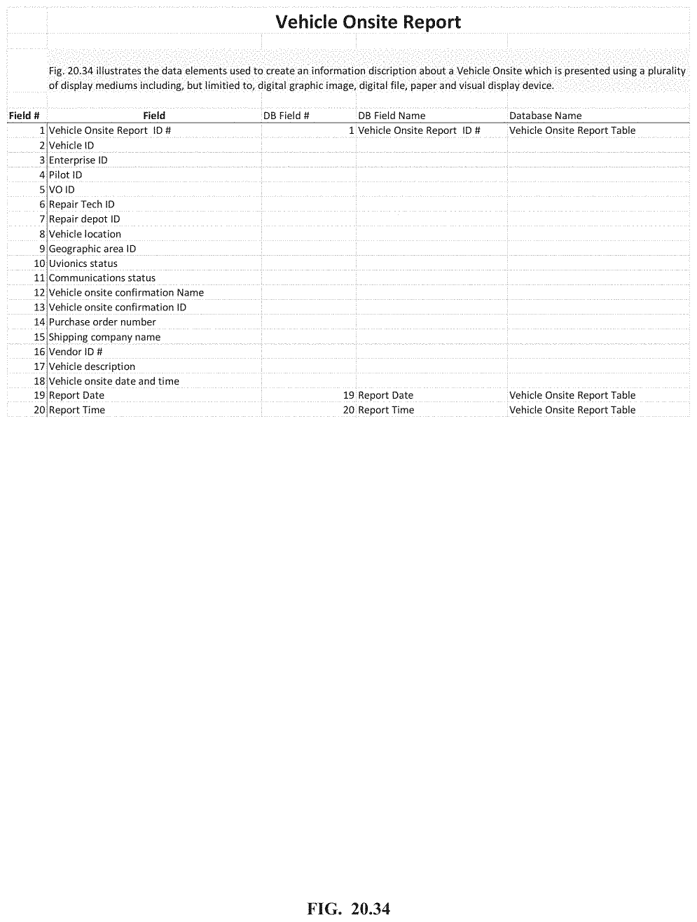

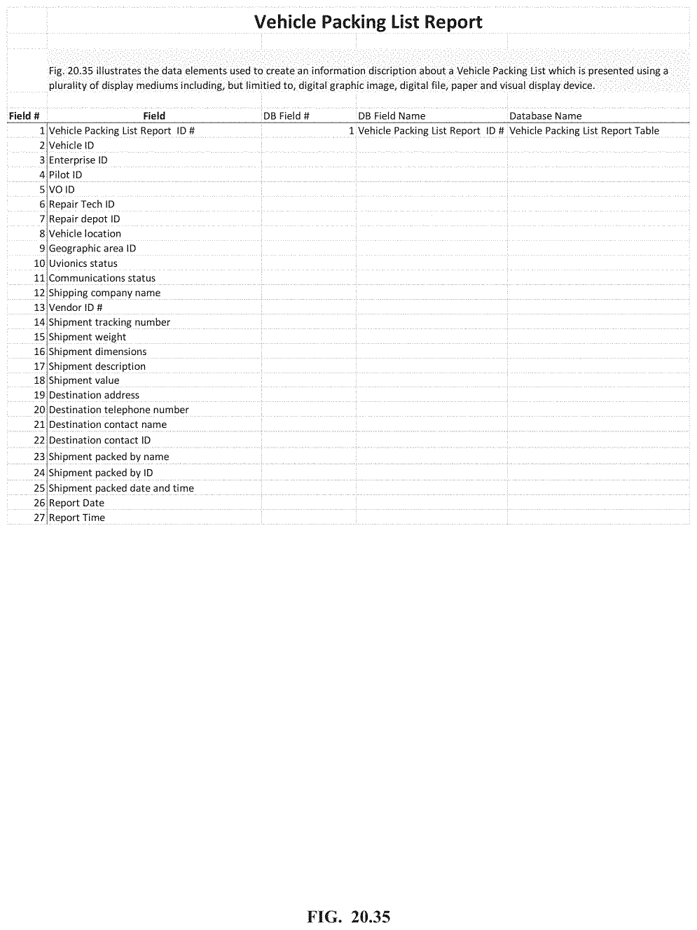

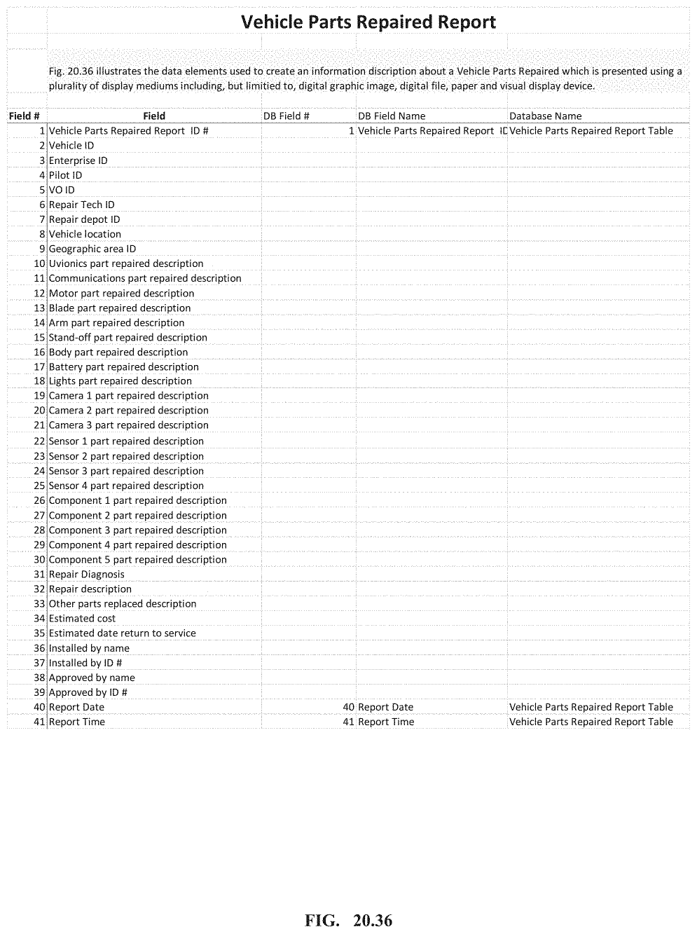

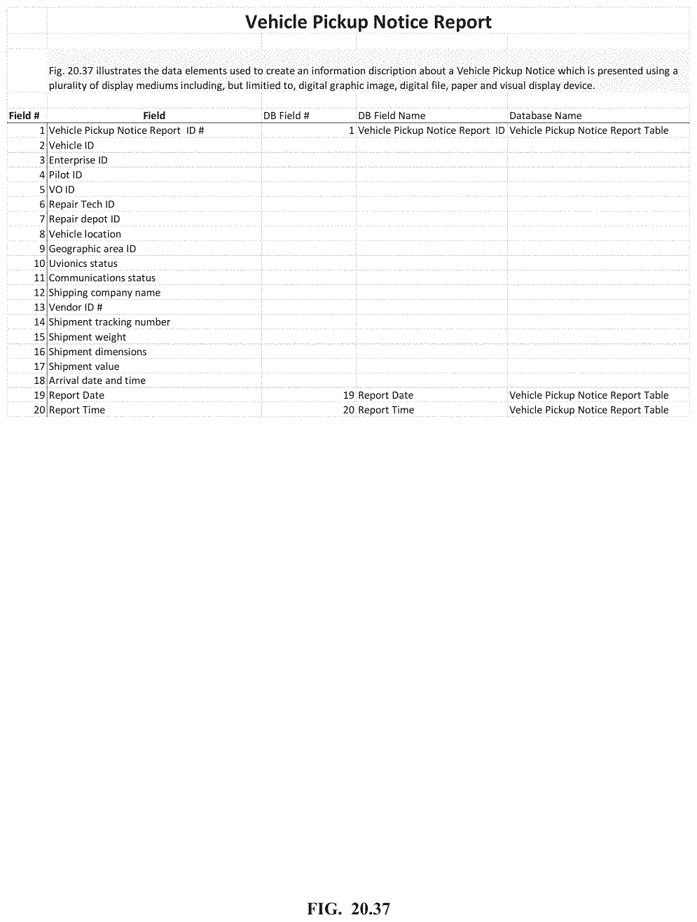

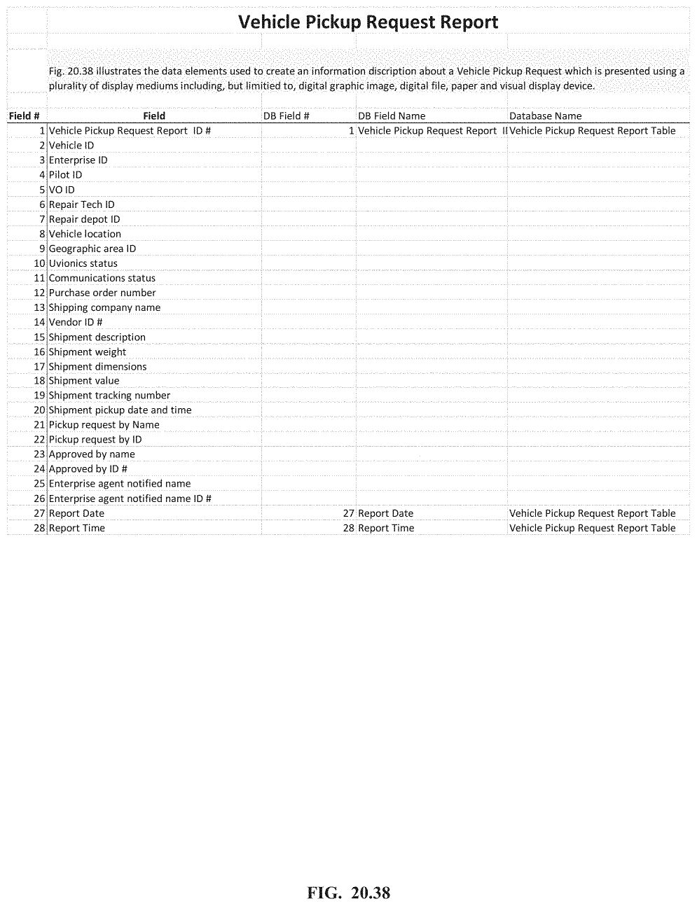

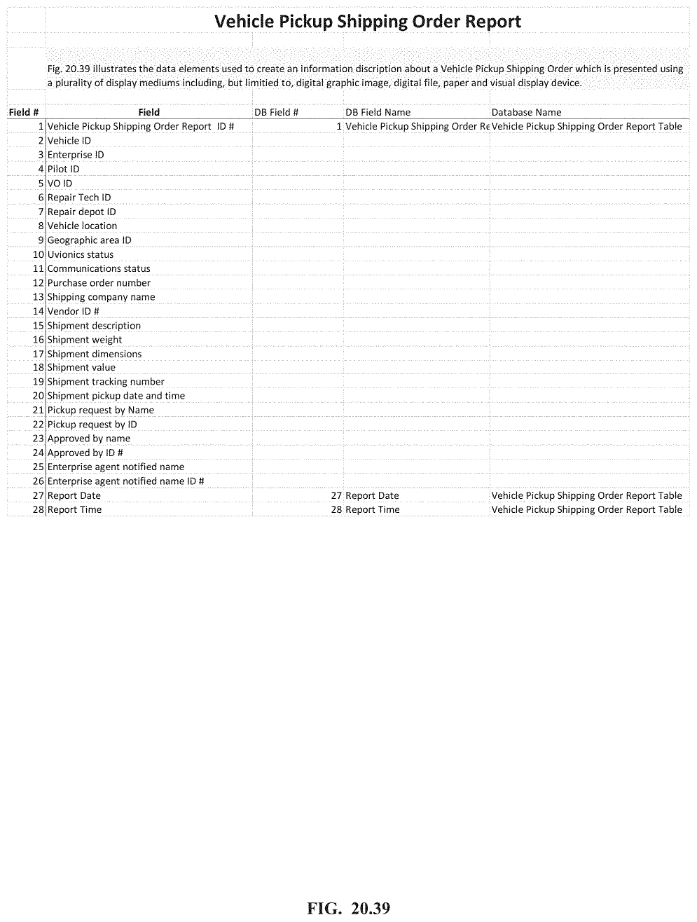

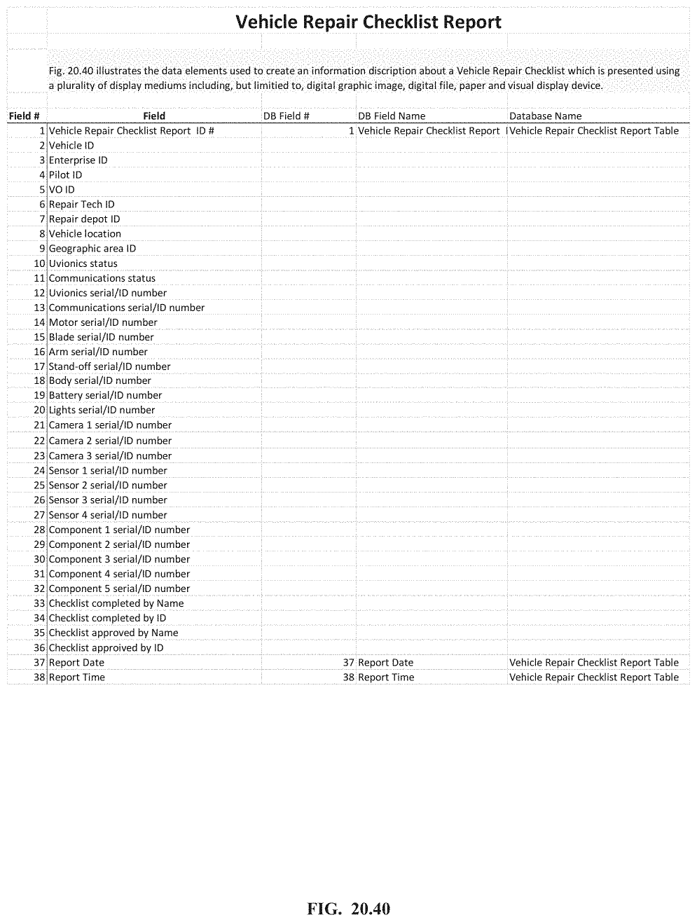

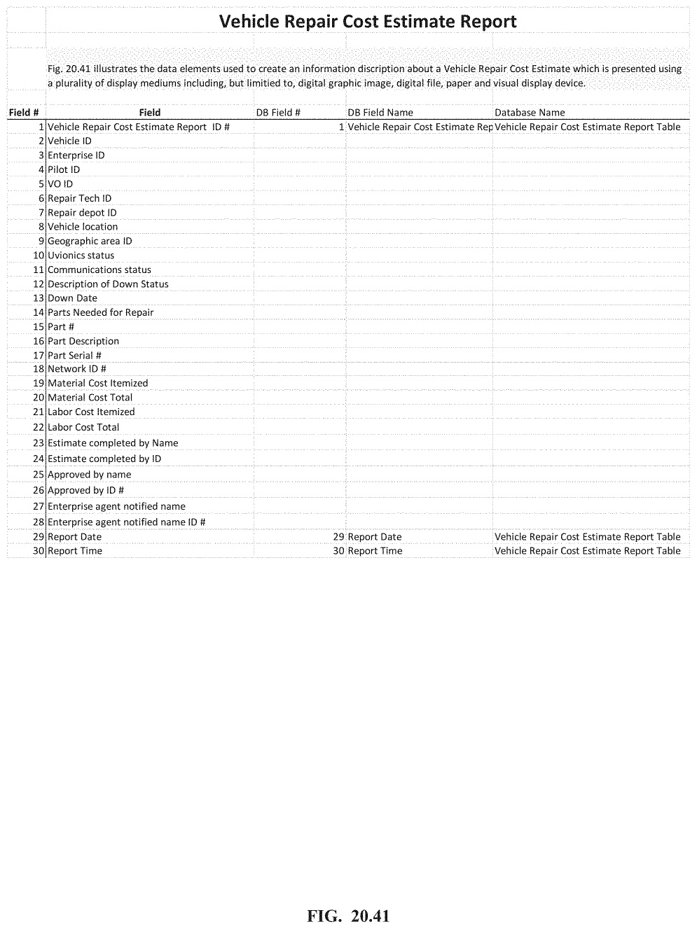

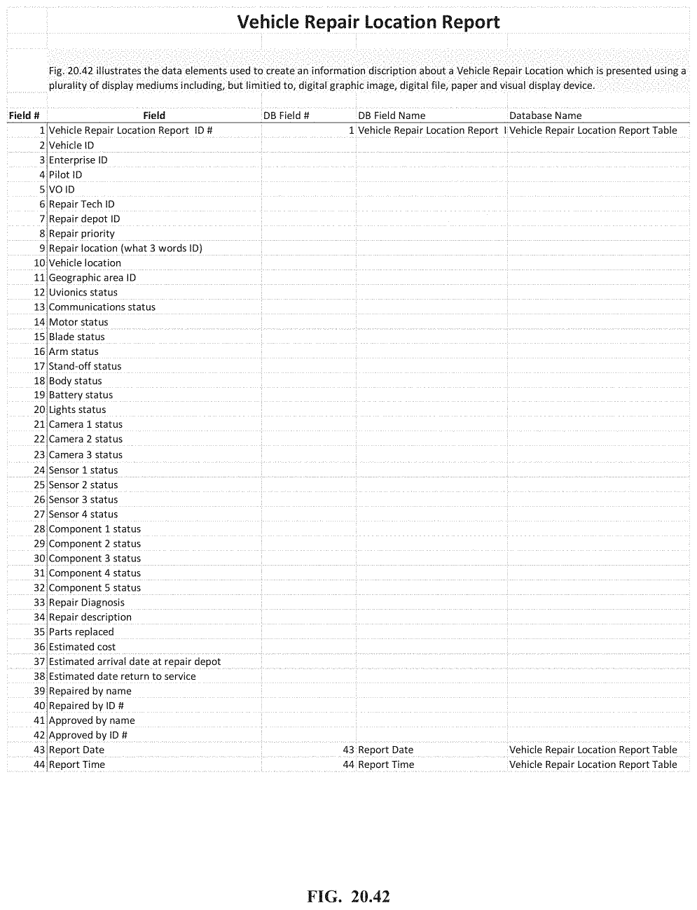

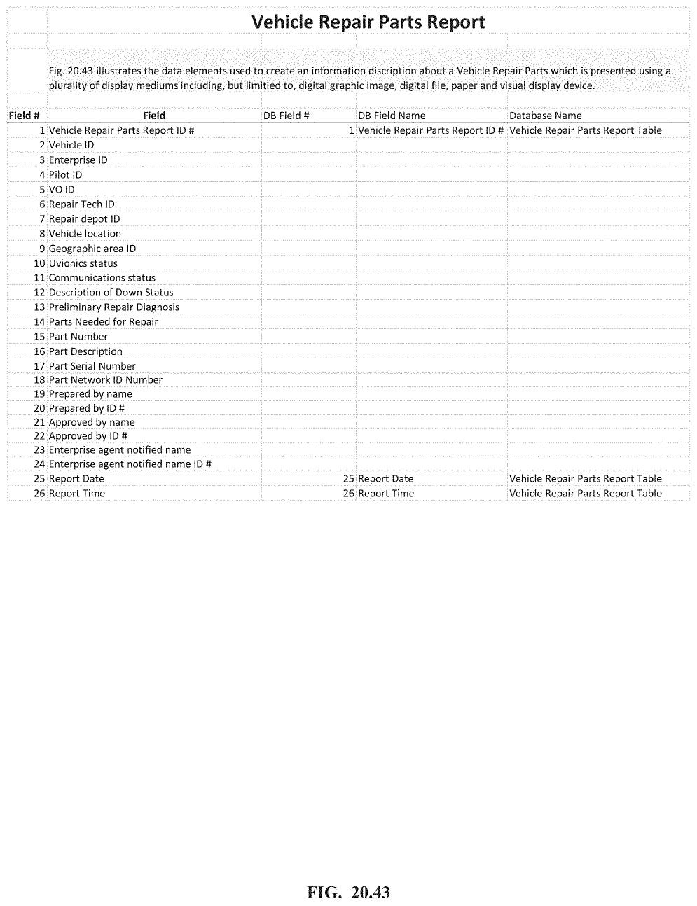

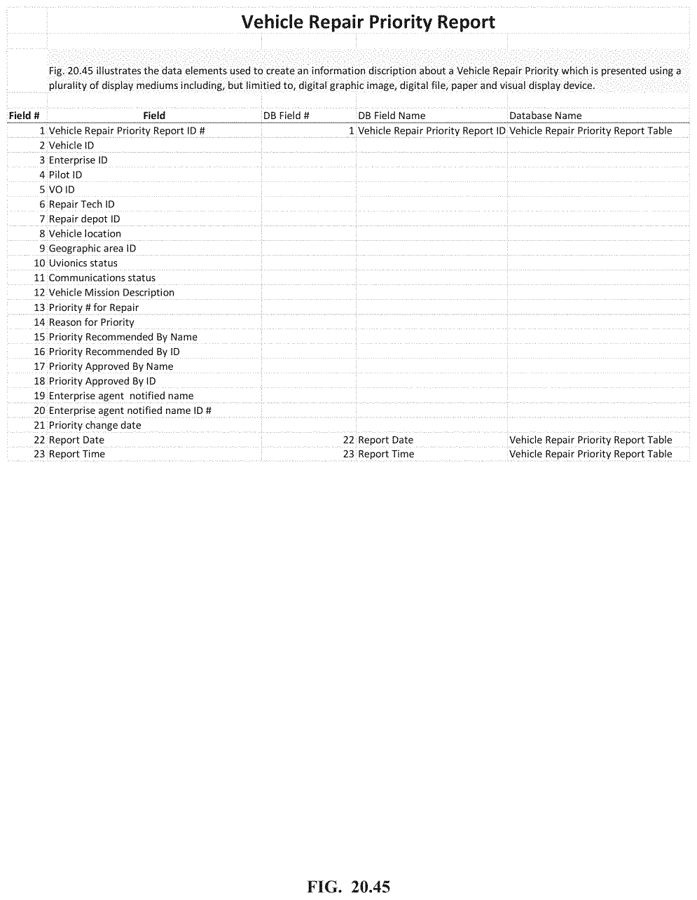

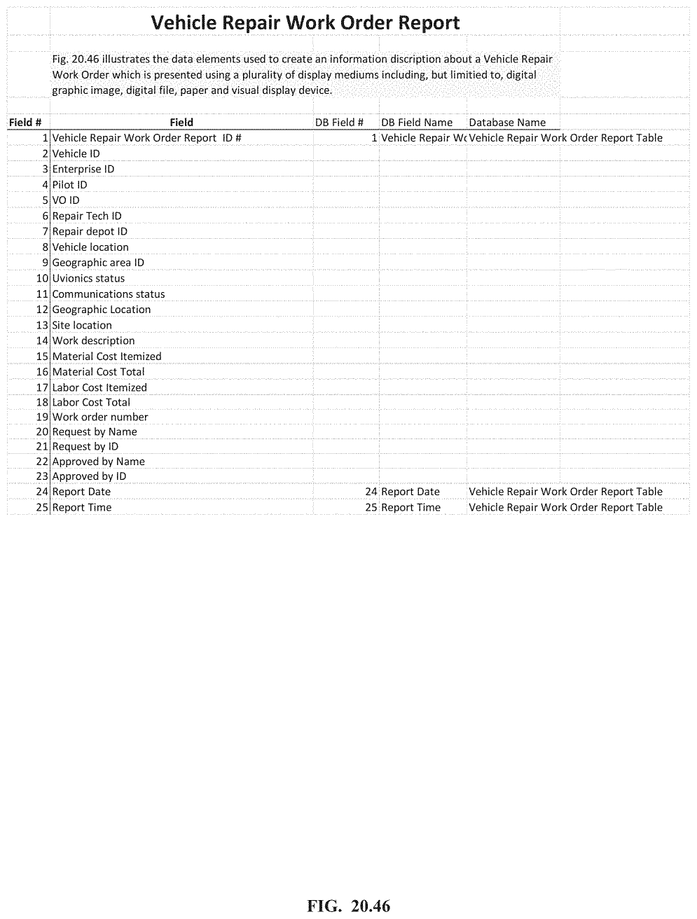

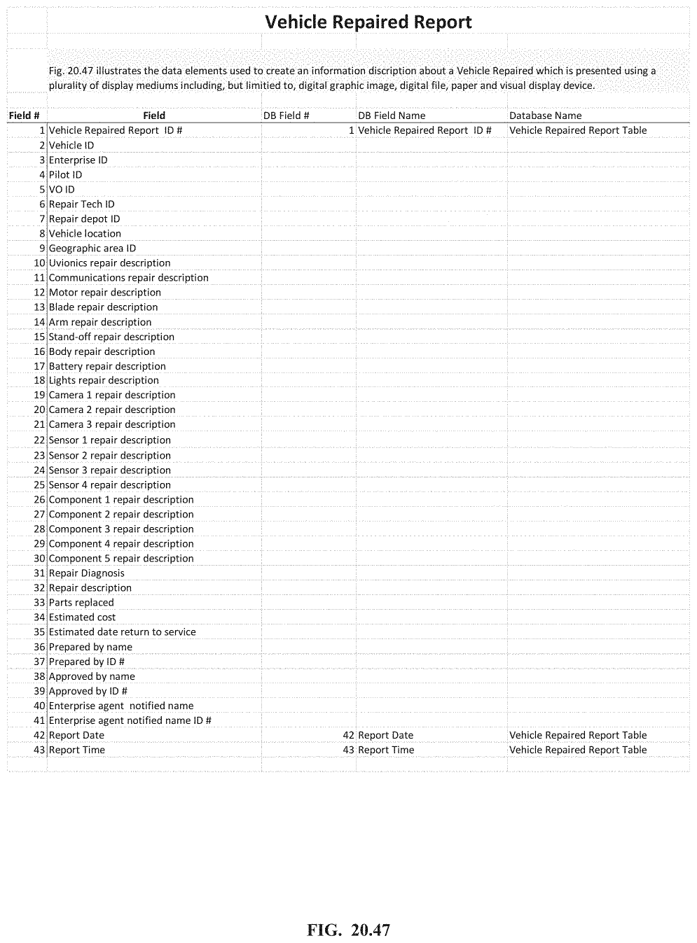

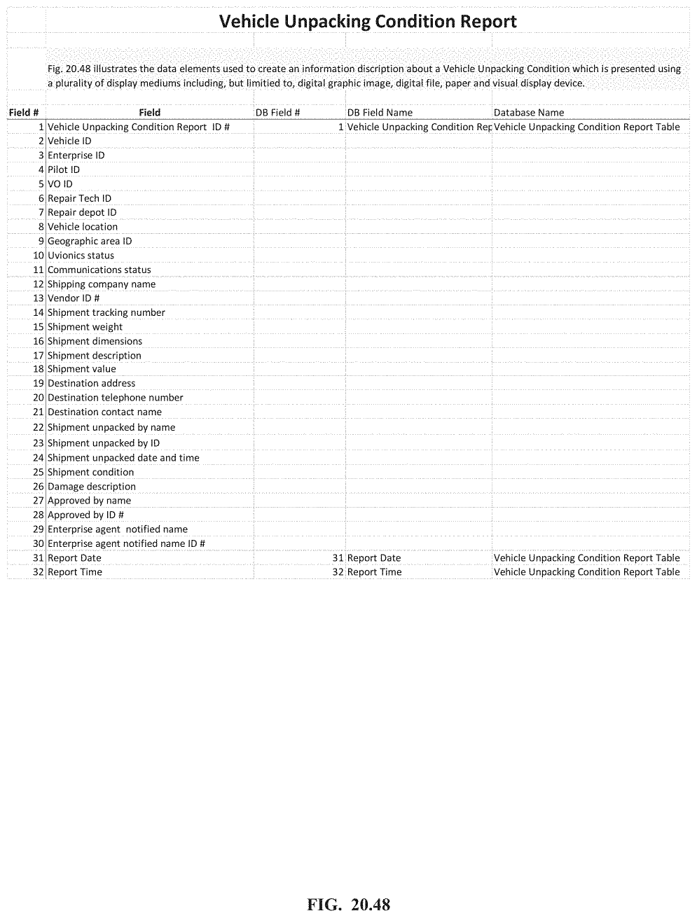

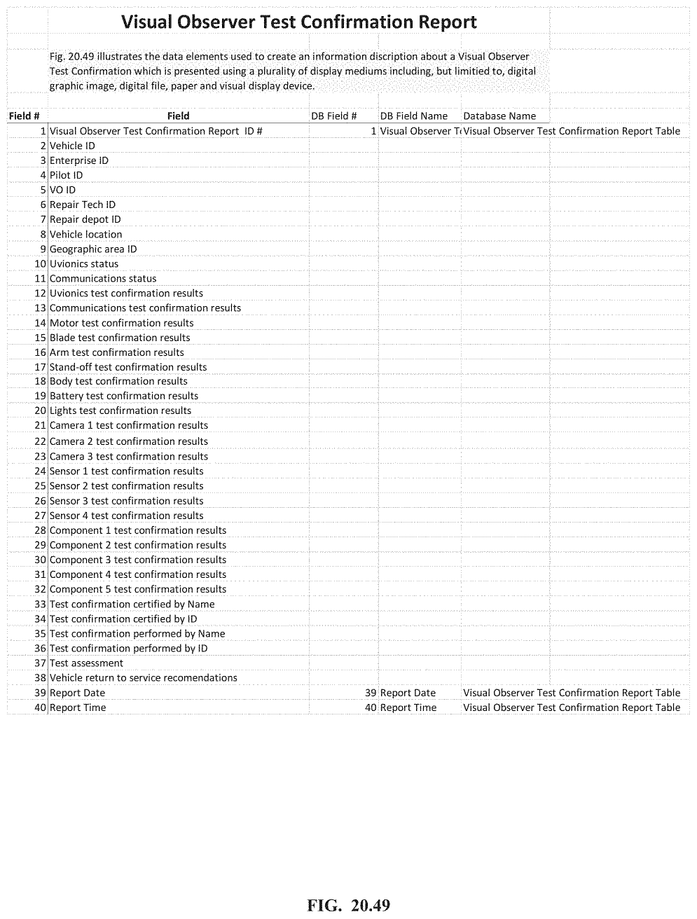

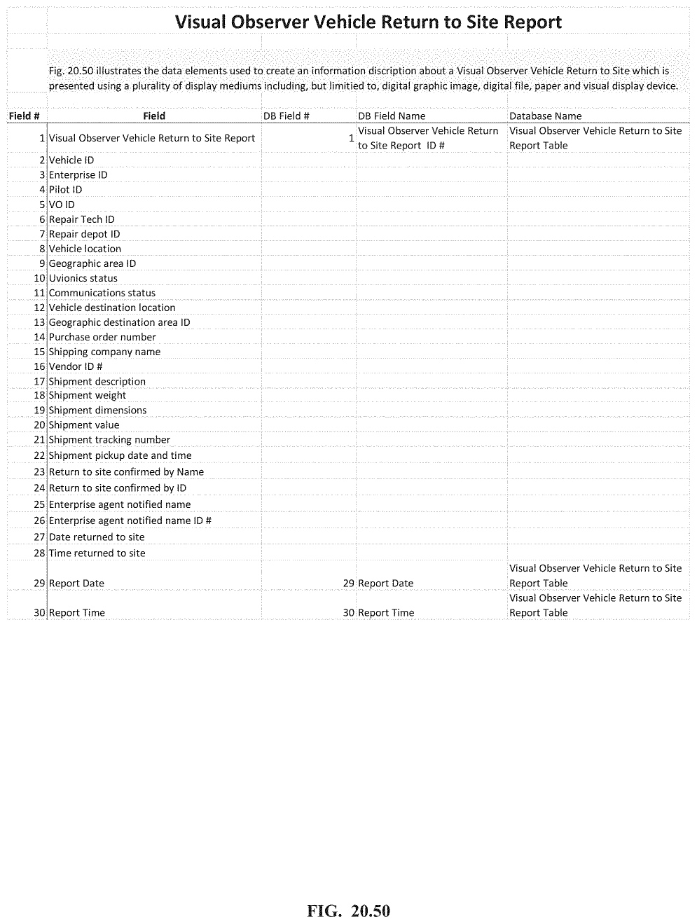

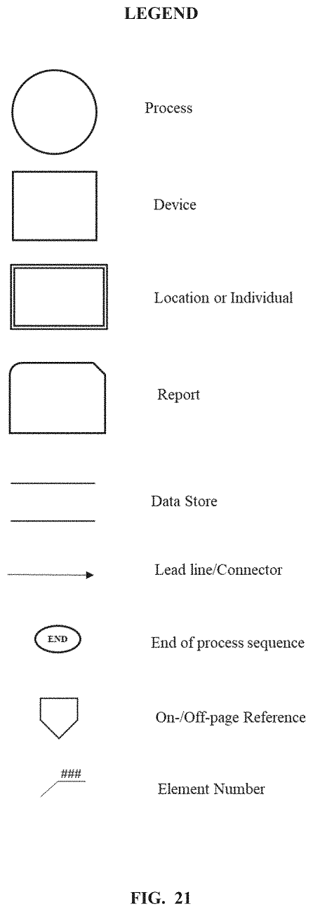

Reference to ‘(1.X)’ in the following description refers to FIG. 1 of the drawings and element number ‘X’ included in the FIG. 1.

To overcome the disadvantages of individual repair and maintenance of unmanned aerial Vehicles, as described in the Background section above, it would therefore be advantageous to use a ROMA to repair and maintain unmanned aerial Vehicles. Using a centrally managed operation with standardized, regulatory compliant procedures and practices to repair and maintain Vehicles, would markedly improve the consistent and reliable operation of mission critical unmanned aerial Vehicles. Application of unmanned aerial Vehicles for critical inspection of large outdoor commercial assets such as, but not limited to, agricultural crops, electrical high voltage distribution facilities, nuclear power plants, water, gas and petroleum pipelines, radio and cellular towers, solar panel farms, and railroad lines would significantly improve. The use of unmanned aerial Vehicles for vital inspection of outdoor civil and public infrastructure such as, but not limited to streets, pavements, highways, dams, bridges and harbors would be more dependable with ROMA. Public fire, safety and medical emergency applications would operate more reliably and with less down time with ROMA repairing and maintaining the unmanned aerial Vehicles.

Previously, each company and government agency, using unmanned aerial Vehicles, would have to create and support the cost of the repair and maintenance of their own unmanned aerial Vehicles. A centrally managed maintenance process and system would provide for a more cost-effective use of, but not limited to, maintenance and repair personnel as well as maintenance and repair tools, equipment, diagnostic, test equipment. The economies of scale inherent in ROMA repair and maintenance of unmanned aerial Vehicles provides a lower cost and more reliable approach to repairing and maintaining unmanned aerial Vehicles. Best operating and federal, state and local regulatory compliant, practices would be employed consistently across unmanned aerial Vehicle applications such as, but not limited to, critical inspection of large outdoor commercial assets and civil and public infrastructure. Public fire, safety and medical emergency applications using unmanned aerial Vehicles would also benefit from ROMA standardized and regulatory compliance maintenance and repair. The quality and standardization of the maintenance and repair of unmanned aerial Vehicles would be assured. The repair and maintenance of unmanned aerial Vehicles would be greatly improved as would the public welfare and safety because of ROMA.

FIG. 1 illustrates an exemplary system to Identify Vehicle Needing Repair and the related process of the present invention.

According to the process, Repair Tech Queries “down” Vehicles, illustrated in (1.3) the Repair Tech queries the “down” Vehicles. As shown in FIG. 1, the process 1.3 interacts with an associated Vehicle Data Store (1.1) by providing the Vehicle Down Query and the data store provides the Vehicle Down Report. The process, 1.3, produces a Down Vehicle Report (1.5).

The report (1.5) is a Down Vehicle Report. The report is stored in an associated Vehicle Down Report Data Store, illustrated in (1.37).

The process, Repair Tech Reviews Standard Repair Cost and Time Estimates, illustrated in (1.7) for the repair tech review the cost and time of the repair.

The process, Repair Tech Determines Repair Location, illustrated in (1.9) for the Repair Tech to determine the repair location. The process, 1.9, interacts with an associated Vehicle Data Store (1.1) by entering the Vehicle ID and Repair Locations. The process, 1.9, produces a Vehicle Repair Location Report (1.27).

The report (1.27) is a Vehicle Repair Location Report. The report, 1.27, interacts with an associated Vehicle Repair Location Report Data Store (1.33).

The process, Repair Tech Determines Repair Priority, illustrated in (1.11) for the Repair Tech to determine the priority of the repair. The process, 1.11, interacts with an associated Vehicle Data Store by entering the Vehicle ID and Repair Priority. The process, 1.11, produces a Vehicle Repair Priority Report (1.29).

The report (1.29) is a Vehicle Repair Priority Report. The report, 1.29, interacts with an associated Vehicle Repair Priority Report Data Store (1.39).

The process, Repair Tech Estimates Repair Date, illustrated in (1.13) for the Repair Tech to estimate the Repair Date. The process, 1.13, interacts with an associated Vehicle Data Store, 1.1. The process, 1.13, produces a Vehicle Estimated Repair Complete Date Report (1.31) and an Enterprise Vehicle Repair Notice Report (1.17).

The report (1.17) is an Enterprise Vehicle Repair Notice Report. The report, 1.17, is sent to the Enterprise Agent, illustrated in (1.19).

The report (1.31) is a Vehicle Estimated Repair Complete Date Report. The report, 1.31, is stored in an associated Vehicle Estimated Repair Complete Date Report Data Store, illustrated in (1.41).

The process, Repair Tech Notifies Enterprise Vehicle Needs Repair, illustrated in (1.15) for the Repair Tech to notify the Enterprise that a Vehicle needs Repair. The process, 1.15, interacts with an associated Enterprise Data Store (1.25) by entering the Enterprise Contacts Data and the data store returns the Enterprise ID. The process, 1.15, interacts with an associated Vehicle Data Store (1.1).

The process, Repair Tech Sends Enterprise Authorization Vehicle Repair Report, illustrated in (1.21) for the Repair Tech to send the Enterprise Authorization for the Vehicle Repair Report. The process, 1.21, produces an Enterprise Vehicle Repair Authorization Request Report (1.23).

The report (1.23) is an Enterprise Vehicle Repair Authorization Request Report. The report, 1.23, is sent to the Enterprise Agent. The report, 1.23, interacts with an associated Enterprise Repair Notice Report Data Store (1.35).

FIG. 2 illustrates an exemplary system for Enterprise Authorizes Repair and the related process of the present invention.

The process, Enterprise Agent Authorizes Repair, illustrated in (2.1) for the Enterprise Agent to authorize repair. If the Enterprise Agent authorizes repair, a Signed Enterprise Vehicle Authorization Request Report (2.5) is produced.

The report (2.5) is a Signed Enterprise Vehicle Authorization Request Report. The report, 2.5, is stored in an associated Repair Work Orders Data Store, illustrated in (2.7). The report, 2.5, is stored in an associated Vehicle Repair Location Report Data Store, illustrated in (2.33).

If the repair is not authorized, the process, Repair Tech Starts Dispute Process, illustrated in (2.3), takes place. A Repair Dispute Report (2.27) is produced.

The report (2.27) is a Repair Dispute Report. The report, 2.27, is stored in an associated Repair Dispute Report Data Store, illustrated in (2.29).

The process, Repair Tech Starts Loss Mitigation Process, illustrated in (2.9) for the Repair Tech to start Loss Mitigation if the dispute is not resolved.

According to the process, Repair Tech Determines Parts Needed, illustrated in (2.11), the Repair Tech determines parts needed if the repair is authorized or if the dispute is resolved. The process, 2.11, interacts with an associated Vehicle Data Store (2.25) by entering the Vehicle ID and the data store returns the Part Data and Vendor Data. The process, 2.11, produces a Vehicle Repair Parts Report (2.13).

The report (2.13) is a Vehicle Repair Parts Report. The report, 2.13, is stored in an associated Vehicle Repair Parts Report Data Store, illustrated in (2.35).

According to the process, Repair Tech Estimates Cost of Repair, illustrated in (2.15), the Repair Tech estimates the cost of repair. The process interacts with an associated Vehicle Data Store, illustrated in (2.17) by entering the Vehicle ID and Repair Cost. The process, 2.15, produces a Vehicle Repair Cost Estimate Report (2.19).

The report (2.19) is a Vehicle Repair Cost Estimate Report. The report, 2.19, is stored in an associated Vehicle Cost Estimate Report Data Store, illustrated in (2.37).

According to the process, Repair Tech Check Enterprise Credit Balance, illustrated in (2.21), the Repair Tech checks the enterprise credit balance. The process, 2.21, interacts with an associated Vehicle Data Store (2.17) by entering the repair cost and the data store returns the Vehicle ID. The process, 2.21, interacts with an associated Enterprise Data Store, illustrated in (2.23) by entering the Credit Balance and the data store returns the Enterprise ID. The process, 2.21, produces an Enterprise Credit Balance Report (2.29).

The report (2.29) is an Enterprise Credit Balance Report. The report, 2.29, is stored in an Enterprise Credit Balance Report Data Store, illustrated in (2.31).

FIG. 3 illustrates an exemplary system for Repair Tech Schedules Onsite Vehicle Repair and the related process of the present invention.

According to the process, Repair Tech Schedules Repair, illustrated in (3.1), the Repair Tech schedules the repair. The process interacts with an associated Vehicle Data Store, illustrated in (3.5) by entering the Repair Location and the data store returns the Vehicle ID. The process, 3.1, produces a Vehicle repair Work Order Report (3.7) if it is an onsite repair.

The report (3.7) is a Vehicle Repair Work Order Report. The report, 3.7, is stored in a Vehicle Repair Work Order Report Data Store, illustrated in (3.25). The report, 3.7, is stored in a Vehicle Repair Work Orders Data Store, illustrated in (3.31).

The process, Repair Tech Sends Repair Work Order to Flight Management Ops, illustrated in (3.9) for the Repair Tech to send the repair work order to the flight management ops.

In the process, Flight Management Ops ACK Receipt of Work Order, illustrated in (3.11) the Flight Management Ops acknowledges receipt of the work order. The process, 3.11, interacts with an associated Vehicle Repair Work Orders Data Store, illustrated in (3.31).

According to the process, Repair Tech Orders Parts for Vehicle, illustrated in (3.13) the Repair Tech orders the parts for the Vehicle. The process, 3.13, produces a PO for Repair Parts Report, illustrated in (3.17).

The report (3.17) is a PO for Repair Parts Report. The report, 3,17, is stored in a PO for Repair Parts Report Data Store, illustrated in (3.3). The report, 3.17, is stored in a Vehicle Repair Work Orders Data Store, illustrated in (3.31).

In the process, Parts Delivered to Repair Tech, illustrated in (3.19) the parts to be delivered to the Repair Tech are identified.

In the process, Repair Tech ACK Receipt of Parts, illustrated in (3.21) the Repair Tech acknowledges receipt of parts. The process, 3.21, produces a Parts Received Report (3.23).

The report (3.23) is a Parts Received Report. The report, 3.23, is stored in an associated Parts Receipt Report Data Store, illustrated in (3.29).

FIG. 4 illustrates an exemplary system for Vehicle Repaired and the related process of the present invention.

According to the process, Repair Tech Completes Vehicle Repair, illustrated in (4.1) the Repair Tech completes the Vehicle repair. The process, 4.1, produces a Vehicle Repair Completion Report (4.9).

The report (4.9) is a Vehicle Repair Completion Report. The report, 4.9, is stored in an associated Vehicle Repair Completion Report Data Store, illustrated in (4.19).

In the process, Repair Tech Updates Vehicle with New Parts ID, Serial Numbers, illustrated in (4.3) the Repair Tech updates the Vehicle with new Parts ID and Serial Numbers. The process, 4.3, interacts with an associated Vehicle Data Store, illustrated in (4.23). The process, 4.3, produces a Vehicle New Parts Report (4.11).

The report (4.11) is a Vehicle New Parts Report. The report, 4.11, is stored in an associated Vehicle New Parts Report Data Store, illustrated in (4.21).

In the process, Repair Tech Execute Vehicle Full Systems Test and Produces Full System Test Report, illustrated in (4.5) the Repair Tech executes a Vehicle full systems test and produces a full system test result report. The Full System Test Results are sent to an Enterprise Agent, illustrated in (4.13). The process, 4.5, produces full System Test Results Report (4.15).

According to the process, Repair Tech Notifies Flight Management Center Vehicle is Repaired, illustrated in (4.7) the Repair Tech notifies the flight Management Center that the Vehicle is repaired.

The report (4.15) is a Full System Test Results Report. The report, 4.15, is stored in an associated Full System Test Results Report Data Store, illustrated in (4.17).

FIG. 5 illustrates an exemplary system for Repair Tech Schedules Repair Depot Vehicle Repair and the related process of the present invention.

The process, Repair Tech Sends Notice to VO to Prepare Vehicle for Pickup, illustrated in (5.1) is for the Repair Tech to send notice to the VO to prepare the Vehicle for pickup. The process, 5.1, produces a Vehicle Pickup Notice Report (5.3).

The report (5.3) is a Vehicle Pickup Notice Report. The report, 5.3, is stored in an associated Vehicle Pickup Notice Report Data store, illustrated in (5.21).

In the process, VO Gets Pickup Packing Requirements for Vehicle, illustrated in (5.7) the VO gets pickup packing requirements for the Vehicle.

According to the process, VO Requests Delivery of Packing Requirements from Repair Tech, illustrated in (5.9) the VO requests delivery packing requirements from the Repair Tech. The process, 5.9, interacts with an associated Vehicle Data Store, illustrated in (5.5) by entering the Vehicle ID and the data store returns the Packing Requirements. The process, 5.9, produces a Packing List and Crate Report (5.11).

The report (5.11) is a Packing List and Crate Report. The report, 5.11, is stored in an associated Packing List and Crate Report Data Store, illustrated in (5.23).

In the process, Tech Schedules Pickup and Shipping with Shipper, illustrated in (5.13) the Tech schedules pickup and shipping with the shipper. The process interacts with an associated Shipping Company Data Store, illustrated in (5.19) by entering the Vehicle ID and the data store returns the Vehicle GEO Area. The process interacts with an associated Vehicle Data Store (5.5) by entering the Vehicle GEO Area and the data store returns the Shipping Company. The process, 5.13, produces a Vehicle and Crate Pickup and Shipping Order Report (5.15).

The report (5.15) is a Vehicle and Crate Pickup and Shipping Order Report. The report, 5.15, is stored in an associated Crate Pickup and Shipping Order Report Data Store, illustrated in (5.25).

The process, Repair Tech Sends P.O. to Accounts Payable, illustrated in (5.17) is for the Repair Tech to send the P.O. to accounts payable. The process, 5.17, interacts with an associated Purchase Order Data Store, illustrated in (5.27).

FIG. 6 illustrates an exemplary system to Ship Vehicle to Repair Depot and the related processes of the present invention.

In the process, Repair Tech Sends Vehicle and Crate Shipment Tracking Info to VO, illustrated in (6.1) the Repair Tech sends the Vehicle and Crate shipment tracking info to the VO. The process, 6.1, produces a Packing Slip and Crate Tracking Information Report (6.11).

The report (6.11) is a Packing Slip and Crate Tracking Information Report. The report, 6.11, is stored in an associated Packing Slip and Crate Tracking Information Report Data Store, illustrated in (6.19).

According to the process, VO Receives Crate and Packs Vehicle, illustrated in (6.3) the VO receives the crate and packs the Vehicle.

In the process, VO Sends Notice to Repair Tech Vehicle is Packed and Ready for Pickup, illustrated in (6.5) the VO sends a notice to the Repair Tech that the Vehicle is packed and ready for pickup. The process, 6.5, produces a Vehicle Pickup Request Report (6.13).

The report (6.13) is a Vehicle Pickup Request Report. The report, 6.13, is stored in an associated Vehicle Pickup Request Report Data Store, illustrated in (6.21).

The process, Tech Orders Vehicle Pickup from Shipper, illustrated in (6.7) is for the Repair Tech to order the Vehicle for pickup. The process, 6.7, produces a Vehicle Pickup Shipping Order Report (6.15).

The report (6.13) is a Vehicle Pickup Shipping Order Report. The report, 6.15, is stored in an associated Vehicle Pickup Shipping Order Data Store, illustrated in (6.23).

According to the process, Shipper Picks up Vehicle and Crate in the Field and Delivers to Repair Depot, illustrated in (6.9) the shipper picks up the Vehicle and delivers it to the Repair Depot. The process interacts with an associated Bill of Lading Data Store, illustrated in (6.27). A Pickup and Bill of Lading Report (6.17) is produced.

The report (6.17) is a Pickup and Bill of Lading Report. The report, 6.17, is stored in an associated Pickup and Bill of Lading Report Data Store, illustrated in (6.25).

FIG. 7 illustrates an exemplary system for Vehicle Test and the related processes of the present invention.

The process, Repair Tech Receives Vehicle from Shipper, illustrated in (7.1) is for the Repair Tech to receive the Vehicle from the shipper. The process, 7.1, interacts with an associated Shipping Companies Data Store, illustrated in (7.5). The process, 7.1, interacts with an associated Vehicle Data Store, illustrated in (7.7).

In the process, Repair Tech Unpacks Vehicle, illustrated in (7.3) the Repair Tech unpacks the Vehicle. The process, 7.3, produces a Vehicle Unpacking Condition Report (7.23).

The report (7.23) is a Vehicle Unpacking Condition Report. The report, 6.23, is stored in an associated Vehicle Unpacking Condition Report Data Store, illustrated in (7.25).

In the process, Repair Tech Performs Full System Test on Vehicle, illustrated in (7.11) the Repair Tech performs a full system test on the Vehicle. The process, 7.11, interacts with an associated Vehicle Data Store, illustrated in (7.7). The process, 7.11 interacts with an associated Vehicle Log Data Store, illustrated in (7.9). The process, 7.11, produces a Full System Test Report (7.13).

According to the process, Repair Tech Performs Diagnostic Analysis, illustrated in (7.15) the Repair Tech performs a Diagnostic Analysis. The process, 7.15, produces a Test Diagnosis Report (7.17).

The report (7.17) is a Test Diagnosis Report. The report, 7.17, is stored in a Test Diagnosis Report Data Store illustrated in (7.29).

The process, Repair Tech Orders Replacement Parts from Inventory, illustrated in (7.19) is for the Repair Tech to order replacement parts from inventory. The process, 7.19, interacts with an associated Vehicle Data Store illustrated in (7.7). The process, 7.19, interacts with an associated Vehicle Log Data Store, illustrated in (7.9). The process, 7.19, produces a Replacement Parts Order report (7.21).

The report (7.21) is a Replacement Parts Order Report. The report, 7.21, is stored in an associated Replacement Parts Order Report Data Store, illustrated in (7.31).

FIG. 8 illustrates an exemplary system for Vehicle Repair and the related processes of the present invention.

In the process, Repair Tech Repairs Vehicle, illustrated in (8.1) the Repair Tech repairs the Vehicle. The process, 8.1, produces a Vehicle Repair Checklist Report (8.11).

The report (8.11) is a Vehicle Repair Checklist Report. The report, 8.11, is stored in an associated Vehicle Repair Checklist Report Data Store illustrated in (8.25).

In the process, Repair Tech Updates Vehicle Records with New Parts Serial Numbers and ID Numbers, illustrated in (8.3) the Repair Tech updates the Vehicles records with new parts serial numbers and ID numbers. The process, 8.3, interacts in an associated Vehicle Data Store illustrated in (8.21). The process, 8.3, interacts with an associated Vehicle Log Data Store illustrated in (8.23). The process, 8.3, produces a Vehicle Parts Repaired Report (8.13).

The report (8.13) is a Vehicle Parts Repaired Report. The report, 8.13, is stored in an associated Vehicle Parts Repaired Report Data Store, illustrated in (8.27).

The process, Repair Tech Prepares Vehicle Repair Report, illustrated in (8.5) is for the Repair Tech to prepare a Vehicle Repair Report (8.15).

The report (8.15) is a Vehicle Repaired Report. The report, 8.15, is stored in an associated Vehicle Repaired Report Data Store, illustrated in (8.29).

According to the process, Repair Tech Sends Vehicle Repaired Report to Enterprise Agent, illustrated in (8.7) the Repair Tech sends the Vehicle Repaired Report to the Enterprise Agent. The process, 8.7, produces an Enterprise Vehicle Repaired Report (8.17).

The report (8.17) is an Enterprise Vehicle Repaired Report. The report, 8.17, is stored in an associated Enterprise Vehicle Repaired Report Data Store, illustrated in (8.31).

The process, Repair Tech Sends Flight Management Ops Vehicle Repaired Report, illustrated in (8.9) is for the Repair Tech to send the Flight Management Ops Vehicle Repaired Report (8.19).

The report (8.19) is a Flight Management Ops Vehicle Repaired Report. The report, 8.19, is stored in an associated Flight Ops Vehicle Repaired Report Data Store, illustrated in (8.33).

FIG. 9 illustrates an exemplary system to Remove Grounded Status and the related processes of the present invention.

The process, Repair Tech Removes Vehicle “Grounded” Status, illustrated in (9.1) is for the Repair Tech to remove Vehicle “Grounded” Status. The process, 9.1, interacts with an associated Vehicle Log Data Store, illustrated in (9.15). The process, 9.1, produces a Remove Vehicle Grounded Report (9.19).

The report (9.19) is a Remove Vehicle Grounded Report. The report, 9.19, is stored in an associated Removed Vehicle Grounded Report Data Store, illustrated in (9.31).

In the process, Repair Tech Packs Vehicle in Shipping Crate, illustrated in (9.3) the Repair Tech packs the Vehicle in the Shipping Crate. The process, 9.3, produces a Vehicle Packing List Report (9.21).

The report (9.21) is a Vehicle Packing List Report. The report, 9.21, is stored in an associated Vehicle Packing List Report Data Store, illustrated in (9.33).

According to the process, Repair Tech Notifies VO the Vehicle is Being Returned, illustrated in (9.5) the Repair Tech to notifies the VO that the Vehicle is being returned. The process, 9.5, produces a VO Vehicle Return to Site Report (9.23).

The report (9.23) is a VO Vehicle Return to Site Report. The report, 9.23, is stored in an associated VO Vehicle Return to Site Report Data Store, illustrated in (9.35).

In the process, Repair Tech Notifies Enterprise Vehicle is Being Returned to Site, illustrated in (9.7) the Repair Tech notifies the Enterprise that the Vehicle is being returned to site. The process, 9.7, produces an Enterprise Vehicle Return to Site Report (9.25).

The report (9.25) is an Enterprise Vehicle Return to Site Report. The report, 9.25, is stored in an associated Enterprise Vehicle Return to Site Report Data Store, illustrated in (9.37).

In the process, VO Receives the Crate and Unpacks Vehicle, illustrated in (9.9) the VO receives the crate and unpacks the Vehicle. A Bill of Lading Report (9.27) is produced.

The report (9.27) is a Bill of Lading Report. The report, 9.27, is stored in an associated Bill of Lading Report Data Store, illustrated in (9.39).

In the process, VO Notifies Repair Tech Vehicle Arrived at Site, illustrated in (9.11) the VO notifies the Repair Tech that the Vehicle has arrived on site. The process, 9.11, interacts with an associated Vehicle Log Data Store illustrated in (9.15). The process, 9.11, interacts with an associated Vehicle Data Store illustrated in (9.17). The process, 9.11, produces a Vehicle on Site Report (9.29).

The report (9.29) is a Vehicle on Site Report. The report, 9.29, is a Vehicle on Site Report Data Store, illustrated in (9.41).

According to the process, Tech Performs Vehicle Test, illustrated in (9.13) the Repair Tech performs a Vehicle test.

FIG. 10 illustrates an exemplary system for Vehicle Returned to Service and the related processes of the present invention.

The process, VO Confirms Test Results, illustrated in (10.1) is for the VO to confirm Test Results.

In the process, VO Confirms Vehicle is Ready for Service, illustrated in (10.3) the VO confirms the Vehicle is ready for service. The process, 10.3, interacts with an associated Vehicle Log Data Store, illustrated in (10.13). The process, 10.3, produces a VO Test Confirmation Report (10.21).

The report (10.21) is a VO Test Confirmation Report. The report, 10.21, is stored in an associated VO Test Confirmation Report Data Store, illustrated in (10.15).

In the process, Tech Notifies Enterprise Vehicle is Ready for Service, illustrated in (10.5) the Tech notifies the Enterprise that the Vehicle is Ready for Service. The process, 10.5, produces an Enterprise Vehicle Ready for Service Report (10.23).

The report (10.23) is an Enterprise Vehicle Ready for Service Report. The report, 10.23, is stored in an associated Enterprise Vehicle Ready for Service Report Data Store, illustrated in (10.17).

In the process, VO Reviews Secure Vehicle on Site Checklist, illustrated in (10.7) the VO reviews the secure Vehicle on site checklist.

The process, VO Secures Vehicle on Site, illustrated in (10.9) is for the VO to secure the Vehicle on site. The process, 10.9, produces a Secure Vehicle on Site Checklist Report (10.25).

The report (10.25) is a Secure Vehicle on Site Checklist Report. The report, 10.25, is stored in an associated Secure Vehicle on Site Checklist Report Data Store, illustrated in (10.19).

In the process, Flight Ops Returns Vehicle to Service, illustrated in (10.11) the Flight Ops returns Vehicle to service.

FIG. 11 illustrates an exemplary system for Scheduled Maintenance if Unmanned Vehicles Onsite Order Parts and the related processes of the present invention.

The process, Repair Tech Determined Vehicles to be Maintained on Site, illustrated in (11.1) is for the Repair Tech to determine Vehicles to be maintained on site. The process, 11.1, interacts with an associated Vehicle Maintenance Calendar Data Store, illustrated in (11.17) by entering Today's Data and the data store returns the Vehicle ID and Maintenance Job ID.

In the process, Repair Tech Determined Parts Needed, illustrated in (11.3) the Repair Tech determines parts needed. The process, 11.3, interacts with an associated Maintenance Job Data Store, illustrated in (11.19) by entering the Parts List and the data store returns the Maintenance Job ID. The process produces a Maintenance Job Report (11.27).

The report (11.27) is a Maintenance Job Report. The report, 11.27, is stored in an associated Maintenance job Report Data Store, illustrated in (11.33).

According to the process, Repair Tech Creates Parts List, illustrated in (11.5) the Repair Tech creates a Parts List. The process produces a Vehicle Maintenance Repair Parts List Report (11.29).

The report (11.29) is a Vehicle Maintenance Repair Parts List Report. The report, 11.29, is stored in an associated Vehicle Maintenance Parts List Report Data Store, illustrated in (11.35).

In the process, Repair Tech Requests Delivery of Parts on Parts List, illustrated in (11.7) the Repair Tech requests delivery of parts on Part list. The process, 11.17, interacts with an associated Maintenance Parts List Request Data Store, illustrated in (11.21) by entering the Vehicle ID Parts List.

In the process, Repair Manager Checks for Parts Available in Inventory, illustrated in (11.9) for the Repair Manager to check for parts available in inventory. The process, 11.9, interacts with an associated Parts Inventory Data Store, illustrated in (11.23) by entering the Parts ID and the Data Store Returns the Quantity Available.

According to the process, Repair Manager Orders Parts from Vendor, illustrated in (11.11) the Repair Manager orders parts from vendor. The process, 11.11, interacts with an associated Purchase Order Data Store, illustrated in (11.25) by entering the Parts ID and Vendor ID. The process, 11.11, produces a Purchase Order Report (11.31).

The report (11.31) is a Purchase Order Report. The report, 11.31, is stored in an associated Purchase Order Report Data Store, illustrated in (11.37).

In the process, Vendor Ships Parts, illustrated in (11.13) the Vendor ships parts.

In the process, Repair Manager Receives Parts and Updates Inventory, illustrated in (11.15) the Repair Manager receives the parts and update the inventory. The process, 11.15, interacts with an associated Parts Inventory Data Store, illustrated in (11.23).

FIG. 12 illustrates an exemplary system for Parts Sent to Onsite Repair Tech and the related processes of the present invention.

In the process, Repair Manager Packs Maintenance Parts, illustrated in (12.1) the Repair Manager packs maintenance parts. The process, 12.1, interacts with an associated Parts Inventory Data Store, illustrated in (12.11) by entering the Parts ID. The process, 12.1, interacts with an associated Maintenance Job Data Store, illustrated in (12.13) by entering the Vehicle ID and the Data Store returns the Maintenance Job ID. The process, 12.1, produces a Packing List Report (12.23).

The report (12.23) is a Packing List report. The report, 12.23, is stored in an associated Packing List Report Data Store, illustrated in (12.21).

In the process, Repair Manager Sends Parts to Repair Tech, illustrated in (12.3) the Repair Manager sends parts to the Repair Tech. The process, 12.3, interacts with an associated Shipping Companies Data Store, illustrated in (12.15) by entering the GEO Area ID and the Data Store returns the Shipping Company.

The process, Repair Manager Sends Shipping Notice and Packing List to Repair Tech, illustrated in (12.5) is for the Repair Manager to send a shipping notice and packing list to the repair tech.

The process, Repair Tech Receives Parts, illustrated in (12.7) is for the Repair Tech to receive the parts. The process, 12.7, interacts with an associated Vehicle Log Data Store, illustrated in (12.17).

In the process, Repair Tech Schedules Vehicle for Maintenance, illustrated in (12.9) the Repair Tech schedules Vehicle for maintenance. The process, 12.9, interacts with an associated Vehicle Maintenance Calendar Data Store, illustrated in (12.19).

FIG. 13 illustrates an exemplary system for Repair Tech ‘Down’ Vehicle and the related processes of the present invention.

The process, Repair Tech Travels to Vehicle, illustrated in (13.1) is for the Repair Tech to travel to the Vehicle.

The process, Repair Tech Requests Flight Ops to ‘Down’ Vehicle for Maintenance, illustrated in (13.3) is for the Repair Tech to request Flight Ops to ‘Down’ Vehicle for maintenance. The process, 13.3, interacts with an associated Vehicle Log Data Store, illustrated in (13.15) by entering the Down Request.

According to the process, Flight Ops Manager Notifies Enterprise Vehicle ‘Down’ for Maintenance, illustrated in (13.5) for the Flight Ops Manager to notify the Enterprise that a Vehicle is ‘Down’ for maintenance. The process, 13.5, interacts with an associated Vehicle Log Data Store, illustrated in (13.15) by entering the Vehicle Down Notice.

In the process, Flight Ops ‘Down’ Vehicle for Maintenance, illustrated in (13.7) the Flight Ops ‘Downs’ the Vehicle for maintenance. The process, 13.7, interacts with an associated Vehicle Log Data Store (13.15) by entering the Vehicle Down.

The process, Flight Ops Sends ‘Down’ Command to Vehicle via RF, illustrated in (13.9) is for the Flight Ops to send ‘Down’ Command to Vehicle via RF. The process, 13.9, interacts with an associated Vehicle Log Data Store (13.15) by entering the Down Command.

In the process, Flight Ops Notifies Repair Tech Vehicle is ‘Down’, illustrated in (13.11) the Flight Ops notifies the Repair Tech that the Vehicle is ‘Down’.

The process, Repair Examines Vehicle and Confirms Vehicle is ‘Down’, illustrated in (13.13) is for the Repair Tech to examine the Vehicle and Confirm it is ‘Down’. The process, 13.13, interacts with an associated Vehicle Log Data Store (13.15).

FIG. 14 illustrates an exemplary system for Repair Tech Performs Maintenance and the related processes of the present invention.

The process, Repair Tech Installs Parts, illustrated in (14.1) is for the Repair Tech to install parts. The process, 14.1, interacts with an associated Vehicle Log Data Store, illustrated in (14.23).

According to the process, Repair Tech Updates Vehicle Data with New Parts Id, illustrated in (14.3) the Repair Tech updates the Vehicle Data with new Parts ID. The process, 14.3, interacts with an associated Vehicle Fata Store, illustrated in (14.21) by entering the Vehicle ID and Parts ID. The process, 14.3, interacts with an associated Vehicle Log Data Store (14.23) by entering the Vehicle ID and Parts ID.

In the process, Repair Tech Completes Maintenance Job Report, illustrated in (14.5) the Repair Tech completes the Maintenance Job Report. The process, 14.5, interacts with an associated Maintenance Job Data Store, illustrated in (14.55). The process, 14.5, interacts with an associated Vehicle Log Data Store (14.23) by entering the Maintenance Job Report.

In the process, Repair Tech Notified Flight Ops Vehicle Maintenance is Complete, illustrated in (14.7) the Repair Tech notifies Flight Ops that the Vehicle maintenance is complete. The process, 14.7, interacts with an associated Vehicle Log Data Store (14.23) by entering the Vehicle ID Maintenance Complete message. The process, 14.7, produces a Maintenance Job Report (14.29).

The report (14.29) is a Maintenance Job Report. The report, 14.29, is stored in an associated Maintenance Job Report Data Store, illustrated in (14.31).

In the process, Repair Tech Request Flight Ops to Send Full System Test Command to Vehicle, illustrated in (14.9) the Repair Tech requests Flight Ops to send a Full System Test Command to the Vehicle. The process, 14.9, interacts with an associated Vehicle Log Data Store (14.23) by entering the Full System Test Request.

In the process, Flight Ops Sends ‘Full System Test’ Command to Vehicle, illustrated in (14.11) the Flight Ops sends the Full System Test command to the Vehicle. The process, 14.11, interacts with an associated Vehicle Log Data Store (14.23) by entering the Command.

In the process, Vehicle Does ‘Full System Test’, illustrated in (14.13) the Vehicle performs the Full System test. The process, 14.13, interacts with an associated Vehicle Log Data Store (14.23) by entering the Test Complete Vehicle ID. The process, 14.13, produces a Full System Test Report (14.27).

The report (14.27) is a Full System Test Report. The report, 14.27, is stored in an associated Full System Test Report Data Store, illustrated in (14.33).

In the process, Vehicle Sends Test Results to Flight Ops, illustrated in (14.15) the Vehicle sends the test results to Flight Ops. The process, 14.15, interacts with an associated Vehicle Log Data Store (14.23) by entering the Test Results and Vehicle ID. The process, 14.15, interacts with an associated Full System Test Data Store, illustrated in (14.25) by entering the Test Results and Vehicle ID.

The process, Repair Tech Repairs Vehicle, illustrated in (14.17) is for the Repair Tech to repair the Vehicle is the Full System Test Results are Not OK. The process, 14.17, interacts with an associated Vehicle Log Data Store (14.23).

In the process, Repair Tech Confirms Vehicle Test OK, illustrated in (14.19) the Repair Tech Confirms Vehicle Test OK. The process, 14.19, interacts with an associated Vehicle Log Data Store (14.23) by entering the Test OK message.

FIG. 15 illustrates an exemplary system for Vehicle Status Changed From ‘Down’ to ‘Ready’ and the related processes of the present invention.

The process, Repair Tech Requests Flight Ops Remove Vehicle ‘Down’ Status, illustrated in (15.1) is for the Repair Tech to request Flight Ops to remove Vehicle ‘Down’ Status. The process, 15.1, interacts with an associated Vehicle Log Data Store, illustrated in (15.9) by entering the No ‘Down’ Status.

In the process, Flight Ops Changes Vehicle Status From ‘Down’ to ‘Ready’, illustrated in (15.3) the Flight ops changes the Vehicle Status from ‘Down’ to ‘Ready’. The process, 15.3, interacts with an associated Vehicle Log Data Store (15.9) by entering the ‘Ready’ Status.

In the process, Flight Ops Notifies Enterprise Vehicle Maintenance Complete and Status is ‘Ready’, illustrated in (15.5) the Flight Ops notifies the Enterprise that the Vehicle maintenance is complete, and the Vehicle status is ‘Ready’.

In the process, Flight Ops Approves Maintenance Job Report Complete, illustrated in (15.7) the Flight Ops approves the Maintenance Job Report is complete. The process, 15.7, interacts with an associated Vehicle Log Data Store (15.9) by entering the Maintenance Complete message. The process, 14.7, produces a Maintenance Job Complete Report (15.11).

The report (15.11) is a Maintenance Complete Report. The report, 15.11, is stored in an associated Maintenance Job Complete Report Data Store, illustrated in (15.13).

FIG. 16 illustrates an exemplary system for Scheduled Maintenance at Repair Depot and the related processes of the present invention.

In the process, Repair Tech Determined Vehicle Needs Maintenance, illustrated in (16.1) the Repair Tech determines that the Vehicle needs maintenance.

The process, Repair Tech Packs Vehicle to be Shipped to Depot, illustrated in (16.3) is for the Repair Tech to pack the Vehicle to be shipped to the Repair Depot. The process, 16.3, interacts with an associated Vehicle Log Data Store, illustrated in (16.17).

The process, Repair Tech Requests Authorization to Ship Vehicle, illustrated in (16.5) is for the Repair Tech to request authorization to ship the Vehicle. The process, 16.5, produces a Shipping Authorization Report (16.19).

The report (16.19) is a Shipping Authorization Report. The report, 16.19, is stored in an associated Shipping List Report Data Store, illustrated in (16.33).

According to the process, Repair Tech Ships Vehicle to Depot, illustrated in (16.7) the Repair Tech ships the Vehicle to the Repair Deport. The process, 16.7, produces a Bill of Lading Report (16.23) and a Packing List Report (16.25).

The report (16.23) is a Bill of Lading Report. The report, 16.23, is stored in an associated Bill of Lading Report Data Store, illustrated in (16.21).

The report (16.25) is a Packing List Report. The report, 16.25, is stored in an associated Packing List Report Data Store, illustrated in (16.31).

In the process, Vehicle Arrives at Repair Depot, illustrated in (16.9) the Vehicle arrives at the Repair Deport. The process, 16.9, interacts with an associated Vehicle Log Data Store (16.17).

In the process, Repair Tech Inspects for Vehicle Damage, illustrated in (16.11) the Repair Tech inspects for Vehicle damage.

The process, Repair Tech Files Claim with Shipper, illustrated in (16.13) is for the Repair Tech to file a claim with the shipper if there is Vehicle damage. The process, 16.13, produces a Full System Test Report (16.27).

The report (16.27) is a Full System Test Report. The report, 16.27, is stored in an associated Vehicle Data Store, illustrated in (16.29).

In the process, Repair Tech Notifies Asset Accounting of Damage Claim, illustrated in (16.15) the Repair Tech notifies Asset Accounting of the Damage Claim.

FIG. 17 illustrates an exemplary system for Vehicle Returned to Site and the related processes of the present invention.

In the process, Repair Tech Packs Vehicle for Rerun to Site, illustrated in (17.1) the Repair Tech packs the Vehicle for return to the site. The process, 17.1, interacts with an associated Vehicle Data Store, illustrated in (17.11).

According to the process, Repair Tech Requests Authorization to Ship Vehicle, illustrated in (17.3) the Repair Tech requests authorization to ship the Vehicle.

In the process, Flight Ops Management Authorizes Vehicle to be Shipped to Site, illustrated in (17.5) Flight Ops Management authorizes the Vehicle to be shipped back to the site. The process, 17.5, produces a Shipping Authorization Report (17.13).

The report (17.13) is a Shipping Authorization Report. The report, 17.13, is stored in an associated Shipping Authorization Report Data Store, illustrated in (17.23).

In the process, Repair Tech Ships Vehicle to Site, illustrated in (17.7) the Repair Tech ships the Vehicle back to the site. The process, 17.7, produces a Packing List Report (17.15) and a Billing of Lading Report (17.17).

The report (17.15) is a Packing List Report. The report, 17.15, is stored in an associated Packing List Report Data Store, illustrated in (17.21).

The report (17.17) is a Bill of Lading Report. The report, 17.17, is stored in an associated Bill of Lading Report Data Store, illustrated in (17.19).

In the process, Vehicle Arrives at Site, illustrated in (17.9) the Vehicle arrives at the site. The process, 17.9, interacts with an associated Vehicle Data Store (17.11) by entering the Arrives message.

This disclosure is not intended to limit the invention to the described Vehicles, devices, and processes as is more fully described herein. As should be recognized by those skilled in the art, other claims and processes may be integrated and managed using similar methods and are intended to be included under this disclosure. Furthermore, while this invention has been described in conjunction with the exemplary embodiments outlined above, various alternatives, modifications, variations, improvements, and/or substantial equivalents, whether known or that are or may be presently unforeseen, may become apparent to those having at least ordinary skill in the art. Accordingly, the exemplary embodiments of the invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

What is claimed is:

1. A method for repairing an unmanned aerial Vehicle, the method comprising:
identifying the Vehicle needing repair;
requesting and receiving authorization to repair the Vehicle from an Enterprise;
scheduling repair of the Vehicle;
scheduling a repair technician to repair the Vehicle;
if the step of repairing is to be executed at a repair depot, shipping the Vehicle to the repair depot;
receiving the Vehicle at the repair depot
repairing the Vehicle;
removing a grounded status of the Vehicle; and
returning the Vehicle to service. Vehicle

2. The method of claim 1, wherein a step of identifying the Vehicle needing repair comprises:
querying a datastore for ‘Down’ Vehicles;
producing a down Vehicle Report;
determining a repair location for the Vehicle;
determining a repair priority for the Vehicle;
estimating a repair date for the Vehicle;
notifying the Enterprise that the Vehicle needs repair;
producing an Enterprise Vehicle Repair Report, including a repair date and time and a repair cost estimate;
sending to the Enterprise the Enterprise Vehicle Repair Report;
preparing and sending to the Enterprise a Vehicle Repair authorization Request Report;

3. The method of claim 1, wherein a step of requesting and receiving authorization to repair the Vehicle comprises:
requesting an Enterprise agent to authorize a Vehicle repair;
initiating a Dispute process;
an Enterprise agent authorizing the Vehicle repair;
initiating a loss mitigation process;
determining parts needed to repair the Vehicle
estimating a Vehicle repair cost;
preparing a Vehicle repair cost estimate Report;
checking an accounts receivable credit limit balance for the Enterprise;
producing a repair Dispute Report; and
producing an Enterprise account balance Report, providing the account balance Report to the Enterprise, and permitting the repair if a credit balance as set forth in the credit balance Report is within a predetermined range or above a predetermined threshold.

4. The method of claim 1, wherein a step of scheduling repair of the Vehicle comprises:
producing a Vehicle Repair Work Order Report;
sending the Vehicle Repair Work Order to flight management operations;
acknowledging receipt of Vehicle Repair Work Order by the flight management operations;
ordering repair parts for the Vehicle;
producing a Vehicle Repair Parts Report identifying repair parts that are to be installed on the Vehicle;
producing a Purchase Order for the repair parts not in inventory;
purchasing the repair parts according to the Purchase Order;
receiving the repair parts and delivering the repair parts to a site of the Vehicle; and
acknowledging receipt of the repair parts;

5. The method of claim 1, wherein a step of shipping the Vehicle to the repair depot comprises:
notifying a Visual Observer to prepare a Vehicle for shipment pickup;
producing a Vehicle Pickup Notice;
advising the Visual Observer to identify shipment pickup and packing requirements for the Vehicle;
requesting the shipment pickup and packing requirements for the Vehicle from a Repair Technician;
producing a shipment packing list and crate Report;
scheduling pick-up and transport of the Vehicle;
producing a crate and Vehicle pickup and shipping Report.
issuing a Purchase Order for the repair to the Enterprise.

6. The method of claim 5, further comprising:
sending crate shipment tracking information to the Visual Observer at a site of the Vehicle;
the Visual Observer receiving the crate and packing the Vehicle in the crate;
sending a notice to the repair technician that the Vehicle is packed and ready for pickup;
the repair technician ordering a shipper to pick-up the crate;
the shipper picking up the crate and delivering the crate to the repair depot;
producing a packing list and a crate tracking information Report;
issuing a Vehicle pickup request;
preparing a Vehicle pickup shipping order Report; and
preparing a shipment pickup and bill of lading Report.

7. The method of claim 1, wherein a step of receiving the Vehicle at the repair depot comprises:
receiving the Vehicle at the repair depot as delivered by a shipper;
unpacking the Vehicle and producing a Vehicle condition Report or a repair Report;
performing a Full Systems Test on the Vehicle and producing a Report based thereon;
based on results of the Full Systems Test, performing a diagnostic analysis on the Vehicle and producing a Report based thereon; and
identifying and ordering from inventory replacement parts for the Vehicle.

8. The method of claim 1, wherein a step of repairing the Vehicle comprises:
updating Vehicle information with new identification numbers and new serial numbers for new parts to be installed during the repair;
producing a Vehicle repair checklist;
producing and providing to the Enterprise and to the flight management operations a Vehicle parts repaired Report and a Vehicle repaired Report and;
notifying the flight management center that a Vehicle has been repaired;
producing a Vehicle repair completion Report;
producing a Vehicle New Parts Report identifying new parts installed in the Vehicle during repair; and
conducting a Full Systems Test and producing a Report describing results of the Full Systems Test.

9. The method of claim 1, wherein a step of removing a grounded status of the Vehicle comprises:
determining a Vehicle is at a location other than an operational site;
packing the Vehicle in a shipping crate;
notifying the Enterprise and the Visual Observer that the Vehicle is being returned to an assigned operational site;
at the operational site, the Visual Observer receiving the crate, unpacking the Vehicle, and notifying a repair technician that the Vehicle has arrived at the operational site;
performing a Full Systems Test on the Vehicle;
the Visual Observer producing a Visual Observer test confirmation Report;
producing a remove Vehicle grounded Report;
producing a packing list of contents of the shipping crate;
producing a notice for the Visual Observer and the Enterprise that the Vehicle has returned to the operational site;
producing a bill of lading for the shipper and the Visual Observer; and
the Visual Observer reporting that the Vehicle is at the operational site.

10. The method of claim 1, wherein a step of returning the Vehicle to service comprises:
the Visual Observer confirming the Vehicle has passed a Full Systems Test and that the Vehicle is ready for service;
notifying the Enterprise that the Vehicle is ready for service;
the Visual Observer reviewing a checklist for securing the Vehicle at the operational site;
flight management operations returning the Vehicle to service status; and
advising the Enterprise that the Vehicle's Return to Service status has been applied to the Vehicle.

11. The method of claim 1, further comprising a step of maintaining a Vehicle on site after removing the grounded status of the Vehicle, the step of maintaining comprising:
determining that the Vehicle is to be maintained onsite;
determining maintenance parts needed to maintain the Vehicle on site and creating a list of the maintenance parts;
determining availability of the maintenance parts in inventory;
requesting delivery of the maintenance parts in inventory;
ordering maintenance parts not available in inventory;
receiving ordered parts;
shipping inventory parts and ordered parts to a repair depot;
receiving the inventory parts and the ordered parts at the repair depot;
updating an inventory of parts in inventory;
producing a maintenance job Report
producing a Vehicle maintenance parts list Report

12. The method of claim xx further comprising a step of shipping repair parts from the repair depot to a site of the Vehicle for repair or maintenance of the Vehicle at the site, the method comprising:
packing the repair parts at the repair depot;
sending a shipping notice and packing list to the site of the Vehicle;
sending the parts to the site of the Vehicle;
receiving the parts at the site of the Vehicle;
scheduling the Vehicle for repair or maintenance.

13. The method of claim 1, further comprising a step of Downing the Vehicle for repair or maintenance:
a repair technician traveling to a site of the Vehicle to repair or maintain the Vehicle;
requesting flight operations management to ‘Down’ the Vehicle;
flight operations management notifying the Enterprise that the Vehicle is ‘Down’ for repair or maintenance;
flight operations management commanding the Vehicle to ‘Down’ via a radio frequency signal if the Vehicle is not ‘Down;’
flight operations management notifying the repair technician that the Vehicle is ‘down’ for repair or maintenance;
the repair technician examining the Vehicle and confirming the Vehicle is ‘down’.

14. The method of claim 1, further comprising a step of requesting flight operations management to change a ‘Down’ status on the Vehicle to a ‘ready’ status, the method comprising:
flight operations management receiving and approving a maintenance job completed Report; and
flight operations management notifying the Enterprise that Vehicle maintenance has been completed and the Vehicle status has been changed from ‘Down’ to ‘Ready.’

15. The method of claim 1 further comprising a step of determining that the Vehicle needs maintenance to be performed at a repair depot, comprising
packing the Vehicle in shipping crate for shipping to the repair depot;
requesting authorization from flight operations management to ship the Vehicle to the repair depot;
shipping the Vehicle to the repair depot;
the Vehicle arriving at the repair depot;
examining the Vehicle for damage and filing a claim with a shipper if damage is identified;
conducting a Full Systems Test and producing a Report of the Full Systems Test;
notifying asset accounting of Vehicle damage and filing a claim with the shipper; and
producing a shipping authorization Report, a packing list, and a bill of lading.

16. A method for performing maintenance operations on an unmanned aerial Vehicle, the method comprising:
scheduling maintenance on the Vehicle;
ordering parts required for maintenance operations;
transporting the parts to a repair technician at a site where the Vehicle is located;
downing the Vehicle;
performing maintenance on the Vehicle at the remote site;
installing parts in Vehicle as necessary;
changing Vehicle status from ‘Down’ to ‘Ready’ after the maintenance has been completed;
updating Vehicle information with information about parts installed, further comprising part ID numbers and part serial numbers;
the repair technician completing a Vehicle Maintenance Job Report;
the repair technician notifying flight operations management that Vehicle maintenance has been completed;
the repair technician requesting flight operation management to send a Full Systems Test command to the Vehicle;
the Vehicle transmitting results of the Full Systems Test results to flight operations management;
the repair technician repairing the Vehicle if the Vehicle did not pass the Full Systems Test or the repair technician confirming the Vehicle passed the Full Systems Test;
producing a Full Systems Test Report and a maintenance Report.

17. The method of claim 1, further comprising a step of shipping the Vehicle to an operational site, the method comprising:
packing the Vehicle;
requesting authorization from the flight operations management to ship the Vehicle to the operational site;
flight operations management authorizing shipment of the Vehicle to the operational site;
flight operations management producing a shipping authorization Report;
producing a packing list and a bill of lading;
shipping the Vehicle to the site; and
the Vehicle arriving at the site.
